(19) United States
(12) Patent Application Publication
(10) Pub. No.: US 2009/0319544 A1
(43) Pub. Date: Dec. 24, 2009

(54) FACILITATING INTEGRATION OF DIFFERENT COMPUTER DATA SYSTEMS

(76) Inventors: James R. Griffin, Charlotte, NC (US); Rebecca D. Griffin, Charlotte, NC (US); Doyle A. Shelton, Pleasant Garden, NC (US); James D. Giffin, Charlotte, NC (US); Christopher M. Beck, Charlotte, NC (US)

Correspondence Address: TILLMAN WRIGHT, PLLC, PO BOX 49309, CHARLOTTE, NC, 28277-0076, US

(21) Appl. No.: 12/175,669

(22) Filed: Jul. 18, 2008

Related U.S. Application Data
(63) Continuation-in-part of application No. 12/143,746, filed on Jun. 20, 2008, now abandoned.

(51) Int. Cl. G06F 17/30

(52) U.S. Cl. 707/100; 707/E17.045

(57) ABSTRACT

A method for facilitating integration of multiple computer data systems may include source-target mapping between first and second data sources of the computer data systems. The method includes mapping, by a user, data fields from the first computer data source of the first computer data system to system-neutral business terms of an object-oriented abstraction layer; mapping, by a user, data fields from the second computer data source of the second computer data system to system-neutral business terms of the object-oriented abstraction layer; and saving the mappings in a computer-readable medium; wherein the object-oriented abstraction layer further comprises business documents, each business document comprising one or more of the business terms of the object-oriented abstraction layer.

### CROSS-REFERENCE TO RELATED APPLICATION

The present application is a U.S. continuation-in-part patent application of, and claims priority under 35 U.S.C. §120 to, U.S. nonprovisional patent application Ser. No. 12/143,746, filed Jun. 20, 2008, which '746 patent application is hereby incorporated herein by reference.

### COPYRIGHT STATEMENT

All of the material in this patent document, including the computer program listing, is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to computer data sources and associated systems and, in particular, to related methods for data migration, data integration, data conversion, upgrades, and implementations.

Information technology (“IT”) landscapes and system architectures do not remain static. Acquisitions and divestitures are normal occurrences. Newly installed software rarely makes it through an implementation cycle before upgrades and changes occur. In contrast to this backdrop, all large enterprise resource planning (“ERP”), electronic data warehousing, and major system changes share common attributes, namely: existing systems and landscapes which are not conducive to major changes; complex business environments; hard-to-decommission legacy systems; high levels of project risk in terms of costs, time and impact to existing processes; data segregated by systems and/or divisions with incompatible standards; inconsistent master data; and complex, multi-team communications.

Large, distributed, cross-system projects create increasingly complex problems to the point that they become an almost insurmountable obstacle to success. Much the same can be said for the problems associated with data integration projects. The same problems appear over and over: project plans that underestimate time and effort while overestimating results; master data management across applications; metadata management across systems; naming standards that vary between different applications; labels (without definitions) that vary between applications; inconsistent reporting standards; inconsistent data governance; and language and vocabulary barriers between teams having different expertise as well as possibly different nationalities and cultures.

Considering the complexity of today's systems and the problems mentioned above, it is no wonder that most projects never achieve the success expected. The reality is that most projects have many common failings.

There comes a point that the effort is too great to make the project (as originally stated) a success. Somewhere before this occurs, smart managers begin the spin and market the project as successful.

IT implementations are rarely done for IT alone. Projects are done to support business—the actions of making, buying, selling and meeting legal obligations. If projects are not done for these reasons or to support these reasons, they are wasteful.

Projects, especially IT-driven projects, have been done the same way for many years. Most improvements are “personal productivity tools”—cell phones, laptops and desktop software tools such as word processing, spreadsheet and presentation software. If anything, there is a more complex mix of electronic documents, mostly inaccurate and out-of-date, being spread throughout an organization at the speed of email.

The end result is that projects have gotten more complex, more costly and more time consuming. As the speed of business worldwide increases, it makes little sense to continue to manage and implement projects by doing more of the same.

Even data implementations with the most advanced tool sets have a basic problem: different departments and teams use different tools and languages to discuss, define, test and approve requirements. While many tools can ‘communicate’ with each other, this usually means that data is replicated into multiple formats.

Further, it is very common to manage different functionalities with different applications. This separation of data requires extensive reviews and manual efforts to insure consistency and quality. Changes over time require extensive management to insure accuracy and consistency. With data in separate applications, new relationships must be manually researched, defined and maintained.

A need exists for improvement in enterprise-wide data management and system integration. This, and other needs, are addressed by implementations, systems, and methods in accordance with one or more preferred embodiments of the present invention.

### SUMMARY OF THE INVENTION

The present invention includes many aspects and features. Moreover, while many aspects and features relate to, and are described in, the context of data migration, data integration, data conversion, upgrades, and implementations, the present invention is not so limited to use only in these contexts as will become apparent from the following summaries and detailed descriptions of aspects, features, and one or more implementations in accordance with preferred embodiments of the present invention.

### SUMMARY EXEMPLARY CONTEXT & IMPLEMENTATION

For example, to remain competitive in today's market, a company must have good data management strategies and processes. In today's global business landscape, competitive advantage depends on timely and effective access to data across an entire enterprise. Furthermore, accuracy, consistency and traceability are no longer optional, but required by laws and regulations. System conversions, interfaces, decommissioning, mergers and acquisitions, master data management and enterprise data warehousing all require managing complex data rules and implementation projects.

A typical EDW implementation often includes the steps of: identifying the source systems; creating logical EDW data model; creating a physical EDW data model; mapping the source systems to the logical or physical model (point-to-point mapping); defining and writing the extract, transform and load (“ETL”) routines; testing and validating mappings and ETL; creating semantic views; creating reports and analytics based on views; and creating an enterprise glossary of business terms and definitions.

While these steps are important, there are additional factors that commonly inhibit implementation performance and, thus, significantly impact costs. Such additional factors include:
Source system inventories are commonly maintained on spreadsheets. If system inventories exist in a relational database management system (“RDBMS”), they typically do not contain the data definition language (“DDL”) that specifies the table and field structures with the associated data types and data lengths.
Logical and physical models developed and maintained in specific data modeling tools.
Mappings between source system and the model are typically done in spreadsheets.
To control and manage document revisions, document management systems are required.
ETL rules and code is maintained in the ETL tools.
Semantic (simplified business model views) can be done in the modeling tool, but usually are in a different tool.
Reports and analytics specifications are normally done in spreadsheets.
Enterprise glossaries of business terms and definitions are in separate tools if done at all.

The problems above are compounded by having work done by multiple people on different functional and technical teams leading to difficult communications. The heavy usage of common desktop software for specifications and documentation for ease-of-use results in increased overhead, lost time and costs as accuracy reviews and consistency checks are done manually in multiple review processes.

Not surprisingly, the results often includes: complexity of design and specifications; high manual effort to control accuracy and consistency; implementation times in years; less functionality (thus less business benefit) than projected; and high failure rates.

Accordingly, an exemplary implementation of a preferred embodiment of the invention such as the software found in and represented by the “Computer Program Listing” section hereof (the “Exemplary Software”) generally relates to transforming enterprise data into business understanding and intelligence and, more specifically, to transforming enterprise data into business understanding and intelligence based on data associated with EDW systems and methods. The Exemplary Software addresses these issues in a simple understandable manner and thereby reduces project times by months and provides fully documented, version-controlled and traceable specifications and documentation.

The Exemplary Software may be described as a three dimensional integration model reconciling and aligning the normally divergent architectures of business goals, processes, systems, applications, data and organization. A holistic integration tool based on understandable business needs and real-life experience, the Exemplary Software does not enforce a specific viewpoint such as an IT or business only perspective. The core concept is an easy-to-understand business document construct with predefined business terms. With over forty predefined documents and thousands of business terms and definitions, project times are dramatically reduced while quality and consistency are radically improved.

The Exemplary Software defines a platform for providing definition and control in large scale data conversion, migration and storage projects. More specifically, the Exemplary Software provides a platform for a controlled methodology and framework for data definition, data organization and data mapping between systems, views, models and reports. Preferably, the Exemplary Software is application-neutral and works with any existing applications, databases and data transform tools. Implementations the Exemplary Software can be used in application system replacement (system migration), establishment of data marts, and data warehouses and system decommissioning. System requirements in preferred implementations include, on the front-end, personal computers with current web browsers; and include, on the backend, a 2-4 processor server, a web server, and a database.

The Exemplary Software may be designed and configured to work with SAP with predefined SAP R/3, SAP ECC and mySAP ERP content and table-field mapping for SAP environments. Using the Exemplary Software, the complex and risky job of mapping SAP data to external sources can be done simply and quickly reducing time and risk. Whether starting a new SAP implementation, managing an enterprise data strategy or implementing an EDW, the Exemplary Software accelerates the implementation speed with increased quality and reduced risk.

The Exemplary Software also may be designed and configured to work with SAP and to provide financial compliance (which characteristic is sometimes referred to as “DX-FCS”). In this respect, the Exemplary Software represents a turn-key data warehouse that meets the specific requirements of IRS and state sales and use tax compliance. A replacement for “SAP Data Retention and Archiving” or “DART”, the Exemplary Software fulfills legal requirements while offering superior proactive reporting and analytics in a database and the elimination of problems often encountered in DART. Instead of simply archiving financial data in text format, the investment can be leveraged for operational and strategic financial reporting while meeting IRS audit requirements.

In accordance with the Exemplary Software, methodology, toolsets and predefined content are rendered in web-based manner for rapid and accurate data definition and mapping between multiple physical and logical systems. The platform replaces the more common, inaccurate and expensive methods of using multiple non-integrated spreadsheets, text, graphics and presentation tools with a single integrated relational database platform. Unlike conventional mapping solutions, the Exemplary Software integrates process and data, and business and technical, seamlessly by providing multiple perspective views of consistent underlying data.

The Exemplary Software is specifically built to handle complex data definition and mapping. Typical projects that benefit from the Exemplary Software include large system replacement, upgrades and implementation; legacy decommissioning; data mart consolidation; enterprise data warehousing; and reporting and analytics definitions. By providing the platform having a predefined extensible data framework, dramatic reductions in implementation time, costs and management overhead are achieved while insuring a rapid accurate and successful implementation.

The Exemplary Software starts with a predefined and customizable layer of abstraction built upon common understandable business objects including: documents, business terms and term definitions. Documents—and the business terms they contain—are associated to processes. The results are immediate communication improvements between business and technical teams. Misunderstandings of term meanings and usage are eliminated. A common, documented and defined language is immediately available. Since the foundation is based on business terms, it is inherently system-neutral. By agreeing on term usage, definitions and relationships at the beginning are thereby determined independent from technical systems and, thus, problems, errors and wasted work effort that would otherwise occur are eliminated.

System inventories and the associated data structures (Data Definition Language) for logical (entities and attributes) and physical (tables and fields) systems are loaded into the system and metadata repositories of the Exemplary Software. By mapping the Data Definition Language to the business document, precise definition, meaning and usage is established for the technical table and field names. The document and business terms become the common linkage for multiple systems. Source to target mapping becomes a database query using the document and business term. Data transform rules can be added at this time at the field level.

This unique two-step approach to mapping through defined business objects results in substantial advantages: standard processes, documents and definitions can be defined in advance; DDL mappings to documents from common commercial applications like SAP ECC can be defined in advance; and validations, data element usages, gap analysis and project metrics are fast and accurate, since all of this particular data resides in a common database.

Core components of the Exemplary Software include these predefined business objects, including: two thousand business terms with definitions; fifty master data objects; sixty cross-reference objects; forty-one transaction objects; seven business processes; and seven star schema reporting views aligned to the business processes. Referring to the drawings, FIG. 1 illustrates common components of various implementations of the Exemplary Software.

The Exemplary Software designed and configured for SAP upon this by further providing predefined SAP ECC mappings to the core components business objects. With over sixty-nine thousand predefined table-field mappings, SAP ECC data integration has never been faster or easier. Predefined mappings to SAP BW standard content also may be provided.

By changing the way projects are done, the Exemplary Software dramatically reduces the time and cost to implement, increases the ability to manage and quantify change and provides a single, consistent and accurate view of any data migration and management project.

FIGS. 2-4 serve to illustrate a unique approach utilized by the Exemplary Software. The approach includes first starting with an application-neutral abstraction layer built from logical business documents. The architecture of each logical document includes segments and business terms with definitions. A pre-configured and populated library of logical documents, terms and definitions exists within the Exemplary Software, and the preconfigured content can be modified or extended, and new documents, terms and definitions can be added, as desired in a particular implementation.

Second, the common point-to-point mapping process is procedurally changed to a two-step process. First, the system DDL (any source or target) is mapped to a logical document. Selecting a source and target system for a specific logical document generates a source-target mapping. ETL rules are added as the second step of the process.

The logical document can replace a logical data model, and the physical model can be generated from the Exemplary Software. Process integrity is insured through defined roles with separate responsibilities and security privileges.

This unique approach has many advantages. For example, the Exemplary Software foundation is web-based and built on a multi-user relational database; everyone working on the integrated design always has up-to-date, accurate information; no version control issues exist and, therefore, no document management systems are required; system inventories and DDL are loaded into the Exemplary Software's metadata repository for consistent usage; inter-team communications become a non-issue due to the logical document construct with defined business terms; teams can work in parallel since technical point-to-point mapping is removed; the enterprise glossary is always up-to-date and a by-product of the approach (no additional cost or time required); validations and consistency checks are built-in and automatic, not manual, and thus quality and accuracy is dramatically improved; multiple views for different teams are available from consistent underlying data (business, technical and data teams view the data as they need it, but without replication or consistency issues); and information about data is readily available, for example, where data is used and where the data has come from (i.e., “data traceability” or “lineage”).

### DX-ADS: User Roles

At least three types of user roles or profiles that can create and modify data and configuration are preferred, each with different objectives and tasks. These three user roles include: Administrator; Architect; and Analyst. Two additional preferred roles, which are view-only consumers of information for reporting and technical specification purposes, include: Project Manager/PMO; and ETL Developer/Architect. Furthermore, for a particular user, the profiles are not exclusive, so the same user may have multiple profiles as part of the user definition. The user roles/profiles are now described in detail.

### DX-ADS: Administrator

The Administrator is responsible for maintaining the client, user roles and security profiles. Typical tasks of this user include: client maintenance including the tasks of adding, changing, and deleting client(s); user maintenance including the tasks of users; and security profile creation and maintenance.

### DX-ADS: Architect

The Architect is responsible for creation and maintenance of logical documents, segments, business terms, term definitions, system inventories and system DDL. Typical tasks of the meta data architect include: loading system DDL; loading model DDL; loading new logical documents; loading external mapping spreadsheets; adding, changing, and deleting business terms; adding aliases to existing business terms; adding, changing, and deleting document types; adding, changing, and deleting logical document definitions (both service provider and client instances); adding, changing, and deleting system/model information; adding, changing, and deleting client specific information (client tables such as division, hardware, operating systems etc); adding, changing, and deleting standard ETL Rules and Comments; and adding and changing versions of logical documents.

### DX-ADS: Analyst

The Analyst is the primary role and is responsible for mapping all system tables and fields or model entities and attributes to the logical document and business terms. Typical tasks of a mapping user include: mapping system table/field to the logical document; mapping model entity/attribute to the logical document; adding/changing ETL rules and comments during the mapping process; assigning system table/field(s) a status of “do not map” for reporting; assigning model entity/attribute(s) a status of “do not map” for reporting; assigning tables to document types (or instances) to reduce mapping effort; and assigning “do not use” flag to terms.

### DX-ADS: View-Only Users

View-only users have access to the reports for validating the logical documents, structures, terms and definitions and mappings. Typical tasks of View-only users include: view logical document instance definitions; view business term definitions; view segment definitions; view mappings by logical document instance; view mappings by system; view mappings by business term(s); view mapping gaps by system; view mapping gaps by logical document instance; view “dashboard” statistics by system, logical document instances; view system-to-system and/or system-to-model mapping to identify gaps and data type/length differences; add comments; view status of mappings by system (e.g., system ABC is 86% mapped); view status of mapping by logical document instance (e.g., purchase order is 99% mapped); view counts of “mapped” vs. “unmapped” vs. “do not map” by system or logical document; view overall project mapping status (e.g., 1500 systems; 8,000 tables; 35,000 fields; and is 45% mapped to logical document instances); highlight and query data type differences (e.g., alpha and numeric); highlight and query data length differences (e.g., 8 bytes vs. 12 bytes); highlight and query mapping gaps between systems; and view and edit all ETL rules and comments with the mappings.

### DX-ADS. Compliance and Progress Tracking

DX-ADS provides complete management and audit capabilities with accuracy in tracking each object through the process. Tracking includes: stage information, which is applicable to documents; status information, which is applicable to documents; state information, which is applicable to documents, segments and terms; and version information, which is applicable to documents. Each is now described in detail below.

### DX-ADS: Stage

The stage information applies to documents, and each primary section of work is divided into stages. Stages represent major divisions of work defined by role responsibility and the stages are separated by stage gates. Stage gates are review and approval points in the process that insure complete and accurate work prior to forward movement in the process. The following Table 1 sets forth six preferred stages for documents. The relationship between these stages in the process is illustrated in FIG. 5.

TABLE 1

| Name | Description |
|---|---|
| Stage 0 | Reference or library documents. |
| Stage 1 | In use by the architect. |
| Stage 2 | In use by the analyst. |
| Stage 3 | Development |
| Stage 4 | Test |
| Stage 5 | Production |

### DX-ADS: Status

The status information describes the position of the document in the work stream of a stage. Statuses are assigned based on the work progress through a stage and stage gate. Once approved, the statuses will start over in the next stage. The following Table 2 sets forth five preferred statuses for documents.

TABLE 2

| Name | Description |
|---|---|
| Waiting (0) | No work has started. |
| In-work (1) | Object is in-work. |
| Approval-Ready (2) | Object is complete and waiting approval. |
| Rejected (3) | Object's approval request is rejected. |
| Approved (4) | Object's approval request is granted. |

### DX-ADS: State

State information applies to documents, segments, and terms. The state information is used to control visibility and actions and can be applied to all document objects: the logical document, segments within the document and terms within the segment. The concept of state allows for the development of complete objects (a document with segments and terms or set of documents) understanding that all of the objects may not be used immediately, but should be available for use at the proper time. For example, many reference documents may exist, but only the ones appropriate to the phase of the project are enabled. The same is true for segments and terms.

While everyone has read-only access to all document objects (enabled or disabled), only the architect can change state from disable to enable. The analyst can see only enabled objects when mapping, thus focusing the work to be done.

Once work on an object is complete, the analysts changes the state from enabled to locked thus insuring no uncontrolled changes are made and reducing the remaining work displayed. This same concept is used when a document is revised in that only the changes to be worked are enabled. The architect controls the complete structure of the document in a holistic manner, but gives visibility to work items to the analyst by enabling objects. The analyst controls the completion of an object by locking the object. The following Table 3 sets forth three preferred states for documents.

TABLE 3

| Name | Description |
|---|---|
| Disabled (0) | 1. The object (term, segment or document) is inactive. |
| | 2. Disabled objects are available for the architect to enable |
| | for use by the analyst for mapping. Disabled objects may |
| | be displayed in a read-only mode for reference, but is |
| | unavailable for mapping. |
| Enabled (1) | 1. The object (term, segment or document) is active |
| | and available for use by the analyst for mapping. |
| | 2. Objects are enabled by the architect. |
| Locked (2) | 1. Once enabled objects are mapped and complete, |
| | they are locked by the analyst. |
| | 2. Locked objects are restricted from further change. |

### DX-ADS: Versioning

Versioning information applies to documents. Documents are controlled through their life-cycle by versioning. A version consists of two parts, a version number and version status. The following rules apply to control consistency: first, when a new version is created, it is assigned a sequentially increasing number starting at “1”; second, only one active version is permitted to exist at any given time; only one draft version can exist at any given time; when a new version is to be activated, the current active version is designated as obsolete, and the approved draft version then is made active; and only draft documents can be deleted. In the normal process, an architect will create a draft document version and enable the appropriate terms and segments (not document) to be worked. Once approved, the document is enabled and promoted to stage 2. Once approved for production, the document state is set to active.

TABLE 4

| | |
|---|---|
| Obsolete (0) | Any version prior to the active version. |
| Active (1) | The version of document in production. |
| Draft (2) | A draft version that is in-work. Once development is |
| | complete and approved, the active version will be made |
| | obsolete and the draft will become active. |

FIGS. 150-191 comprise a presentation demonstrating aspects and features in accordance with the foregoing exemplary platform.

With particular respect to claims, the present invention includes many aspects and features.

One aspect of the present invention relates to a method for facilitating integration of multiple computer data systems. The method includes the steps of providing a platform having predefined content, the predefined content including predefined business terms and logical documents comprised of one or more of the predefined business terms, adding, by a user, additional content to the platform, such additional content including new business terms and new logical documents comprised of one or more of the predefined business terms and the new business terms, and mapping, by a user, data fields from each of the computer data systems to the business terms of the platform.

A second aspect of the present invention relates to a method for facilitating source-target mapping between first and second data sources of first and second computer data systems. The method includes the steps of: (a) mapping, by a user, data fields from the first computer data source of the first computer data system to system-neutral business terms of an object-oriented abstraction layer; (b) mapping, by a user, data fields from the second computer data source of the second computer data system to system-neutral business terms of the object-oriented abstraction layer; and (c) saving the mappings of said steps (a) and (b) in a computer-readable medium; (d) wherein the object-oriented abstraction layer further comprises business documents, each business document comprising one or more of the business terms of the object-oriented abstraction layer.

In a feature of this aspect of the invention, each business term represents an object in an object-oriented computer programming language.

In a feature of this aspect of the invention, each business document representing an object in the object-oriented computer programming language, each business document object being comprised of one or more of the business term objects.

In a feature of this aspect of the invention, the method further includes the step of validating data format of all data fields of the first and second computer data systems that map to the same business term of the object-oriented abstraction layer and determining ETL logic where such data fields do not include the same data format.

In a feature of this aspect of the invention, the method further includes the step of providing target-to-source mappings based on performance of said steps (a), (b) and (c).

In a feature of this aspect of the invention, the method further includes the step of validating data format of all data fields of the first and second computer data systems that map to the same business term of the object-oriented abstraction layer.

In a feature of this aspect of the invention, the method further includes the step of defining, by a user, ETL logic where such data fields do not include the same data format.

In a feature of this aspect of the invention, the method further includes storing the defined ETL logic in computer-readable medium.

In a feature of this aspect of the invention, said step (a) is performed by the user via a web browser.

In a feature of this aspect of the invention, said step (a) is performed by the user over the Internet.

In a feature of this aspect of the invention, said step (b) is performed by a different user via a web browser.

In a feature of this aspect of the invention, the computer-readable medium to which the mappings are stored is located at a central data repository and wherein users performing said steps (a) and (b) are remotely located relative to the central data repository.

In a feature of this aspect of the invention, the users performing said steps (a) and (b) are remotely located relative to each other.

In a feature of this aspect of the invention, access to the central data repository is provided by a first party as a commercial service to a second party and wherein the computer data systems are operated by the second party.

In a feature of this aspect of the invention, the method further includes providing access over the Internet to a software platform that provides graphical user interfaces through which users perform said steps (a) and (b).

In a feature of this aspect of the invention, the access provided to the software platform is provided as part of the commercial service provided by the first party.

A third aspect of the present invention relates to a method for use in integrating multiple computer data systems of third parties. The method includes the steps of, for a particular one of the third parties, providing a platform having predefined content, enabling or disabling, by a user, elements of the predefined content for the system integration of the particular third party, adding, by a user, additional content to the platform for the system integration of the particular third party, and providing a relational specification between the computer data systems using the platform for integration of the computer data systems of the particular third party; for another one of the third parties, providing the same platform having the same predefined content, enabling or disabling, by a user, elements of the predefined content for the system integration of the other third party, adding, by a user, additional content to the platform for the system integration of the other third party, and providing a relational specification between the computer data systems for integration of the computer data systems of the other third party.

In a feature of this aspect of the invention, the step of providing comprises one or more of the steps of displaying the relational specification on a display; printing the relational specification; and saving the relational specification to a computer-readable medium.

In a feature of this aspect of the invention, the method further includes the step of saving, by the user, the mappings to a computer-readable medium.

In addition to the aforementioned aspects and features of the present invention, it should be noted that the present invention further encompasses the various possible combinations and subcombinations of such aspects and features.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 illustrates components in accordance with a preferred embodiment of the invention;

FIGS. 2-4 illustrate an example of a logical document including architecture and mappings associated therewith;

FIG. 5 illustrates relationships in process flow between stages applicable to documents;

FIGS. 6A-B are flowcharts depicting implementation of varied work statuses and work stages in accordance with a preferred embodiment of the present invention;

FIG. 7A is a website screenshot of an intro page of in accordance with a preferred embodiment of the present invention;

FIG. 7B is a website screenshot of a login page in accordance with a preferred embodiment of the present invention;

FIG. 8A is a website screenshot of a user page home tab in accordance with a preferred embodiment of the present invention, depicting a plurality of paper icons;

FIG. 8B is a website screenshot of the user page home tab of FIG. 8, depicting a backlit paper icon;

FIG. 9 is a website screenshot of the user page home tab of FIG. 8 after a user has clicked on the paper icon associated with the design work stage;

FIG. 10 is a website screenshot of the user page home tab of FIG. 8 after a user has clicked on the paper icon associated with the mapping work stage;

FIG. 11 is a website screenshot of the user page home tab of FIG. 8 after a user has clicked on the paper icon associated with the development work stage;

FIG. 12 is a website screenshot of the user page home tab of FIG. 8 after a user has clicked on the paper icon associated with the testing work stage;

FIG. 13 is a website screenshot of the user page home tab of FIG. 8 after a user has clicked on the paper icon associated with the production work stage;

FIG. 14 is a website screenshot of the user page home tab of FIG. 8, depicting an interactive chart with a plurality of expandable menus;

FIG. 15 is a website screenshot of the user page home tab of FIG. 14, depicting an expandable menu in an expanded form;

FIG. 16 is a website screenshot of a user page components tab in accordance with a preferred embodiment of the present invention;

FIG. 17 is a website screenshot of the user page components tab of FIG. 16, depicting a document types subpage;

FIG. 18 is a website screenshot of the document types subpage of FIG. 17 after a user has searched for the text “transaction” in a search field;

FIG. 19 is a website screenshot of the document types subpage of FIG. 17 after a user has cleared the search field;

FIG. 20 is a website screenshot of the user page components tab of FIG. 16, depicting a document type details subpage associated with the document types subpage;

FIG. 21 is a website screenshot of the document type details subpage of FIG. 20, depicting a history subpage associated therewith;

FIG. 22 is a website screenshot of the document type details subpage of FIG. 20, depicting a document type editing subpage associated therewith;

FIG. 23 is a website screenshot of the document types subpage of FIG. 17, depicting a document type identifier and associated document type descriptor together in a highlighted row;

FIG. 24 is a website screenshot of the document types subpage of FIG. 17, depicting a document type editing interface associated with an edit icon of a selected row;

FIG. 25 is a website screenshot of the document types subpage of FIG. 17, depicting a document type creation interface;

FIG. 26 is a website screenshot of the user page components tab of FIG. 16, depicting a document classes subpage;

FIG. 27 is a website screenshot of the user page components tab of FIG. 16, depicting a document class details subpage associated with the document classes subpage;

FIG. 28 is a website screenshot of the document class details subpage of FIG. 27, depicting a document class editing subpage associated therewith;

FIG. 29 is a website screenshot of the user page components tab of FIG. 16, depicting a document segments subpage;

FIG. 30 is a website screenshot of the user page components tab of FIG. 16, depicting a document segment details subpage associated with the document segments subpage;

FIG. 31 is a website screenshot of the document segment details subpage of FIG. 30, depicting a document segment editing subpage associated therewith;

FIG. 32 is a website screenshot of the user page components tab of FIG. 16, depicting a business terms subpage;

FIG. 33 is a website screenshot of the user page components tab of FIG. 16, depicting a business term details subpage associated with the business terms subpage;

FIG. 34 is a website screenshot of the business term details subpage of FIG. 33, depicting a business term editing subpage associated therewith;

FIG. 35 is a website screenshot of the user page components tab of FIG. 16, depicting a business processes subpage;

FIG. 36 is a website screenshot of the user page components tab of FIG. 16, depicting a business process details subpage associated with the business processes subpage;

FIG. 37 is a website screenshot of the business process details subpage of FIG. 36, depicting a business process editing subpage associated therewith;

FIG. 38 is a website screenshot of the user page components tab of FIG. 16, depicting a business areas subpage;

FIG. 39 is a website screenshot of the user page components tab of FIG. 16, depicting a business area details subpage associated with the business areas subpage;

FIG. 40 is a website screenshot of the business area details subpage of FIG. 39, depicting a business area editing subpage associated therewith;

FIG. 41 is a website screenshot of the user page components tab of FIG. 16, depicting a system types subpage;

FIG. 42 is a website screenshot of the user page components tab of FIG. 16, depicting a system type details subpage associated with the system types subpage;

FIG. 43 is a website screenshot of the business area details subpage of FIG. 42, depicting a system type editing subpage associated therewith;

FIG. 44 is a website screenshot of the user page components tab of FIG. 16, depicting a projects subpage;

FIG. 45 is a website screenshot of the user page components tab of FIG. 16, depicting a project details subpage associated with the projects subpage;

FIG. 46 is a website screenshot of the business area details subpage of FIG. 45, depicting a project editing subpage associated therewith;

FIG. 47A is a website screenshot of the user page components tab of FIG. 16, depicting a project phases subpage;

FIG. 47B is a website screenshot of the user page components tab of FIG. 16, depicting a project phase reordering page;

FIG. 48 is a website screenshot of the user page components tab of FIG. 16, depicting a project phase details subpage associated with the project phases subpage;

FIG. 49 is a website screenshot of the business area details subpage of FIG. 48, depicting a project phase editing subpage associated therewith;

FIG. 50 is a website screenshot of the user page components tab of FIG. 16, depicting a project stages subpage;

FIG. 51 is a website screenshot of the user page components tab of FIG. 16, depicting a document priorities subpage;

FIG. 52 is a website screenshot of the user page components tab of FIG. 16, depicting an object states subpage;

FIG. 53 is a website screenshot of the user page components tab of FIG. 16, depicting an object locks subpage;

FIG. 54 is a website screenshot of the user page components tab of FIG. 16, depicting a version statuses subpage;

FIG. 55 is a website screenshot of the user page components tab of FIG. 16, depicting a work statuses subpage;

FIG. 56 is a website screenshot of the user page components tab of FIG. 16, depicting a business term classes subpage;

FIG. 57 is a website screenshot of a user page systems tab in accordance with a preferred embodiment of the present invention;

FIG. 58 is a website screenshot of the user page systems tab of FIG. 57, depicting an add new system page;

FIG. 59 is a website screenshot of the user page systems tab of FIG. 57, depicting a search field for finding a system;

FIG. 60 is a website screenshot of the user page systems tab of FIG. 57, depicting a set of systems returned from a search using the search field;

FIG. 61 is a website screenshot of the user page systems tab of FIG. 57, depicting a system details subpage;

FIG. 62 is a website screenshot of the system details subpage of FIG. 61, depicting a data table editing interface;

FIG. 63 is a website screenshot of the system details subpage of FIG. 61, depicting a data field identifier and associated data field descriptor together in a highlighted row;

FIG. 64 is a website screenshot of the system details subpage of FIG. 61, depicting a data field editing interface associated with the highlighted row;

FIG. 65 is a website screenshot of the system details subpage of FIG. 61, depicting a data table details subpage;

FIG. 66 is a website screenshot of the data table details subpage of FIG. 65, depicting a data field identifier and associated data field descriptor together in a highlighted row;

FIG. 67A is a website screenshot of the system details subpage of FIG. 61, depicting a data field details subpage associated therewith and with the data table details subpage;

FIG. 67B is a website screenshot of the data field details subpage of FIG. 67A, depicting logical documents associated with a data field;

FIG. 68 is a website screenshot of the user page systems tab of FIG. 57, depicting a data table creation page;

FIG. 69 is a website screenshot of the system details subpage of FIG. 61, depicting a system editing interface;

FIG. 70 is a website screenshot of the system details subpage of FIG. 61, depicting mapping bundle memberships;

FIG. 71 is a website screenshot of the system details subpage of FIG. 61, depicting a search field and cancel button;

FIG. 72A is a website screenshot of the system details subpage of FIG. 61, depicting data table identifiers returned in a search;

FIG. 72B is a website screenshot of the system details subpage of FIG. 61, depicting data field identifiers returned in a search;

FIG. 73 is a website screenshot of the system details subpage of FIG. 61, depicting details associated with a system;

FIG. 74A is a website screenshot of the system details subpage of FIG. 61, depicting a descriptions button toggled so as to display descriptors;

FIG. 74B is a website screenshot of the system details subpage of FIG. 61, depicting a descriptions button toggled so as not to display descriptors;

FIG. 75 is a website screenshot of the data table details subpage of FIG. 65, depicting an options bar;

FIG. 76 is a website screenshot of the data table details subpage of FIG. 65, depicting a data field creation page associated therewith;

FIG. 77 is a website screenshot of the data table details subpage of FIG. 65, depicting mapping bundle memberships associated therewith;

FIG. 78 is a website screenshot of the data table details subpage of FIG. 65, depicting data field identifiers returned in a search;

FIG. 79 is a website screenshot of the data table details subpage of FIG. 65, depicting details associated with a data table;

FIG. 80 is a website screenshot of the data field details subpage of FIG. 67A, depicting an options bar;

FIG. 81 is a website screenshot of the data field details subpage of FIG. 67A, depicting a data field editing page;

FIG. 82 is a website screenshot of the data field details subpage of FIG. 67A, depicting details associated with a data field;

FIG. 83A is a website screenshot of the user page systems tab of FIG. 57, depicting a system connections page;

FIG. 83B is a website screenshot of the user page systems tab of FIG. 57, depicting a system connection creation interface;

FIG. 84A is a website screenshot of the user page systems tab of FIG. 57, depicting an upload subpage;

FIG. 84B is a website screenshot of the user page systems tab of FIG. 57, depicting a template for spreadsheet formatting;

FIG. 84C is a website screenshot of the user page systems tab of FIG. 57, depicting an information page for providing information pertaining to an upload;

FIG. 85A is a website screenshot of a user page logical documents tab in accordance with a preferred embodiment of the present invention;

FIG. 85B is a website screenshot of the user page logical documents tab of FIG. 85A, depicting an add new document page;

FIG. 86 is a website screenshot of the user page logical documents tab of FIG. 85A, depicting a search field for finding a document;

FIG. 87 is a website screenshot of the user page logical documents tab of FIG. 85A, depicting a document details subpage;

FIG. 88 is a website screenshot of the document details subpage of FIG. 87, depicting a document segment editing interface;

FIG. 89 is a website screenshot of the document details subpage of FIG. 87, depicting a business term creation interface;

FIG. 90 is a website screenshot of the document details subpage of FIG. 87, depicting a document segment creation interface;

FIG. 91 is a website screenshot of the document details subpage of FIG. 87, depicting a business term identifier displayed for each business term of each document segment;

FIG. 92 is a website screenshot of the document details subpage of FIG. 87, depicting a business term editing interface;

FIG. 93 is a website screenshot of the document details subpage of FIG. 87, depicting a document segment details subpage associated therewith;

FIG. 94 is a website screenshot of the document segment details subpage of FIG. 93, depicting a business term identifier and associated business term descriptor together in a highlighted row;

FIG. 95A is a website screenshot of the document details subpage of FIG. 87, depicting a business term details subpage associated therewith and with the document segment details subpage;

FIG. 95B is a website screenshot of the business term details subpage of FIG. 95A, depicting systems associated with a business term;

FIG. 96A is a website screenshot of the document details subpage of FIG. 87, depicting an options bar;

FIG. 96B is a website screenshot of the document details subpage of FIG. 87, depicting a demote button if a document is in mapping mode;

FIG. 97 is a website screenshot of the document details subpage of FIG. 87, depicting whether a document is contained in a mapping bundle;

FIG. 98 is a website screenshot of the document details subpage of FIG. 87, depicting document segment identifier returned in a search;

FIG. 99 is a website screenshot of the document details subpage of FIG. 87, depicting details associated with a document;

FIG. 100A is a website screenshot of the document details subpage of FIG. 87, depicting descriptions button toggled so as to display descriptors;

FIG. 100B is a website screenshot of the document details subpage of FIG. 87, depicting descriptions button toggled so as not to display descriptors;

FIG. 101 is a website screenshot of the document details subpage of FIG. 87, depicting a hierarchy of document segments of a document;

FIG. 102 is a website screenshot of the user page logical documents tab of FIG. 85A, depicting a validation page;

FIG. 103 is a website screenshot of the user page logical documents tab of FIG. 85A, depicting a change page;

FIG. 104 is a website screenshot of the user page logical documents tab of FIG. 85A, depicting an approvers page;

FIG. 105A is a website screenshot of the user page logical documents tab of FIG. 85A, depicting an approver editing page;

FIG. 105B is a website screenshot of the user page logical documents tab of FIG. 85A, depicting an approver creation page;

FIG. 106 is a website screenshot of the user page logical documents tab of FIG. 85A, depicting a document segment creation page;

FIG. 107 is a website screenshot of the user page logical documents tab of FIG. 85A, depicting a document editing interface;

FIG. 108 is a website screenshot of the document segment details subpage of FIG. 93, depicting an options bar;

FIG. 109 is a website screenshot of the user page logical documents tab of FIG. 85A, depicting a business term creation page;

FIG. 110 is a website screenshot of the business term details subpage of FIG. 95A, depicting an options bar;

FIG. 111 is a website screenshot of a user page relationships tab in accordance with a preferred embodiment of the present invention;

FIG. 112A is a website screenshot of the user page relationships tab of FIG. 111, depicting an expandable menu in an expanded form to display links associated with business processes;

FIG. 112B is a website screenshot of the user page relationships tab of FIG. 111, depicting a menu page associated with business processes;

FIG. 113 is a website screenshot of the user page relationships tab of FIG. 111, depicting a set of results returned from a search using a search field;

FIG. 114 is a website screenshot of the user page relationships tab of FIG. 111, depicting a definitions button toggled so as not to display descriptors;

FIG. 115 is a website screenshot of the user page relationships tab of FIG. 111, depicting a relationship details subpage;

FIG. 116 is a website screenshot of the user page relationships tab of FIG. 111, depicting a relationships editing page;

FIG. 117 is a website screenshot of the user page relationships tab of FIG. 111, depicting a reordering page;

FIG. 118 is a website screenshot of a user page mappings tab in accordance with a preferred embodiment of the present invention;

FIG. 119 is a website screenshot of the user page mappings tab of FIG. 118, depicting a mapping bundle subpage;

FIG. 120 is a website screenshot of the mapping bundle subpage of FIG. 119, depicting an assignment interface;

FIG. 121A is a website screenshot of the mapping bundle subpage of FIG. 119, depicting a mapping button;

FIG. 121B is a website screenshot of the mapping bundle subpage of FIG. 119, depicting a mappings editor page;

FIG. 121C is a website screenshot of the mapping bundle subpage of FIG. 119, depicting a select data tables page;

FIGS. 122A-C are website screenshots of the mappings editor page of FIG. 121B, depicting mapping of data fields;

FIG. 123A is a website screenshot of the mapping bundle subpage of FIG. 119, depicting an ETL editor button;

FIG. 123B is a website screenshot of the mapping bundle subpage of FIG. 119, depicting an expandable menu for each mapped document segment;

FIGS. 123C-D are website screenshots of the mapping bundle subpage of FIG. 119, depicting an ETL interface;

FIG. 124A is a partial website screenshot of a user page account tab in accordance with a preferred embodiment of the present invention;

FIG. 124B is a partial website screenshot of the user page account tab of FIG. 124A, depicting a permission set interface;

FIG. 124C is a partial website screenshot of the user page account tab of FIG. 124A, depicting a developer page;

FIG. 124D is a partial website screenshot of the user page account tab of FIG. 124A, depicting an account update interface;

FIG. 125A is a website screenshot of a user page dashboard tab in accordance with a preferred embodiment of the present invention;

FIG. 125B is a website screenshot of the user page dashboard tab of FIG. 125A, depicting a critical documents page;

FIG. 125C is a website screenshot of the user page dashboard tab of FIG. 125A, depicting a waiting approval page;

FIG. 125D a partial website screenshot of the user page dashboard tab of FIG. 125A, depicting an issues page;

FIG. 125E a partial website screenshot of the user page dashboard tab of FIG. 125A, depicting an issue information screen;

FIG. 125F a partial website screenshot of the user page dashboard tab of FIG. 125A, depicting an issue editing interface;

FIG. 125G a partial website screenshot of the user page dashboard tab of FIG. 125A, depicting a resolution interface;

FIG. 125H is a website screenshot of the user page dashboard tab of FIG. 125A, depicting a documents and terms page;

FIGS. 125I-L are website screenshots of the user page dashboard tab of FIG. 125A, depicting phase information associated with a project phase dashboard page;

FIG. 126A is a website screenshot of a user page reports tab in accordance with a preferred embodiment of the present invention;

FIG. 126B is a website screenshot of the user page reports tab of FIG. 126A, depicting a mapping gap identification report page;

FIGS. 126C-D are website screenshots of the user page reports tab of FIG. 126A, depicting a report generated by the mapping gap identification report page;

FIG. 126E is a website screenshot of the user page reports tab of FIG. 126A, depicting a system to system mappings report page;

FIG. 126F is a website screenshot of the user page reports tab of FIG. 126A, depicting a report generated by the system to system mappings report page;

FIG. 126G is a website screenshot of the user page reports tab of FIG. 126A, depicting a mapping statistics report page;

FIG. 126H is a website screenshot of the user page reports tab of FIG. 126A, depicting a report generated by the mapping statistics report page;

FIG. 126I is a website screenshot of the user page reports tab of FIG. 126A, depicting an enterprise glossary report page;

FIG. 126J is a website screenshot of the user page reports tab of FIG. 126A, depicting a directory page;

FIG. 126K is a website screenshot of the user page reports tab of FIG. 126A, depicting a logical document display page;

FIG. 127A is a website screenshot of a locations bar in accordance with a preferred embodiment of the present invention;

FIG. 127B is a website screenshot of a log issues interface in accordance with a preferred embodiment of the present invention;

FIGS. 128-139 are website screenshots depicting a method in accordance with a preferred embodiment of the present invention;

FIG. 140 is a flowchart of a process for mapping two systems to a logical document and creating ETL rules in accordance with a preferred embodiment of the present invention;

FIGS. 141-149 are diagrams depicting various uses and implementations in accordance with a preferred embodiment of the present invention;

FIGS. 150-191 comprise a presentation demonstrating aspects and features in accordance with an embodiment of the present invention;

FIG. 192 is an illustration of a contemplated graphical display of a project configurator in accordance with an embodiment of the present invention;

FIG. 193 is an illustration of the contemplated graphical display of FIG. 192, illustrating how shading may be utilized;

FIG. 194 is an illustration of a system display of the contemplated graphical display of FIG. 192;

FIG. 195 is an illustration of how project management statistics may be depicted via the contemplated graphical display of FIG. 192;

FIG. 196 is an illustration of how pre-defined business model content may be utilized in the contemplated graphical display of FIG. 192;

FIG. 197 is an illustration of how “what if” scenarios may be considered using the graphical user interface of FIG. 192;

FIG. 198 is a screenshot from the Access database software application, illustrating an expression builder tool;

FIG. 199A is a series of exemplary screenshots illustrating the entry of a base business term;

FIG. 199B is a series of exemplary screenshots illustrating the entry of a business term alias;

FIG. 199C is a series of exemplary screenshots illustrating the entry of a derived business term;

FIG. 200 is a flowchart of a process flow in accordance with an embodiment of the present invention;

FIG. 201 illustrates a configuration task of FIG. 200 in more detail;

FIG. 202 illustrates a document design task of FIG. 200 in more detail;

FIG. 203 illustrates a mapping task of FIG. 200 in more detail;

FIG. 204 illustrates actions that may be taken on a plurality of tabs of preferred software and platforms, and the associated effects such actions may have on actions that may be taken on other tabs.

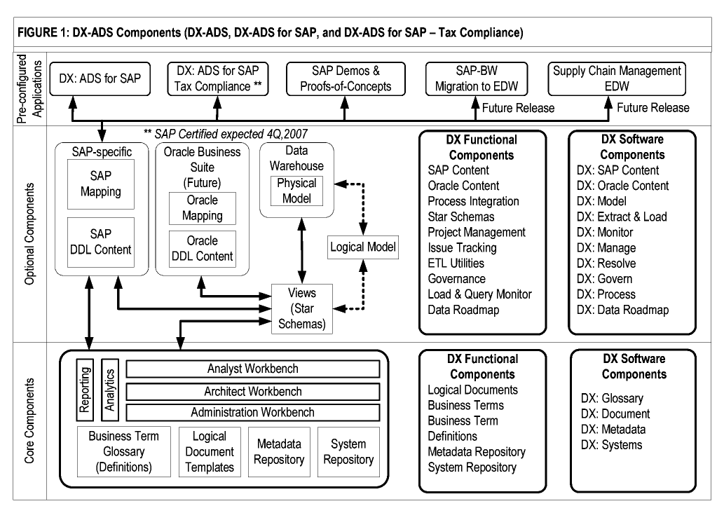

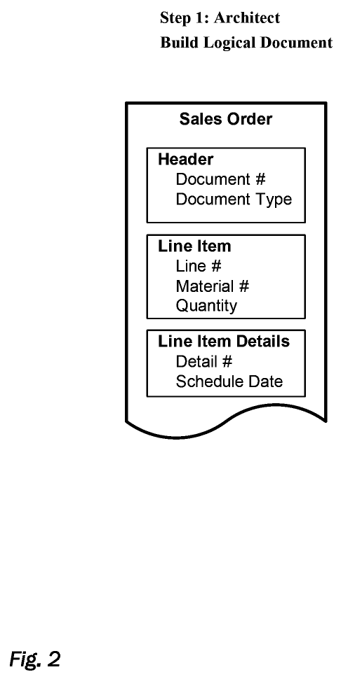

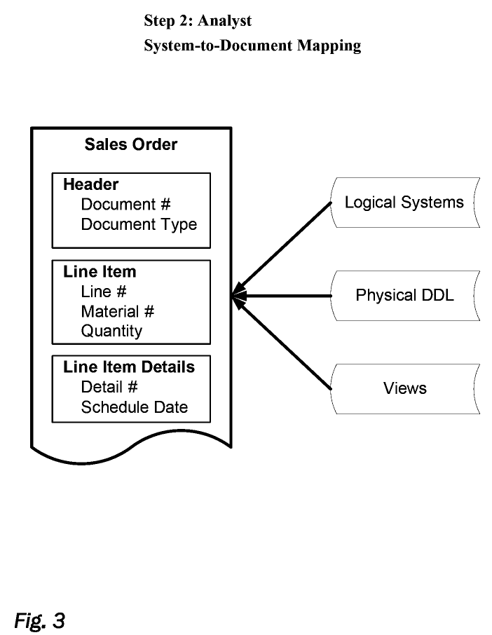

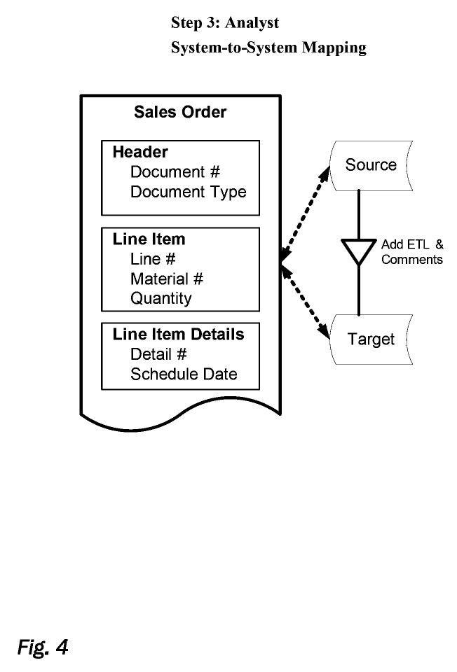

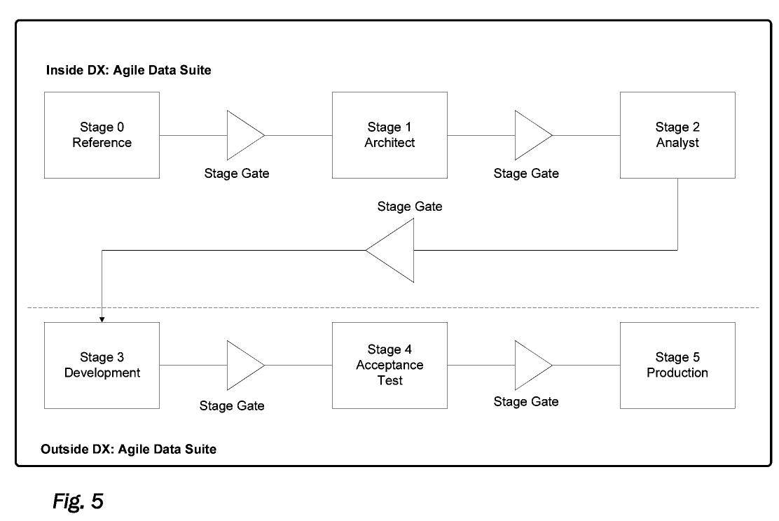

Moreover, it will be appreciated that several of the screenshots of the foregoing drawings include a frame that may be collapsed and expanded and that in several of the screenshots such frame is indeed shown in the collapsed state.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is it to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

With reference now to the drawings, one or more preferred embodiments of the present invention are now described in detail. As will be appreciated, one or more preferred embodiments of the present invention enable rapid and accurate data definition and mapping between multiple systems.

In the context of software and platforms in accordance with preferred embodiments of the invention, a “system” and, more particularly, a “computer data system” of a company, includes a data source and, most likely, software, an associated database, and data contained therein for a company. Each such system may correspond to any business system of a company such as, for example, manufacturing systems (e.g., engineering, bills of material, scheduling, capacity, workflow management, quality control, cost management, manufacturing process, manufacturing projects, manufacturing flow); supply chain management systems (e.g., inventory, order entry, purchasing, product configurator, supply chain planning, supplier scheduling, inspection of goods, claim processing, commission calculation); financial systems (e.g., general ledger, cash management, accounts payable, accounts receivable, fixed assets); projects systems (e.g., costing, billing, time and expense, activity management); human resources (human resources, payroll, training, time & attendance, rostering, benefits); and customer relationship management systems (e.g., sales and marketing, commissions, service, customer contact and call center support).

In the preferred software and platforms, such systems are represented by a collection of data, and more specifically by a collection of metadata pertaining to such systems. Indeed, a user may define a plurality of systems as needed and desired, such as when a new systems is incorporated into the business. Each system may be described by a system type. A user may define systems of various system types, and may even define the system types that he or she wishes to define systems for, as set forth below. In at least some embodiments, the preferred software and platforms come predefined with application, business intelligence, logical model, physical model, and/or semantic layer system types.

Each system may have a plurality of data fields. These data fields themselves are organized in data tables of the system. A user may define the data fields and data tables of each system such that references to the data stored in each system will be included in the preferred software and platforms.

The plurality of systems may each be mapped to one or more logical documents, sometimes referred to simply as documents. These logical documents are constructed from components, which are the building blocks of the preferred software and platforms. These components include two types of components, document components and application components. Document components are used to construct the logical documents and/or related objects, and include document types, document classes, document segments, business terms, business processes, business areas, and system types. Document components may be created, edited, and deleted within the preferred software and platforms.

A logical document comprises a certain document type and is classified within a certain document class. Document types indicate what the document contains, while document classes indicate how the document is used. Further, a logical document may include a number of document segments. Each of these segments may in turn include child segments, or sub-segments. These sub-segments may in turn have their own child segments, etc. Each segment preferably includes at least one business term. The preferred software and platforms allow data fields of a system to be mapped to business terms of a document.

Additionally, the preferred software and platforms allow a connection to be defined between a target system and a source system. Once multiple systems are mapped to the same logical document, and a system connection is defined between the systems, extract, transform, and load (“ETL”) rules may be defined for converting data contained in a data field of a source system into a format utilized in a data field of a target system. In this way, each of the data fields of each of the plurality of systems need only be mapped once, to logical documents, rather than mapping each data field to each system that needs its data.

Other components are utilized to enhance this process. Specifically, business processes and business areas are two document components that are used to group documents. Business processes define a broad sequence of events and actions. They are used to group documents that are used in the process. Business areas tend to be smaller groupings of documents and do not indicate a sequence of events, only a logical grouping. A document may be defined as belonging to one or more business processes or areas.

The preferred software and platforms utilize application components to further enhance this process. Projects may be defined to separate distinct undertakings being performed on the preferred software and platforms. Project phases may likewise be defined as pieces of a larger project.

In at least some embodiments of the invention, there are five predefined project stages: a design stage, a mapping stage, a development stage, a testing stage, and a production stage. In alternative embodiments different stages may be defined, and in at least some alternative embodiment users may be able to define their own stages.

In at least some embodiments of the invention, there are four predefined document priorities: critical, high, medium, and low. Users may set the priority of documents to high, medium or low, but only the system may set the priority of documents to critical. In alternative embodiments different priorities may be defined and, in at least some alternative embodiments, users may be able to define their own priorities.

In at least some embodiments of the invention, there are two predefined object states. Disabled objects (terms, segments or documents) are inactive. Disabled objects may, however, be enabled. Disabled objects may be displayed in a read-only mode for reference, but are unavailable for mapping unless enabled. Enabled objects are active and available for mapping. Objects may be enabled by any developer with the appropriate permission. In alternative embodiments, different states may be defined and, in at least some alternative embodiments, users may be able to define their own states.

Locks are defined in such a way as to allow an object to be either locked or unlocked. An unlocked object may be changed. A locked object may not be changed. Active and obsolete document versions are locked to prevent any change to any object. In order for a change to occur, a new draft must be created. In alternative embodiments, different locks may be defined and, in at least some alternative embodiments, users may be able to define their own locks.

A document may include a version status. Multiple document objects may be associated with each other as different versions of the same document. In at least some embodiments of the invention, there are four predefined version statuses. A reference status applies to a reference document. Reference documents must be copied into a draft version before modification. A draft status signifies a version is in-work. Once development is complete and approved, the active version will be made obsolete and the draft will become active. An active status designates the version of document in production. An obsolete status is appropriate for any version prior to the active version. Active versions must be set to obsolete before a draft can be made active. In alternative embodiments, different statuses may be defined and, in at least some alternative embodiments, users may be able to define their own statuses.

In at least some embodiments of the invention, there are six predefined work statuses. A “none” work status signifies no work has started. An “in-work” work status signifies an object is in-work. A “waiting approval” work status signifies an object is complete and waiting approval. A “rejected” work status signifies an object's approval request was rejected and must be entered back into the work stream as “in-work” status. This also triggers a change in the document's priority to critical. An “approved” work status signifies an object's approval request was granted, and the work status is thus set to complete. Once complete, the document moves to the next stage and the status is returned to none.

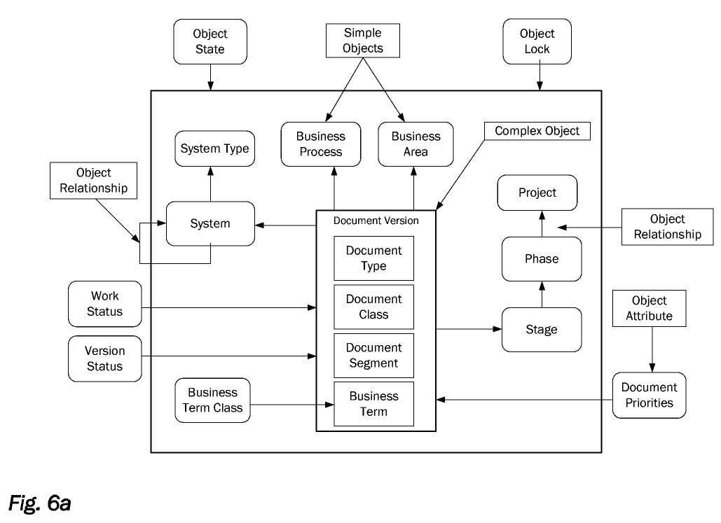

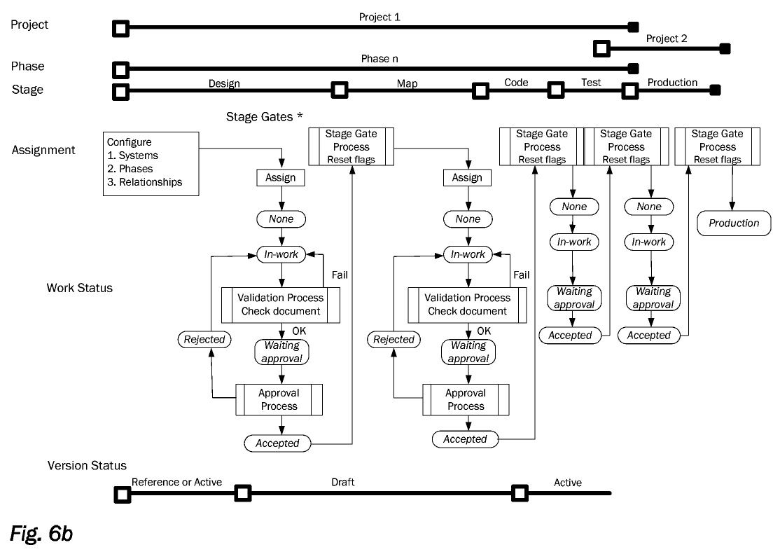

FIG. 6B is a flowchart illustrating how work statuses and project stages may be utilized in one efficient process. At each work stage, an assignment is made to a developer, at which point the status is in-work. The developer completes his work, has it validated if appropriate, and then sets the status to waiting approval. A document is either rejected, at which point it returns to being in-work, or else is accepted, at which point it moves on to the next stage and all flags are reset. Its priority is reset to medium, and it is reset to the none work stage and assigned to a developer. The process repeats through the work stages until the document is accepted at the test stage, and then it goes into production.

In at least some embodiments, each document is a complex object having a document type object, a document class object, one or more document segment and sub-segment objects, and one or more business term objects, as can be seen in FIG. 6A. Each business term object may be associated with a business term class object. The document version object may have a work status attribute, a version status attribute, and a document priority attribute.

The document object may be associated with a stage object, which itself may be associated with a project phase object, which itself may be associated with a project object.

The document object further may be associated with a system object, which itself may be associated with a system type object. The document version object may still further be associated with a business process object and a business area object.

Each object may have a state attribute and a lock attribute.

It will be appreciated that in at least some embodiments, documents presented as versions of the same document are actually distinct document objects, which can perhaps be more easily understood as document version objects.

### ADS: A Preferred Embodiment

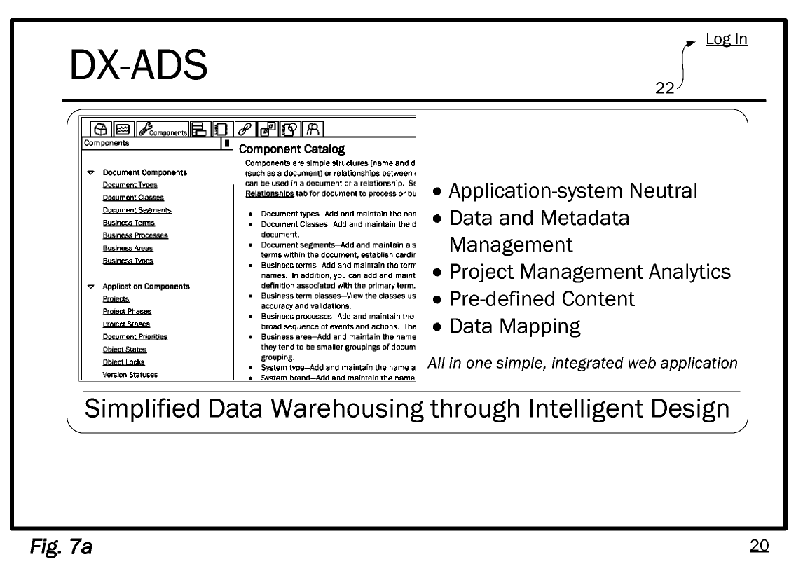

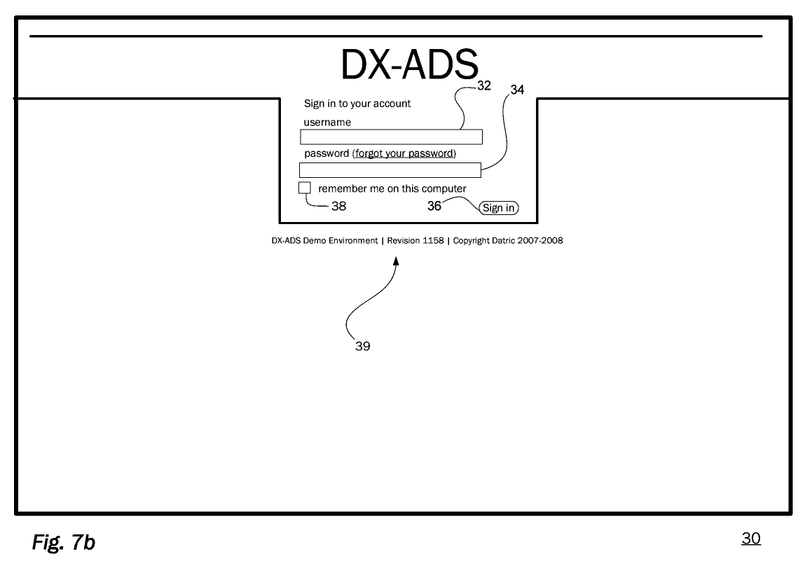

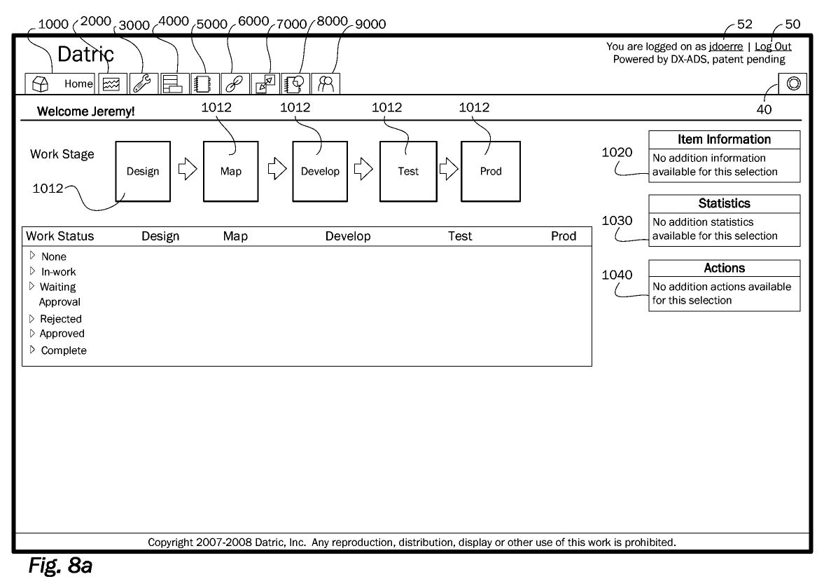

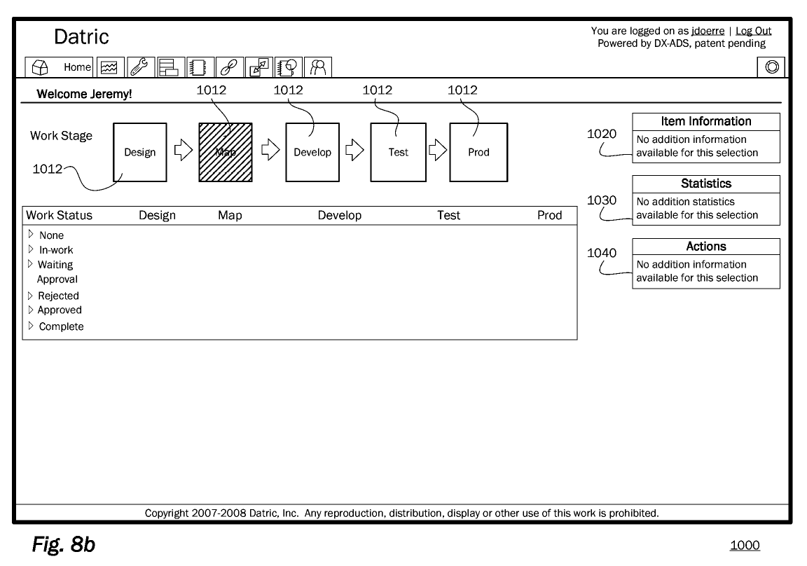

In a preferred commercial implementation, one or more aspects of the present invention are embodied in the form of a web-based software application. In particular, the web-based software application is provided to users in the form of a web site with which one or more users may interact. FIG. 7A is a screenshot of an intro page 20 of a website in accordance with a preferred embodiment of the present invention. The intro page 20 may be accessed by a user by pointing a web browser to a particular URL corresponding to the intro page 20. The intro page 20 includes a login link 22. A user may click on the login link 22 to effect navigation to a login page 30 of the website, a screenshot of which is provided in FIG. 7B. It will be appreciated by the Ordinary Artisan, however, that alternatively, a user may be able to access the login page 30 directly by pointing a web browser to a particular URL corresponding to the login page 30. In the login page 30, a user must enter a user name and password into a respective user field 32 and password field 34 and then click on a sign in button 36 in order to log in. The login page 30 also preferably includes a memory check box 38. A user may click on the memory check box 38 before clicking the sign in button 36 to save his or her sign in information so that he or she will not have to re-enter it every time he or she visits the website. The login page 30 further includes version information 39 associated with the website. When a user enters his or her login and password information into the respective user and password fields 32,34 and clicks the sign in button 36, the login and password information is validated. If the login and password information is found valid, the user is logged in and navigation is effected to a user page of the website, which user page initially displays a home tab 1000, as can be seen in FIG. 8. The user page further includes a dashboard tab 2000, a components tab 3000, a systems tab 4000, a logical documents tab 5000, a relationships tab 6000, a mappings tab 7000, a reports tab 8000, and an account tab 9000. Further still, the user page includes a help link 40, and a log out link 50. The help link 40 will effect navigation to information providing instruction on how to use the website, while the log out link 50 will cause a user to log out of the website. Proximate the log out link 50 is an account link 52, which will effect navigation to the account tab 9000 when clicked.

### Home Tab

FIG. 8A is a screenshot of the home tab 1000 of the user page. Displayed proximate a top of the home tab 1000 is a visual representation of a plurality of work stages in the form of a plurality of paper icons 1012. These work stages include design, mapping, development, testing, and production. When a user mouses over one of the plurality of paper icons 1012, the one of the plurality of paper icons 1012 is backlit, as can be seen in FIG. 8B.

Further, an item information box 1020, a statistics box 1030, and an actions box 1040 are displayed proximate a right side of the home tab 1000. A user may click on one of the paper icons 1012 to display information, statistics, and actions pertaining to the work stage associated with that icon in the boxes 1020,1030,1040. Additionally, when a user clicks on a paper icon 1012, that paper icon 1012 is backlit.

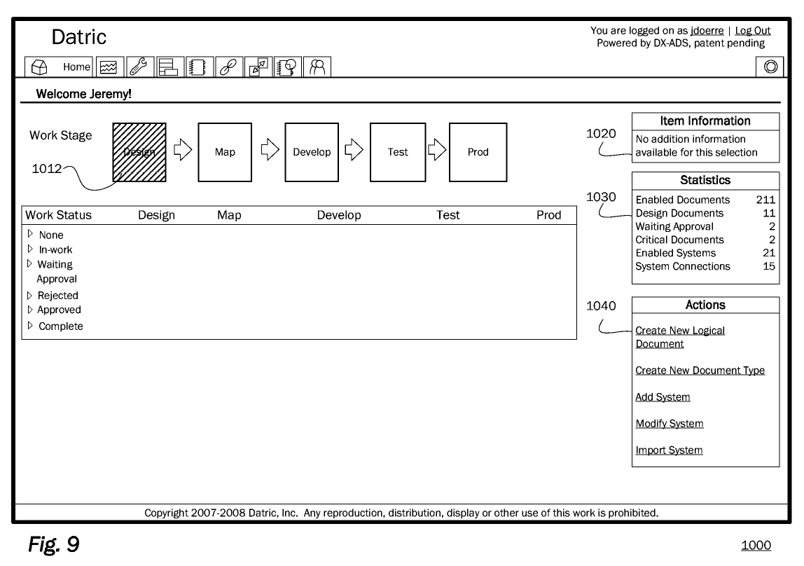

FIG. 9 is a screenshot of the home tab 1000 of FIG. 8A after a user has clicked on the paper icon 1012 associated with the design work stage. As can be seen in FIG. 9, no additional item information is displayed in the item information box 1020, however, statistics are displayed in the statistics box 1030 and actions that may be taken are presented in link form in the actions box 1040. The statistics box 1030 displays the number of enabled documents, design documents, documents waiting approval, critical documents, enabled systems, and system connections. The actions box 1040 presents links that allow a user to create a new logical document, create a new document type, add a new system, modify an existing system, or import a system.

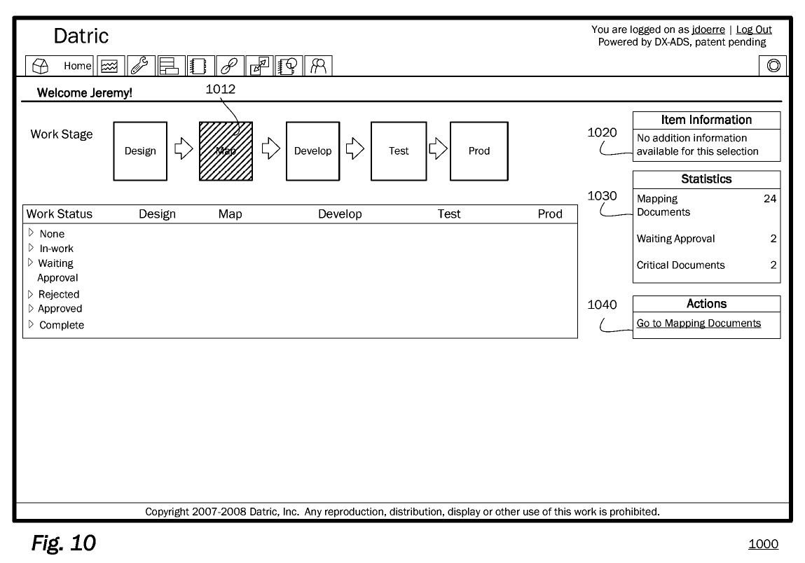

FIG. 10 is a screenshot of the home tab 1000 of FIG. 8A after a user has clicked on the paper icon 1012 associated with the mapping work stage. As can be seen in FIG. 10, no additional item information is displayed in the item information box 1020, however, statistics are displayed in the statistics box 1030 and an action that may be taken is presented in link form in the actions box 1040. The statistics box 1030 displays the number of mapping documents, mapping documents waiting approval, and critical mapping documents. The actions box 1040 presents a link that allows a user to navigate to the mappings tab 7000.

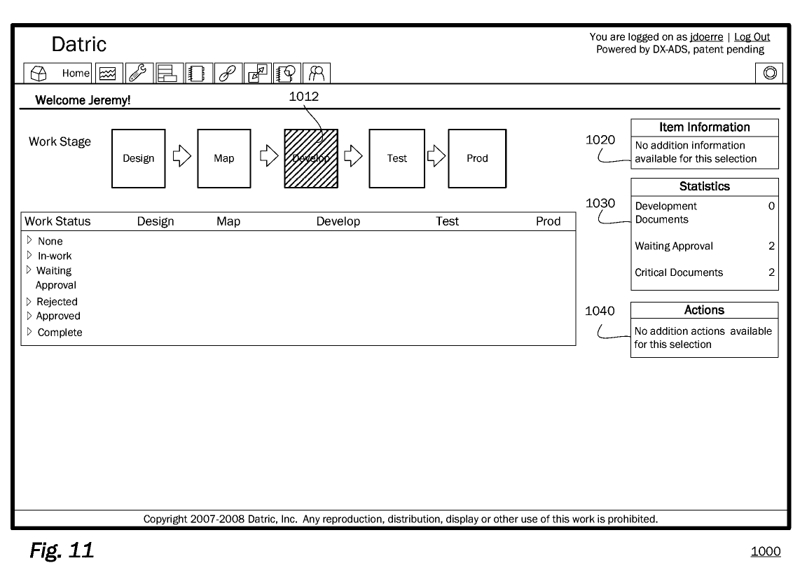

FIG. 11 is a screenshot of the home tab 1000 of FIG. 8A after a user has clicked on the paper icon 1012 associated with the development work stage. As can be seen in FIG. 11, no additional item information is displayed in the item information box 1020 and no additional actions are displayed in the actions box 1040, however, statistics are displayed in the statistics box 1030. The statistics box 1030 displays the number of development documents, development documents waiting approval, and critical development documents.

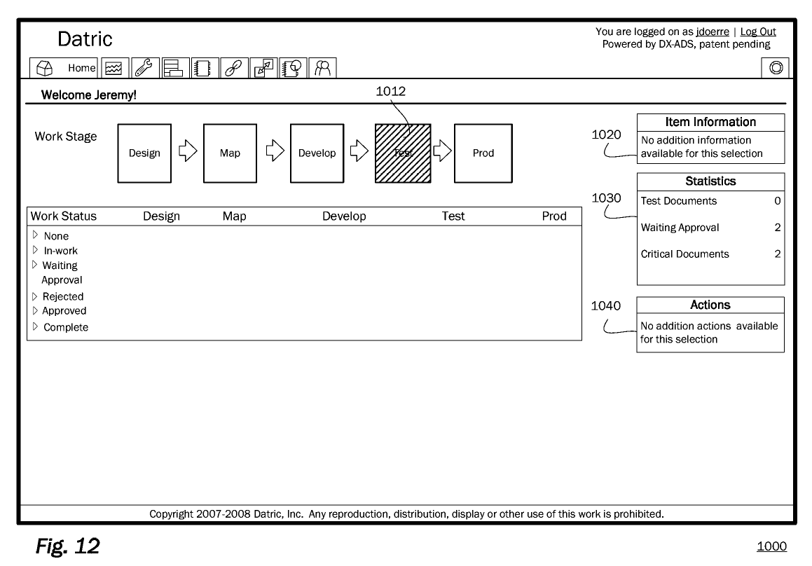

FIG. 12 is a screenshot of the home tab 1000 of FIG. 8A after a user has clicked on the paper icon 1012 associated with the testing work stage. As can be seen in FIG. 12, no additional item information is displayed in the item information box 1020 and no additional actions are displayed in the actions box 1040, however, statistics are displayed in the statistics box 1030. The statistics box 1030 displays the number of test documents, test documents waiting approval, and critical test documents.

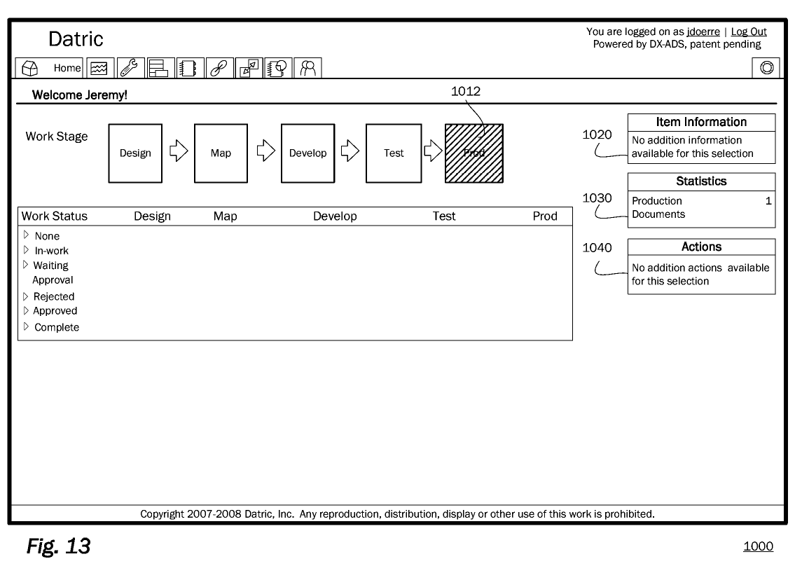

FIG. 13 is a screenshot of the home tab 1000 of FIG. 8A after a user has clicked on the paper icon 1012 associated with the production work stage. As can be seen in FIG. 13, no additional item information is displayed in the item information box 1020 and no additional actions are displayed in the actions box 1040, however, statistics are displayed in the statistics box 1030. The statistics box 1030 displays the number of production documents, production documents waiting approval, and critical production documents.

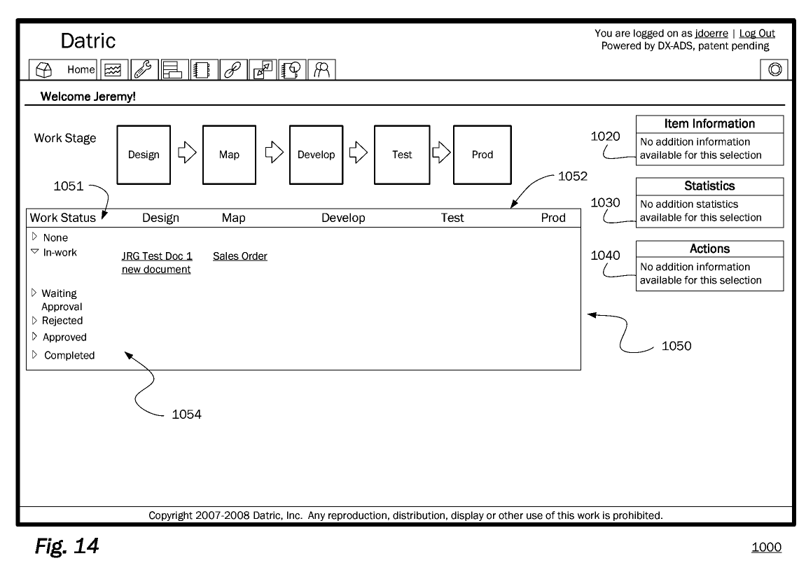

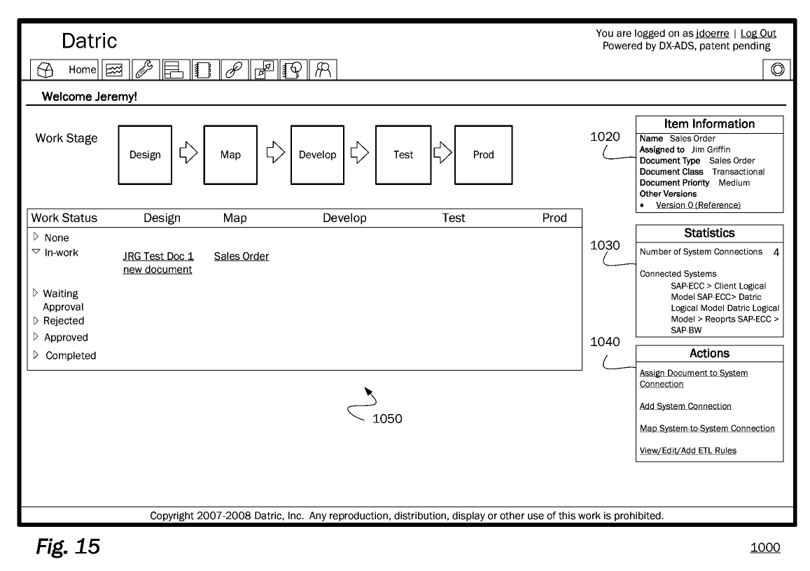

The home tab 1000 further includes an interactive chart 1050, which itself includes a plurality of expandable menus 1054 corresponding to work status identifiers along a vertical axis 1051 and a representation of each of the plurality of work stages along a horizontal axis 1052. Each of the plurality of expandable menus corresponds to one of the following statuses: none, in-work, waiting approval, rejected, approved, and complete. Clicking on a certain expandable menu 1054 expands the certain expandable menu 1054 and causes any items currently associated with that status to be displayed in an appropriate column corresponding to one of the plurality of work stages represented on the horizontal axis 1052, as can be seen in FIG. 14. Clicking on one of these items will cause item information, statistics, and actions to be displayed respectively in the boxes 1020,1030,1040, as can be seen in FIG. 15. Thus, clicking on the expandable menu corresponding to the status of “In-work” displays a document named “JRG Test Doc 1” that is in the design work stage and a document named “Sales Order” that is in the mapping work stage, as can be seen in FIG. 14. Additionally, clicking on the document named “Sales Order” displays information, statistics, and actions related to that document in the boxes 1020,1030,1040, as can be seen in FIG. 15. Specifically, the item information box 1020 displays a name of the document, an identifier of a person the document is assigned to, a type of the document, a class of the document, a priority identifier of the document, and other versions of the document. The statistics box 1030 displays the number of system connections and connected systems. The actions box 1040 presents links that allow a user to assign the document to a system connection, add a system connection, map a system to system connection, or view, edit, or add extract transform and load rules.

### Components Tab

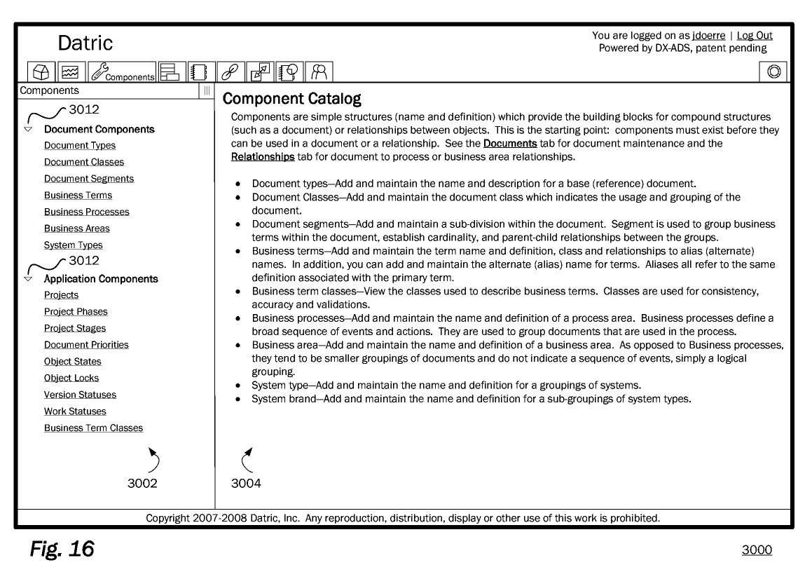

FIG. 16 is a screenshot of the components tab 3000 of the user page of the website. The components tab 3000 allows a user to view, modify, and create components. Components are simple elements which may serve as building blocks for compound elements, including, but not limited to, a document, or relationships between objects. The components tab 3000 includes two expandable menus 3012 located in a left pane 3002 of the components tab 3000. Clicking on one of the two expandable menus 3012 expands the one of the two expandable menus 3012 that was clicked on and displays a plurality of links. The first expandable menu 3012 is associated with document components, while the second expandable menu 3012 is associated with application components.

The expandable menu 3012 associated with document components will display links associated with the following types of document components when expanded: Document Types, Document Classes, Document Segments, Business Terms, Business Processes, Business Areas, System Types.

### Components Tab—Document Type Document Components

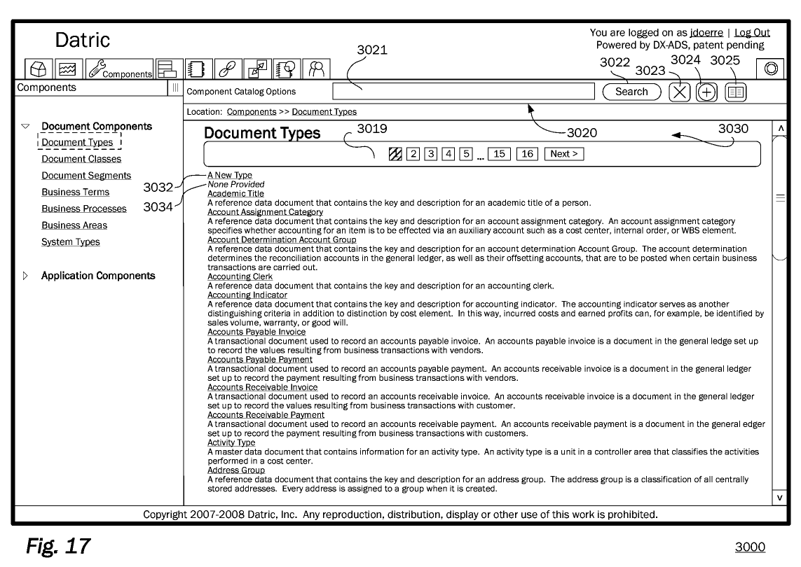

Clicking on a first of the links associated with types of document components, specifically a link associated with document type document components, will display in a right pane 3004 of the components tab 3000 a document types subpage 3030, as can be seen in FIG. 17. The document types subpage 3030 displays a plurality of document types and provides a page interface 3019 whereby a user may navigate to different pages of the document types subpage 3030.

Upon navigating to the document types subpage 3030, a document type identifier 3032 is displayed for each document type, together with a document type descriptor 3034 of the document type. These document type descriptors 3034 may be toggled on or off by a description toggle button 3025 located in an options bar 3020. The options bar 3020 is located proximate the top of the document types subpage 3030. The options bar 3020 further includes a search field 3021, a search button 3022, a clear button 3023, and an add component button 3024.

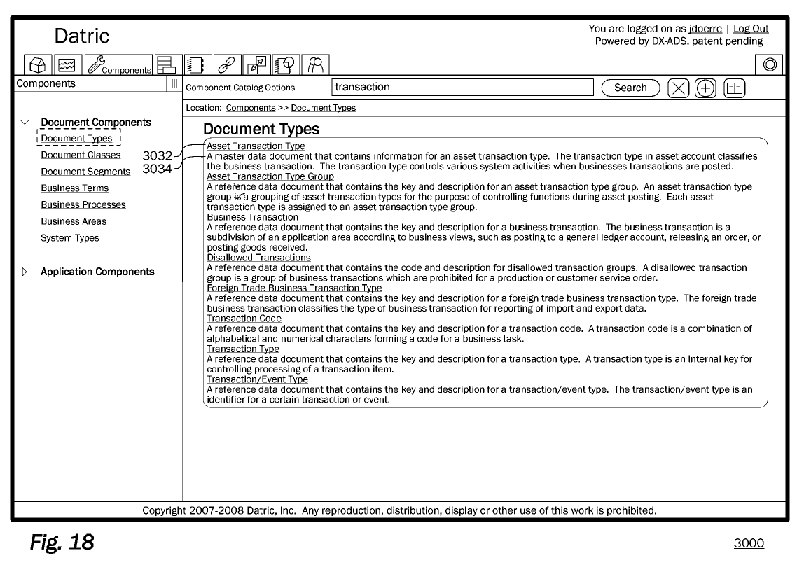

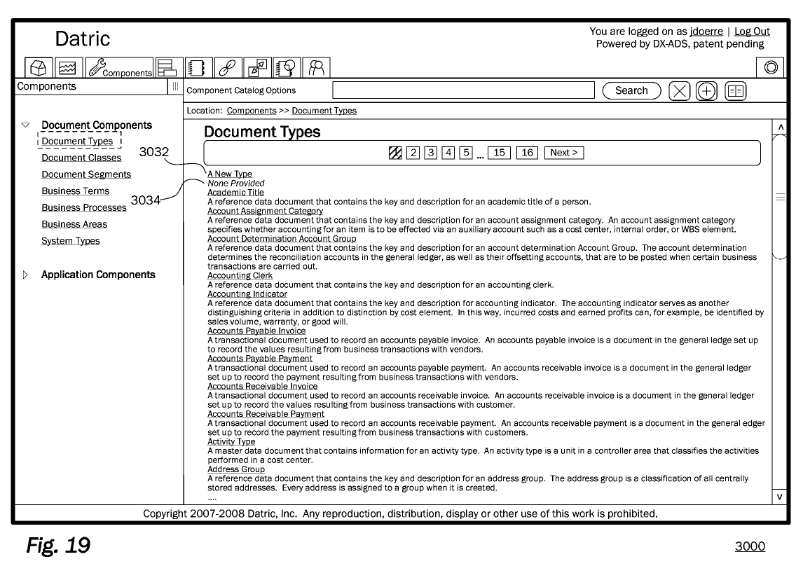

From the document types subpage 3030, a user may search for a document type by entering information into the search field 3021 and then clicking the search button 3022. FIG. 18 is a screenshot of the document types subpage 3030 after a user has searched for the text “transaction.” Because there are not multiple pages of results, no page interface 3019 is displayed. It will be appreciated that search results are displayed as a document type identifier 3032, together with a document type descriptor 3034. After a search, a user may click the clear button 3023 to clear the results of the search. FIG. 19 is a screenshot of the document types subpage 3030 after the results of the search of FIG. 18 have been cleared. It will be appreciated that the document types subpage 3030 of FIG. 19 is identical to the document types subpage 3030 of FIG. 17.

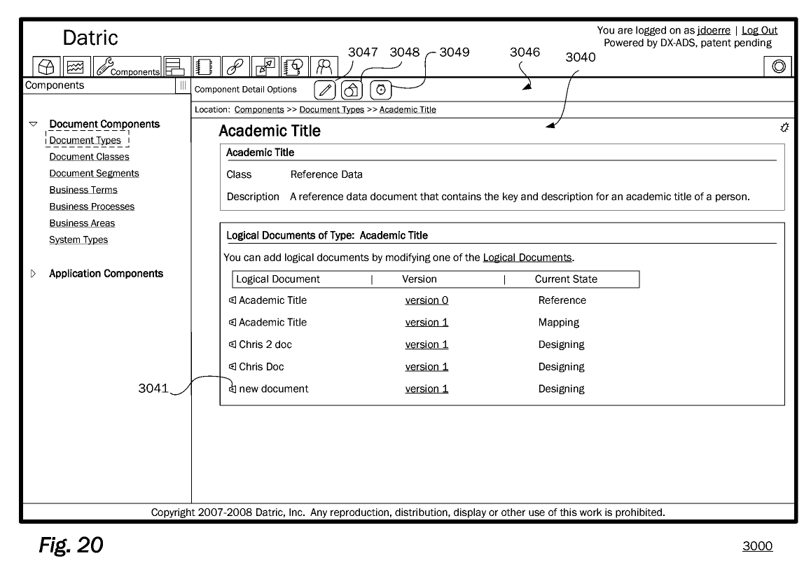

A user may click on one of the document type identifiers 3032 to display a document type details subpage 3040 with more detailed information for a document type associated with the document type identifiers 3032. Clicking on the document type identifier 3032 labeled “Academic Title” displays more detailed information associated with the Academic Title document type, as can be seen in FIG. 20. The document type details subpage 3040 displays a class and a description of the document type. Further, on the document type details subpage 3040, any logical documents of the document type are displayed. Thus, in FIG. 20, logical documents of the Academic Title document type are displayed. Each logical document is displayed as a clickable link which will effect navigation to a page associated with that logical document. Additionally, a version and current state of each of the logical documents is displayed. Further, an enabling toggle 3041 allows a user to toggle each logical document displayed between an enabled state and a disabled state.

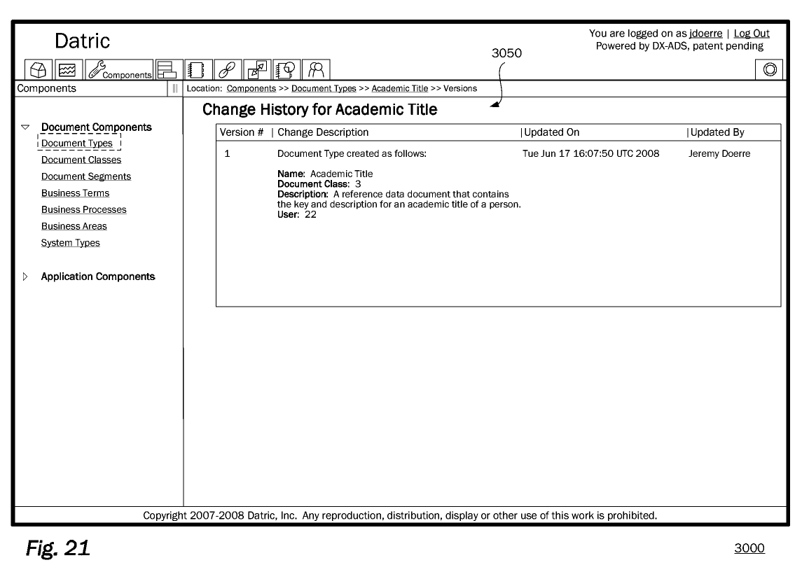

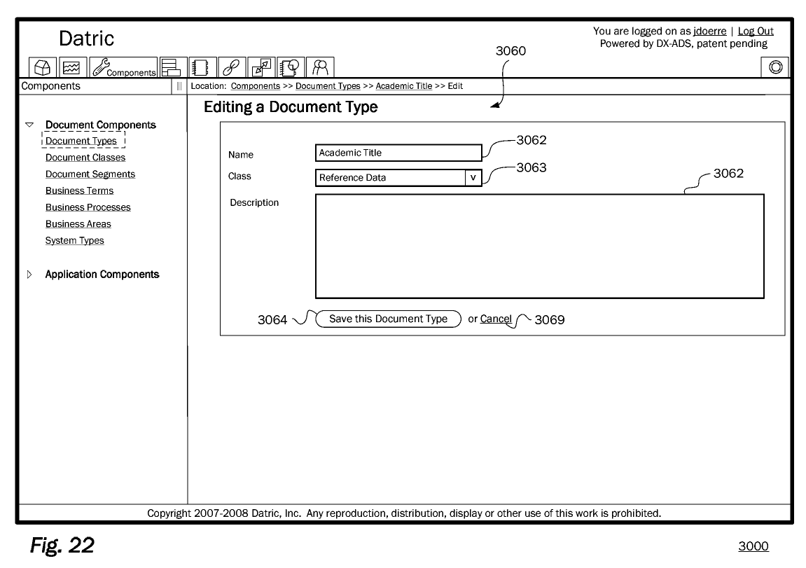

An options bar 3046 is displayed proximate the top of the document type details subpage 3040, and includes an edit button 3047, a delete button 3048, and a history button 3049. A user may click the history button 3049 to display change history in a history subpage 3050, as can be seen in FIG. 21. A user may click the delete button 3048 to delete the document type associated with the document type details subpage 3040, after confirming this choice. Further, a user may click the edit button 3047 to effect navigation to a document type editing subpage 3060, as can be seen in FIG. 22. The document type editing subpage 3060 allows a user to edit the name and description of the document type via input fields 3062, and further allows a user to edit the class of the document type via a dropdown menu 3063. A user may save his or her changes with a save button 3064, or else may cancel making changes via a cancel link 3069.

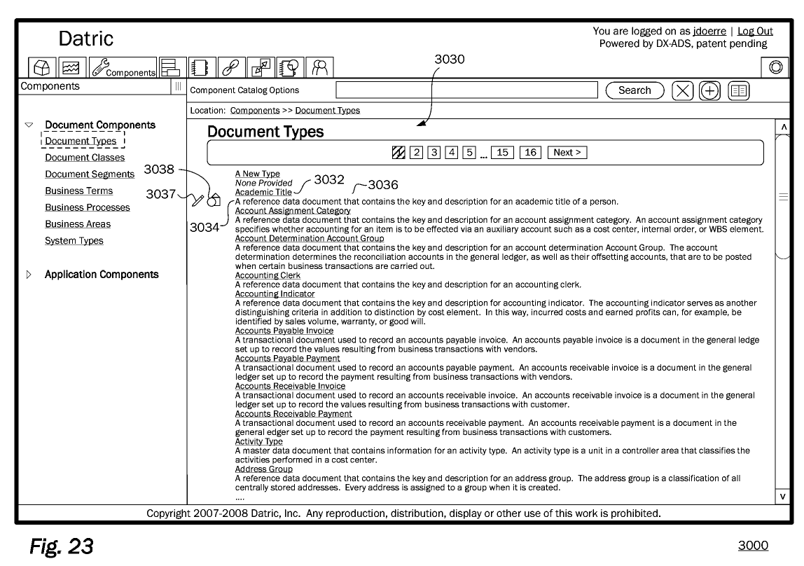

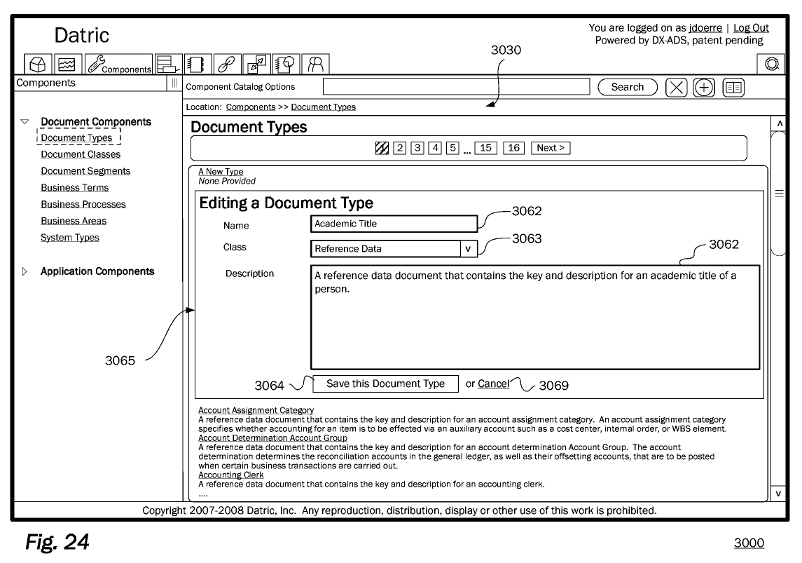

On the document type subpage 3030, each document type identifier 3032 and associated document type descriptor 3034 are displayed together in a row 3036. When a user mouses over the row 3036, the row 3036 is highlighted and an edit icon 3037 and a removal icon 3038 are displayed in the row 3036, as can be seen in FIG. 23. A user may click the removal icon 3038 in one of the rows 3036 to delete the document type associated with the document type identifier 3032 and document type descriptor 3034 displayed in the one of the rows 3036. A user must first confirm this choice. A user may click the edit icon 3037 in one of the rows 3036 to display a document type editing interface 3065 similar to the document type editing subpage 3060 described above, as can be seen in FIG. 24. The document type editing interface 3065 allows a user to edit the name and description of the document type via input fields 3062, and further allows a user to edit the class of the document type via a dropdown menu 3063. A user may save his or her changes with a save button 3064, or else may cancel making changes via a cancel link 3069.

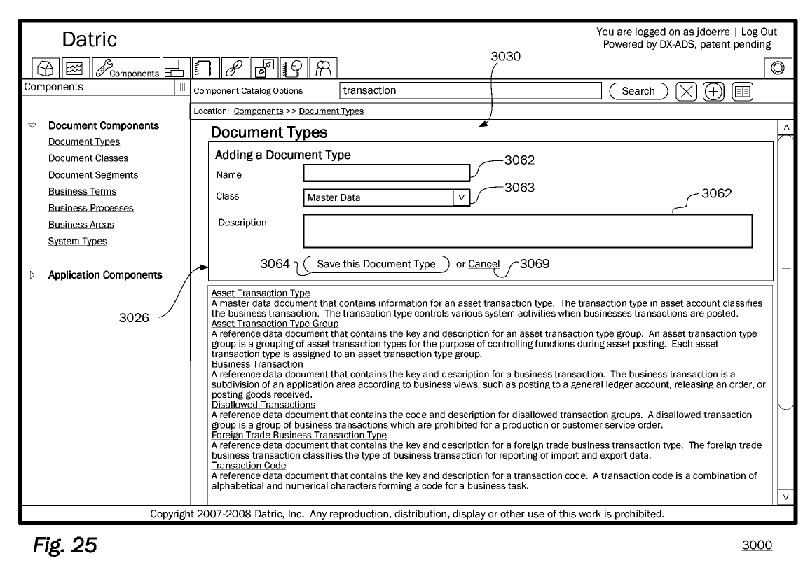

On the document type subpage 3030, a user may click on the add component button 3024 to display a document type creation interface 3026 similar to the document type editing interface 3065, as can be seen in FIG. 25. The document type creation interface 3026 allows a user to input a name and description of a new document type to create via input fields 3062, and further allows a user to input a class of the new document type via a dropdown menu 3063. A user may save the new document type with a save button 3064, or else may cancel creation via a cancel link 3069.

Pages associated with document type document components have been described hereinabove. Similar pages associated with other types of document and application components will now be described hereinbelow, with accompanying figures emphasizing any differences with respect to the description hereinabove of pages associated with document type document components.

### Components Tab—Document Class Document Components

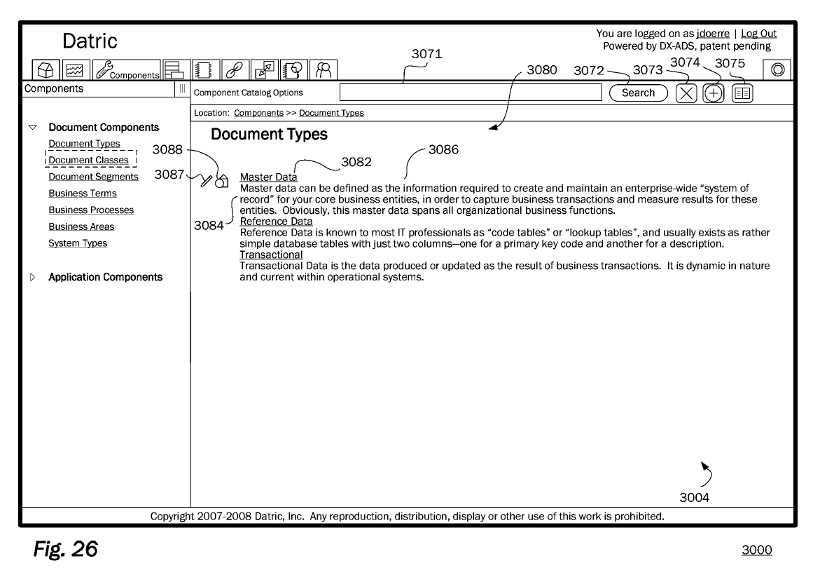

Clicking on a second of the links associated with types of document components, specifically a link associated with document class document components, will display in a right pane 3004 of the components tab 3000 a document classes subpage 3080, as can be seen in FIG. 26. The document classes subpage 3080 displays a plurality of document classes and, if necessary, may provide a page interface 3019 whereby a user may navigate to different pages of the document classes subpage 3080.

Upon navigating to the document classes subpage 3080, a document class identifier 3082 is displayed for each document class, together with a document class descriptor 3084 of the document class. These document class descriptors 3084 may be toggled on or off by a description toggle button 3075 located in an options bar 3070. The options bar 3070 is located proximate the top of the document classes subpage 3080. The options bar 3070 further includes a search field 3071, a search button 3072, a clear button 3073, and an add component button 3074.

From the document classes subpage 3080, a user may search for a document class by entering information into the search field 3071 and then clicking the search button 3072. It will be appreciated that search results are displayed as a document class identifier 3082, together with a document class descriptor 3084. After a search, a user may click the clear button 3073 to clear the results of the search.

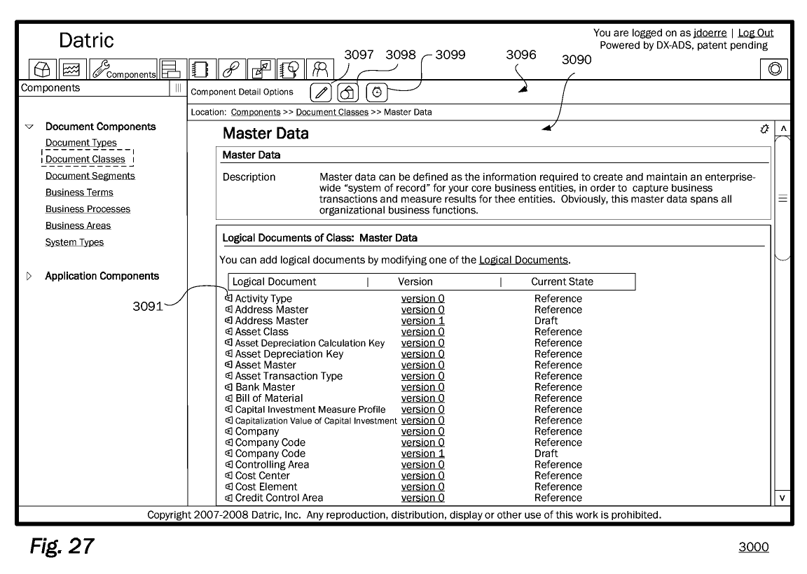

A user may click on one of the document class identifiers 3082 to display a document class details subpage 3090 with more detailed information for a document class associated with the one of the document class identifiers 3082. Clicking on the document class identifier 3082 labeled “Master Data” displays more detailed information associated with the Master Data document class, as can be seen in FIG. 27. The document class details subpage 3090 displays a description of the document class. Further, on the document class details subpage 3090, any logical documents of the document class are displayed. Thus, in FIG. 27, logical documents of the Master Data document class are displayed. Each logical document is displayed as a clickable link which will effect navigation to a page associated with that logical document. Additionally, a version and current state of each of the logical documents is displayed. Further, an enabling toggle 3091 allows a user to toggle each logical document displayed between an enabled state and a disabled state.

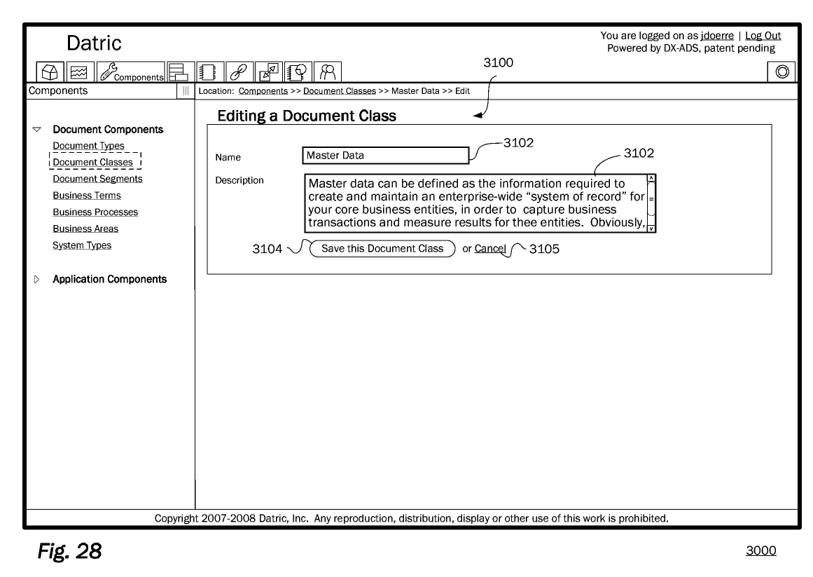

An options bar 3096 is displayed proximate the top of the document class details subpage 3090, and includes an edit button 3097, a delete button 3098, and a history button 3099. A user may click the history button 3099 to display a history subpage. A user may click the delete button 3098 to delete the document class associated with the document class details subpage 3090, after confirming this choice. Further, a user may click the edit button 3097 to effect navigation to a document class editing subpage 3100, as can be seen in FIG. 28. The document class editing subpage 3100 allows a user to edit the name and description of the document class via input fields 3102. A user may save his or her changes with a save button 3104, or else may cancel making changes via a cancel link 3105.

On the document class subpage 3080, each document class identifier 3082 and associated document class descriptor 3084 are displayed together in a row 3086. When a user mouses over the row 3086, the row 3086 is highlighted and an edit icon 3087 and a removal icon 3088 are displayed in the row 3086, as can be seen in FIG. 26. A user may click the removal icon 3088 in one of the rows 3086 to delete the document class associated with the document class identifier 3082 and document class descriptor 3084 displayed in the one of the rows 3086. A user must first confirm this choice. A user may click the edit icon 3087 in one of the rows 3086 to display a document class editing interface similar to the document class editing subpage 3100 described above. The document class editing interface allows a user to edit the name and description of the document class via input fields. A user may save his or her changes with a save button, or else may cancel making changes via a cancel link.

On the document class subpage 3080, a user may click on the add component button 3074 to display a document class creation interface similar to the document class editing interface. The document class creation interface allows a user to input a name and description of a new document class to create via input fields. A user may save the new document class with a save button, or else may cancel creation via a cancel link.

### Components Tab—Document Segment Document Components

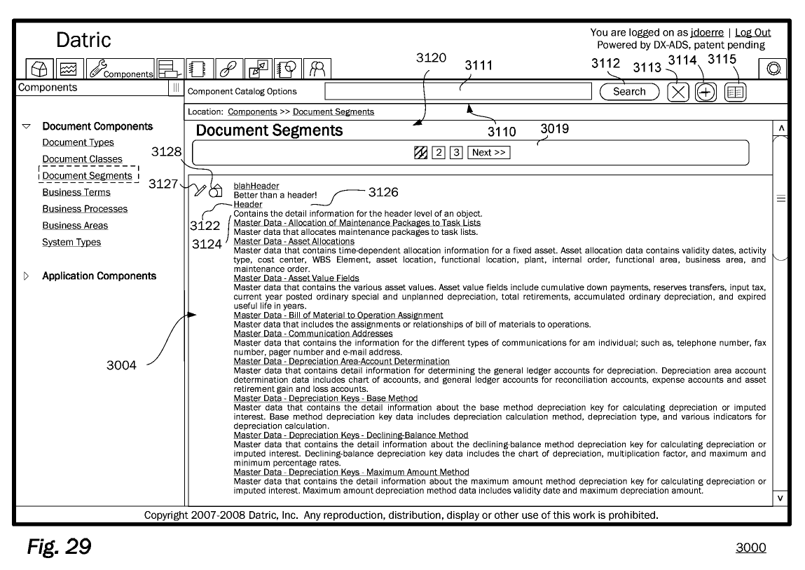

Clicking on a third of the links associated with types of document components, specifically a link associated with document segment document components, will display in a right pane 3004 of the components tab 3000 a document segments subpage 3120, as can be seen in FIG. 29. The document segments subpage 3120 displays a plurality of document segments and, if necessary, may provide a page interface 3019 whereby a user may navigate to different pages of the document segments subpage 3120.

Upon navigating to the document segments subpage 3120, a document segment identifier 3122 is displayed for each document segment, together with a document segment descriptor 3124 of the document segment. These document segment descriptors 3124 may be toggled on or off by a description toggle button 3115 located in an options bar 3110. The options bar 3110 is located proximate the top of the document segments subpage 3120. The options bar 3110 further includes a search field 3111, a search button 3112, a clear button 3113, and an add component button 3114.

From the document segments subpage 3120, a user may search for a document segment by entering information into the search field 3111 and then clicking the search button 3112. It will be appreciated that search results are displayed as a document segment identifier 3122, together with a document segment descriptor 3124. After a search, a user may click the clear button 3113 to clear the results of the search.

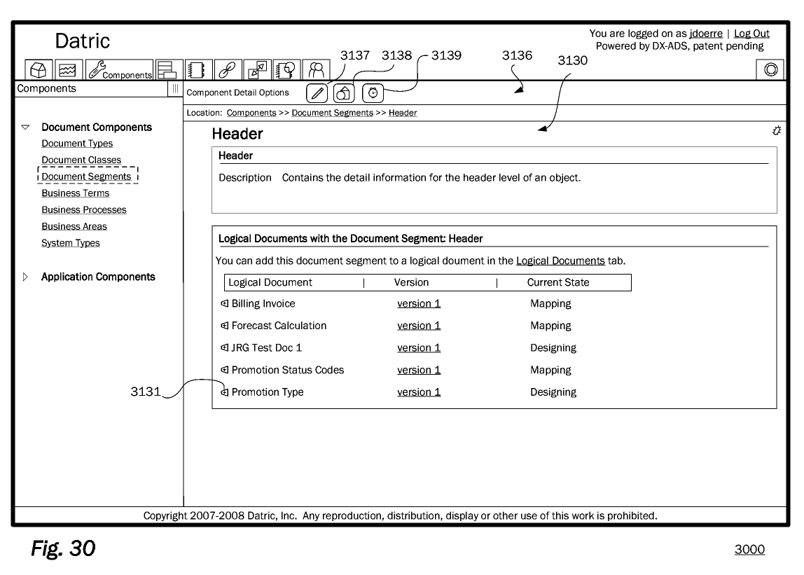

A user may click on one of the document segment identifiers 3122 to display a document segment details subpage 3130 for a document segment associated with the one of the document segment identifiers 3122. Clicking on the document segment identifier 3122 labeled “Header” displays more detailed information associated with the Header document segment, as can be seen in FIG. 30. The document segment details subpage 3130 displays a description of the document segment. Further, on the document segment details subpage 3130, any logical documents with the document segment are displayed. Thus, in FIG. 30, logical documents with the Header document segment are displayed. Each logical document is displayed as a clickable link which will effect navigation to a page associated with that logical document. Additionally, a version and current state of each of the logical documents is displayed. Further, an enabling toggle 3131 allows a user to toggle each logical document displayed between an enabled state and a disabled state.

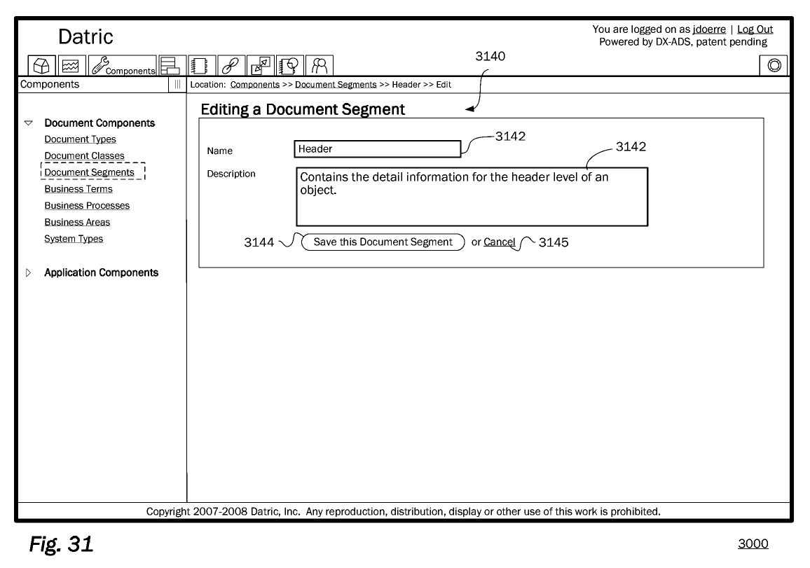

An options bar 3136 is displayed proximate the top of the document segment details subpage 3130, and includes an edit button 3137, a delete button 3138, and a history button 3139. A user may click the history button 3139 to display a history subpage. A user may click the delete button 3138 to delete the document segment associated with the document segment details subpage 3130, after confirming this choice. Further, a user may click the edit button 3137 to effect navigation to a document segment editing subpage 3140, as can be seen in FIG. 31. The document segment editing subpage 3140 allows a user to edit the name and description of the document segment via input fields 3142. A user may save his or her changes with a save button 3144, or else may cancel making changes via a cancel link 3145.

On the document segment subpage 3120, each document segment identifier 3122 and associated document segment descriptor 3124 are displayed together in a row 3126. When a user mouses over the row 3126, the row 3126 is highlighted and an edit icon 3127 and a removal icon 3128 are displayed in the row 3126, as can be seen in FIG. 29. A user may click the removal icon 3128 in one of the rows 3126 to delete the document segment associated with the document segment identifier 3122 and document segment descriptor 3124 displayed in the one of the rows 3126. A user must first confirm this choice. A user may click the edit icon 3127 in one of the rows 3126 to display a document segment editing interface similar to the document segment editing subpage 3140 described above. The document segment editing interface allows a user to edit the name and description of the document segment via input fields. A user may save his or her changes with a save button, or else may cancel making changes via a cancel link.

On the document segment subpage 3120, a user may click on the add component button 3114 to display a document segment creation interface similar to the document segment editing interface. The document segment creation interface allows a user to input a name and description of a new document segment to create via input fields. A user may save the new document segment with a save button, or else may cancel creation via a cancel link.

### Components Tab—Business Term Document Components

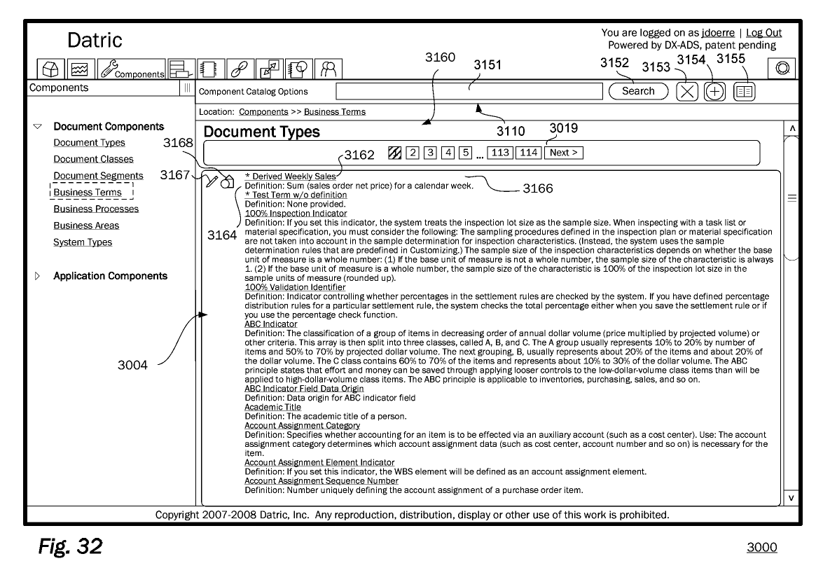

Clicking on a fourth of the links associated with types of document components, specifically a link associated with business term document components, will display in a right pane 3004 of the components tab 3000 a business terms subpage 3160, as can be seen in FIG. 32. The business terms subpage 3160 displays a plurality of business terms and, if necessary, may provide a page interface 3019 whereby a user may navigate to different pages of the business terms subpage 3160.

Upon navigating to the business terms subpage 3160, a business term identifier 3162 is displayed for each business term, together with a business term descriptor 3164 of the business term. These business term descriptors 3164 may be toggled on or off by a description toggle button 3155 located in an options bar 3150. The options bar 3150 is located proximate the top of the business terms subpage 3160. The options bar 3150 further includes a search field 3151, a search button 3152, a clear button 3153, and an add component button 3154.

From the business terms subpage 3160, a user may search for a business term by entering information into the search field 3151 and then clicking the search button 3152. It will be appreciated that search results are displayed as a business term identifier 3162, together with a business term descriptor 3164. After a search, a user may click the clear button 3153 to clear the results of the search.

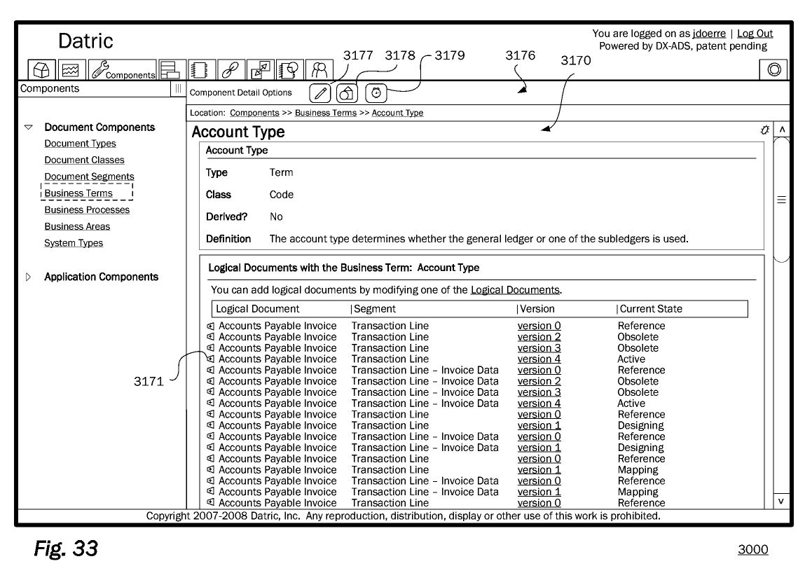

A user may click on one of the business term identifiers 3162 to display a business term details subpage 3170 for a business term associated with the one of the business term identifiers 3162. Clicking on the business term identifier 3162 labeled “Account Type” displays more detailed information associated with the Account Type business term, as can be seen in FIG. 33. The business term details subpage 3170 displays a type, class, and definition of the business term, as well as displaying an indication of whether the business term was derived. Further, on a business term details subpage 3170 associated with a certain business term, any logical documents with the certain business term are displayed. Thus, in FIG. 33, logical documents with the Account Type business term are displayed. Each logical document is displayed as a clickable link which will effect navigation to a page associated with that logical document. Additionally, a segment, version, and current state of each of the logical documents is displayed. Further, an enabling toggle 3171 allows a user to toggle each logical document displayed between an enabled state and a disabled state.

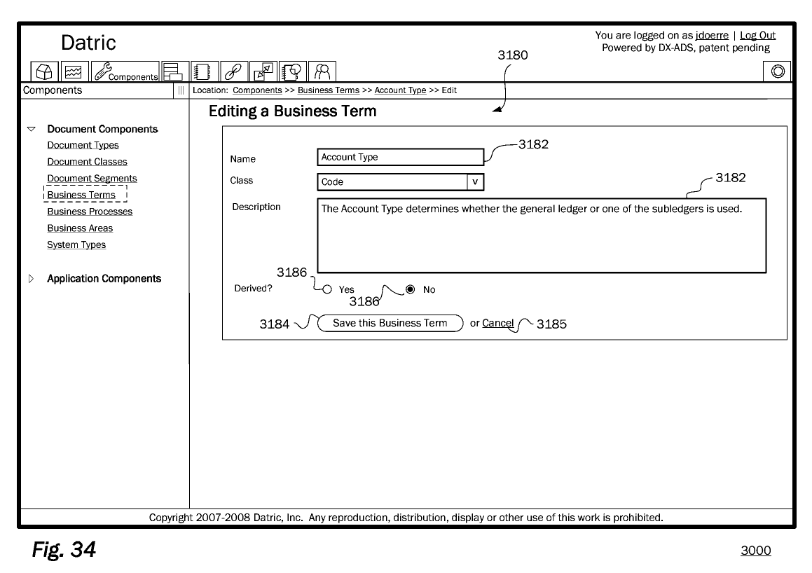

An options bar 3176 is displayed proximate the top of the business term details subpage 3170, and includes an edit button 3177, a delete button 3178, and a history button 3179. A user may click the history button 3179 to display a history subpage. A user may click the delete button 3178 to delete the business term associated with the business term details subpage 3170, after confirming this choice. Further, a user may click the edit button 3177 to effect navigation to a business term editing subpage 3180, as can be seen in FIG. 34. The business term editing subpage 3180 allows a user to edit the name and definition of the business term via input fields 3182. A user further may edit the class of the business term via a dropdown menu 3183 and may select, via two radio buttons 3186, whether the business term was derived. A user may save his or her changes with a save button 3184, or else may cancel making changes via a cancel link 3185.

On the business term subpage 3160, each business term identifier 3162 and associated business term descriptor 3164 are displayed together in a row 3166. When a user mouses over the row 3166, the row 3166 is highlighted and an edit icon 3167 and a removal icon 3168 are displayed in the row 3166, as can be seen in FIG. 32. A user may click the removal icon 3168 in one of the rows 3166 to delete the business term associated with the business term identifier 3162 and business term descriptor 3164 displayed in the one of the rows 3166. A user must first confirm this choice. A user may click the edit icon 3167 in one of the rows 3166 to display a business term editing interface similar to the business term editing subpage 3180 described above. The business term editing interface allows a user to edit the name and definition of the business term via input fields. A user further may edit the class of the business term via a dropdown menu and may select, via two radio buttons, whether the business term was derived. A user may save his or her changes with a save button, or else may cancel making changes via a cancel link.

On the business term subpage 3160, a user may click on the add component button 3154 to display a business term creation interface similar to the business term editing interface. The business term creation interface allows a user to input a name and definition of a new business term to create via input fields. A user further may input a class of the business term via a dropdown menu and may select, via two radio buttons, whether the business term was derived. A user may save the new business term with a save button, or else may cancel creation via a cancel link.

### Components Tab—Business Process Document Components

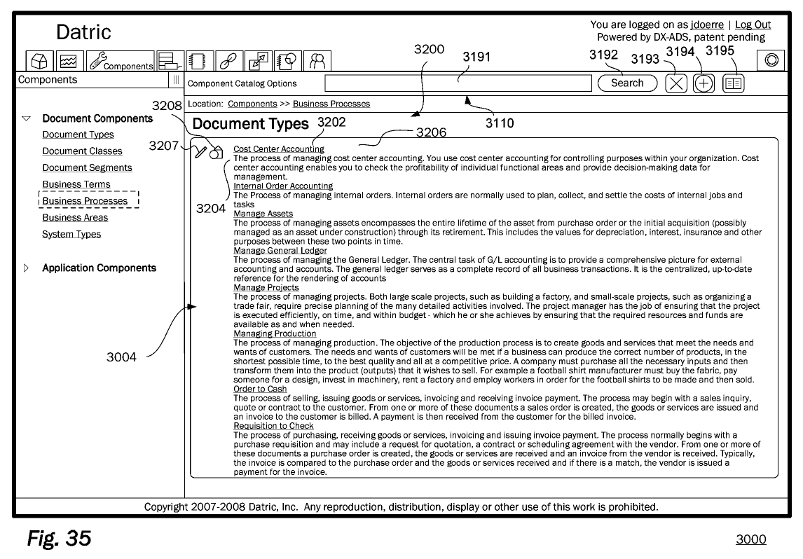

Clicking on a fifth of the links associated with types of document components, specifically a link associated with business process document components, will display in a right pane 3004 of the components tab 3000 a business processes subpage 3200, as can be seen in FIG. 35. The business processes subpage 3200 displays a plurality of business processes and, if necessary, may provide a page interface 3019 whereby a user may navigate to different pages of the business processes subpage 3200.

Upon navigating to the business processes subpage 3200, a business process identifier 3202 is displayed for each business process, together with a business process descriptor 3204 of the business process. These business process descriptors 3204 may be toggled on or off by a description toggle button 3195 located in an options bar 3190. The options bar 3190 is located proximate the top of the business processes subpage 3200. The options bar 3190 further includes a search field 3191, a search button 3192, a clear button 3193, and an add component button 3194.

From the business processes subpage 3200, a user may search for a business process by entering information into the search field 3191 and then clicking the search button 3192. It will be appreciated that search results are displayed as a business process identifier 3202, together with a business process descriptor 3204. After a search, a user may click the clear button 3193 to clear the results of the search.

Each of the business process identifiers 3202 may include an expandable menu 3203. A user may expand one of the expandable menus 3203 to display one or more additional business area identifiers 3202 associated with the business area the one of the expandable menus was associated with.

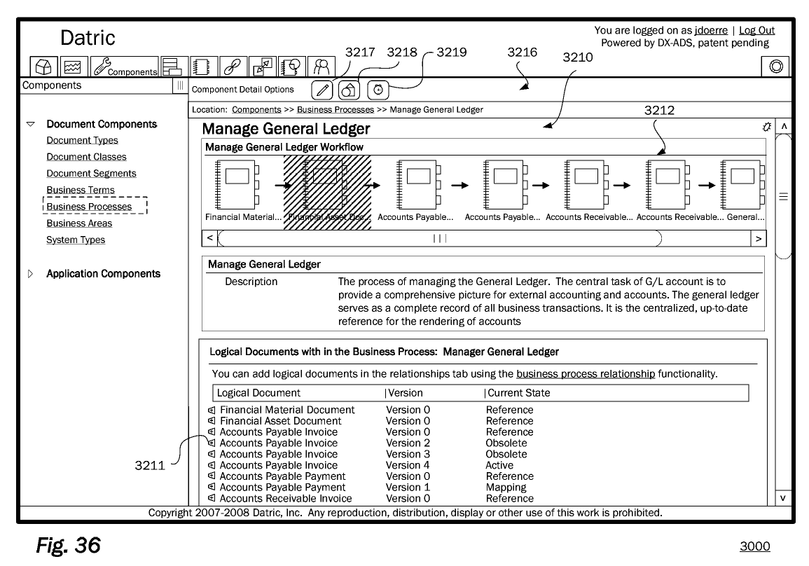

A user may click on one of the business process identifiers 3202 to display a business process details subpage 3210 with more detailed information for a business process associated with the one of the business process identifiers 3202. Clicking on the business process identifier 3202 labeled “Manage General Ledger” displays more detailed information associated with the Manage General Ledger business process, as can be seen in FIG. 36. The business process details subpage 3210 displays a description of the business process, and may display a business process workflow 3212 as well. Further, on a business process details subpage 3210 associated with a certain business process, any logical documents in the certain business process are displayed. Thus, in FIG. 36, logical documents in the Manage Assets business process are displayed. Each logical document is displayed as a clickable link which will effect navigation to a page associated with that logical document. Additionally, the business process workflow 3212 may include a plurality of pictorial links associated with the above described logical documents. Further, a version and current state of each of the logical documents is displayed. Further still, an enabling toggle 3211 allows a user to toggle each logical document displayed between an enabled state and a disabled state.

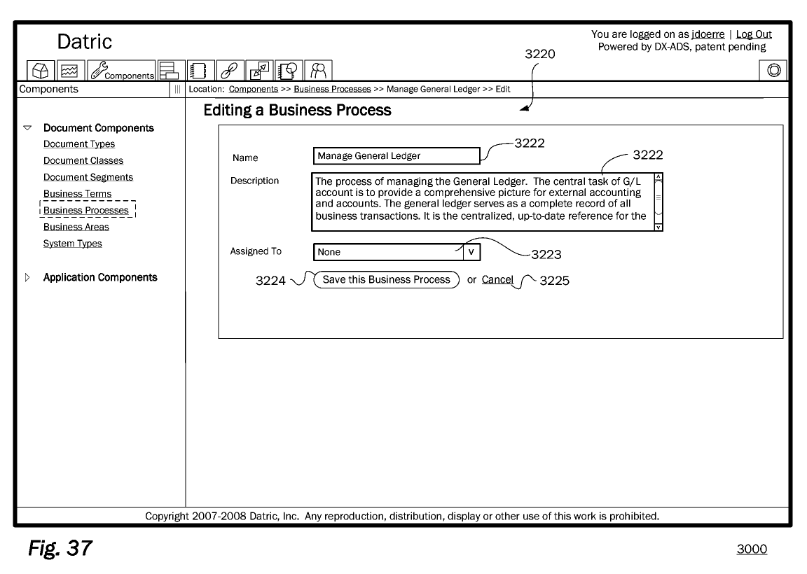

An options bar 3216 is displayed proximate the top of the business process details subpage 3210, and includes an edit button 3217, a delete button 3218, and a history button 3219. A user may click the history button 3219 to display a history subpage. A user may click the delete button 3218 to delete the business process associated with the business process details subpage 3210, after confirming this choice. Further, a user may click the edit button 3217 to effect navigation to a business process editing subpage 3220, as can be seen in FIG. 37. The business process editing subpage 3220 allows a user to edit the name and description of the business process via input fields 3222. A user further may assign the business process to a second business process via a dropdown menu 3223, in which case the business process will be displayed as an item under an expandable menu 3243 associated with the second business process. A user may save his or her changes with a save button 3224, or else may cancel making changes via a cancel link 3225.

On the business process subpage 3200, each business process identifier 3202 and associated business process descriptor 3204 are displayed together in a row 3206. When a user mouses over the row 3206, the row 3206 is highlighted and an edit icon 3207 and a removal icon 3208 are displayed in the row 3206, as can be seen in FIG. 35. A user may click the removal icon 3208 in one of the rows 3206 to delete the business process associated with the business process identifier 3202 and business process descriptor 3204 displayed in the one of the rows 3206. A user must first confirm this choice. A user may click the edit icon 3207 in one of the rows 3206 to display a business process editing interface similar to the business process editing subpage 3220 described above. The business process editing interface allows a user to edit the name and description of the business process via input fields. A user further may assign the business process to a second business process via a dropdown menu. A user may save his or her changes with a save button, or else may cancel making changes via a cancel link.

On the business process subpage 3200, a user may click on the add component button 3194 to display a business process creation interface similar to the business process editing interface. The business process creation interface allows a user to input a name and description of a new business process to create via input fields. A user further may assign the business process to a second business process via a dropdown menu. A user may save the new business process with a save button, or else may cancel creation via a cancel link.

### Components Tab—Business Area Document Components

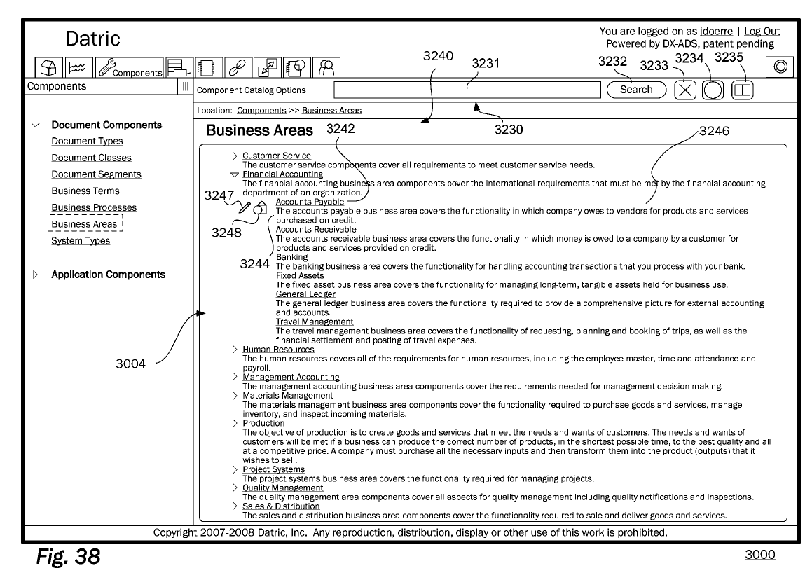

Clicking on a sixth of the links associated with types of document components, specifically a link associated with business area document components, will display in a right pane 3004 of the components tab 3000 a business areas subpage 3240, as can be seen in FIG. 38. The business areas subpage 3240 displays a plurality of business areas and, if necessary, may provide a page interface 3019 whereby a user may navigate to different pages of the business areas subpage 3240.

Upon navigating to the business areas subpage 3240, a business area identifier 3242 is displayed for each business area, together with a business area descriptor 3244 of the business area. These business area descriptors 3244 may be toggled on or off by a description toggle button 3235 located in an options bar 3230. The options bar 3230 is located proximate the top of the business areas subpage 3240. The options bar 3230 further includes a search field 3231, a search button 3232, a clear button 3233, and an add component button 3234.

From the business areas subpage 3240, a user may search for a business area by entering information into the search field 3231 and then clicking the search button 3232. It will be appreciated that search results are displayed as a business area identifier 3242, together with a business area descriptor 3244. After a search, a user may click the clear button 3233 to clear the results of the search.

Each of the business area identifiers 3242 may include an expandable menu 3243. A user may expand one of the expandable menus 3243 to display one or more additional business area identifiers 3242 associated with the business area that the one of the expandable menus was associated with, as can be seen in FIG. 38.

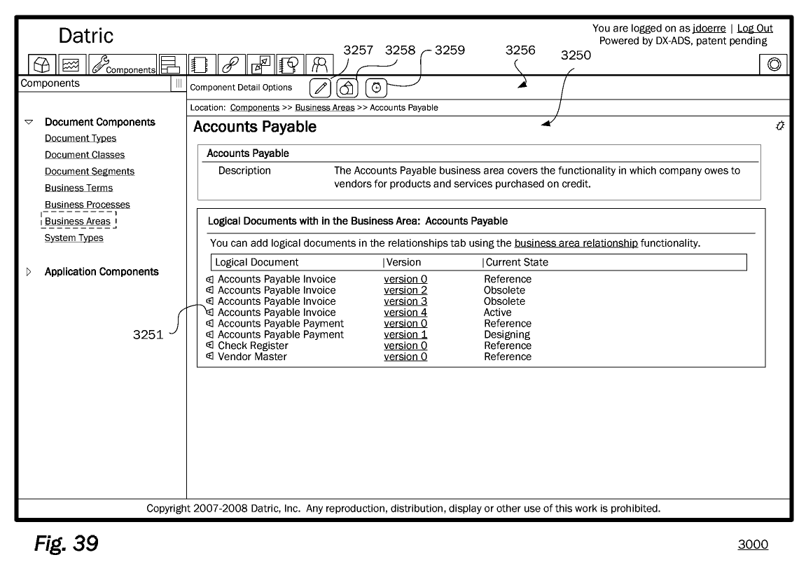

A user may click on one of the business area identifiers 3242 to display a business area details subpage 3250 for a business area associated with the one of the business area identifiers 3242. Clicking on the business area identifier 3242 labeled “Accounts Payable” displays more detailed information associated with the accounts payable business area, as can be seen in FIG. 39. The business area details subpage 3250 displays a description of the business area. Further, on a business area details subpage 3250 associated with a certain business area, any logical documents in the certain business area are displayed. Thus, in FIG. 39, logical documents in the accounts payable business area are displayed. Each logical document is displayed as a clickable link which will effect navigation to a page associated with that logical document. Additionally, a version and current state of each of the logical documents is displayed. Further still, an enabling toggle 3251 allows a user to toggle each logical document displayed between an enabled state and a disabled state.

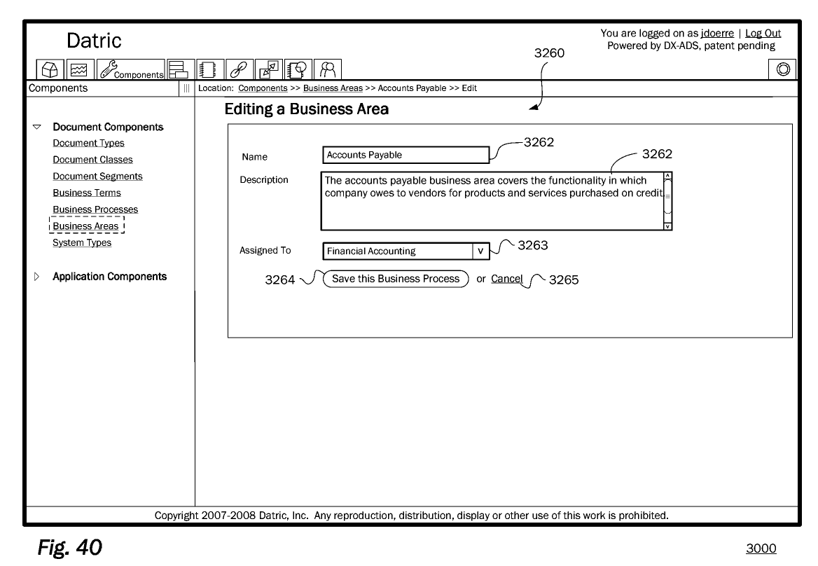

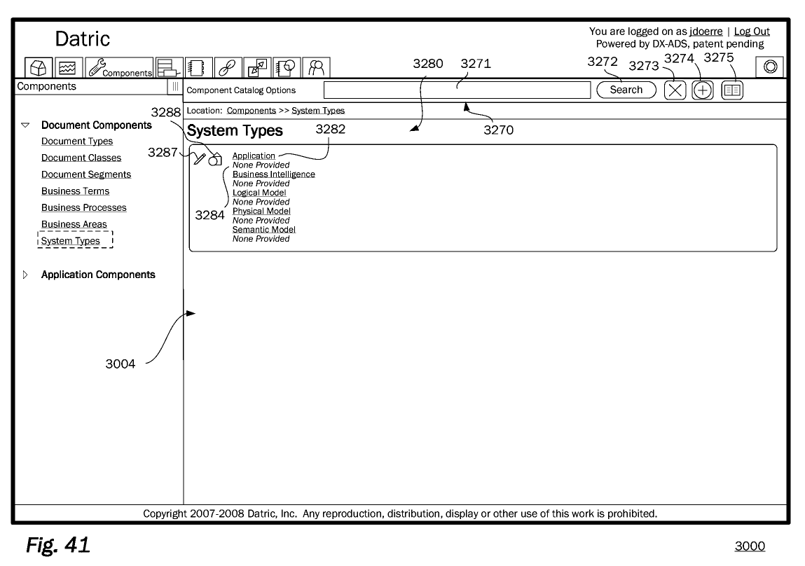

An options bar 3256 is displayed proximate the top of the business area details subpage 3250, and includes an edit button 3257, a delete button 3258, and a history button 3259. A user may click the history button 3259 to display a history subpage. A user may click the delete button 3258 to delete the business area associated with the business area details subpage 3250, after confirming this choice. Further, a user may click the edit button 3257 to effect navigation to a business area editing subpage 3260, as can be seen in FIG. 40. The business area editing subpage 3260 allows a user to edit the name and description of the business area via input fields 3262. A user further may assign the business area to a second business area via a dropdown menu 3263, in which case the business area will be displayed as an item under an expandable menu 3243 associated with the second business area. A user may save his or her changes with a save button 3264, or else may cancel making changes via a cancel link 3265.

On the business area subpage 3240, each business area identifier 3242 and associated business area descriptor 3244 are displayed together in a row 3246. When a user mouses over the row 3246, the row 3246 is highlighted and an edit icon 3247 and a removal icon 3248 are displayed in the row 3246, as can be seen in FIG. 38. A user may click the removal icon 3248 in one of the rows 3246 to delete the business area associated with the business area identifier 3242 and business area descriptor 3244 displayed in the one of the rows 3246. A user must first confirm this choice. A user may click the edit icon 3247 in one of the rows 3246 to display a business area editing interface similar to the business area editing subpage 3260 described above. The business area editing interface allows a user to edit the name and description of the business area via input fields. A user further may assign the business area to a second business area via a dropdown menu. A user may save his or her changes with a save button, or else may cancel making changes via a cancel link.

On the business area subpage 3240, a user may click on the add component button 3234 to display a business area creation interface similar to the business area editing interface. The business area creation interface allows a user to input a name and description of a new business area to create via input fields. A user further may assign the business area to a second business area via a dropdown menu. A user may save the new business area with a save button, or else may cancel creation via a cancel link.

### Components Tab—System Type Document Components

Clicking on a seventh of the links associated with types of document components, specifically a link associated with system type document components, will display in a right pane 3004 of the components tab 3000 a system types subpage 3280, as can be seen in FIG. 41. The system types subpage 3280 displays a plurality of system types and, if necessary, may provide a page interface 3019 whereby a user may navigate to different pages of the system types subpage 3280.

Upon navigating to the system types subpage 3280, a system type identifier 3282 is displayed for each system type, together with a system type descriptor 3284 of the system type. These system type descriptors 3284 may be toggled on or off by a description toggle button 3275 located in an options bar 3270. The options bar 3270 is located proximate the top of the system types subpage 3280. The options bar 3270 further includes a search field 3271, a search button 3272, a clear button 3273, and an add component button 3274.

From the system types subpage 3280, a user may search for a system type by entering information into the search field 3271 and then clicking the search button 3272. It will be appreciated that search results are displayed as a system type identifier 3282, together with a system type descriptor 3284. After a search, a user may click the clear button 3273 to clear the results of the search.

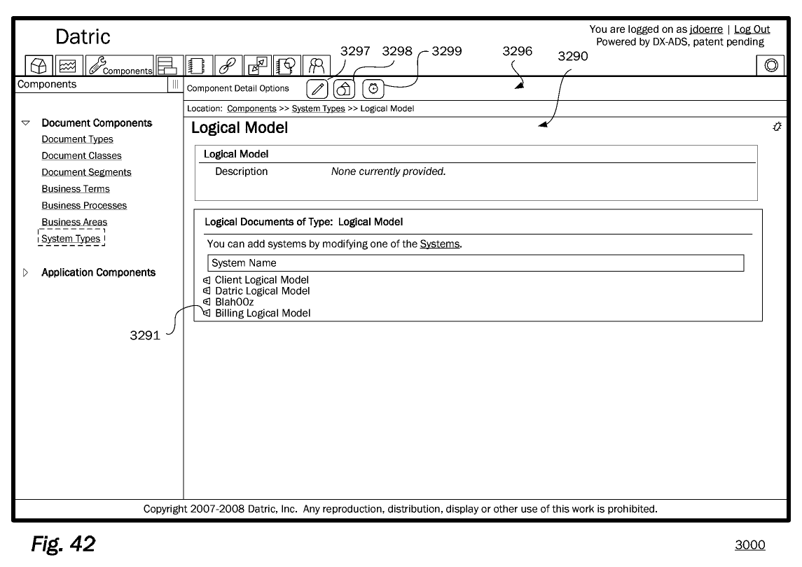

A user may click on one of the system type identifiers 3282 to display a system type details subpage 3290 for a system type associated with the one of the system type identifiers 3282. Clicking on the system type identifier 3282 labeled “Logical Model” displays more detailed information associated with the logical model system type, as can be seen in FIG. 42. The system type details subpage 3290 displays a description of the system type. Further, on the system type details subpage 3290, any logical documents of the system type are displayed. Thus, in FIG. 42, logical documents of the logical model system type are displayed. Each logical document is displayed as a clickable link which will effect navigation to a page associated with that logical document. Additionally, a version and current state of each of the logical documents is displayed. Further, an enabling toggle 3291 allows a user to toggle each logical document displayed between an enabled state and a disabled state.

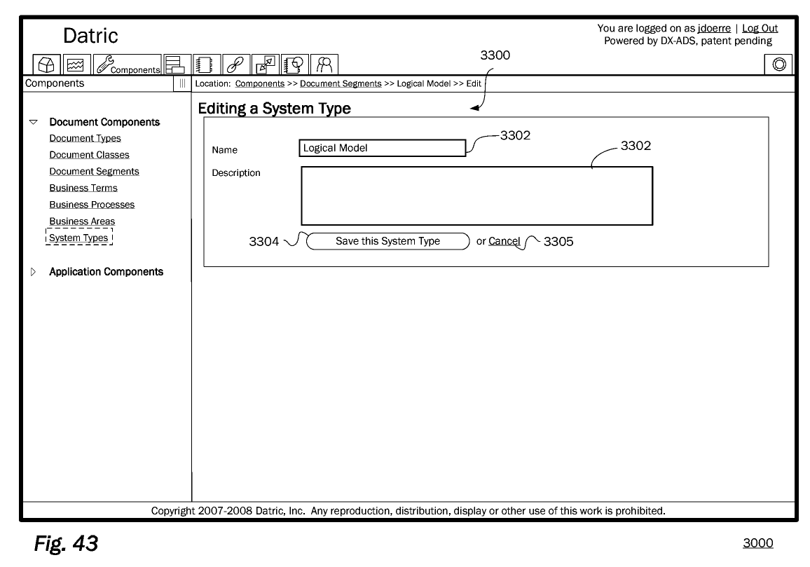

An options bar 3296 is displayed proximate the top of the system type details subpage 3290, and includes an edit button 3297, a delete button 3298, and a history button 3299. A user may click the history button 3299 to display a history subpage. A user may click the delete button 3298 to delete the system type associated with the system type details subpage 3290, after confirming this choice. Further, a user may click the edit button 3297 to effect navigation to a system type editing subpage 3300, as can be seen in FIG. 43. The system type editing subpage 3300 allows a user to edit the name and description of the system type via input fields 3302. A user may save his or her changes with a save button 3304, or else may cancel making changes via a cancel link 3305.

On the system type subpage 3280, each system type identifier 3282 and associated system type descriptor 3284 are displayed together in a row 3286. When a user mouses over the row 3286, the row 3286 is highlighted and an edit icon 3287 and a removal icon 3288 are displayed in the row 3286, as can be seen in FIG. 41. A user may click the removal icon 3288 in one of the rows 3286 to delete the system type associated with the system type identifier 3282 and system type descriptor 3284 displayed in the one of the rows 3286. A user must first confirm this choice. A user may click the edit icon 3287 in one of the rows 3286 to display a system type editing interface similar to the system type editing subpage 3300 described above. The system type editing interface allows a user to edit the name and description of the system type via input fields. A user may save his or her changes with a save button, or else may cancel making changes via a cancel link.

On the system type subpage 3280, a user may click on the add component button 3274 to display a system type creation interface similar to the system type editing interface. The system type creation interface allows a user to input a name and description of a new system type to create via input fields. A user may save the new system type with a save button, or else may cancel creation via a cancel link.

### Components Tab—Application Components

The expandable menu 3012 associated with application components will display links associated with the following types of application components when expanded: Projects, Project Phases, Project Stages, Document Priorities, Object States, Object Locks, Version Statuses, Work Statuses, and Business Term Classes.

### Components Tab—Project Application Components

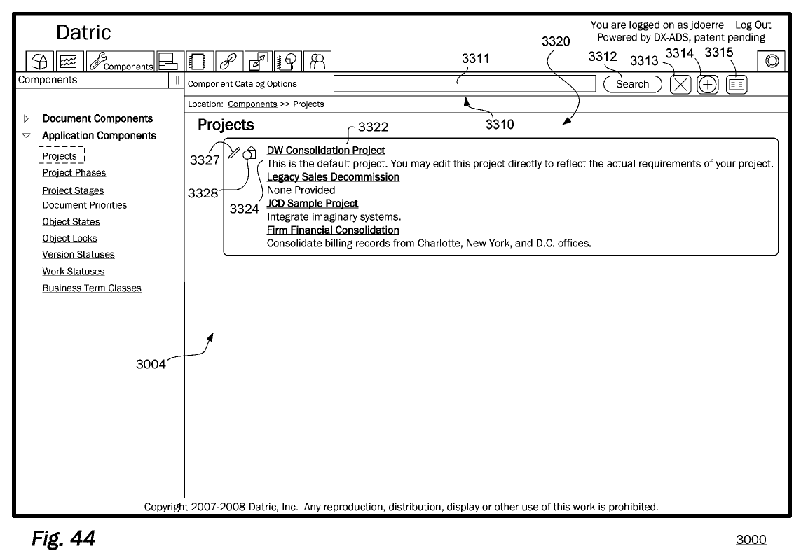

Clicking on a first of the links associated with types of application components, specifically a link associated with project application components, will display in a right pane 3004 of the components tab 3000 a projects subpage 3320, as can be seen in FIG. 44. The projects subpage 3320 displays a plurality of projects and, if necessary, may provide a page interface 3019 whereby a user may navigate to different pages of the projects subpage 3320.

Upon navigating to the projects subpage 3320, a project identifier 3322 is displayed for each project, together with a project descriptor 3324 of the project. These project descriptors 3324 may be toggled on or off by a description toggle button 3315 located in an options bar 3310. The options bar 3310 is located proximate the top of the projects subpage 3320. The options bar 3310 further includes a search field 3311, a search button 3312, a clear button 3313, and an add component button 3314.

From the projects subpage 3320, a user may search for a project by entering information into the search field 3311 and then clicking the search button 3312. It will be appreciated that search results are displayed as a project identifier 3322, together with a project descriptor 3324. After a search, a user may click the clear button 3313 to clear the results of the search.

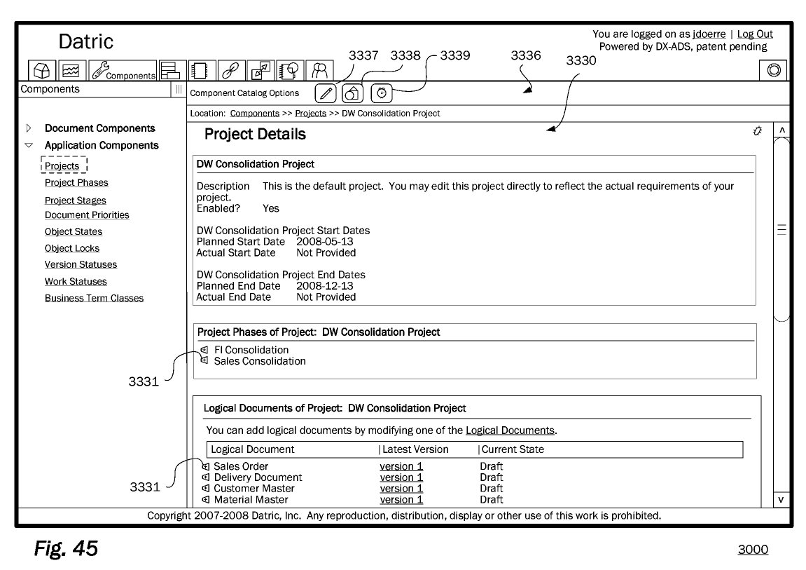

A user may click on one of the project identifiers 3322 to display a project details subpage 3330 for a project associated with the one of the project identifiers 3322. Clicking on the project identifier 3322 labeled “DW Consolidation Project” displays more detailed information associated with the DW Consolidation Project, as can be seen in FIG. 45. The project details subpage 3330 displays a description of the project, whether the project is enabled, a planned start date of the project, a planned end date of the project, an actual start date of the project, and an actual end date of the project. Further, on the project details subpage 3330, any logical documents of the project are displayed. Thus, in FIG. 45, logical documents of the DW Consolidation Project are displayed. Each logical document is displayed as a clickable link which will effect navigation to a page associated with that logical document. Additionally, a version and current state of each of the logical documents is displayed. Further, an enabling toggle 3331 allows a user to toggle each logical document displayed between an enabled state and a disabled state. Further still, as with the logical documents, any project phases associated with the project are displayed as clickable links with an enabling toggle 3331.

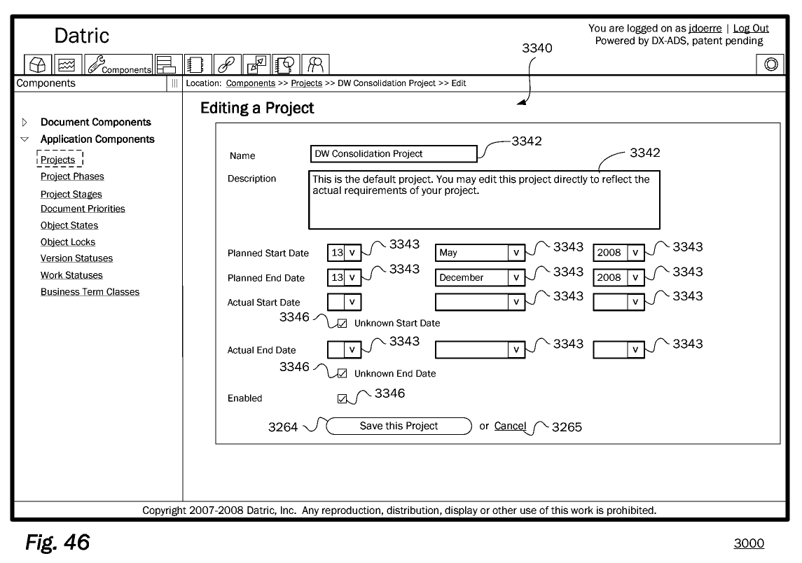

An options bar 3336 is displayed proximate the top of the project details subpage 3330, and includes an edit button 3337, a delete button 3338, and a history button 3339. A user may click the history button 3339 to display a history subpage. A user may click the delete button 3338 to delete the project associated with the project details subpage 3330, after confirming this choice. Further, a user may click the edit button 3337 to effect navigation to a project editing subpage 3340, as can be seen in FIG. 46. The project editing subpage 3340 allows a user to edit the name and description of the project via input fields 3342. A user may additionally edit the planned start date, planned end date, actual start date, and actual end date of the project via a plurality of drop down menus 3343. A user may select that they do not know their actual start or end date, and whether the project is enabled or disabled, via a plurality of check boxes 3346. A user may save his or her changes with a save button 3344, or else may cancel making changes via a cancel link 3345.

On the project subpage 3320, each project identifier 3322 and associated project descriptor 3324 are displayed together in a row 3326. When a user mouses over the row 3326, the row 3326 is highlighted and an edit icon 3327 and a removal icon 3328 are displayed in the row 3326, as can be seen in FIG. 44. A user may click the removal icon 3328 in one of the rows 3326 to delete the project associated with the project identifier 3322 and project descriptor 3324 displayed in the one of the rows 3326. A user must first confirm this choice. A user may click the edit icon 3327 in one of the rows 3326 to display a project editing interface similar to the project editing subpage 3340 described above. The project editing interface allows a user to edit the name and description of the project via input fields. A user may additionally edit the planned start date, planned end date, actual start date, and actual end date of the project via a plurality of drop down menus. A user may select that they do not know their actual start or end date, and whether the project is enabled or disabled, via a plurality of check boxes. A user may save his or her changes with a save button, or else may cancel making changes via a cancel link.

On the project subpage 3320, a user may click on the add component button 3314 to display a project creation interface similar to the project editing interface. The project creation interface allows a user to input a name and description of a new project to create via input fields. A user may additionally edit the planned start date, planned end date, actual start date, and actual end date of the project via a plurality of drop down menus. A user may select that they do not know their actual start or end date, and whether the project is enabled or disabled, via a plurality of check boxes. A user may save the new project with a save button, or else may cancel creation via a cancel link.

### Components Tab—Project Phase Application Components

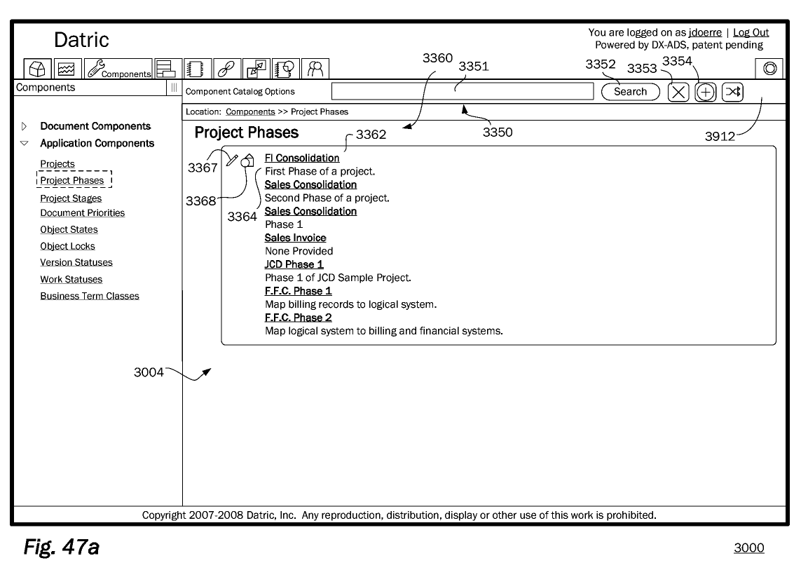

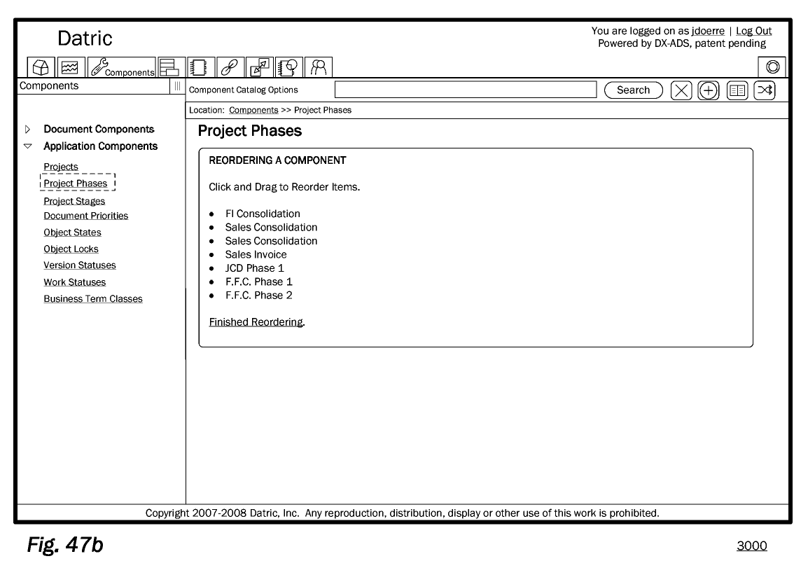

Clicking on a second of the links associated with types of application components, specifically a link associated with project phase application components, will display in a right pane 3004 of the components tab 3000 a project phases subpage 3360, as can be seen in FIG. 47A. The project phases subpage 3360 displays a plurality of project phases and, if necessary, may provide a page interface 3019 whereby a user may navigate to different pages of the project phases subpage 3360.

Upon navigating to the project phases subpage 3360, a project phase identifier 3362 is displayed for each project phase, together with a project phase descriptor 3364 of the project phase. These project phase descriptors 3364 may be toggled on or off by a description toggle button 3355 located in an options bar 3350. The options bar 3350 is located proximate the top of the project phases subpage 3360. The options bar 3350 further includes a search field 3351, a search button 3352, a clear button 3353, an add component button 3354, and a reorder button 3912.

A user may click on the reorder button 3912 to reorder the project phases via a project phase reordering page 3910, as can be seen in FIG. 47B.

From the project phases subpage 3360, a user may search for a project phase by entering information into the search field 3351 and then clicking the search button 3352. It will be appreciated that search results are displayed as a project phase identifier 3362, together with a project phase descriptor 3364. After a search, a user may click the clear button 3353 to clear the results of the search.

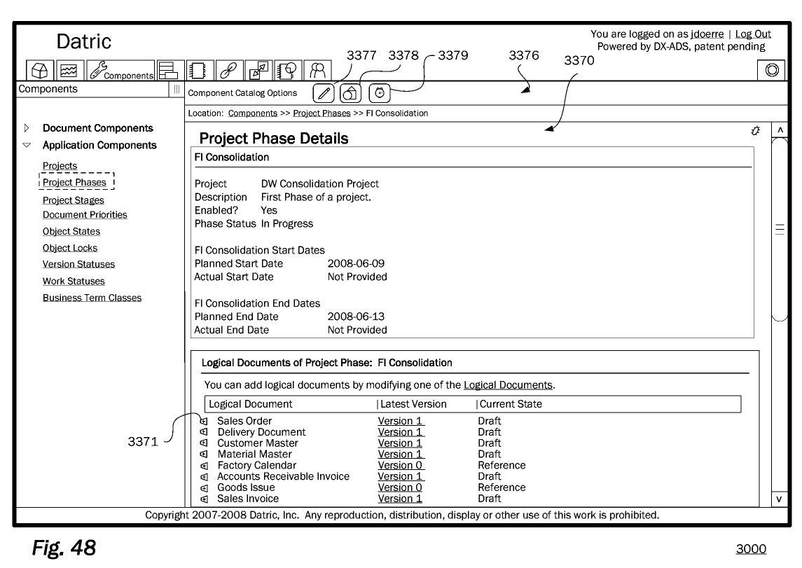

A user may click on one of the project phase identifiers 3362 to display a project phase details subpage 3370 for a project phase associated with the one of the project phase identifiers 3362. Clicking on the project phase identifier 3362 labeled “FI Consolidation” displays more detailed information associated with the FI Consolidation project phase, as can be seen in FIG. 48. The project phase details subpage 3370 displays a project the project is a phase of, a description of the project phase, a status of the project phase, whether the project phase is enabled, a planned start date of the project phase, a planned end date of the project phase, an actual start date of the project phase, and an actual end date of the project phase. Further, on the project phase details subpage 3370, any logical documents of the project phase are displayed. Thus, in FIG. 48, logical documents of the DW Consolidation Project phase are displayed. Each logical document is displayed as a clickable link which will effect navigation to a page associated with that logical document. Additionally, a version and current state of each of the logical documents is displayed. Further, an enabling toggle 3371 allows a user to toggle each logical document displayed between an enabled state and a disabled state.

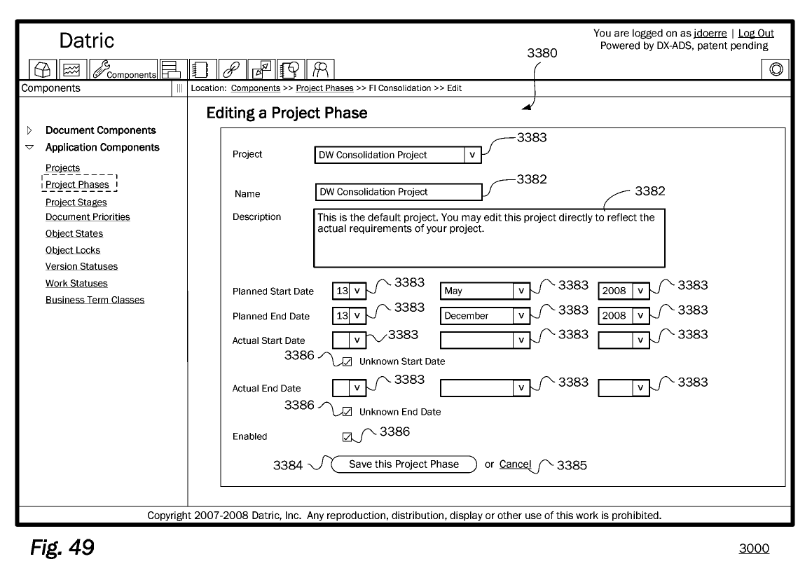

An options bar 3376 is displayed proximate the top of the project phase details subpage 3370, and includes an edit button 3377, a delete button 3378, and a history button 3379. A user may click the history button 3379 to display a history subpage. A user may click the delete button 3378 to delete the project phase associated with the project phase details subpage 3370, after confirming this choice. Further, a user may click the edit button 3377 to effect navigation to a project phase editing subpage 3380, as can be seen in FIG. 49. The project phase editing subpage 3380 allows a user to edit the name and description of the project phase via input fields 3382. A user may additionally edit the project the phase is a part of, status, planned start date, planned end date, actual start date, and actual end date of the project phase via a plurality of drop down menus 3383. A user may select that they do not know their actual start or end date, and may select whether the project phase is enabled or disabled, via a plurality of check boxes 3386. A user may save his or her changes with a save button 3384, or else may cancel making changes via a cancel link 3385.

On the project phase subpage 3360, each project phase identifier 3362 and associated project phase descriptor 3364 are displayed together in a row 3366. When a user mouses over the row 3366, the row 3366 is highlighted and an edit icon 3367 and a removal icon 3368 are displayed in the row 3366, as can be seen in FIG. 47. A user may click the removal icon 3368 in one of the rows 3366 to delete the project phase associated with the project phase identifier 3362 and project phase descriptor 3364 displayed in the one of the rows 3366. A user must first confirm this choice. A user may click the edit icon 3367 in one of the rows 3366 to display a project phase editing interface similar to the project phase editing subpage 3380 described above. The project phase editing interface allows a user to edit the name and description of the project phase via input fields. A user may additionally edit the project the phase is a part of, status, planned start date, planned end date, actual start date, and actual end date of the project phase via a plurality of drop down menus. A user may select that they do not know their actual start or end date, and may select whether the project phase is enabled or disabled, via a plurality of check boxes. A user may save his or her changes with a save button, or else may cancel making changes via a cancel link.

On the project phase subpage 3360, a user may click on the add component button 3314 to display a project phase creation interface similar to the project phase editing interface. The project phase creation interface allows a user to input a name and description of a new project phase to create via input fields. A user may additionally edit the project the phase is a part of, status, planned start date, planned end date, actual start date, and actual end date of the project phase via a plurality of drop down menus. A user may select that they do not know their actual start or end date, and may select whether the project phase is enabled or disabled, via a plurality of check boxes. A user may save the new project phase with a save button, or else may cancel creation via a cancel link.

### Components Tab—Contemplated ETL Rules Application Components

It is contemplated that a link associated with ETL Rules Application Components may be added to the components tab 3000, and further that users may be allowed to create, edit, and delete the ETL rule types available for selection on the mapping tab 7000. This may be accomplished via an ETL components subpage, which subpage may have similar functionality as that outlined above with respect to other component subpages.

### User-Editability of Application Components

It will be appreciated that unlike the above described components, the application components described below are not editable by a user, although in at least some alternative embodiments they may be.

### Components Tab—Project Stage Application Components

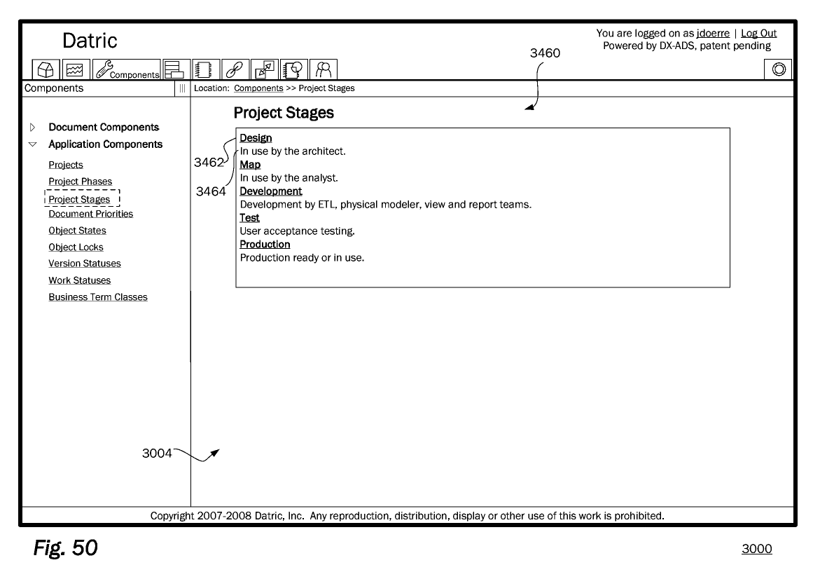

Clicking on a third of the links associated with types of application components, specifically a link associated with project stage application components, will display in a right pane 3004 of the components tab 3000 a project stages subpage 3460, as can be seen in FIG. 50. The project stages subpage 3460 displays a plurality of project stages and, if necessary, may provide a page interface 3019 whereby a user may navigate to different pages of the project stages subpage 3460.

Upon navigating to the project stages subpage 3460, a project stage identifier 3462 is displayed for each project stage, together with a project stage descriptor 3464 of the project stage.

A user may click on one of the project stage identifiers 3462 to display a project stage details subpage for a project stage associated with the one of the project stage identifiers 3462. The project stage details subpage displays a description of the project stage. Further, on the project stage details subpage, any logical documents of the project stage are displayed. Each logical document is displayed as a clickable link which will effect navigation to a page associated with that logical document. Additionally, a version and current state of each of the logical documents is displayed. Further, an enabling toggle allows a user to toggle each logical document displayed between an enabled state and a disabled state.

There are five predefined project stages: a design stage, a mapping stage, a development stage, a testing stage, and a production stage. In alternative embodiments different stages may be defined, and in at least some alternative embodiment users may be able to define their own stages.

### Components Tab—Document Priority Application Components

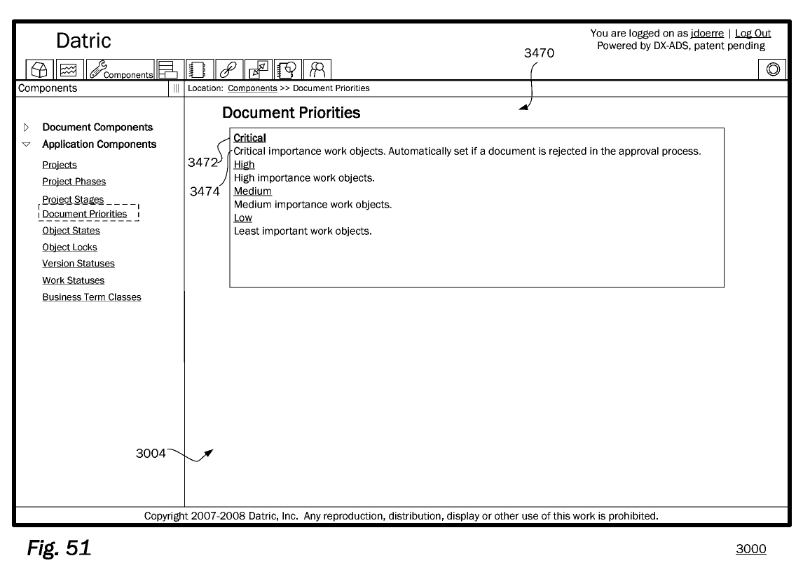

Clicking on a fourth of the links associated with types of application components, specifically a link associated with document priority application components, will display in a right pane 3004 of the components tab 3000 a document priorities subpage 3470, as can be seen in FIG. 51. The document priorities subpage 3470 displays a plurality of document priorities and, if necessary, may provide a page interface 3019 whereby a user may navigate to different pages of the document priorities subpage 3470.

Upon navigating to the document priorities subpage 3470, a document priority identifier 3472 is displayed for each document priority, together with a document priority descriptor 3474 of the document priority.

A user may click on one of the document priority identifiers 3472 to display a document priority details subpage for a document priority associated with the one of the document priority identifiers 3472. The document priority details subpage displays a description of the document priority. Further, on the document priority details subpage, any logical documents of the document priority are displayed. Each logical document is displayed as a clickable link which will effect navigation to a page associated with that logical document. Additionally, a version and current state of each of the logical documents is displayed. Further, an enabling toggle allows a user to toggle each logical document displayed between an enabled state and a disabled state.

There are four predefined document priorities: critical, high, medium, and low. Users may set documents to high, medium or low, but only the system may set documents to critical. In alternative embodiments different priorities may be defined, and in at least some alternative embodiment users may be able to define their own priorities.

### Components Tab—Object State Application Components

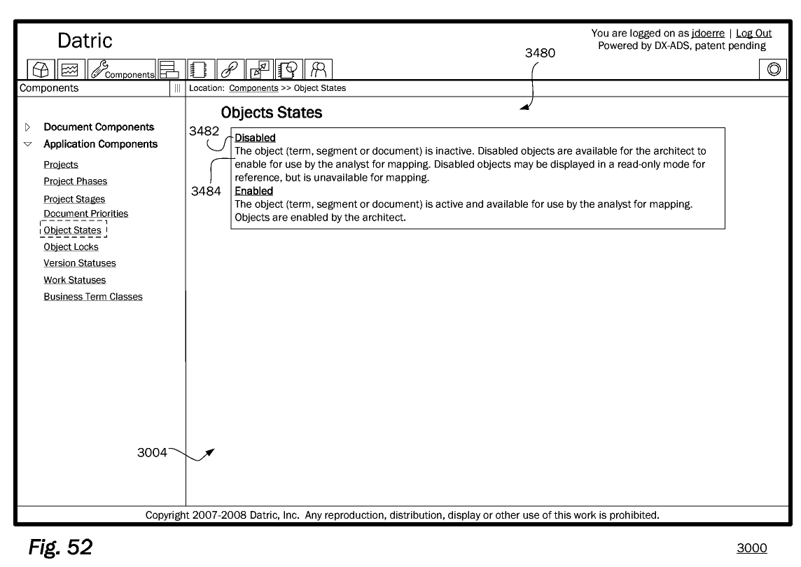

Clicking on a fifth of the links associated with types of application components, specifically a link associated with object state application components, will display in a right pane 3004 of the components tab 3000 an object states subpage 3480, as can be seen in FIG. 52. The object states subpage 3480 displays a plurality of object states and, if necessary, may provide a page interface 3019 whereby a user may navigate to different pages of the object states subpage 3480.

Upon navigating to the object states subpage 3480, an object state identifier 3482 is displayed for each object state, together with an object state descriptor 3484 of the object state.

A user may click on one of the object state identifiers 3482 to display an object state details subpage for an object state associated with the one of the object state identifiers 3482. The object state details subpage displays a description of the object state. Further, on the object state details subpage, any logical documents of the object state are displayed. Each logical document is displayed as a clickable link which will effect navigation to a page associated with that logical document. Additionally, a version and current state of each of the logical documents is displayed. Further, an enabling toggle allows a user to toggle each logical document displayed between an enabled state and a disabled state.

There are two predefined object states. Disabled objects (term, segment or document) are inactive. Disabled objects may, however, be enabled. Disabled objects may be displayed in a read-only mode for reference, but are unavailable for mapping unless enabled. Enabled objects are active and available for mapping. Objects may be enabled by any developer with the appropriate permission. In alternative embodiments different states may be defined, and in at least some alternative embodiment users may be able to define their own states.

### Components Tab—Object Lock Application Components

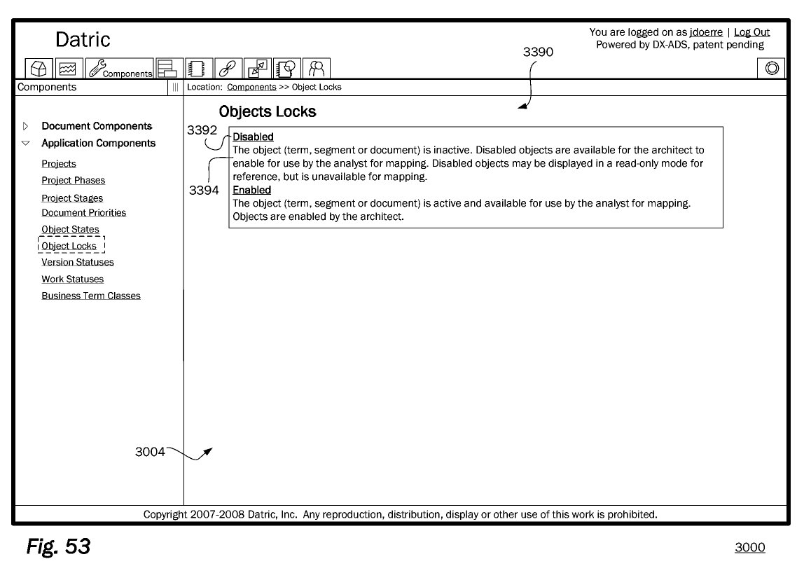

Clicking on a sixth of the links associated with types of application components, specifically a link associated with object lock application components, will display in a right pane 3004 of the components tab 3000 an object locks subpage 3390, as can be seen in FIG. 53. The object locks subpage 3390 displays a plurality of object locks and, if necessary, may provide a page interface 3019 whereby a user may navigate to different pages of the object locks subpage 3390.

Upon navigating to the object locks subpage 3390, an object lock identifier 3392 is displayed for each object lock, together with an object lock descriptor 3394 of the object lock.

A user may click on one of the object lock identifiers 3392 to display an object lock details subpage for an object lock associated with the one of the object lock identifiers 3392. The object lock details subpage displays a description of the object lock. Further, on the object lock details subpage, any logical documents of the object lock are displayed. Each logical document is displayed as a clickable link which will effect navigation to a page associated with that logical document. Additionally, a version and current state of each of the logical documents is displayed. Further, an enabling toggle allows a user to toggle each logical document displayed between an enabled state and a disabled state.

Locks are defined as allowing an object to be either locked or unlocked. An unlocked object may be changed. A locked object may not be changed. Active and obsolete document versions are locked to prevent any change to any object. In order for a change to occur, a new draft must be created. In alternative embodiments, different locks may be defined and, in at least some alternative embodiments, users may be able to define their own locks.

### Components Tab—Version Status Application Components

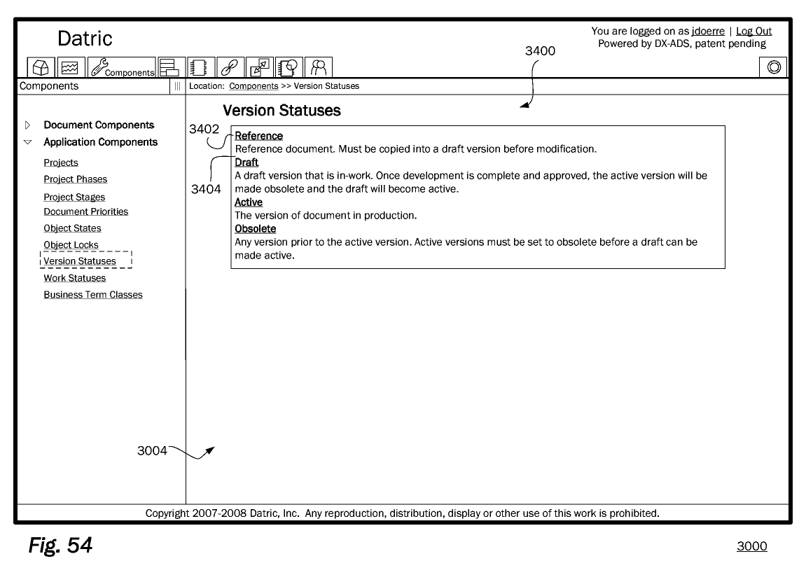

Clicking on a seventh of the links associated with types of application components, specifically a link associated with version status application components, will display in a right pane 3004 of the components tab 3000 a version statuses subpage 3400, as can be seen in FIG. 54. The version statuses subpage 3400 displays a plurality of version statuses and, if necessary, may provide a page interface 3019 whereby a user may navigate to different pages of the version statuses subpage 3400.

Upon navigating to the version statuses subpage 3400, a version status identifier 3402 is displayed for each version status, together with a version status descriptor 3404 of the version status.

A user may click on one of the version status identifiers 3402 to display a version status details subpage for a version status associated with the one of the version status identifiers 3402. The version status details subpage displays a description of the version status. Further, on the version status details subpage, any logical documents of the version status are displayed. Each logical document is displayed as a clickable link which will effect navigation to a page associated with that logical document. Additionally, a version and current state of each of the logical documents is displayed. Further, an enabling toggle allows a user to toggle each logical document displayed between an enabled state and a disabled state.

There are four predefined version statuses. Reference status applies to a reference document. Reference documents must be copied into a draft version before modification. Draft status signifies a version is in-work. Once development is complete and approved, the active version will be made obsolete and the draft will become active. Active status designates the version of document in production. Obsolete status is appropriate for any version prior to the active version. Active versions must be set to obsolete before a draft can be made active. In alternative embodiments, different statuses may be defined and, in at least some alternative embodiments, users may be able to define their own statuses.

### Components Tab—Work Status Application Components

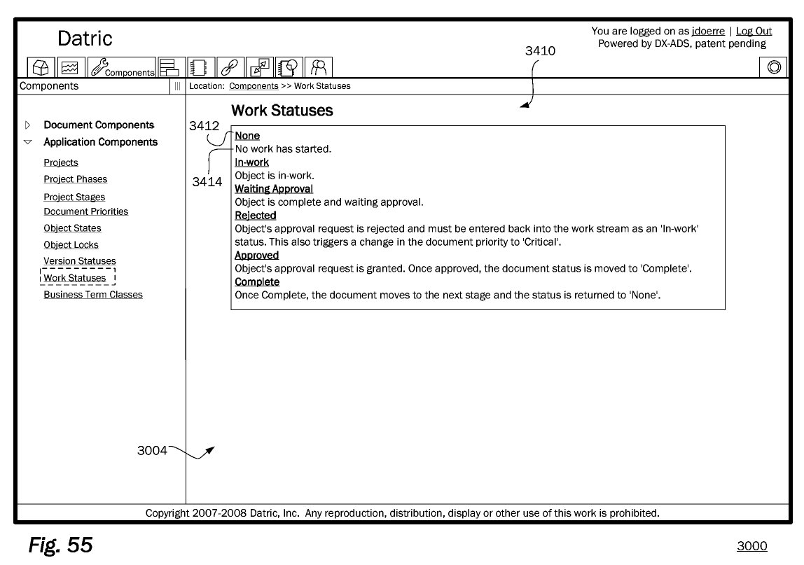

Clicking on an eighth of the links associated with types of application components, specifically a link associated with work status application components, will display in a right pane 3004 of the components tab 3000 a work statuses subpage 3410, as can be seen in FIG. 55. The work statuses subpage 3410 displays a plurality of work statuses and, if necessary, may provide a page interface 3019 whereby a user may navigate to different pages of the work statuses subpage 3410.

Upon navigating to the work statuses subpage 3410, a work status identifier 3412 is displayed for each work status, together with a work status descriptor 3414 of the work status.

A user may click on one of the work status identifiers 3412 to display a work status details subpage for a work status associated with the one of the work status identifiers 3412. The work status details subpage displays a description of the work status. Further, on the work status details subpage, any logical documents of the work status are displayed. Each logical document is displayed as a clickable link which will effect navigation to a page associated with that logical document. Additionally, a version and current state of each of the logical documents is displayed. Further, an enabling toggle allows a user to toggle each logical document displayed between an enabled state and a disabled state.

There are six predefined work statuses. A none work status signifies no work has started. An in-work status signifies an object is in-work. A waiting approval work status signifies an object is complete and waiting approval. A rejected work status signifies an object's approval request was rejected and must be entered back into the work stream as “in-work” status. This also triggers a change in the document's priority to critical. An approved work status signifies an object's approval request was granted, and the document status is thus set to complete. Once complete, the document moves to the next stage and the status is returned to none.

FIG. 6B is a flowchart illustrating how work statuses and work stages may be utilized in one efficient process. At each work stage, an assignment is made to a developer, at which point the status is in-work. The developer completes his work, has it validated if appropriate, and then sets the status to waiting approval. A document is either rejected, at which point it returns to being in-work, or else is accepted, at which point it moves on to the next stage and all flags are reset. Its priority is reset to medium, and it is reset to the none work stage and assigned to a developer. The process repeats through the work stages until the document is accepted at the test stage and then it goes into production.

### Components Tab—Business Term Class Application Components

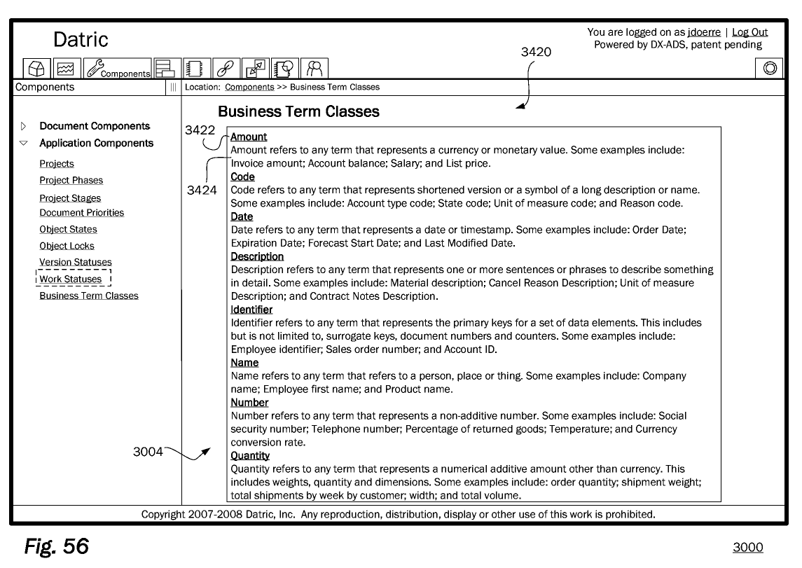

Clicking on a ninth of the links associated with types of application components, specifically a link associated with business term class application components, will display in a right pane 3004 of the components tab 3000 an business term classes subpage 3420, as can be seen in FIG. 56. The business term classes subpage 3420 displays a plurality of business term classes and, if necessary, may provide a page interface 3019 whereby a user may navigate to different pages of the business term classes subpage 3420.

Upon navigating to the business term classes subpage 3420, a business term class identifier 3422 is displayed for each business term class, together with a business term class descriptor 3424 of the business term class.

A user may click on one of the business term class identifiers 3422 to display a business term class details subpage for an business term class associated with the one of the business term class identifiers 3422. The business term class details subpage displays a description of the business term class. Further, on the business term class details subpage, any logical documents of the business term class are displayed. Each logical document is displayed as a clickable link which will effect navigation to a page associated with that logical document. Additionally, a version and current state of each of the logical documents is displayed. Further, an enabling toggle allows a user to toggle each logical document displayed between an enabled state and a disabled state.

### Systems Tab

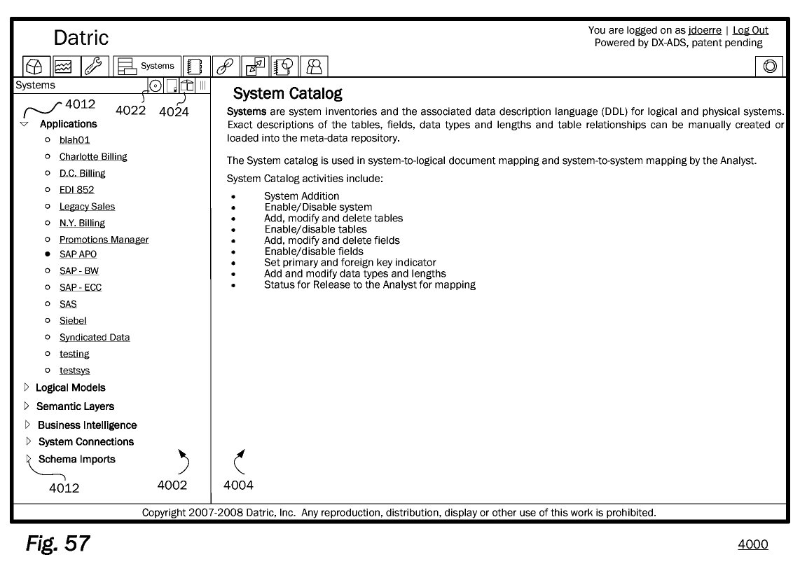

FIG. 57 is a screenshot of the systems tab 4000 of the user page of the website. The systems tab 4000 allows a user to view, modify, and create systems, tables, fields, and system connections. The systems tab 4000 includes a plurality of expandable menus 4012 located in a left pane 4002 of the systems tab 4000. Clicking on one of the plurality of expandable menus 4012 expands the expandable menu 4012 that was clicked.

### Systems Tab—Systems

One or more of the expandable menus 4012 are associated with system type document components defined under the components tab 3000. In FIG. 57, Applications, Logical Models, Semantic Layers, and Business Intelligence are all system types defined as system type document components. When an expandable menu is expanded, systems, i.e. instances of the system type, are displayed as links. Next to each link is a colored indicator indicating whether the system is enabled or disabled.

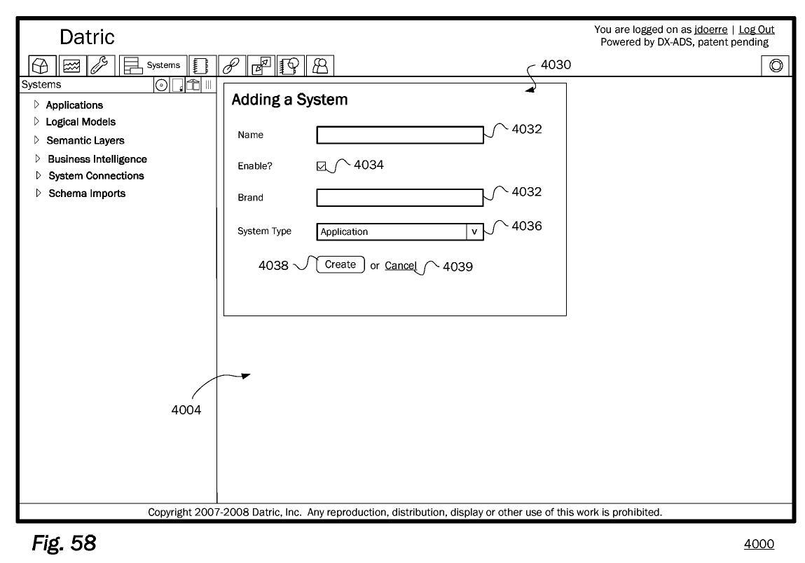

A user may create a new system, by clicking an add new system button 4022 located proximate a top of the left pane 4002. When a user clicks the add new system button 4022, an add new system page 4030 is displayed in a right pane 4004 of the systems tab 4000, as can be seen in FIG. 58. On the add new system page 4030, a user may input a name and brand into text fields 4032. A user may further input whether the system is enabled or disabled via a check box 4034. A user may select a system type via a dropdown menu 4036. A user may then click a create button 4038 to create the new system, or else cancel creation via a cancel link 4039.

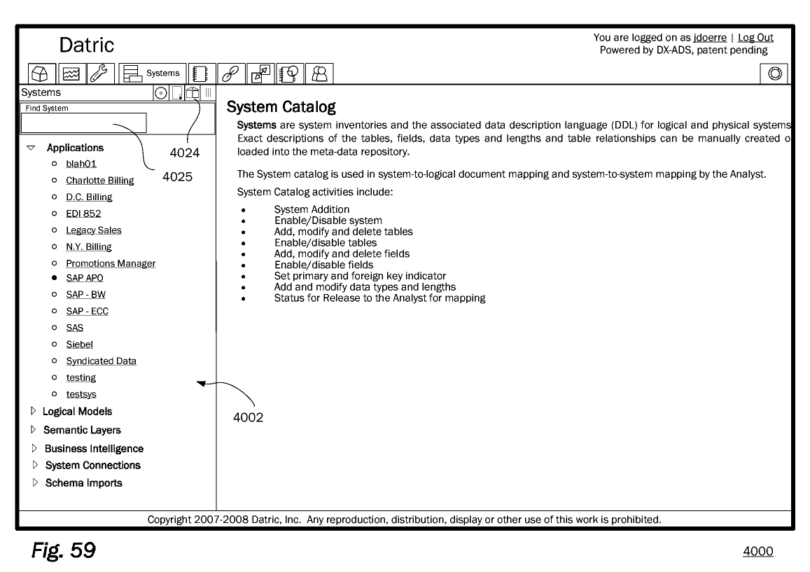

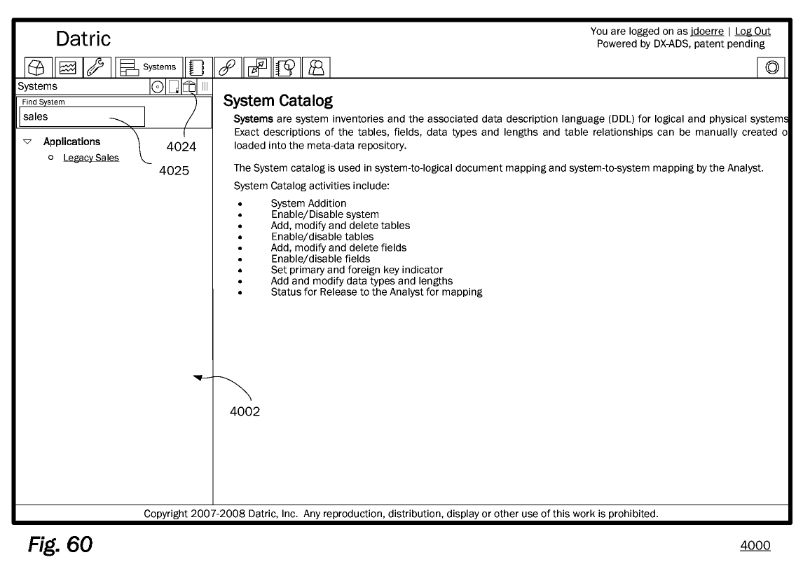

A user may search for a system via a search button 4024 located proximate a top of the left pane 4002. Clicking the search button 4024 effects display of a search field 4025, as can be seen in FIG. 59. Searching for a term effects display in the left pane 4002 of all systems returned as a result, as can be seen in FIG. 60.

### Systems Tab—System Details Subpage

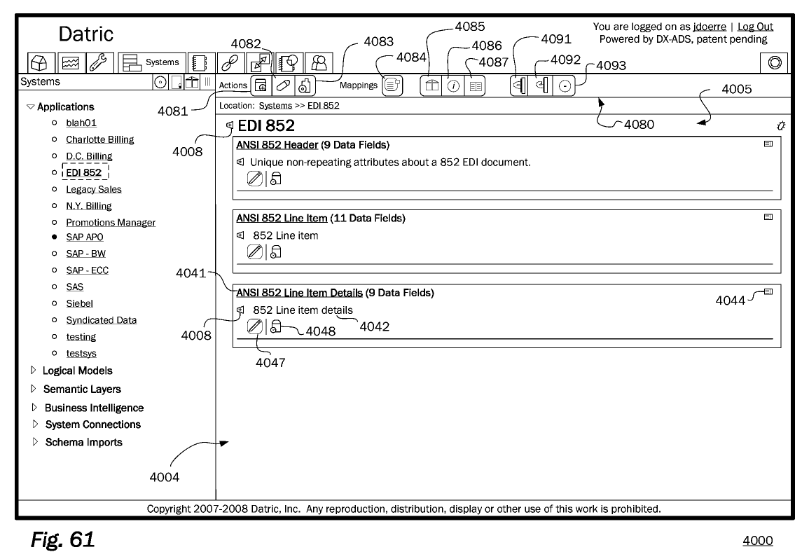

When a user clicks on a system, a system details subpage 4005 is displayed in the right pane 4004. It will be appreciated that the system details subpage 4005 that is displayed after clicking on a system is associated with that system. Specifically, the name of the system is displayed with an enabling toggle 4008, along with a data table identifier 4041 for each data table of the system, as can be seen in FIG. 61. Displayed with each data table identifier 4041 is a data table descriptor 4042 of the data table, the number of data fields the data table has, an enabling toggle 4008, an edit button 4047, a delete button 4048, and an expand button 4044.

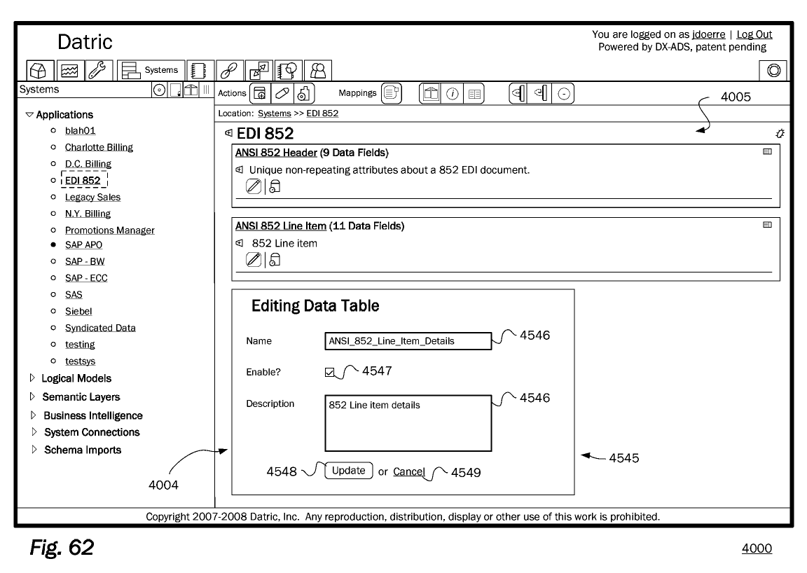

Clicking on the delete button 4048 deletes the associated data table. Clicking on the edit button 4042 displays a data table editing interface 4545, as can be seen in FIG. 62. The data table editing interface 4545 allows a user to input a name and description of the data table via input fields 4546. The data table editing interface 4545 further allows a user to indicate the data table is enabled or disabled via a check box 4547. A user may save this input via an update button 4548 or may discard this input via a cancel link 4549.

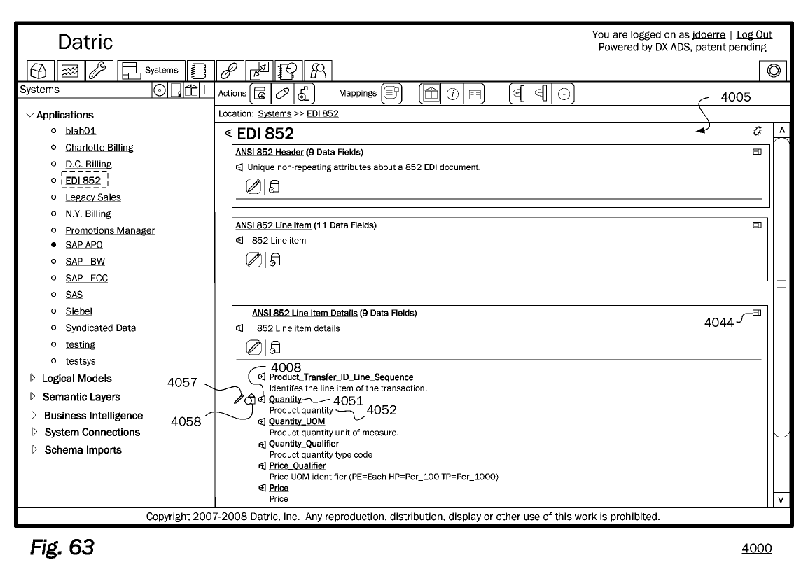

Clicking on the expand button 4044 displays a data field identifier 4051 for each data field of the data table. Displayed with each data field identifier 4051 is a data field descriptor 4052 and an enabling toggle 4008. Each data field identifier 4051 and associated data field descriptor 4052 are displayed together in a row 4056. When a user mouses over the row 4056, the row 4056 is highlighted and an edit icon 4057 and a removal icon 4058 are displayed in the row 4056, as can be seen in FIG. 63. A user may click the removal icon 4058 in one of the rows 4056 to delete the data field associated with the data field identifier 4051 and descriptor 4052 displayed in the one of the rows 4056. A user must first confirm this choice. A user may click the edit icon 4057 in one of the rows 4056 to display a data field editing interface 4070.

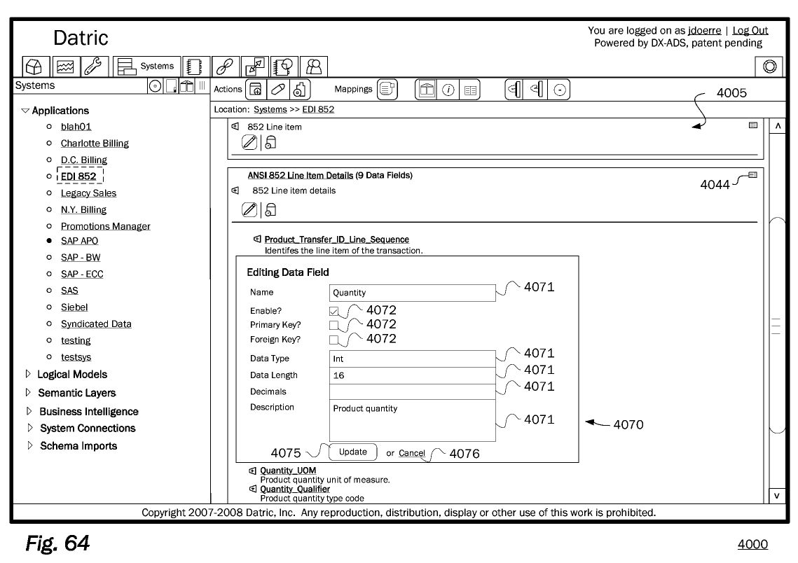

As can be seen in FIG. 64, the data field editing interface 4070 allows a user to input a name, data type, data length, a description, and decimals information via input fields 4071. The data field editing interface 4070 further allows a user to indicate the data field is enabled or disabled, a primary key or not, and a foreign key or not via check boxes 4072. A user may save this input via an update button 4075 or may discard this input via a cancel link 4076.

### Systems Tab—Data Table Details Subpage

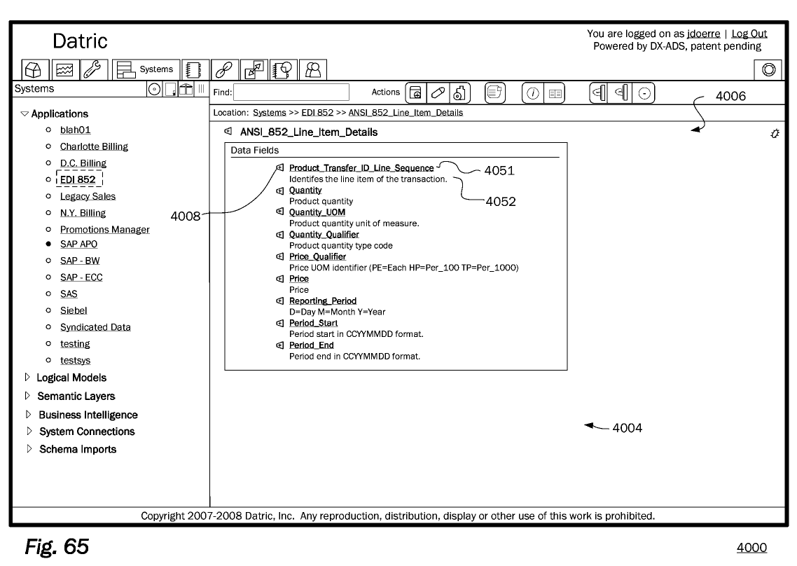

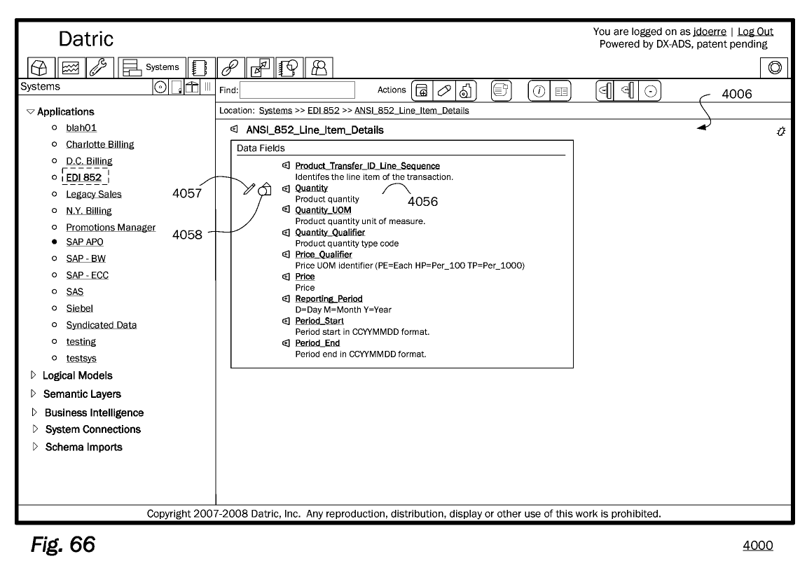

On the system details subpage 4005, a user may click on a data table identifier 4041 to display a data table details subpage 4006. It will be appreciated that the data table details subpage 4006 that is displayed after clicking on a data table will be associated with that data table. On this data table details subpage 4006, a data field identifier 4051 is displayed for each data field of the data table, as can be seen in FIG. 65. Displayed with each data field identifier 4051 is a data field descriptor 4052 and an enabling toggle 4008. Each data field identifier 4051 and associated data field descriptor 4052 are displayed together in a row 4056. When a user mouses over the row 4056, the row 4056 is highlighted and an edit icon 4057 and a removal icon 4058 are displayed in the row 4056, as can be seen in FIG. 66. A user may click the removal icon 4058 in one of the rows 4056 to delete the data field associated with the data field identifier 4051 and descriptor 4052 displayed in the one of the rows 4056. A user must first confirm this choice. A user may click the edit icon 4057 in one of the rows 4056 to display the data field editing interface 4070.

### Systems Tab—Data Field Details Subpage

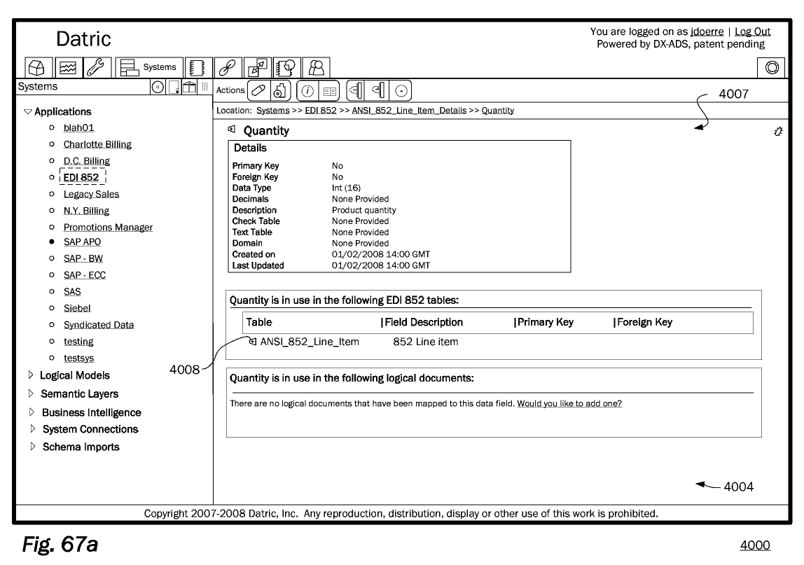

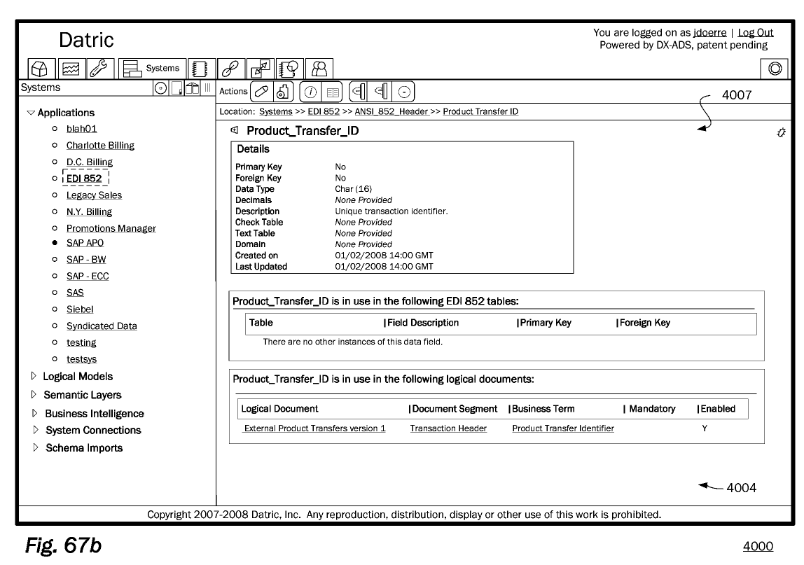

On the system details subpage 4005 or the data table details subpage 4006, a user may click on a data field identifier 4051 to display a data field details subpage 4007, as can be seen in FIG. 67A. It will be appreciated that the data field details subpage 4007 that is displayed after clicking on a data field will be associated with that data field. On this data field details subpage 4007, details of the data field may be displayed, including whether the data field is a primary key, whether the data field is a foreign key, a data type of the data field, decimals information associated with the data field, a description of the data field, a check table of the data field, a text table of the data field, a domain of the data field, a creation date of the data field, and a date the data field was last updated. Further, every other data table of the system that uses the data field is displayed as a link, together with an enabling toggle 4008, a description, an indication of whether it is a primary key, and an indication of whether it is a foreign key, as can be seen in FIG. 67A. Further still, every logical document the data field is used in is displayed as a link, together with the document segment it is associated with displayed as a link, the business term it is associated with displayed as a link, an indication whether it is mandatory, and an indication whether it is enabled, as can be seen in FIG. 67B.

### Systems Tab—Options Bars

On each system details subpage 4005, data table details subpage 4006, and data field details subpage 4007, options bars 4080,4120,4720 are displayed.

On the system details subpage 4005, an options bar 4080 is displayed proximate a top of the system details subpage 4005, as can be seen in FIG. 61. The options bar 4080 includes an add data table button 4081, an edit system button 4082, a delete system button 4083, a mapping button 4084, a show search button 4085, a show information button 4086, a toggle descriptions button 4087, a show enabled button 4091, a show disabled button 4092, and a show enabled and disabled button 4093.

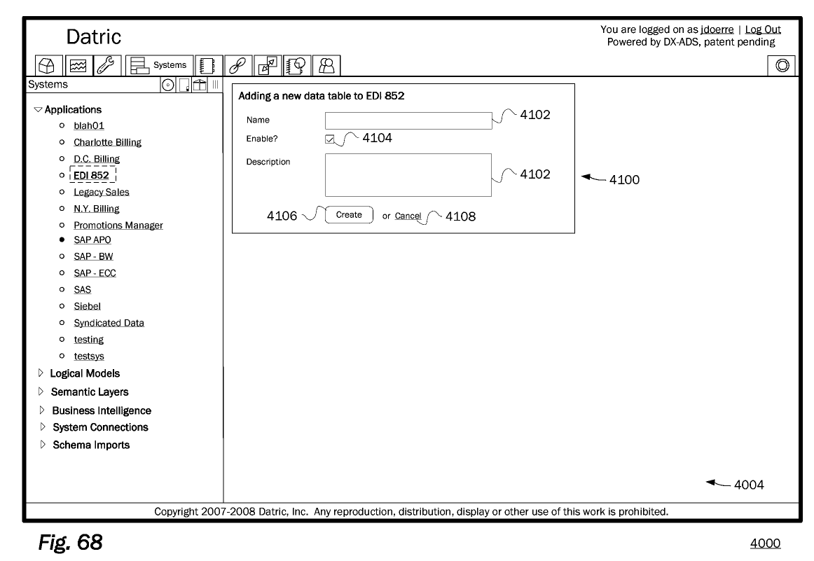

A user may click on the add data table button 4081 to display a data table creation page 4100 in the right pane 4004, as can be seen in FIG. 68. A user may input a name and description into the data table creation page 4100 via input fields 4102. A user may further indicate whether the data table to be created is to be enabled via a check box 4104. A user may create a new data table using the information he or she has input by clicking a create button 4106, or alternatively may cancel creation via a cancel link 4108.

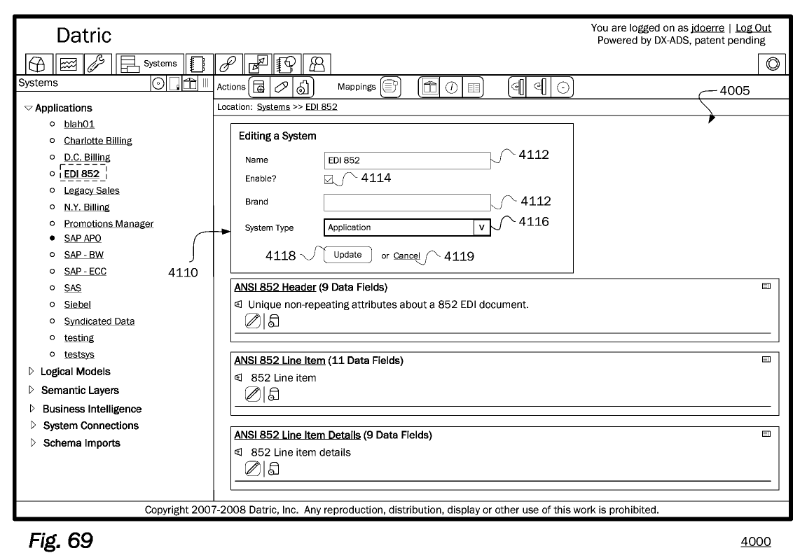

A user may click on the edit system button 4082 to display a system editing interface 4110, as can be seen in FIG. 69. A user may edit the name and brand of the system via text fields 4112. A user may further edit whether the system is enabled or disabled via a check box 4114. A user may edit the system type via a dropdown menu 4116. A user may then click an update button 4118 to save the changes, or a cancel link 4119 to discard the changes.

A user may click the delete system button 4083 to delete the system. A user must confirm this decision before deletion is effected.

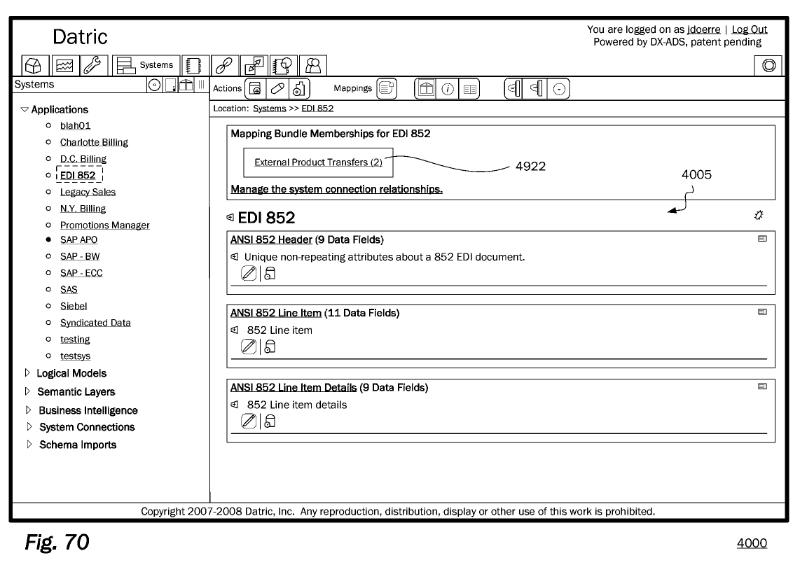

A user may click the mapping button 4084 to display mapping bundle memberships 4922 for the system, as can be seen in FIG. 70. Each mapping bundle membership 4922 displays a name of a document the system is mapped to and a total number of systems the document is mapped to. A link to the relationships tab 6000 is also displayed.

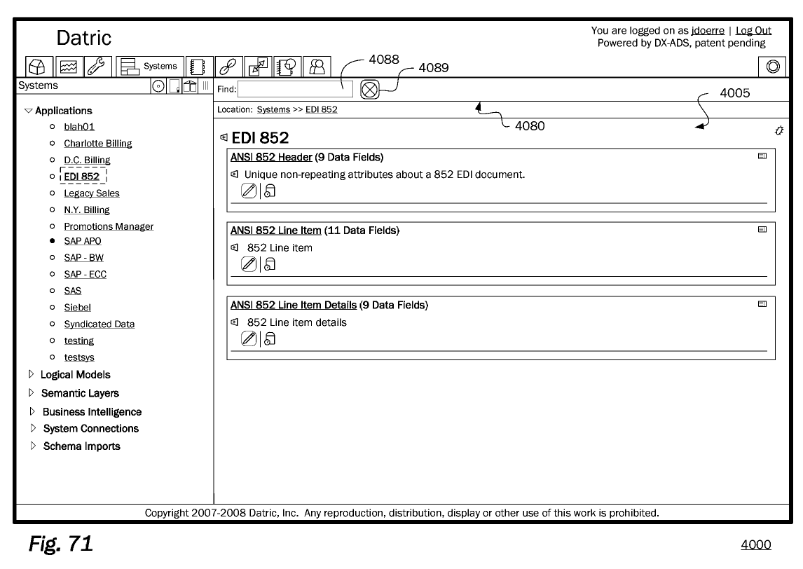

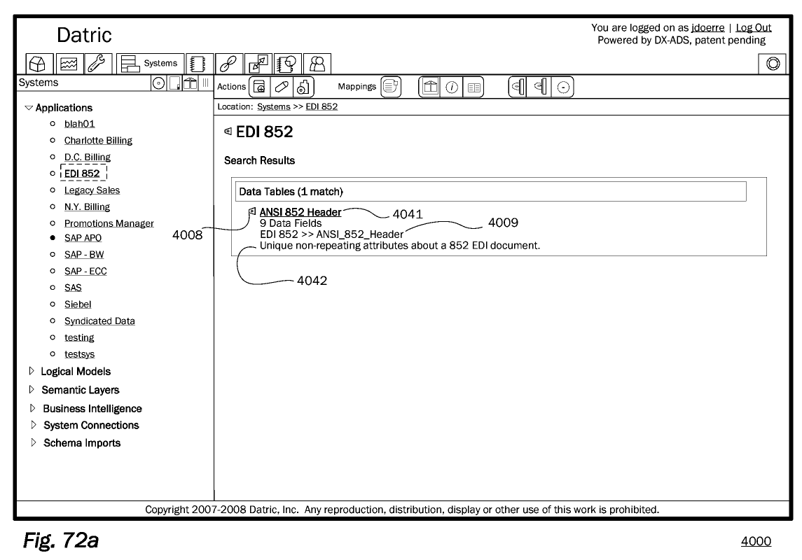

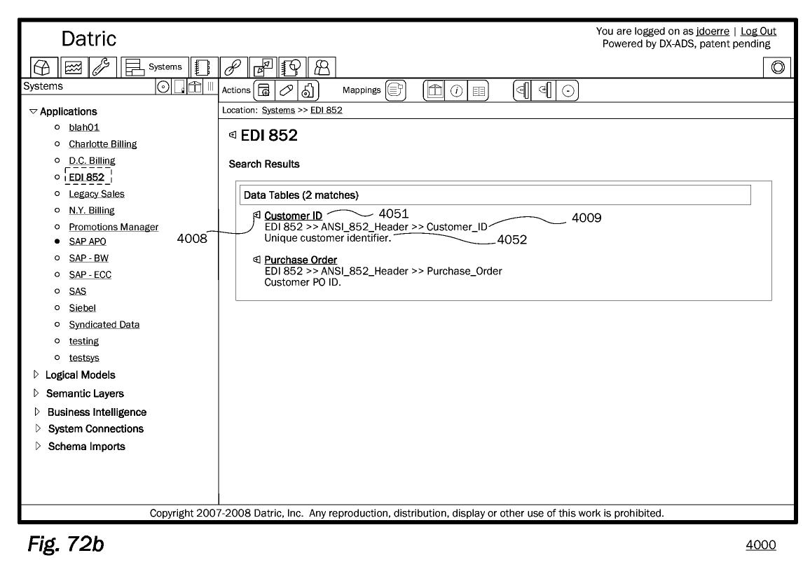

A user may click on the search button 4085 to display a search field 4088 and cancel button 4089 in the options bar 4080, as can be seen in FIG. 71. A user may enter text to search for in the search field 4088 and then effect a search by pressing enter. In at least some alternative embodiments, there may be a start search button that effects the search. In response to a user search, a data table identifier 4041 is displayed for each data table that is a positive result of the search, as can be seen in FIG. 72A. Displayed with each data table identifier 4041 is a data table descriptor 4042 of the data table, the number of data fields the data table has, an enabling toggle 4008, and a directory representation 4009 of the data table and the system it is a part of.

Further, in response to a user search, a data field identifier 4051 is displayed for each data field that is a positive result of the search, as can be seen in FIG. 72B. Displayed with each data field identifier 4051 is a data field descriptor 4052 of the data field, an enabling toggle 4008, and a directory representation 4009 of the data field, the data table it is a part of, and the system the data table is a part of.

A user may cause the options bar 4080 to return to its default display as it was before the search button 4085 was clicked by clicking the cancel button 4089.

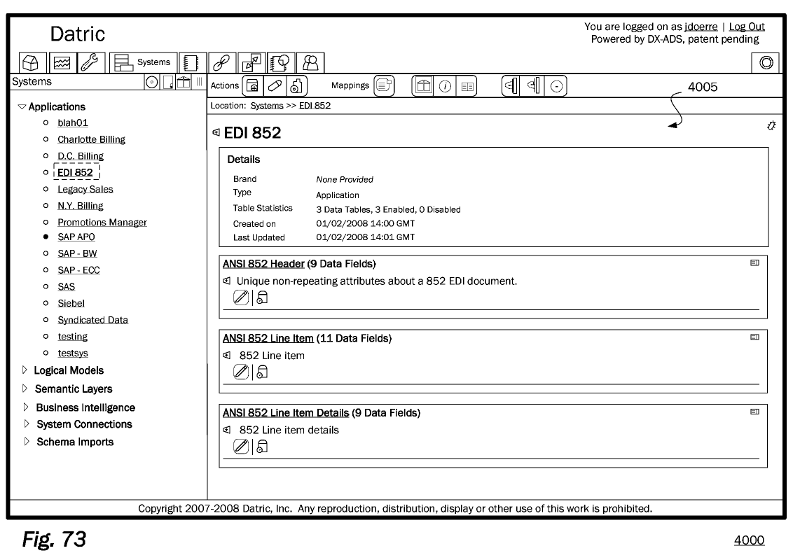

A user may click the show information button 4086 to display details associated with the system. Specifically, the brand of the system, the system type, a number of data tables of the system, a number of enabled data tables of the system, a number of disabled data tables of the system, a date and time the system was created, and a date and time the system was last updated will be displayed, as can be seen in FIG. 73.

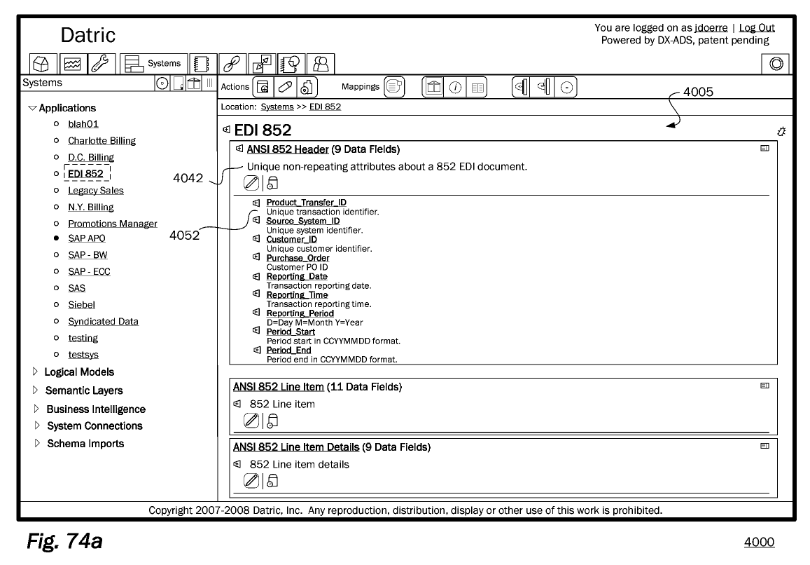

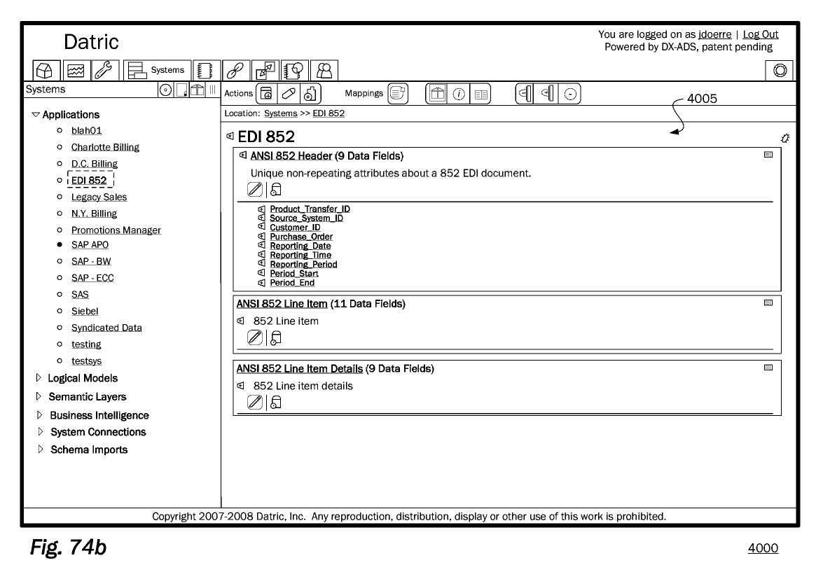

A user may click the toggle descriptions button 4087 to toggle between descriptors 4042,4052 being displayed and not displayed, as can be seen via comparison of FIG. 74A, in which descriptors 4042,4052 are displayed, and FIG. 74B, in which they are not.

Buttons 4091,4092,4093 function as radio buttons, in that only one of the three buttons can be selected at any given time. If a user clicks on the show enabled button 4091, only enabled elements will be displayed. If a user clicks on the show disabled button 4092, only disabled elements will be displayed. If a user clicks on the show enabled and disabled button 4093, both enabled and disabled elements will be displayed.

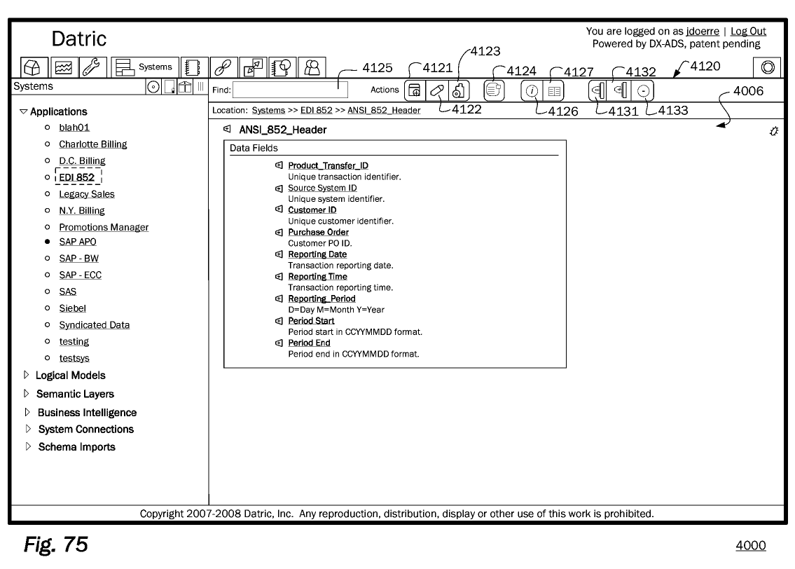

On the data table details subpage 4006, an options bar 4120 is displayed proximate the top of the data table details subpage 4006, as can be seen in FIG. 75. The options bar 4120 includes an add data field button 4121, an edit data table button 4122, a delete data table button 4123, a mapping button 4124, a search field 4125, a show information button 4126, a toggle descriptions button 4127, a show enabled button 4131, a show disabled button 4132, and a show enabled and disabled button 4133.

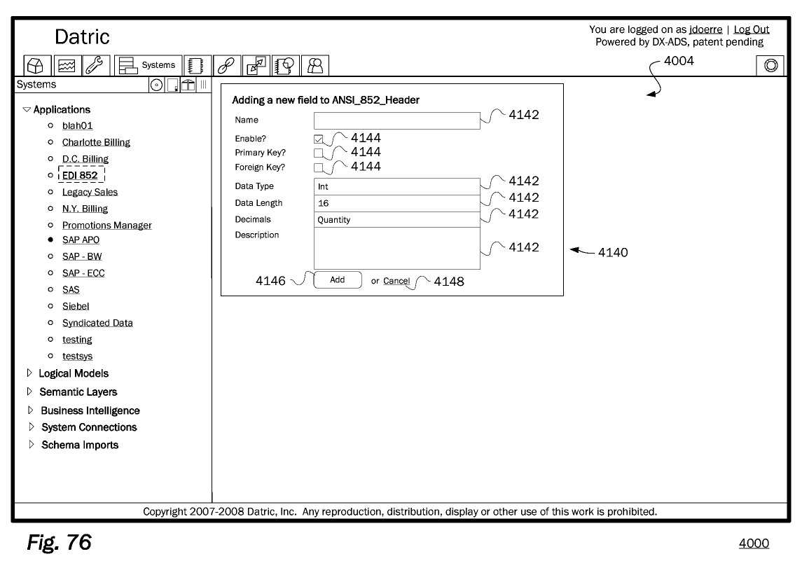

A user may click on the add data field button 4121 to display a data field creation page 4140 in the right pane 4004, as can be seen in FIG. 76. A user may input a name, data type, data length, a description, and decimals information into the data field creation page 4140 via input fields 4142. A user may further indicate whether the data field to be created is to be enabled or disabled, a primary key or not, and a foreign key or not, via check boxes 4144. A user may create a new data field using the information he or she has input by clicking a create button 4146, or alternatively may cancel creation via a cancel link 4148.

A user may click on the edit data table button 4122 to display the data table editing interface 4545, previously described above.

A user may click the delete data table button 4123 to delete the data table. A user must confirm this decision before deletion is effected.

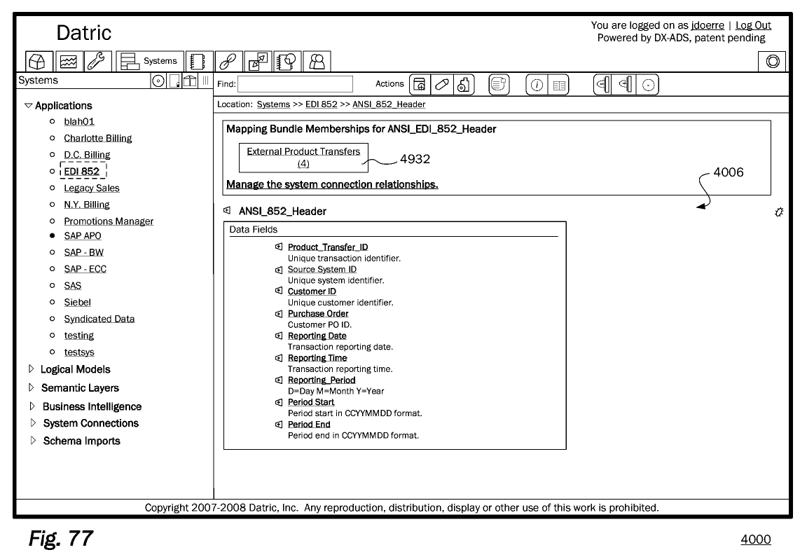

A user may click the mapping button 4124 to display mapping bundle memberships 4932 for the data table, as can be seen in FIG. 77. Each mapping bundle membership 4932 displays a name of a document the data table is mapped to and a total number of data tables mapped to the document. A link to the mapping tab 7000 is also displayed.

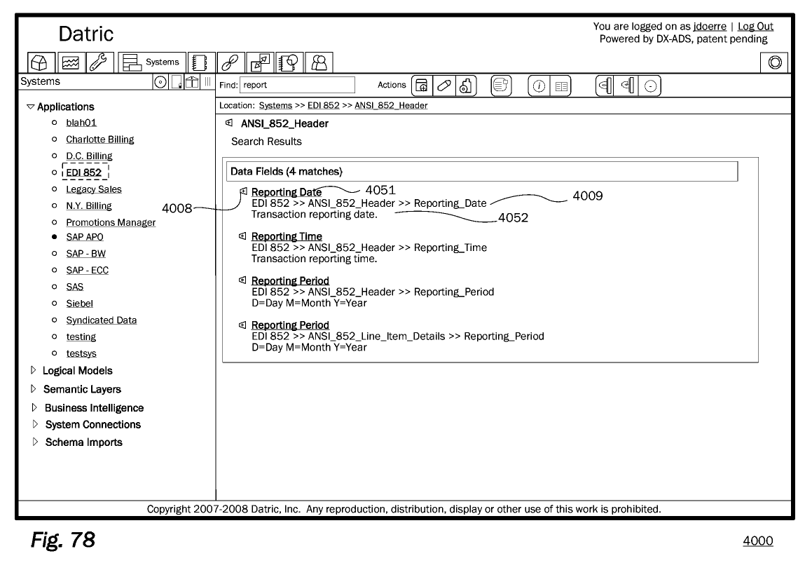

A user may enter text to search for in the search field 4125 and then effect a search by pressing enter. In at least some alternative embodiments, there may be a start search button that effects the search. In response to a user search, a data field identifier 4051 is displayed for each data field that is a positive result of the search, as can be seen in FIG. 78. Displayed with each data field identifier 4051 is a data field descriptor 4052 of the data field, an enabling toggle 4008, and a directory representation 4009 of the data field, the data table it is a part of, and the system the data table is a part of.

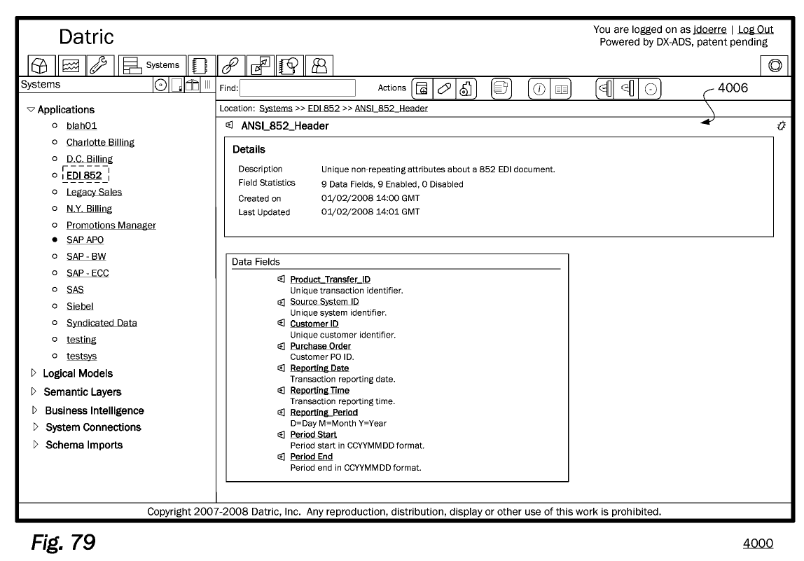

A user may click the show information button 4126 to display details associated with the data table. Specifically, a description of the data table, a number of data fields of the data table, a number of enabled data fields of the data table, a number of disabled data fields of the data table, a date and time the data table was created, and a date and time the data table was last updated will be displayed, as can be seen in FIG. 79.

A user may click the toggle descriptions button 4127 to cause all displayed descriptors 4042,4052 to no longer be displayed.

Buttons 4131,4132,4133 function as radio buttons, in that only one of the three buttons can be selected at any given time. If a user clicks the show enabled button 4131, only enabled elements will be displayed. If a user clicks the show disabled button 4132, only disabled elements will be displayed. If a user clicks the show enabled and disabled button 4133, both enabled and disabled elements will be displayed.

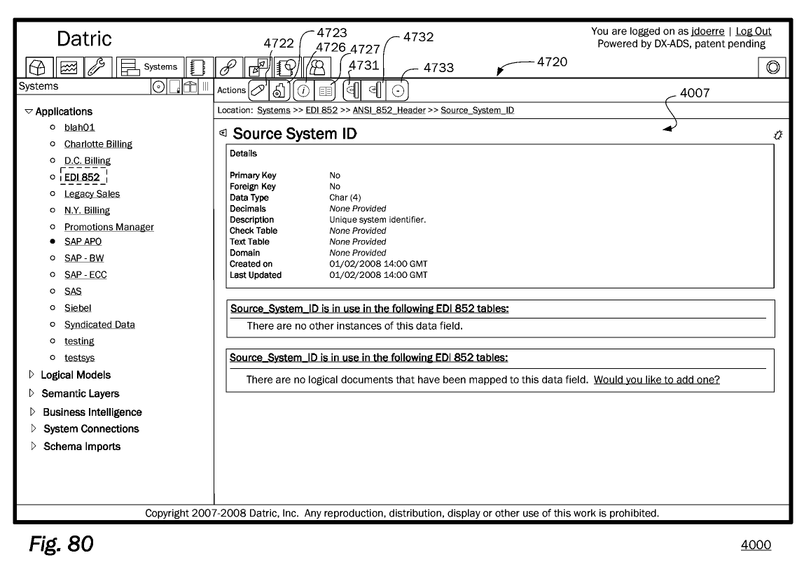

On the data field details subpage 4007, an options bar 4720 is displayed proximate the top of the data field details subpage 4007, as can be seen in FIG. 80. The options bar 4720 includes an edit data field button 4722, a delete data field button 4723, a show information button 4726, a toggle descriptions button 4727, a show enabled button 4731, a show disabled button 4732, and a show enabled and disabled button 4733.

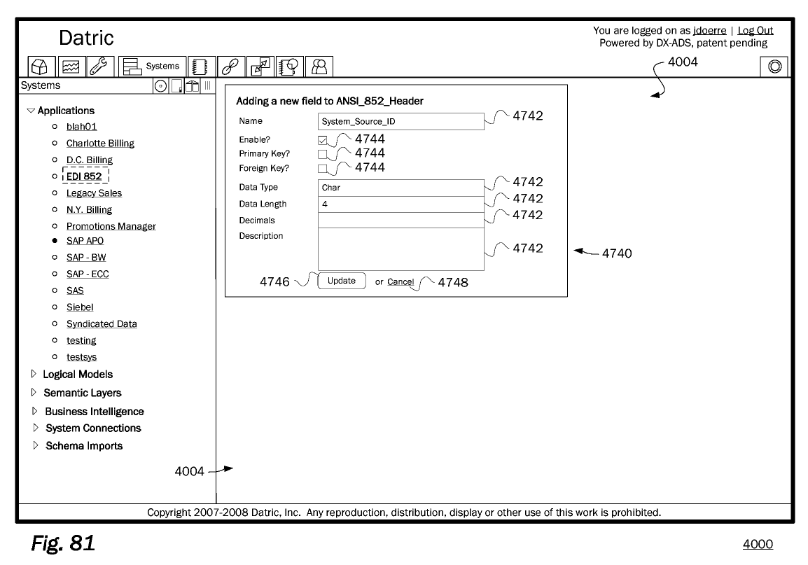

A user may click on the edit data field button 4722 to display a data field editing page 4740 in the right pane 4004, as can be seen in FIG. 81. A user may input a name, data type, data length, a description, and decimals information into the data field editing page 4740 via input fields 4742. A user may further indicate whether the data field to be edited is to be enabled or disabled, a primary key or not, and a foreign key or not, via check boxes 4744. A user may save the changes he or she has input by clicking an update button 4746, or alternatively may cancel editing via a cancel link 4748.

A user may click the delete data field button 4723 to delete the data field. A user must confirm this decision before deletion is effected.

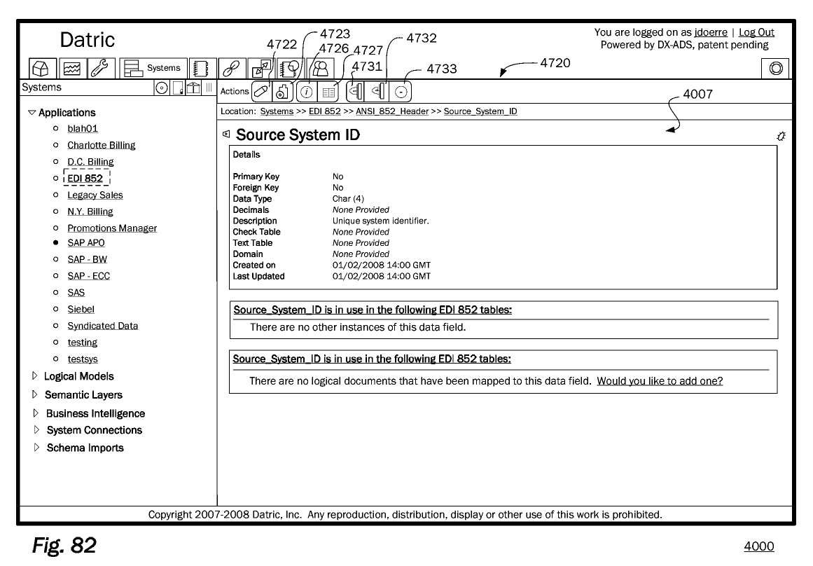

A user may click the show information button 4726 to display details associated with the data field, including whether the data field is a primary key, whether the data field is a foreign key, a data type of the data field, decimals information associated with the data field, a description of the data field, a check table of the data field, a text table of the data field, a domain of the data field, a creation date of the data field, and a date the data field was last updated, as can be seen in FIG. 82.

A user may click the toggle descriptions button 4727 to cause all displayed descriptors 4042,4052 to no longer be displayed.

Buttons 4731,4732,4733 function as radio buttons, in that only one of the three buttons can be selected at any given time. If a user clicks the show enabled button 4731, only enabled elements will be displayed. If a user clicks the show disabled button 4732, only disabled elements will be displayed. If a user clicks the show enabled and disabled button 4733, both enabled and disabled elements will be displayed.

### Systems Tab—System Connections

Returning to the left pane 4002 of the systems tab 4000, one of the expandable menus 4012 is associated with system connections. A user may click on the expandable menu 4012 to expand it. When the expandable menu is expanded, the previously described systems, i.e. instances of system type components, are displayed as links. Next to each link is a colored indicator indicating whether the system is enabled or disabled.

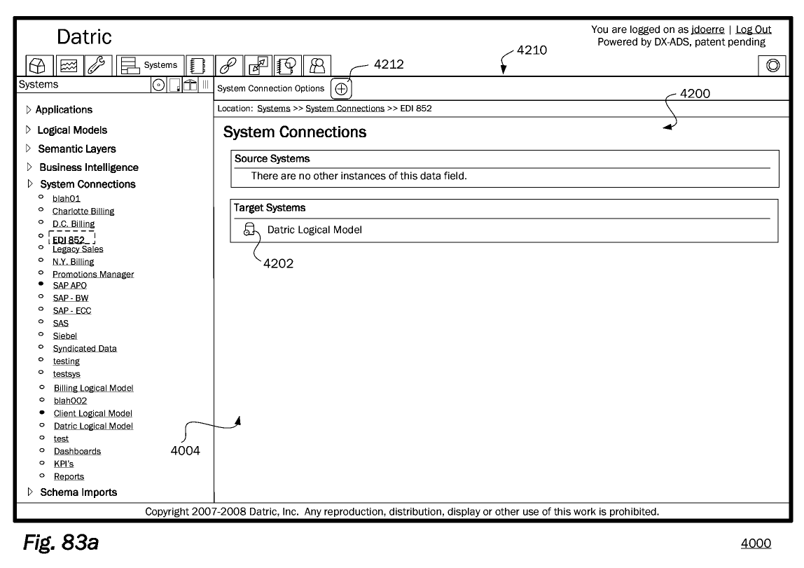

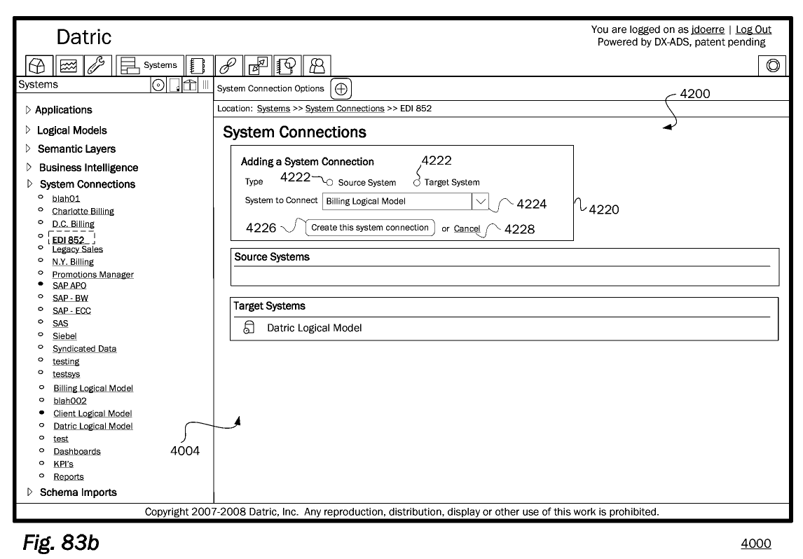

A user may click on a system to display a system connections subpage 4200, as can be seen in FIG. 83A. It will be appreciated that the displayed system connections subpage 4200 is associated with the particular system that was clicked on. The systems connection subpage 4200 displays source systems and target systems associated with the particular system. When a user mouses over a displayed source or target system, a removal icon 4202 is displayed, as can be seen in FIG. 83A. A user may click on the removal icon 4202 to remove the system connection between the particular system and the source or target system associated with the removal icon 4202. The system connections subpage 4200 includes an options bar 4210 located proximate the top of the system connections subpage 4200. The options bar 4210 includes a create system connection button 4212. A user may click the create system connection button 4212 to display a system connection creation interface 4220, as can be seen in FIG. 83B. A user may select whether the system connection is to a source or target system via radio buttons 4222, and may further select a system the connection is to, via a dropdown menu 4224. A user may then create the system connection via a create button 4226, or cancel creation via a cancel link 4228.

### Schema Imports

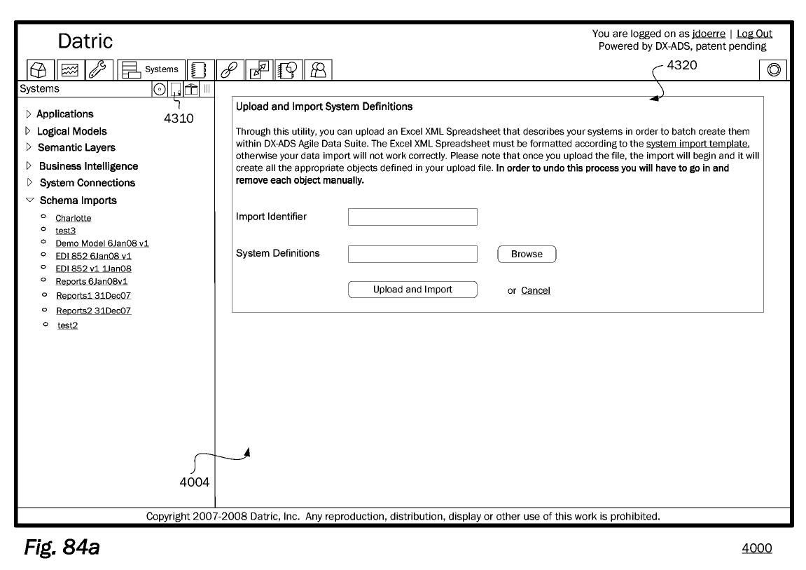

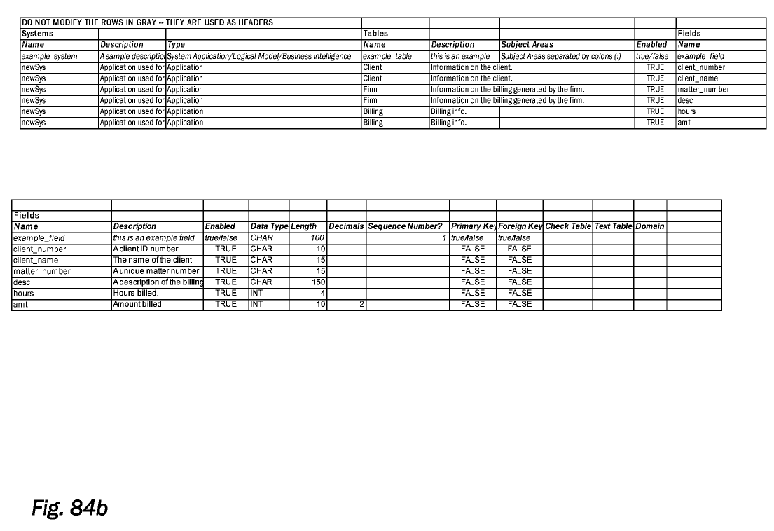

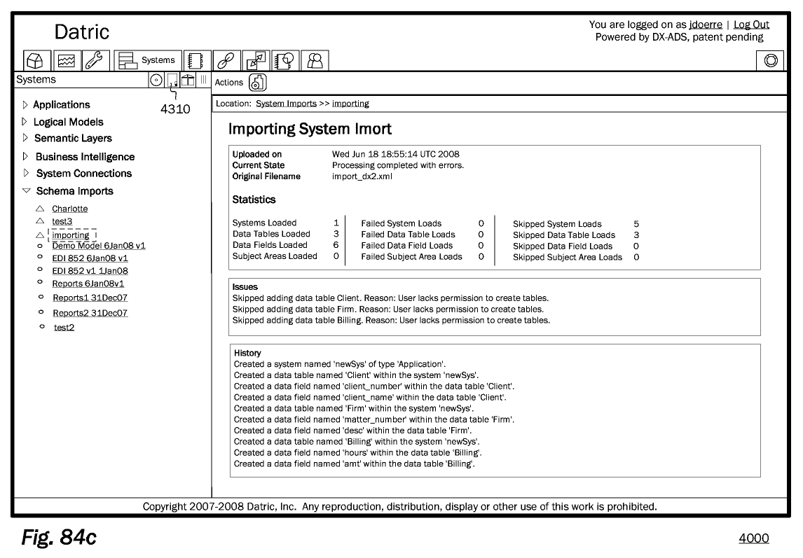

On the systems tab 4000, a user may further click an import button 4310 to display an upload subpage 4320 in the right pane 4004, as can be seen in FIG. 84A. The upload page 4320 allows a user to upload an XML spreadsheet containing information describing systems, data tables, and data fields to be created within the website. The spreadsheet must be formatted according to a specific template, which template is illustrated in two fragmented sections in FIG. 84B. After uploading an XML spreadsheet, an information page 4330 will be displayed, informing a user if the upload was successful or not and how many systems, data tables, and data fields were imported successfully, as can be seen in FIG. 84C.

### Logical Documents Tab

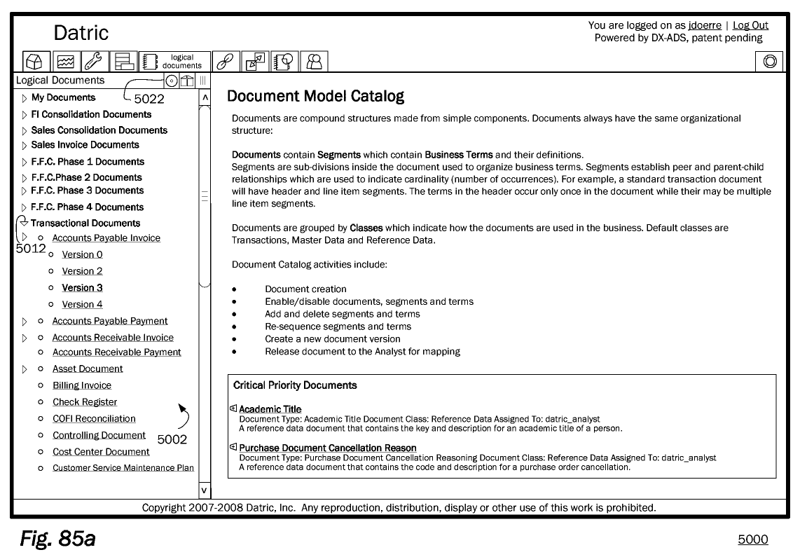

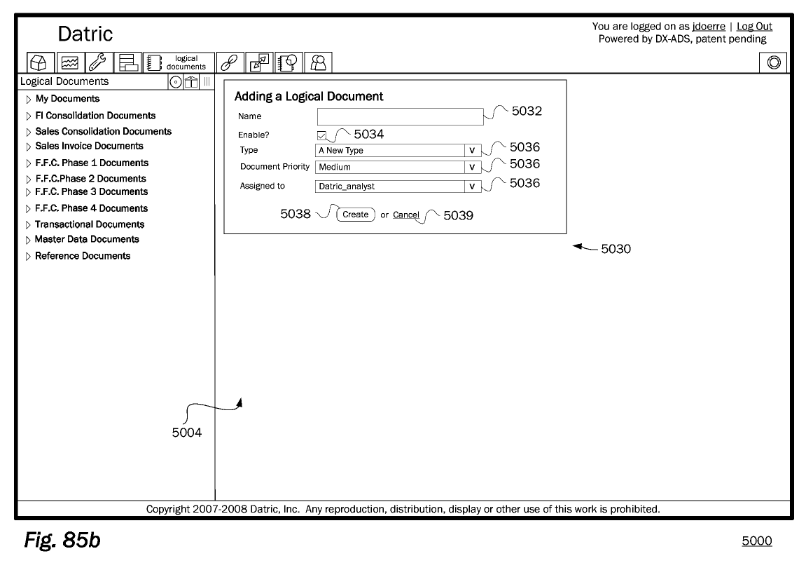

FIG. 85A is a screenshot of the logical documents tab 5000 of the user page of the website. The logical documents tab 5000 allows a user to view, modify, and create documents. The logical documents tab 5000 includes a plurality of expandable menus 5012 located in a left pane 5002 of the logical documents tab 5000. One of the expandable menus 5012 may be associated with documents associated with a user, as exemplified by the expandable menu labeled “My Documents” in FIG. 85A. Further, each project phase defined under the components tab 3000 is associated with an expandable menu 5012, as exemplified by the expandable menu labeled “FI Consolidation Documents”. Further still, each document class defined under the components tab 3000 is associated with an expandable menu 5012, as exemplified by the expandable menu 5012 labeled “Transactional Documents”.

Clicking on one of the plurality of expandable menus 5012 expands the expandable menu 5012 that was clicked. When an expandable menu 5012 is expanded, logical documents associated with that expandable menu 5012 are displayed as links. For example, expanding the expandable menu 5012 associated with “Transaction Documents” will display documents associated with that expandable menu, i.e. documents of the transaction document class. Preferably, links with a priority of critical will be colored red.

Adjacent each link is a colored indicator indicating whether the document is enabled or disabled. A link itself may have its own expandable menu 5012. Expanding this expandable menu 5012 will display different versions of the document as links, as can be seen in FIG. 85A. Next to each version link is a colored indicator indicating the version of the document.

A user may create a new document by clicking an add new document button 5022 located proximate a top of the left pane 5002. When a user clicks the add new document button 5022, an add new document page 5030 is displayed in a right pane 5004 of the logical documents tab 5000, as can be seen in FIG. 85B. On the add new system page 5030, a user may input a name into a text field 5032. A user may further input whether the system is enabled or disabled via a check box 5034. A user may select a document type, document priority, and user to assign the document to via dropdown menus 5036. A user may then click a create button 5038 to create the new document, or else cancel creation via a cancel link 5039.

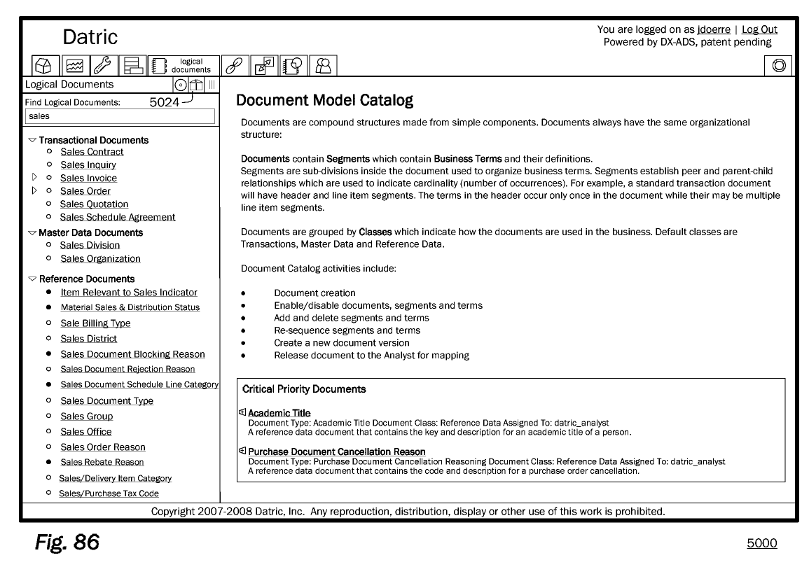

A user may search for a document via a search button 5024 located proximate a top of the left pane 5002. Clicking the search button 5024 effects display of a search field 5025, as can be seen in FIG. 86. Searching for a term effects display in the left pane 5002 of all documents returned as a result, as can be seen in FIG. 86.

Logical Documents Tab—Document Details Subpage

When a user clicks on a document, a document details subpage 5005 is displayed in the right pane 5004. It will be appreciated that the document details subpage 5005 that is displayed after clicking on a document is associated with that document. It will be appreciated from the description below that documents at different stages will display dissimilar document details subpages 5005.

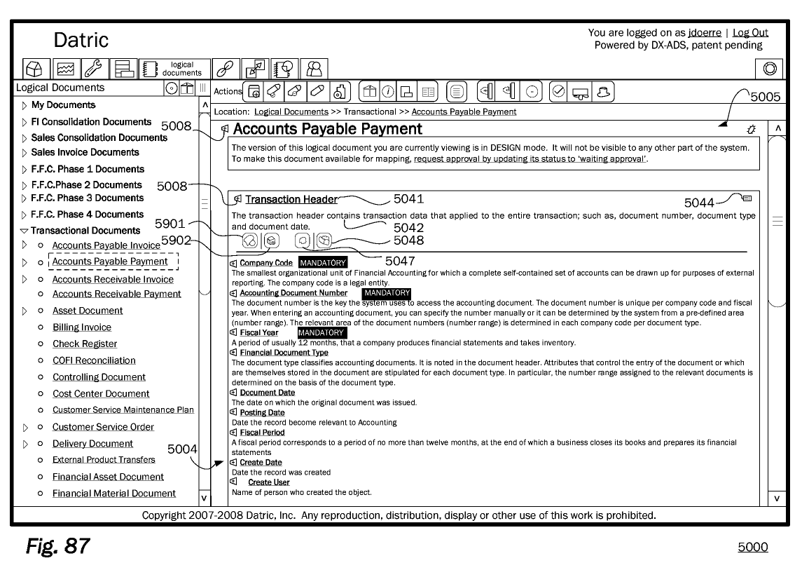

On the document details subpage 5005, the name of the document is displayed with an enabling toggle 5008, along with a document segment identifier 5041 for each document segment of the document, as can be seen in FIG. 87. Displayed with each document segment identifier 5041 is a document segment descriptor 5042 of the document segment, an enabling toggle 5008, and a close button 5044. If the document is in the design stage, an edit button 5047, a delete button 5048, an add business term button 5901, and an add document segment button 5902 are also displayed.

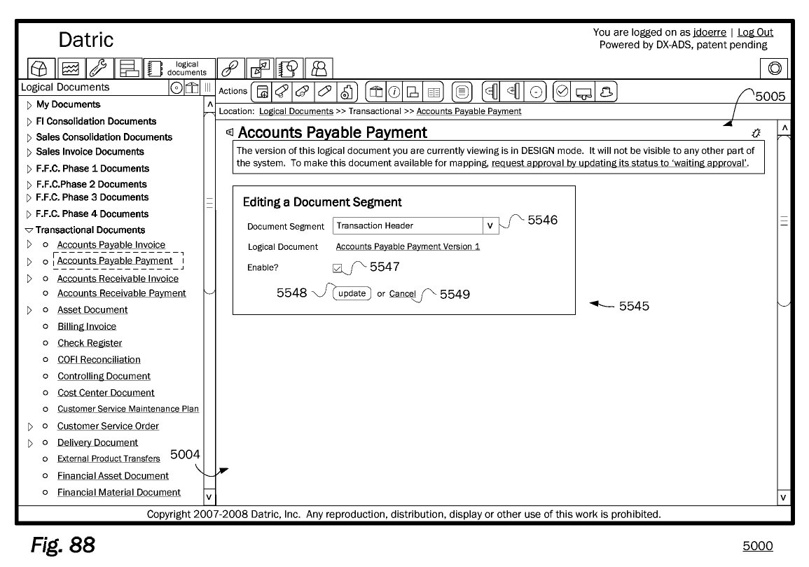

Clicking on the delete button 5043 deletes the associated document segment. Clicking on the edit button 5042 displays a document segment editing interface 5545, as can be seen in FIG. 88. The document segment editing interface 5545 displays the logical document the document segment is a part of as a link. The document segment editing interface 5545 allows a user to select a document segment via a dropdown menu 5546. The document segment editing interface 5545 further allows a user to indicate the document segment is enabled or disabled via a check box 5547. A user may save this input via an update button 5548 or may discard this input via a cancel link 5549.

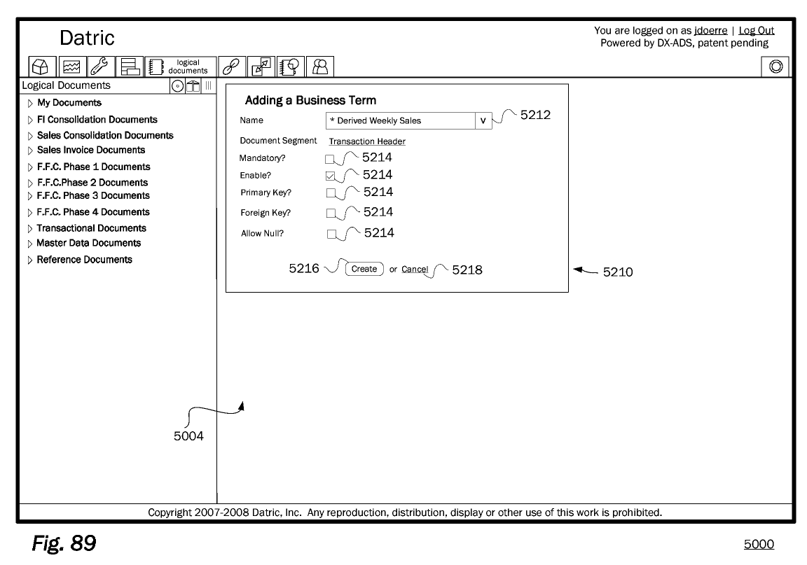

Clicking on the add business term button 5901 displays a business term creation interface 5210 as can be seen in FIG. 89. The business term creation interface displays the document segment the business term is a part of as a link. The business term creation interface 5210 allows a user to select a business term via a drop down menu 5212. The business term creation interface 5210 further allows a user to indicate whether the business term is enabled or disabled, mandatory or not, a primary key or not, a foreign key or not, and whether it allows null values via checkboxes 5214. A user may create this business term via a create button 5216 or may cancel creation via a cancel link 5218.

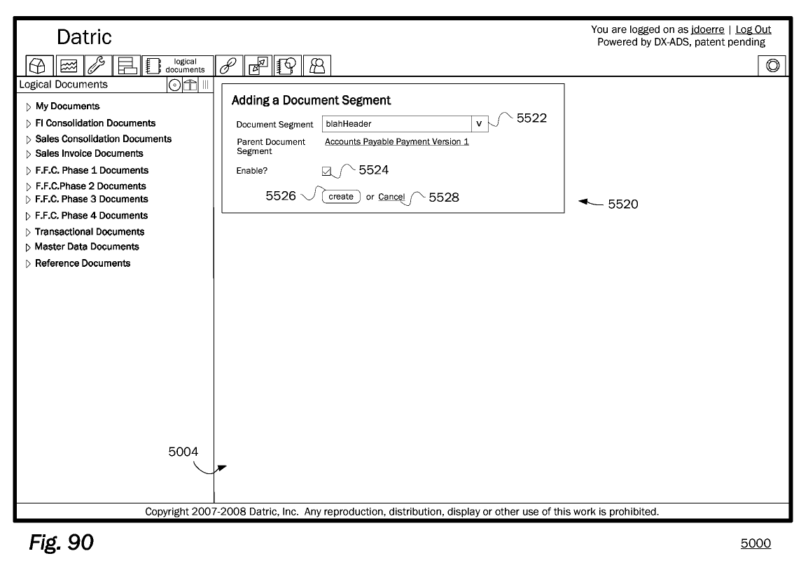

A user may also add a child document segment to a document segment by clicking the add document segment button 5902. Clicking the add document segment button 5902 displays a document segment creation interface 5220, as can be seen in FIG. 90. The document segment creation interface 5220 displays the parent document segment the document segment is a part of as a link. The document segment creation interface 5220 allows a user to select a document segment via a dropdown menu 5222. The document segment creation interface 5220 further allows a user to indicate the document segment is enabled or disabled via a check box 5224. A user may save this input via an update button 5226 or may discard this input via a cancel link 5228.

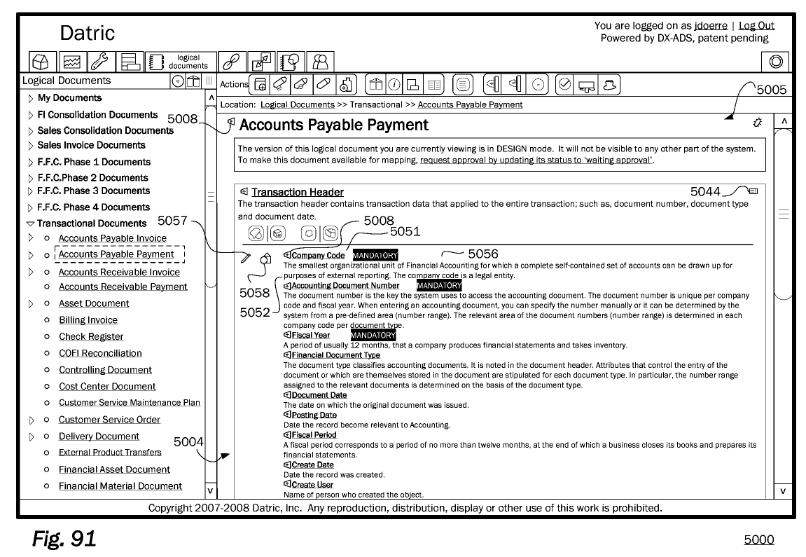

On the document details subpage 5005, a business term identifier 5051 is displayed for each business term of each document segment of the document, as can be seen in FIG. 91. Displayed with each business term identifier 5051 is a business term descriptor 5052 and an enabling toggle 5008. Each business term identifier 5051 and associated business term descriptor 5052 are displayed together in a row 5056. Further, an indicator of whether the business term is mandatory, is a primary key, or is a foreign key may be displayed. If the document is in the design stage, then when a user mouses over the row 5056, the row 5056 is highlighted and an edit icon 5057 and a removal icon 5058 are displayed in the row 5056.

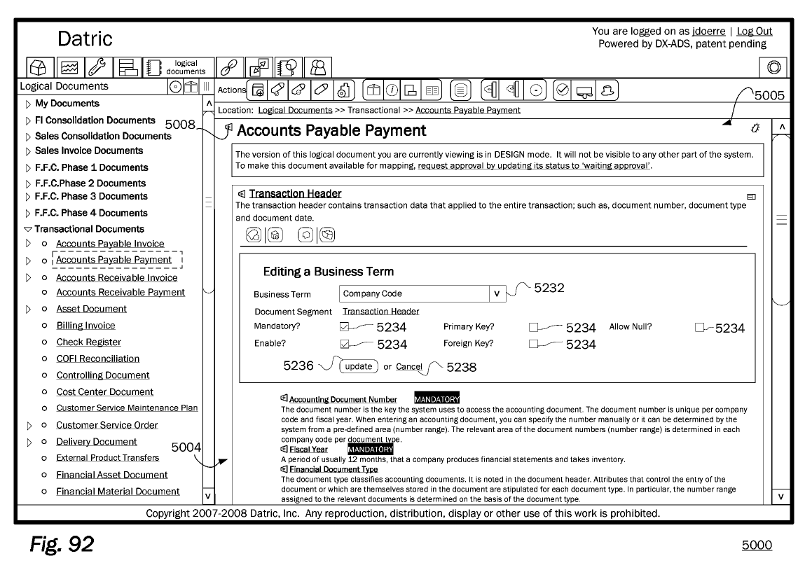

A user may click the removal icon 5058 in one of the rows 5056 to delete the business term associated with the business term identifier 5051 and descriptor 5052 displayed in the one of the rows 5056. A user must first confirm this choice. A user may click the edit icon 5057 in one of the rows 5056 to display a business term editing interface 5230, as can be seen in FIG. 92. The business term editing interface 5230 displays the document segment the business term is a part of as a link. The business term editing interface 5230 allows a user to select a business term via a drop down menu 5232. The business term editing interface 5230 further allows a user to indicate whether the business term is enabled or disabled, mandatory or not, a primary key or not, a foreign key or not, and whether it allows null values via checkboxes 5234. A user may save this business term via an update button 5236, or may cancel his or her updates via a cancel link 5238.

### Logical Documents Tab—Document Segment Details Subpage

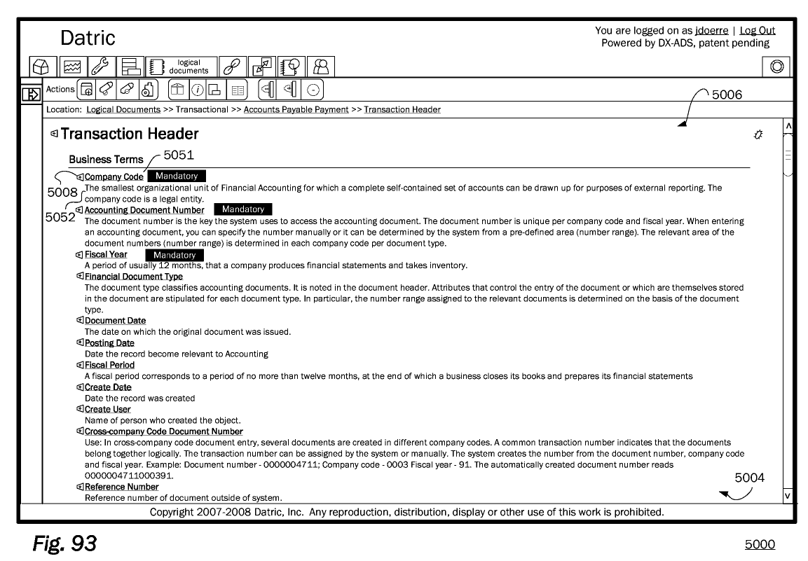

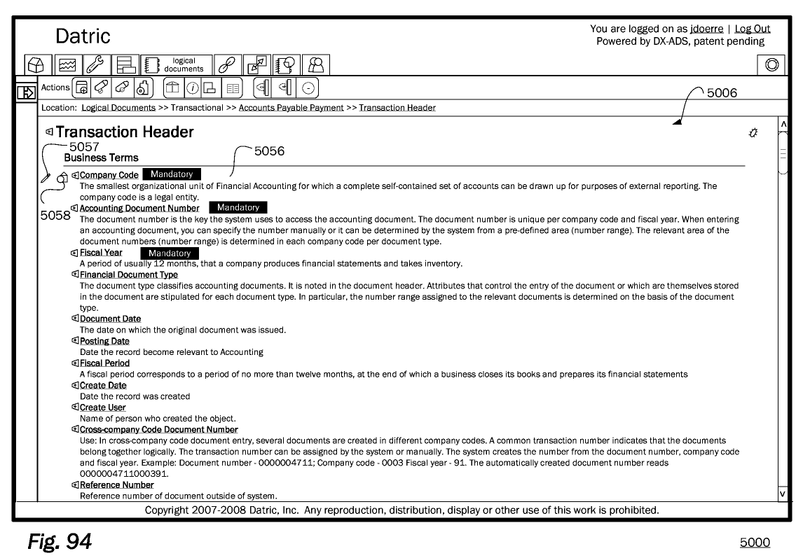

On the document details subpage 5005, a user may click on a document segment identifier 5041 to display a document segment details subpage 5006. It will be appreciated that the document segment details subpage 5006 that is displayed after clicking on a document segment will be associated with that document segment. On this document segment details subpage 5006, a business term identifier 5051 is displayed for each business term of the document segment, as can be seen in FIG. 93. Displayed with each business term identifier 5051 is a business term descriptor 5052 and an enabling toggle 5008. Further, an indication of whether the business term is mandatory, a primary key, or a foreign key may be displayed. Each business term identifier 4051 and associated business term descriptor 5052 are displayed together in a row 5056. If the document is in the design stage, then when a user mouses over the row 5056, the row 5056 is highlighted and an edit icon 5057 and a removal icon 5058 are displayed in the row 5056, as can be seen in FIG. 94. A user may click the removal icon 5058 in one of the rows 5056 to delete the business term associated with the business term identifier 5051 and descriptor 5052 displayed in the one of the rows 5056. A user must first confirm this choice. A user may click the edit icon 5057 in one of the rows 5056 to display the business term editing interface 5230.

### Logical Documents Tab—Business Term Details Subpage

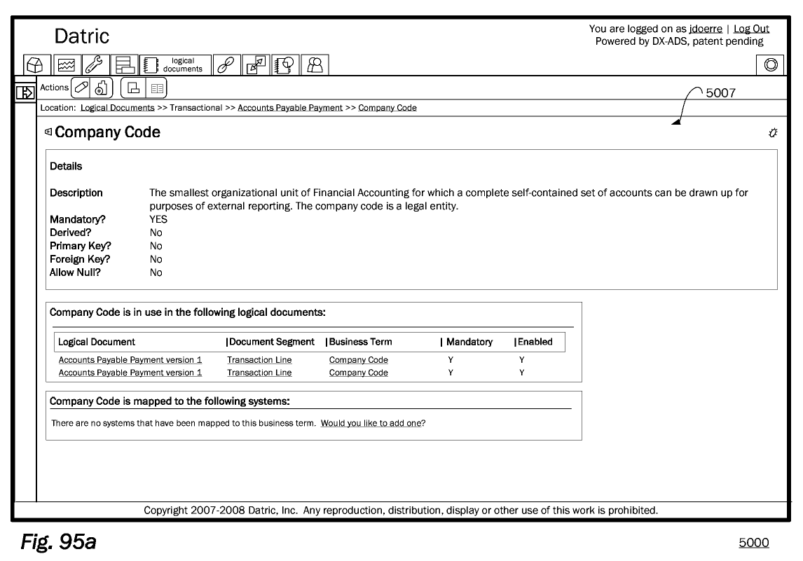

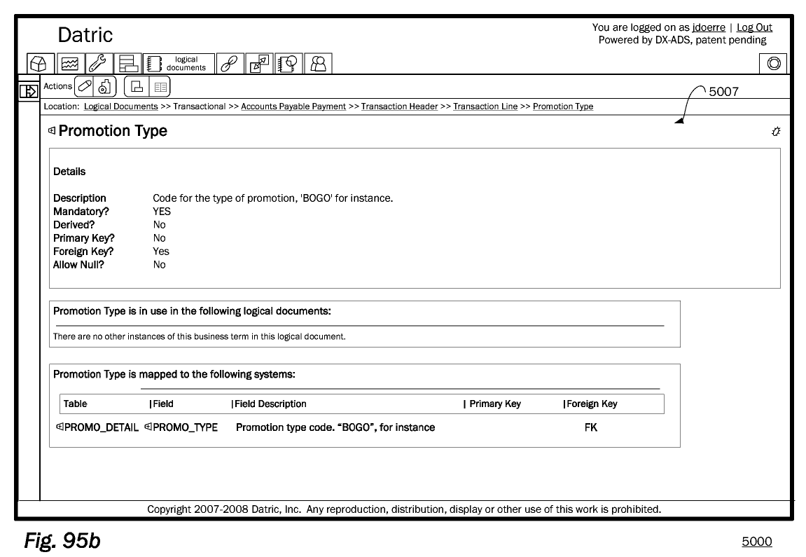

On the document details subpage 5005 or the document segment details subpage 5006, a user may click on a business term identifier 5051 to display a business term details subpage 5007, as can be seen in FIG. 95A. It will be appreciated that the business term details subpage 5007 that is displayed after clicking on a business term will be associated with that business term. On this business term details subpage 5007, details of the business term may be displayed, including whether the business term is a primary key, whether the business term is a foreign key, whether the business term is mandatory, whether the business term is derived, whether the business term allows null values, and a description of the business term. Further, every system that the business term is mapped to is displayed as a link, together with an enabling toggle 5008, a data field displayed as a link, a field description, an indication of whether it is a primary key, and an indication of whether it is a foreign key, as can be seen in FIG. 95B. Further still, every logical document the business term is used in is displayed as a link, together with the document segment it is associated with displayed as a link, the business term it is associated with displayed as a link, an indication whether it is mandatory, and an indication whether it is enabled, as can be seen in FIG. 95A.

### Logical Documents Tab—Options Bars

On the document details subpage 5005, document segment details subpage 5006, and business term details subpage 5007, options bars 5080,5120,5720 are displayed.

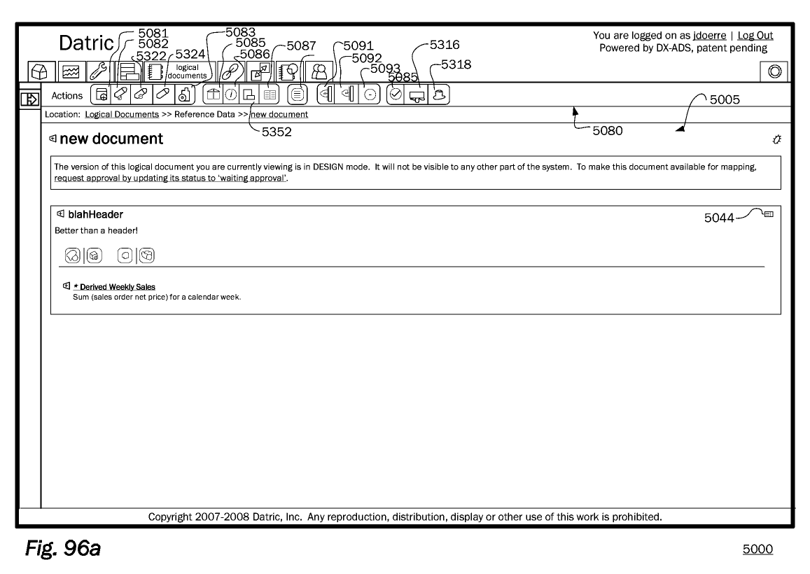

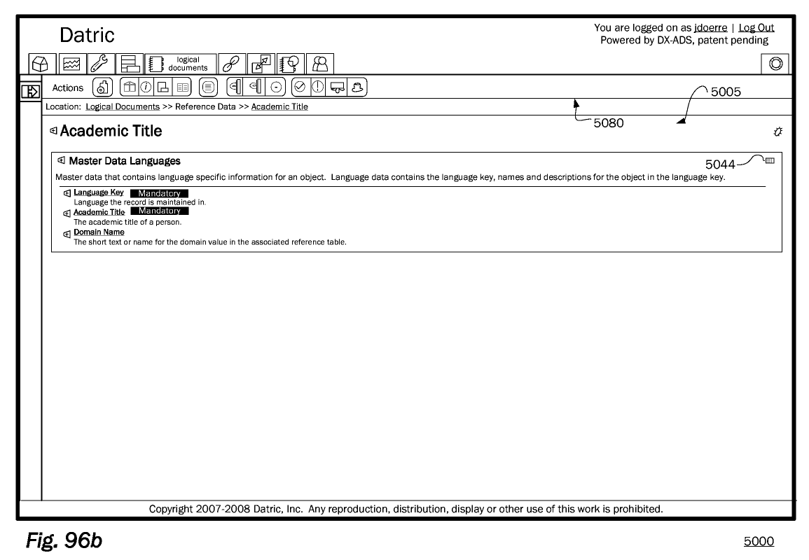

On the document details subpage 5005, an options bar 5080 is displayed proximate a top of the document details subpage 5005, as can be seen in FIG. 96A. The options bar 5080 includes a mapping button 5084, a show search button 5085, a show information button 5086, a show hierarchy button 5352, a toggle descriptions button 5087, a show enabled button 5091, a show disabled button 5092, and a show enabled and disabled button 5093. If the document is a reference document or is in production mode, then a create new version button 5310 is also included. Additionally, if the document is in design mode or mapping mode, then a delete document button 5083, validate button 5314, change priority/assignment/work status button 5316, and approvers button 5318 are also included on the options bar 5080. Further, if the document is in mapping mode, then a demote button 5317 is included, as can be seen in FIG. 96B. Further still, if the document is in design mode, an add document segment button 5081, edit document button 5082, enable all terms button 5322, and disable all terms button 5324 are included, as can be seen in FIG. 96A.

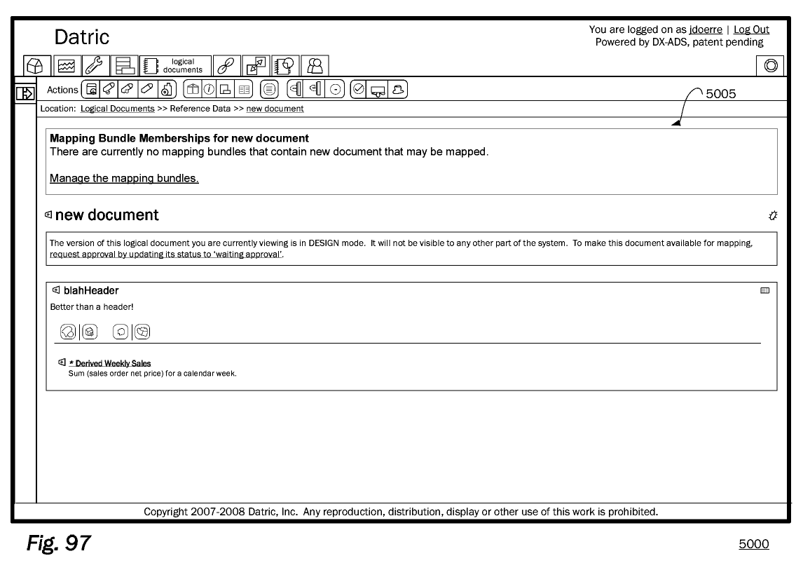

A user may click the mapping button 5084 to display whether the document is contained in a mapping bundle, as can be seen in FIG. 97. A link to the mapping tab 7000 is also displayed.

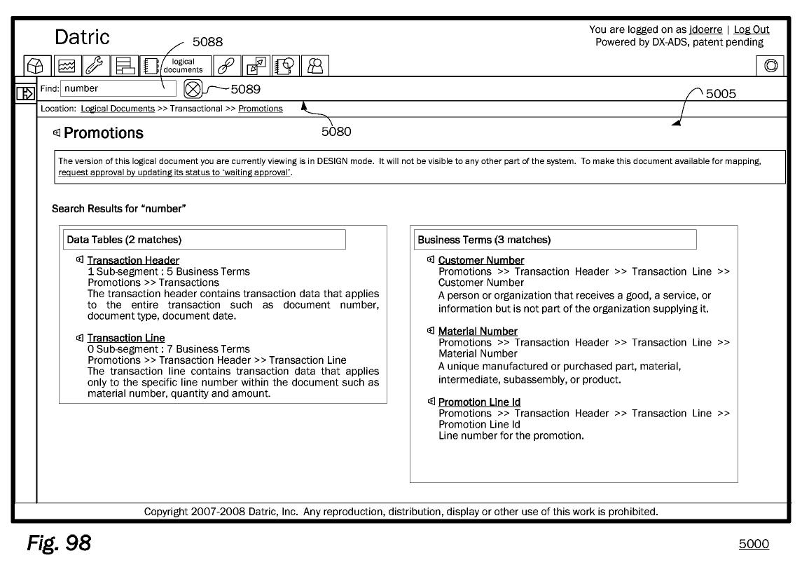

A user may click on the search button 5085 to display a search field 5088 and cancel button 5089 in the options bar 5080, as can be seen in FIG. 98. A user may enter text to search for in the search field 5088 and then effect a search by pressing enter. In at least some alternative embodiments, there may be a start search button that effects the search. In response to a user search, a document segment identifier 5041 is displayed for each document segment that is a positive result of the search, as can be seen in FIG. 98. Displayed with each document segment identifier 5041 is a document segment descriptor 5042 of the document segment, the number of sub-segments the document segment has, the number of business terms the document segment has, an enabling toggle 5008, and a directory representation 5009 of the document segment and the document it is a part of. Further, a business term identifier 5051 is displayed for each business term that is a positive result of the search, as can be seen in FIG. 98. Displayed with each business term identifier 5051 is a business term descriptor 5052 of the business term, an enabling toggle 5008, and a directory representation 5009 of the business term and the document segment and document it is a part of. A user may cause the options bar 5080 to return to its default display as it was before the search button 5085 was clicked by clicking the cancel button 5089.

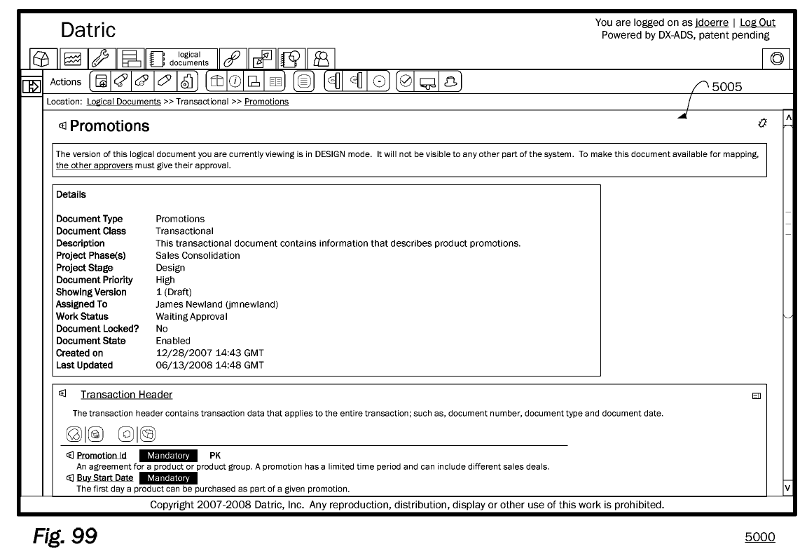

A user may click the show information button 5086 to display details associated with the document. Specifically, a document type, a document class, a description, a project stage, a document priority, a version number, assignment information, work status, whether the document is locked, a document state, a date and time the document was created, and a date and time the document was last updated will be displayed, as can be seen in FIG. 99.

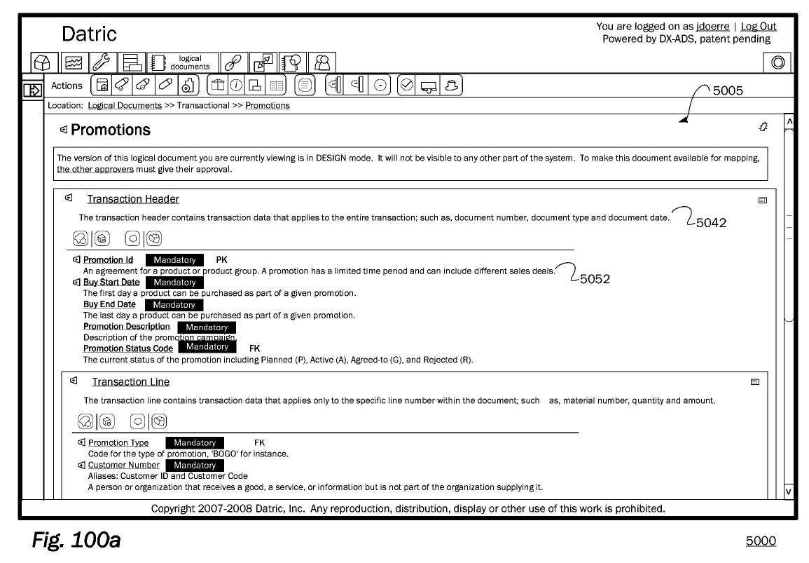

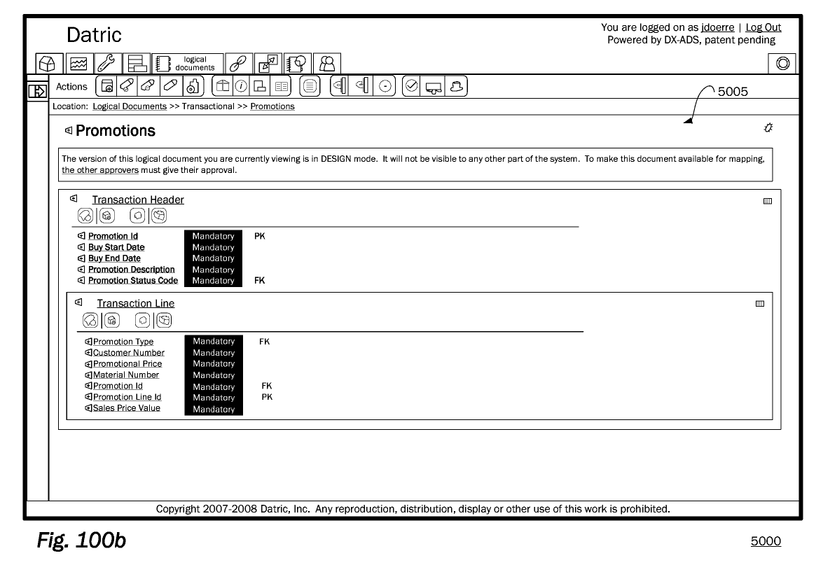

A user may click the toggle descriptions button 5087 to cause all displayed descriptors 5042,5052 to no longer be displayed, as can be seen by comparison of FIG. 100A, in which descriptors 5042,5052 are displayed, with FIG. 100B, in which they are not.

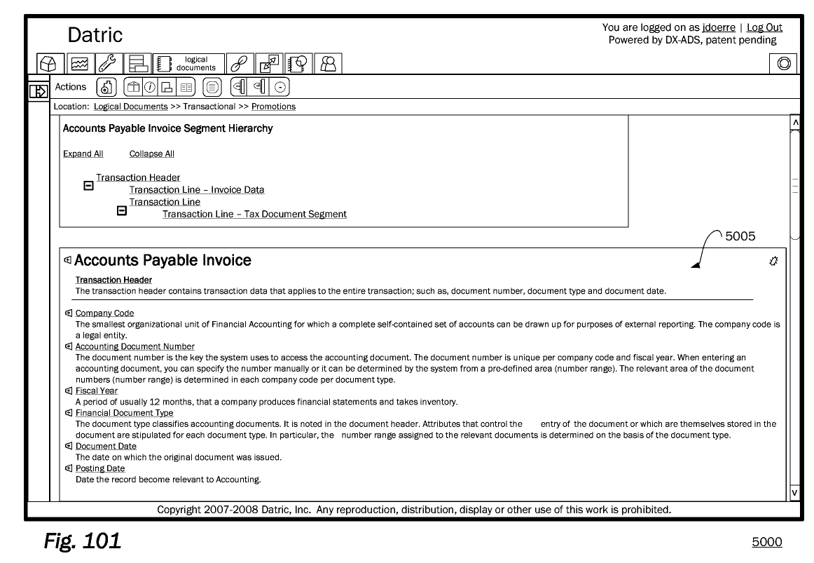

A user may click the show hierarchy button 5352 to display an expandable and collapsible document hierarchy showing the hierarchy of document segments of the document, as can be seen in FIG. 101.

Buttons 5091,5092,5093 function as radio buttons, in that only one of the three buttons can be selected at any given time. If a user clicks on the show enabled button 5091, only enabled elements will be displayed. If a user clicks on the show disabled button 5092, only disabled elements will be displayed. If a user clicks on the show enabled and disabled button 5093, both enabled and disabled elements will be displayed.

If the document is a reference document or is in production mode, then a user may click the create new version button 5310 to create a new, identical version of the document. The new version will be in design mode.

If the document is in design mode or mapping mode, then a user may click the delete document button 5083 to delete the document. A user must confirm this decision before deletion is effected.

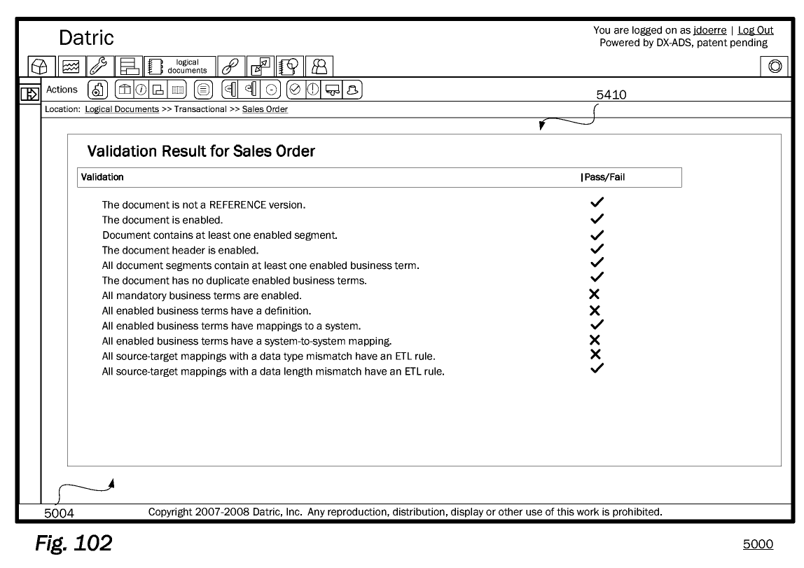

If the document is in design mode or mapping mode, a user may click the validate button 5314 to display a validation page 5410 in the right pane 5004, as can be seen in FIG. 102. The validation page 5410 will display an indication whether the document is a reference version, is enabled, contains at least one enabled segment, the header is enabled, all document segments of the document contain at least one business term, the document has no duplicate enabled business terms, all mandatory business terms are enabled, and all enabled business terms have a definition.

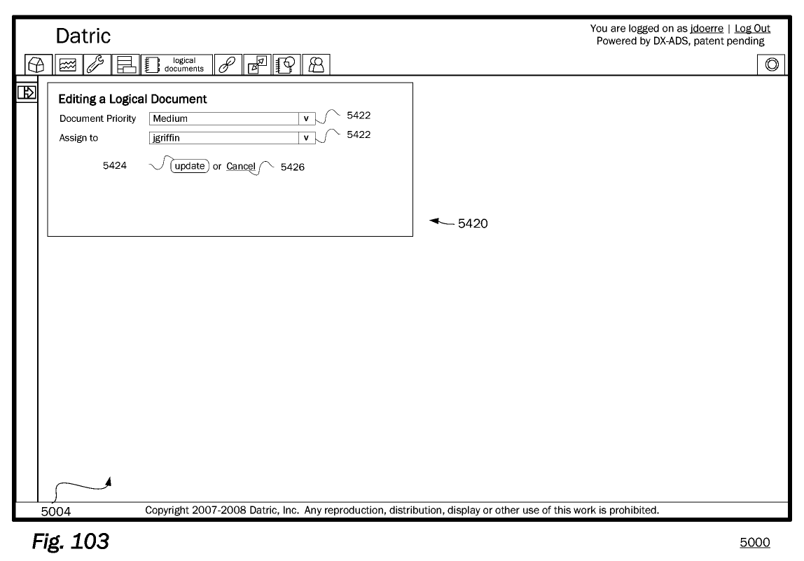

Returning to the options bar 5080, if the document is in design mode or mapping mode, a user may further click on the change priority/assignment/work status button 5316 to display a change page 5420 in the right pane 5004, as can be seen in FIG. 103. On the change page 5420, a user may select a document priority and a developer to assign the document to via dropdown menus 5422. A user may save his or her changes by clicking an update button 5424 or else may cancel his or her changes via a cancel link 5426.

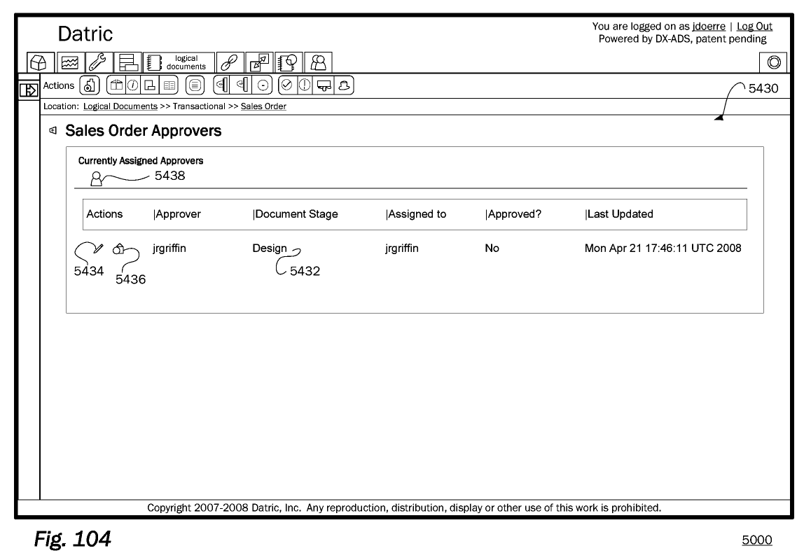

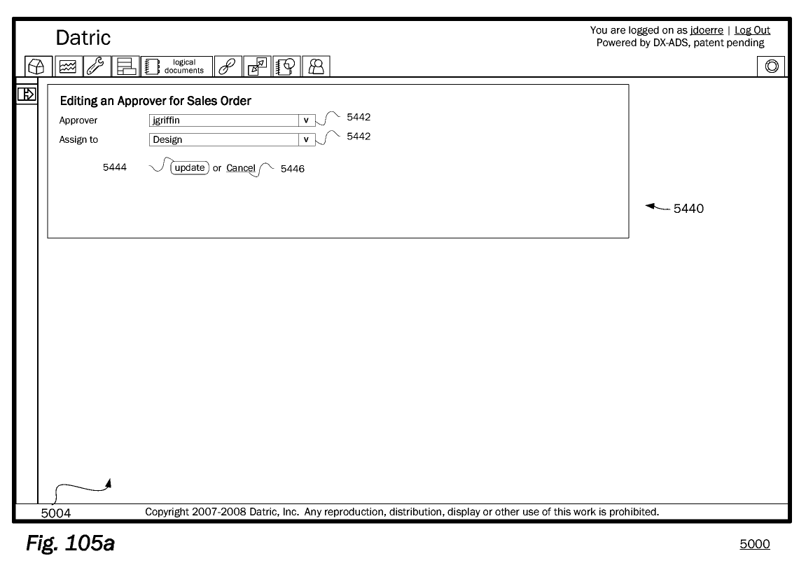

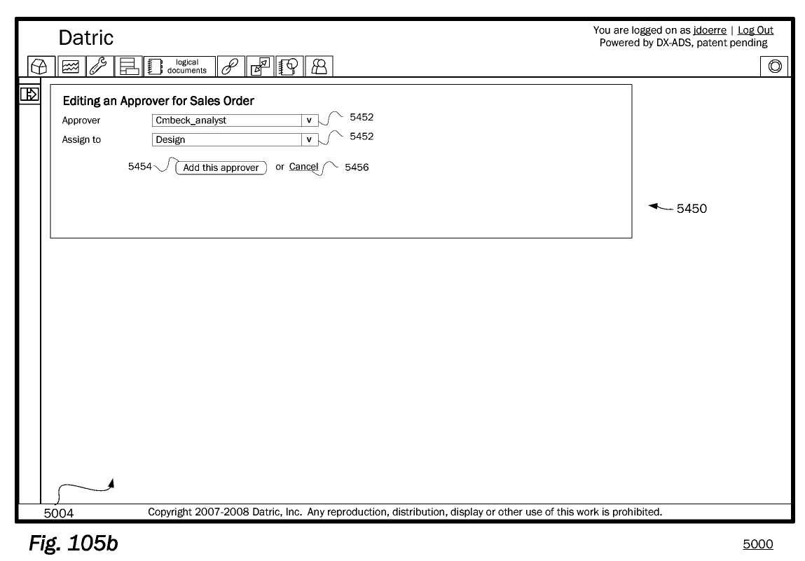

If the document is in design mode or mapping mode, a user may further still click the approvers button 5318 to display an approvers page 5430 in the right pane 5004, as can be seen in FIG. 104. The approvers page 5430 includes a name of each approver for the document, together with the document stage the approver is authorized to approve, an indication of the developer the document is assigned to, an indication whether the document has been approved, and a date the document was last updated, all in a row 5432. A user may mouse over this row 5432 to display an edit icon 5434 and a removal icon 5436. A user may click the removal icon 5436 to remove the approver. A user may click the edit icon 5434 to display an approver editing page 5440, as can be seen in FIG. 105A. On the approver editing page 5440, a user may select an approver and a document stage the approver is authorized to approve via dropdown menus 5442. A user may save his or her changes by clicking an update button 5444, or may cancel his or her changes by clicking a cancel link 5446.

The approvers page 5430 further includes an add approver button 5438. A user may click the add approver button 5438 to display an approver creation page 5450, as can be seen in FIG. 105B. On the approver creation page 5450, a user may select an approver and a document stage the approver is authorized to approve via dropdown menus 5452. A user may save his or her changes by clicking an update button 5454, or may cancel his or her changes by clicking a cancel link 5456.

Returning to the options bar 5080, if the document is in mapping mode, a user may click the demote button 5317 to demote the document to design mode.

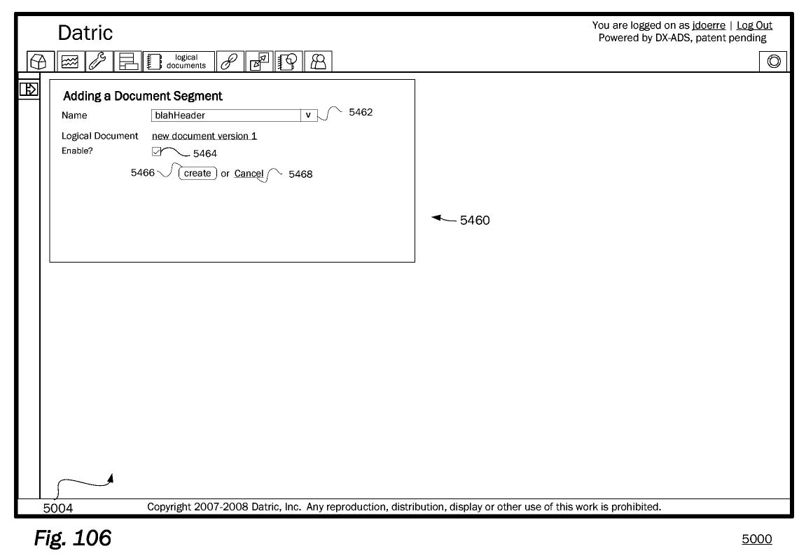

If the document is in design mode, a user may click the add document segment button 5081 to display a document segment creation page 5460, as can be seen in FIG. 106. The document segment creation page 5460 displays the logical document the new document segment is to be a part of as a link. The document segment creation page 5460 allows a user to select a document segment via a dropdown menu 5462. The document segment creation page 5460 further allows a user to indicate whether the document segment is enabled or disabled via a check box 5464. A user may save this input via a create button 5466 or may discard this input via a cancel link 5468.

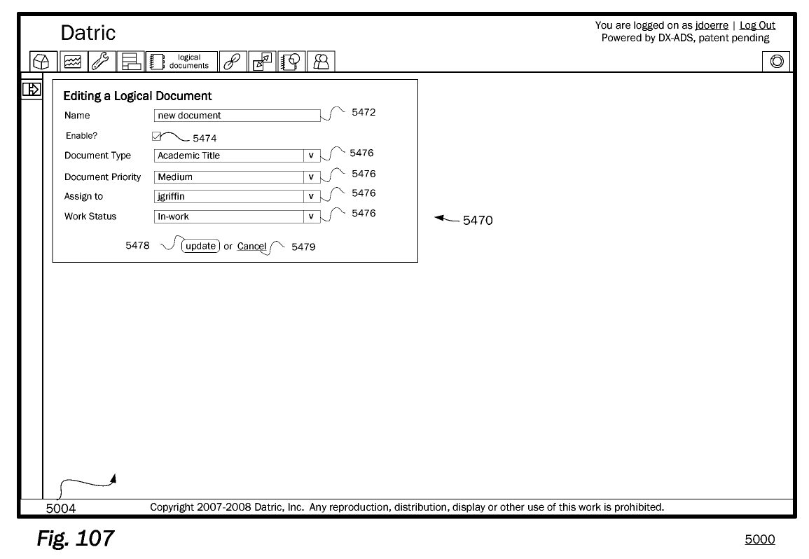

If the document is in design mode, a user may further click on the edit document button 5082 to display a document editing interface 5470, as can be seen in FIG. 107. A user may edit the name of the document via a text field 5472. A user may further edit whether the document is enabled or disabled via a check box 5474. A user may edit the document type, document priority, developer the document is assigned to, and work status via dropdown menus 5476. A user may then click an update button 5478 to save the changes, or a cancel link 5479 to discard the changes.

If the document is in design mode, a user may further click the enable all terms button 5322 to enable all business terms for that document. Likewise, a user may click the disable all terms button 5324 to disable all business terms for that document.

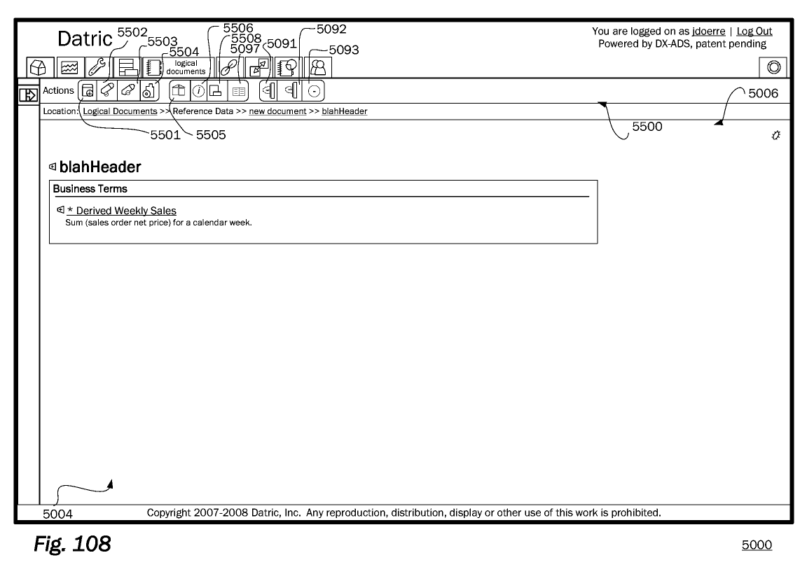

On the document segment details subpage 5006, an options bar 5500 is displayed proximate a top of the document segment details subpage 5006, as can be seen in FIG. 108. The options bar 5500 includes a show search button 5505, a show information button 5506, a show hierarchy button 5508, a toggle descriptions button 5507, a show enabled button 5091, a show disabled button 5092, and a show enabled and disabled button 5093. If the document is in design mode, then a delete document segment button 5504, an add document segment button 5502, an add business term button 5501, and an edit document segment button 5503 are included.

A user may click on the search button 5505 to display a search field and cancel button in the options bar 5500. A user may enter text to search for in the search field and then effect a search by pressing enter. In at least some alternative embodiments, there may be a start search button that effects the search. In response to a user search, a document segment identifier 5041 is displayed for each sub-segment that is a positive result of the search. Displayed with each sub-segment identifier 5041 is a document segment descriptor 5042 of the document segment, the number of sub-segments the sub-segment has, the number of business terms the sub-segment has, an enabling toggle 5008, and a directory representation 5009 of the sub-segment. Further, a business term identifier 5051 is displayed for each business term that is a positive result of the search. Displayed with each business term identifier 5051 is a business term descriptor 5052 of the business term, an enabling toggle 5008, and a directory representation 5009 of the business term and the document segment it is a part of. A user may cause the options bar 5500 to return to its default display as it was before the search button 5505 was clicked by clicking the cancel button.

A user may click the show information button 5506 to display a description of the document.

A user may click the toggle descriptions button 5507 to cause all displayed descriptors 5042,5052 to no longer be displayed.

A user may click the show hierarchy button 5508 to display an expandable and collapsible document hierarchy showing the hierarchy of sub-segments of the document segment.

Buttons 5091,5092,5093 function as radio buttons, in that only one of the three buttons can be selected at any given time. If a user clicks on the show enabled button 5091, only enabled elements will be displayed. If a user clicks on the show disabled button 5092, only disabled elements will be displayed. If a user clicks on the show enabled and disabled button 5093, both enabled and disabled elements will be displayed.

If the document is in design mode, a user may click the delete document segment button 5504 to delete the document segment.

Further, if the document is in design mode, a user may add a child document segment, i.e. a sub-segment, to a document segment by clicking the add document segment button 5502 and displaying the document segment creation page 5460.

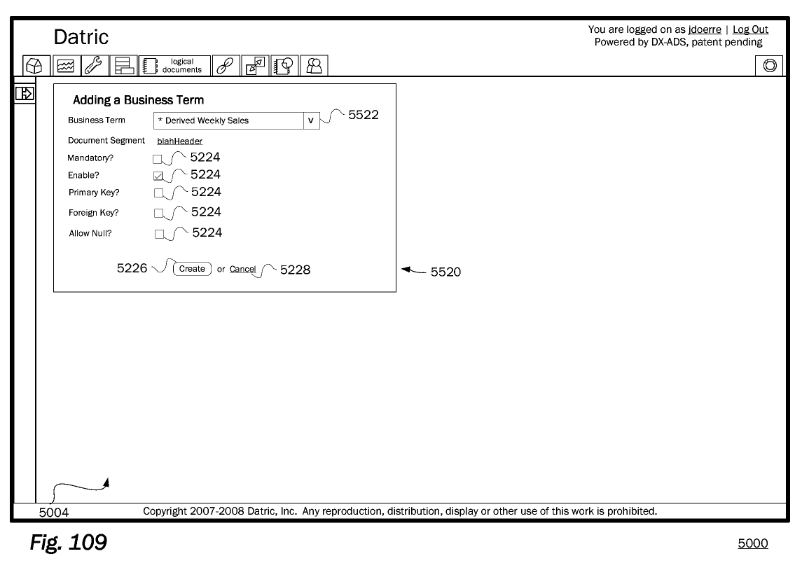

Further still, a user may click on the add business term button 5501 to display a business term creation page 5520, as can be seen in FIG. 109. The business term creation page 5520 displays the document segment the business term is a part of as a link. The business term creation page 5520 allows a user to select a business term via a drop down menu 5522. The business term creation page 5520 further allows a user to indicate whether the business term is enabled or disabled, mandatory or not, a primary key or not, a foreign key or not, and whether it allows null values via checkboxes 5524. A user may add this business term via a create button 5526 or may cancel creation via a cancel link 5528.

Further still, if the document is in design mode, a user may click the edit document segment button 5503 to display a document segment editing page. The document segment editing page displays the logical document the document segment is a part of as a link. The document segment editing page allows a user to select a document segment via a dropdown menu. The document segment creation page further allows a user to indicate whether the document segment is enabled or disabled via a check box. A user may save this input via an update button or may discard this input via a cancel link.

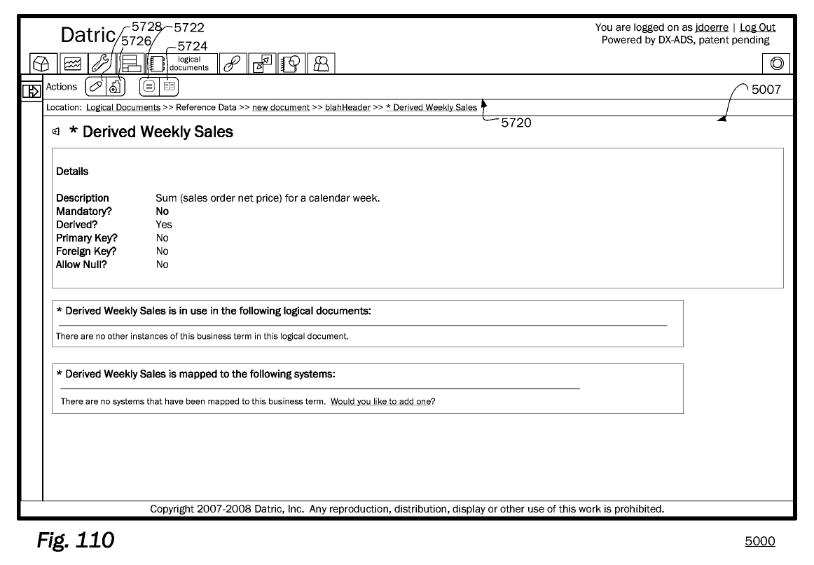

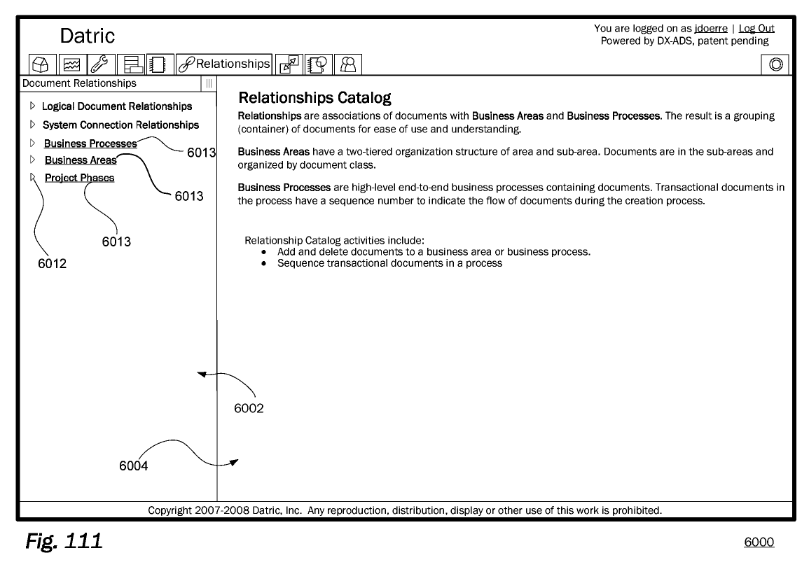

On the business term details subpage 5007, an options bar 5720 is displayed proximate a top of the business term details subpage 5007, as can be seen in FIG. 110. The options bar 5720 includes a show hierarchy button 5722 and a toggle descriptions button 5724. Additionally, if the document is in design mode, a delete business term button 5726 and an edit business term button 5728 are included on the options bar 5720.

A user may click the show hierarchy button 5722 to display an expandable and collapsible document hierarchy showing the hierarchy of sub-segments of the document segment.

A user may click the toggle descriptions button 5724 to cause all displayed descriptors 5042,5052 to no longer be displayed.

If the document is in design mode, a user may click the delete business term button 5726 to remove the business term from the document segment it is a part of.

Further, if the document is in design mode, a user may click the edit business term button 5728 to display the business term editing interface 5230.

### Relationships Tab

FIG. 111 is a screenshot of the relationships tab 6000 of the user page of the website. The relationships tab 6000 allows a user to view, modify, and create documents. The relationships tab 6000 includes a plurality of expandable menus 6012 located in a left pane 6002 of the relationships tab 6000. The plurality of expandable menus 6012 includes expandable menus 6012 associated with logical document relationships, system connection relationships, business processes, business areas, and project phases.

Clicking on one of the plurality of expandable menus 6012 expands the expandable menu 6012 that was clicked. When the expandable menu 6012 associated with logical document relationships is clicked, additional expandable menus 6012 are displayed for each document class. An expandable menu 6012 associated with a certain document class may be expanded to display logical documents, associated with that certain document class, as links. Adjacent each link is a colored indicator indicating whether the document is enabled or disabled.

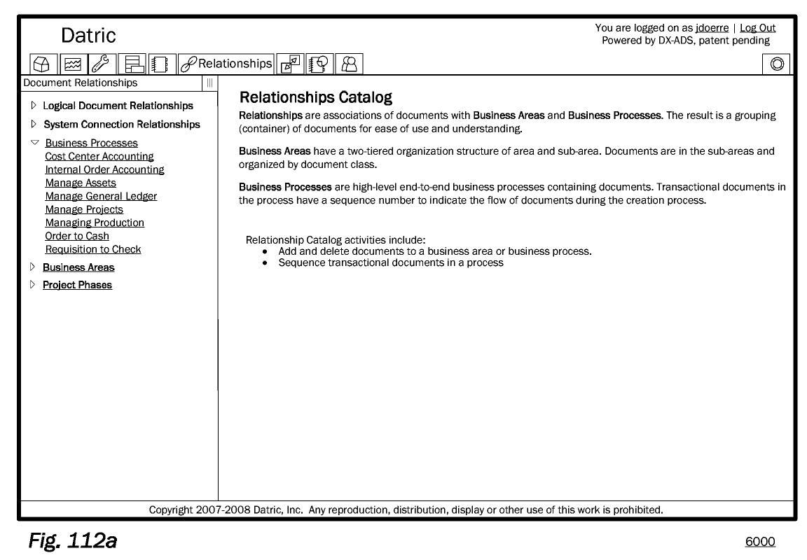

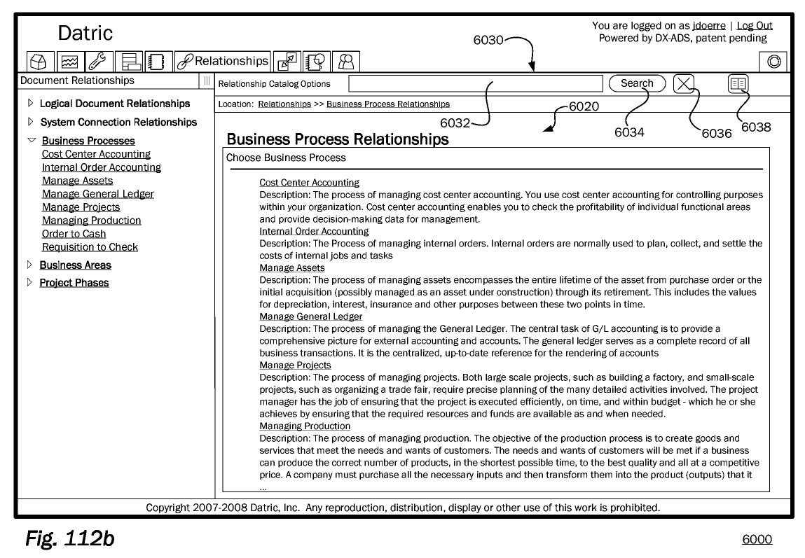

The expandable menus 6012 associated with business processes, business areas, and project phases are presented as clickable links 6013. A user may expand one of the expandable menus 6012 to display, as links, all defined processes, areas, or phases, or alternatively may click on one of the clickable links 6013 to display a menu page 6020 in a right pane 6004 of the relationships tab 6000. For instance, a user may expand the expandable menu 6012 associated with business processes to display links associated with each of the business processes defined under the components tab 3000, as can be seen in FIG. 112A. Or, alternatively, a user may click the clickable link 6013 associated with business processes to display the menu page 6020 associated with business processes, as can be seen in FIG. 112B.

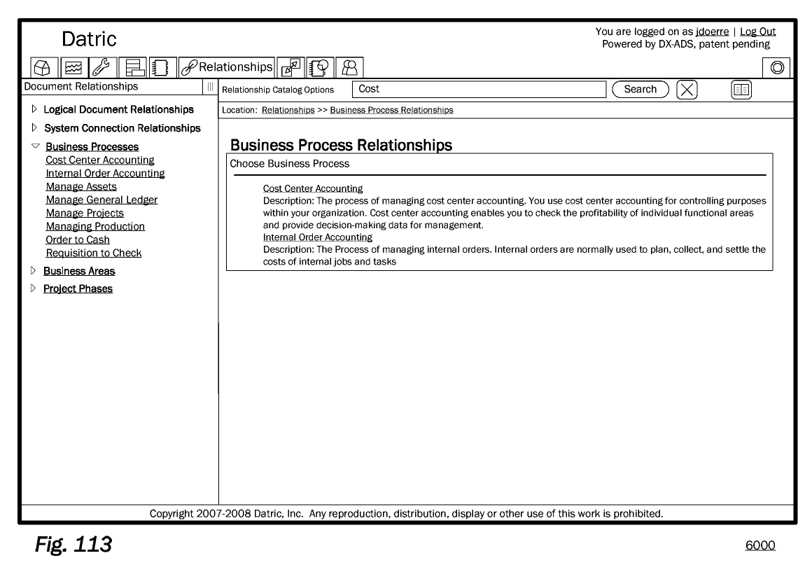

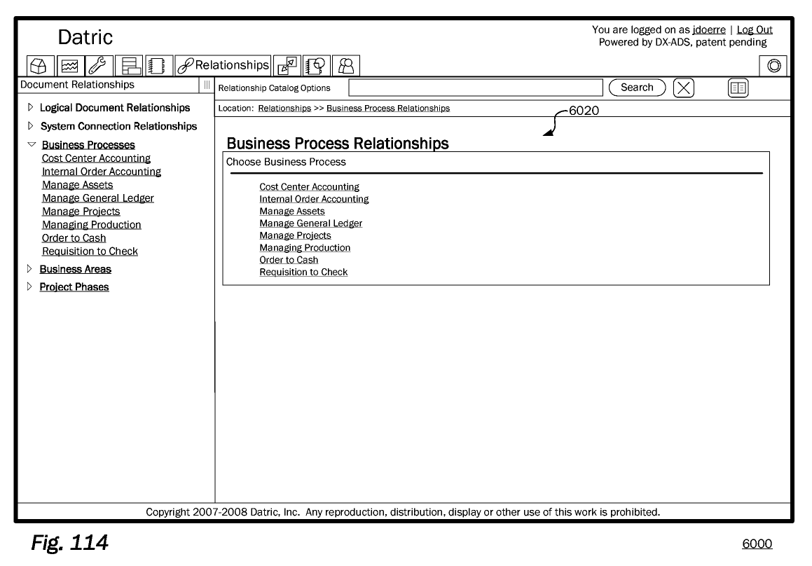

The menu page 6020 displays each process, area, or phase as a link together with a description, as can be seen in FIG. 112B. The menu page 6020 also includes an options bar 6030, having a search field 6032, search button 6034, clear button 6036, and toggle definitions button 6038. A user may enter text into the search field 6032 and then click the search button 6034 to effect a search for it. Following a search, each process, area, or phase that is a positive result is displayed as a link, together with a description, as can be seen in FIG. 113. A user may click the clear button 6036 to clear the results of the search and once more display all processes, areas, or phases. A user may click the toggle definitions button 6038 to cause all displayed descriptions to no longer be displayed, as can be seen in FIG. 114.

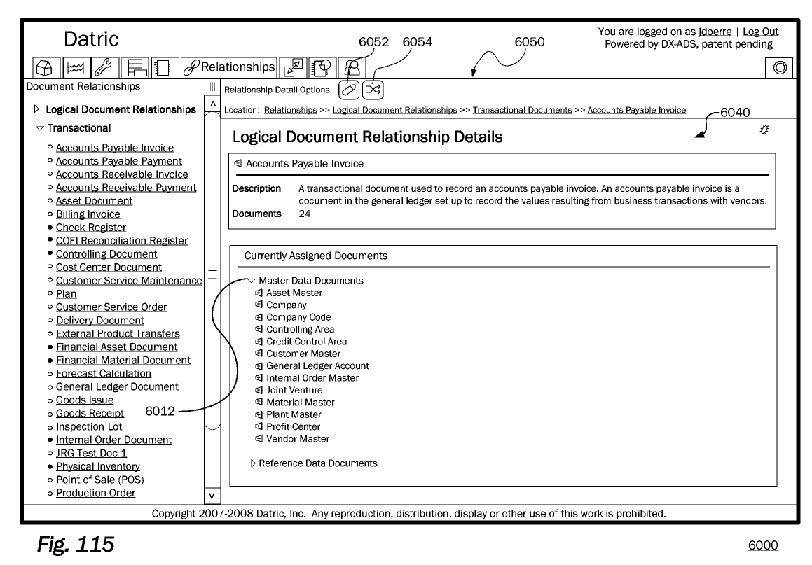

A user may click on a link in the left pane 6002 associated with a logical document, or on a link in the left or right panes 6002,6004 associated with a business process, business area, or project phase to display a relationship details subpage 6040, as can be seen in FIG. 115.

The relationship details subpage 6040 includes a description, and a number of currently assigned documents. The currently assigned documents are also displayed. If the currently assigned documents belong to more than one class of documents, then the currently assigned documents are contained within expandable menus 6012, one expandable menu 6012 being associated with each class, as can be seen in FIG. 115. Adjacent each document is a colored indicator indicating whether the document is enabled or disabled.

The relationship details subpage 6040 may display an enabling toggle 6008, and preferably does if the relationship details subpage 6040 pertains to a logical document.

The relationship details subpage 6040 further includes an options bar 6050, as can be seen in FIG. 115. The options bar 6050 includes an edit button 6052 and a reorder button 6054. A user may click the edit button 6052 to edit the currently assigned documents via a relationships editing page 6060.

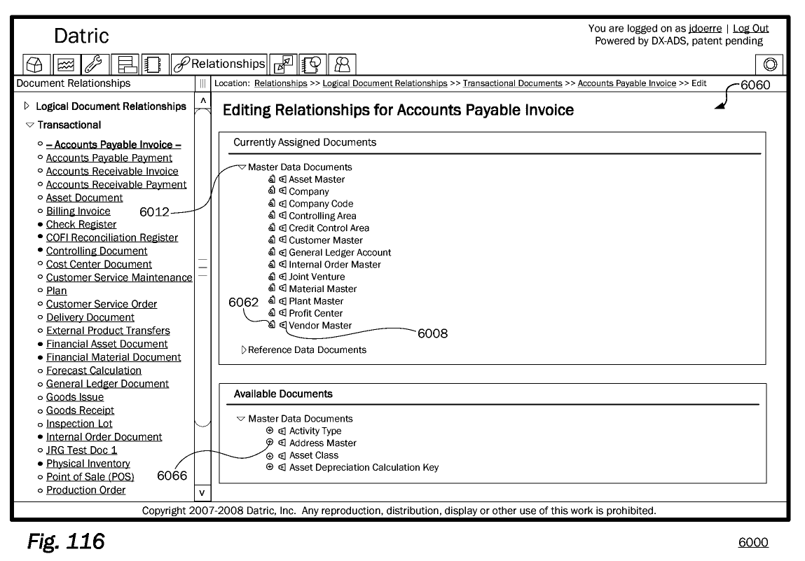

The relationships editing page 6060 displays currently assigned documents and documents available to be assigned within expandable menus 6012 organized by document class. These expandable menus 6012 are initially collapsed, but may be expanded as can be seen in FIG. 116.

Adjacent each currently assigned document is an enabling toggle 6008 and a removal button 6062. A user may click the removal button 6062 associated with a certain document to remove that certain document from the list of assigned documents.

Adjacent each document available to be assigned is an enabling toggle 6008, as well as an add button 6066. A user may click the add button 6066 associated with a certain document to add that certain document to the list of assigned documents.

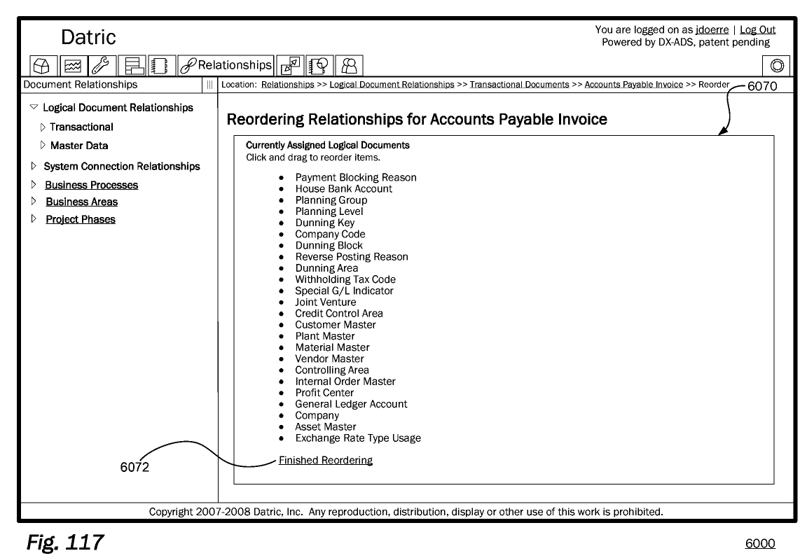

Returning to the options bar 6050 of the relationship details subpage 6040 of FIG. 115, a user may click the reorder button 6054 to reorder the currently assigned documents via a reordering page 6070, as can be seen in FIG. 117.

The reordering page 6070 displays currently assigned documents and allows a user to drag documents to the top or bottom of other documents to reorder them. Once a user has finished reordering the assigned documents, he or she may save his or her changes by clicking a finished link 6072.

Returning to the left pane 6002 of the relationships tab 6000, when the expandable menu 6012 associated with system connection relationships is clicked, system connections defined under the systems tab 4000 are displayed as links. Adjacent each system is a colored indicator indicating whether the system is enabled or disabled.

A user may click on one of the links to display a system connection details page 6080. The system connection details page 6080 displays a number of assigned documents. These currently assigned documents are also displayed. If the currently assigned documents belong to more than one class of documents, then the currently assigned documents are contained within expandable menus 6012, one expandable menu 6012 being associated with each class. Adjacent each document is a colored indicator indicating whether the document is enabled or disabled.

The system connection details page 6080 further includes an options bar 6090. The options bar 6090 includes an edit button 6092. A user may click the edit button 6092 to edit the documents assigned to the system connection via the relationships editing page 6060.

### Mappings Tab

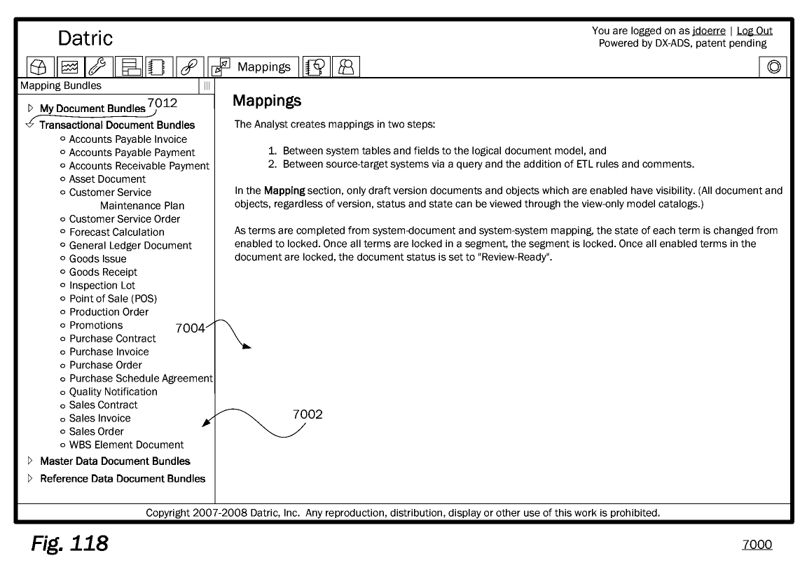

FIG. 118 is a screenshot of the mappings tab 7000 of the user page of the website. The mappings tab 7000 allows a user to create mappings between documents and systems. The mappings tab 7000 includes a plurality of expandable menus 7012 located in a left pane 7002 of the mappings tab 7000. One of the expandable menus 7012 may be associated with documents associated with a user, as exemplified by the expandable menu labeled “My Document Bundles” in FIG. 118. Further, each document class defined under the components tab 3000 is associated with an expandable menu 7012, as exemplified by the expandable menu 7012 labeled “Transactional Document Bundles”.

Clicking on one of the plurality of expandable menus 7012 expands the expandable menu 7012 that was clicked. When an expandable menu 7012 is expanded, documents representing document bundles associated with that expandable menu 7012 are displayed. For example, expanding the expandable menu 7012 associated with “Transactional Document Bundles” will display transactional documents. Adjacent each link is a colored indicator indicating whether the document is enabled or disabled. Documents that represent document bundles that are ready to be mapped are displayed as links. Clicking on one of these links displays a mapping bundle subpage 7010 in a right pane 7004 of the mappings tab 7000.

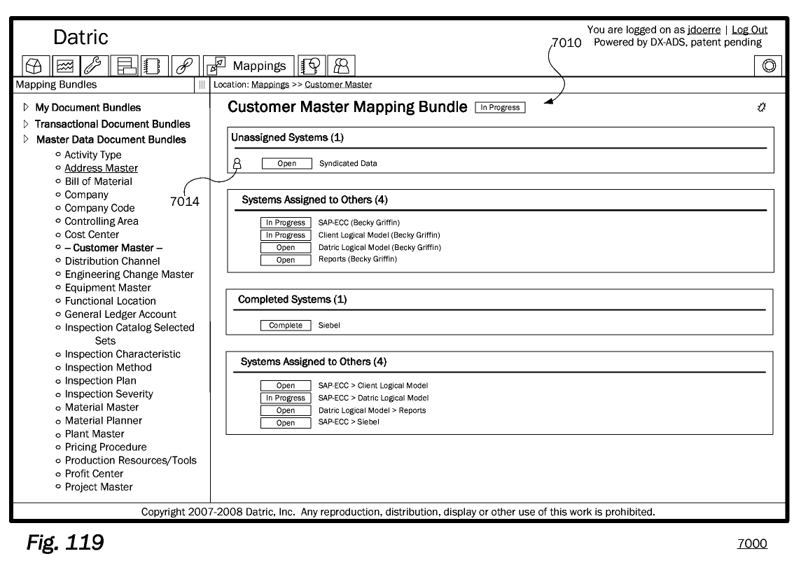

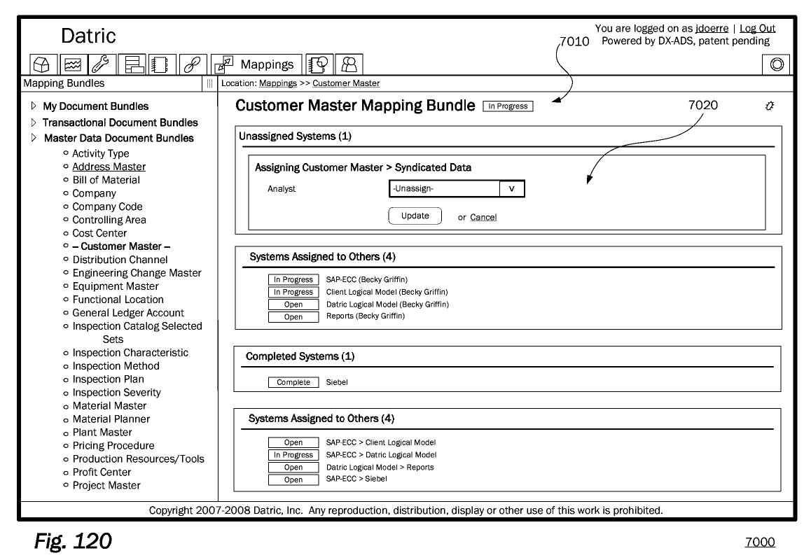

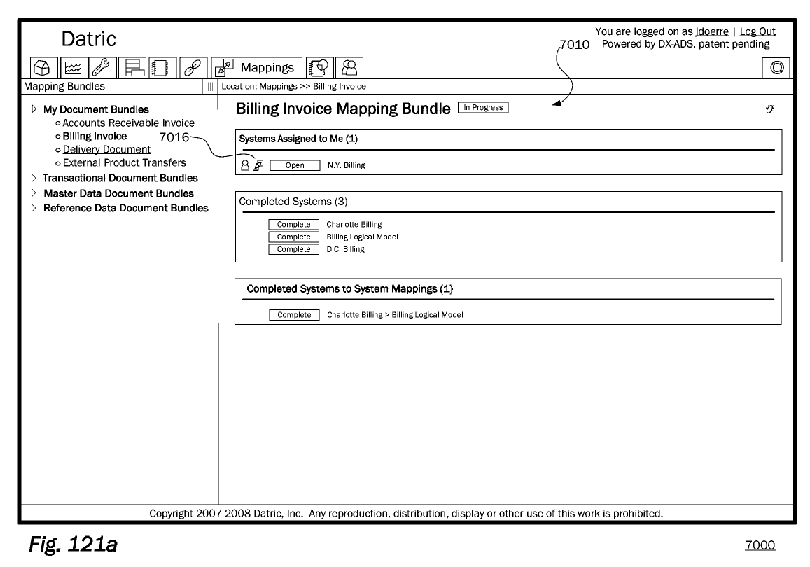

The mapping bundle subpage 7010 displays systems to be mapped to a document bundle, as well as system to system mappings the document bundle is a part of, as can be seen in FIG. 119. These systems and system to system mappings are displayed in groups based on whether they are system mappings or system to system mappings, whether they are assigned to the user viewing the mapping bundle subpage 7010, and whether they are unassigned. Each system to be mapped and system to system mapping may display a name of an analyst the mapping is assigned to, and additionally displays a visual indicator indicating whether the mapping is open(has not started), in progress, or complete. When a user mouses over a system or a system to system mapping, an assignment icon 7014 appears. A user may click the assignment icon 7014 to display an assignment interface 7020, which allows a user to select an analyst to assign the mapping to, as can be seen in FIG. 120.

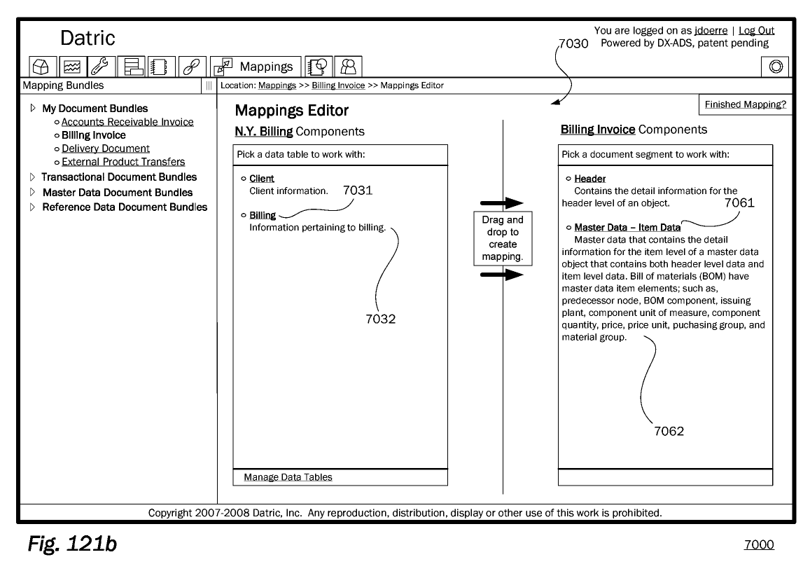

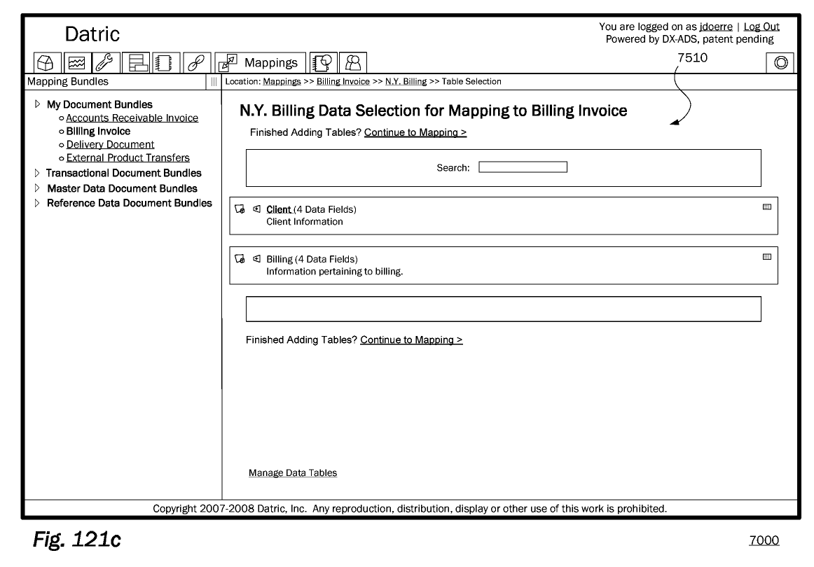

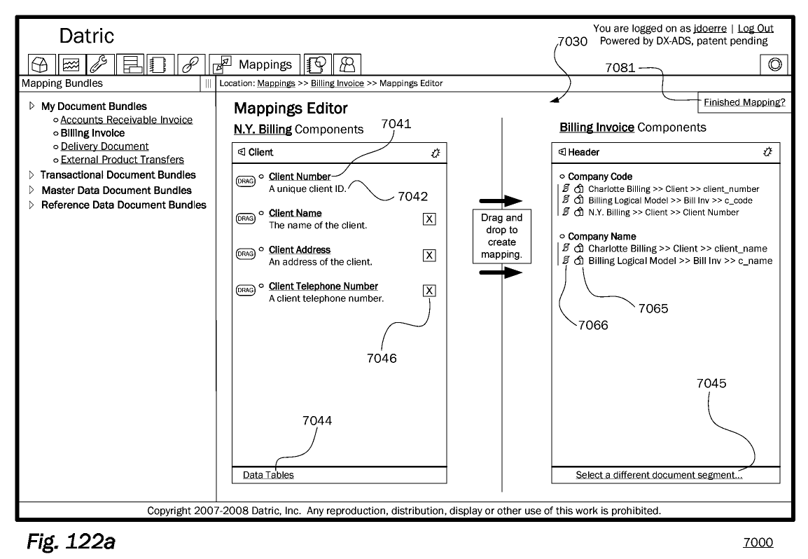

On the mapping bundle subpage 7010, when a user mouses over a system to be mapped that has been assigned to him or her, a mapping button 7016 also appears, as can be seen in FIG. 121A. A user may click the mapping button 7016 to display a mappings editor page 7030, as can be seen in FIG. 121B.

If no data tables have been selected for mapping, however, then a select data tables page 7510 will be displayed first, as can be seen in FIG. 121C. Each data table of the system to be mapped will be displayed together with a button toggling their inclusion or exclusion in mapping. Further, a search interface will be displayed at a top of the select data tables page 7510.

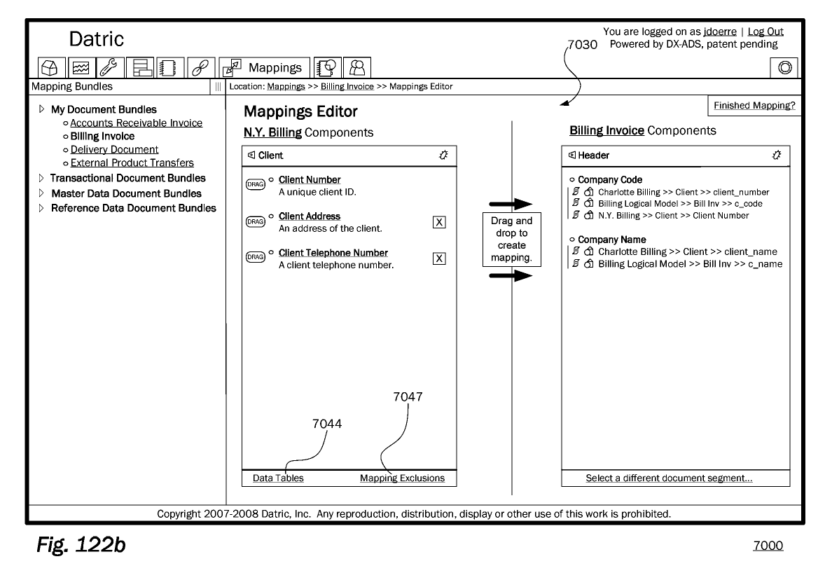

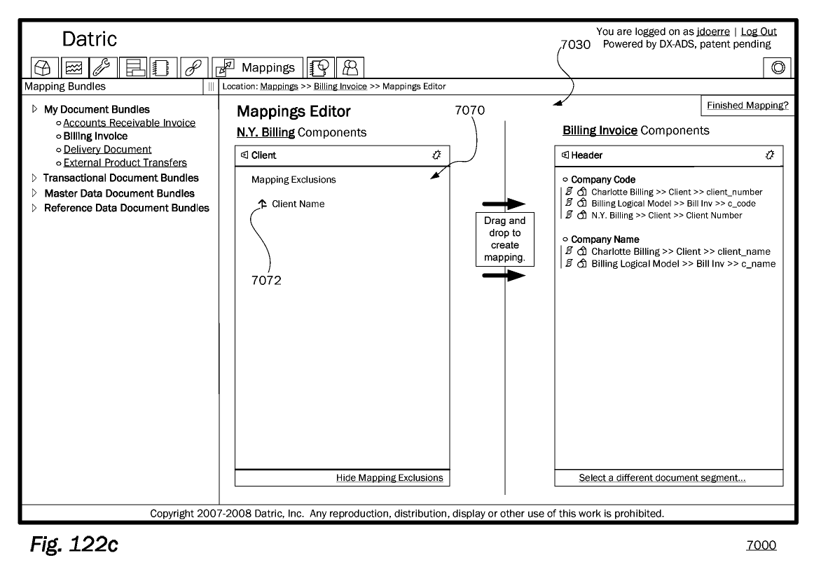

On the mappings editor page 7030, data table identifiers 7031 of the system to be mapped to are displayed as links together with data table descriptors 7032 and a colored indicator 7033, indicating whether the data table is enabled or disabled. A user may select a data table by clicking on the data table identifier 7031 associated with the data table to display the name of the data table selected together with a visual indicator of enablement status, as well as data field identifiers 7041, data field descriptors 7042 and a colored indicator of enablement status for each data field of the data table selected, as can be seen in FIG. 122A. If a data field is a primary key or a foreign key, an indicator of that will be displayed as well. At any time a user may select a different data table via a data tables link 7044.

On the right side of the mapping bundle subpage 7010, document segment identifiers 7061 of the document being mapped are displayed as links together with data table descriptors 7062 and a colored indicator 7063, indicating whether the data table is enabled or disabled, as can be seen in FIG. 121B. A user may select a document segment by clicking on the document segment identifier 7061 associated with the document segment to display the name of the document segment selected together with a visual indicator of enablement status, as well as business terms together with an indicator of enablement status, and directory information for any data fields mapped to the business term, as can be seen in FIG. 122A. A blue line may be displayed to indicate that a business term has a data field mapped to it. At any time a user may select a different document segment via a document segment link 7045.

A user may drag a data field from the left side of the mapping bundle subpage 7010 to a business term on the right side of the mapping bundle subpage 7010 to effect a mapping. Adjacent to the directory information for each data field mapped to a business term is a removal button 7065. Additionally, if Extract, Transform, and Load (“ETL”) rules have been created, or in some embodiments even if they have not, an ETL button 7066 is displayed that will display an ETL interface 7200 when clicked.

A blue line also may be displayed adjacent a data field identifier 7041 and descriptor 7042 to indicate the data field has been mapped to a business term. A grey line may be displayed for any data fields that are disabled. Data fields that are enabled but have not been mapped include a removal box 7046 that a user may click to exclude the data field from mapping. The data field will no longer be displayed, but a user may click an exclusions link 7047 to display an exclusions interface 7070, as can be seen in FIGS. 122B-C. The exclusions interface 7070 displays any excluded data fields and allows a user to re-include excluded data fields via a re-include button 7072 adjacent each excluded data field.

When a user is finished mapping, he or she may click a finalize link 7081 to finalize the mappings after confirming the finalization.

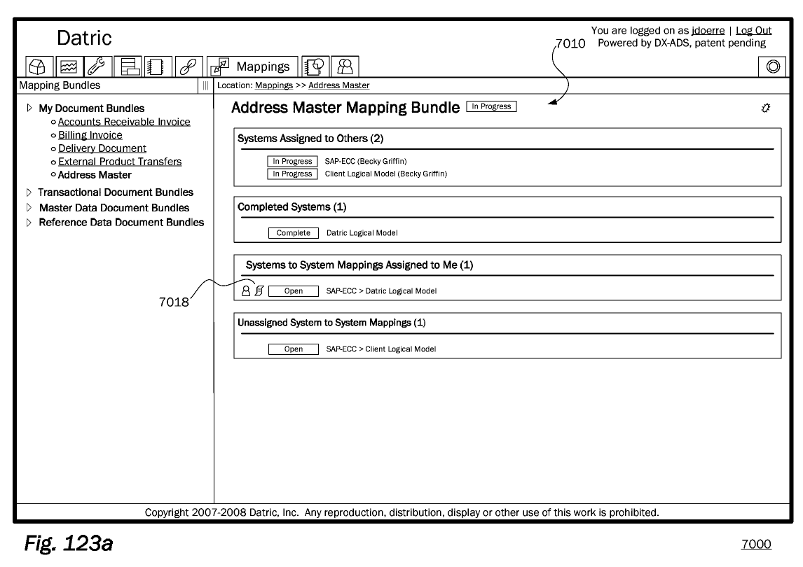

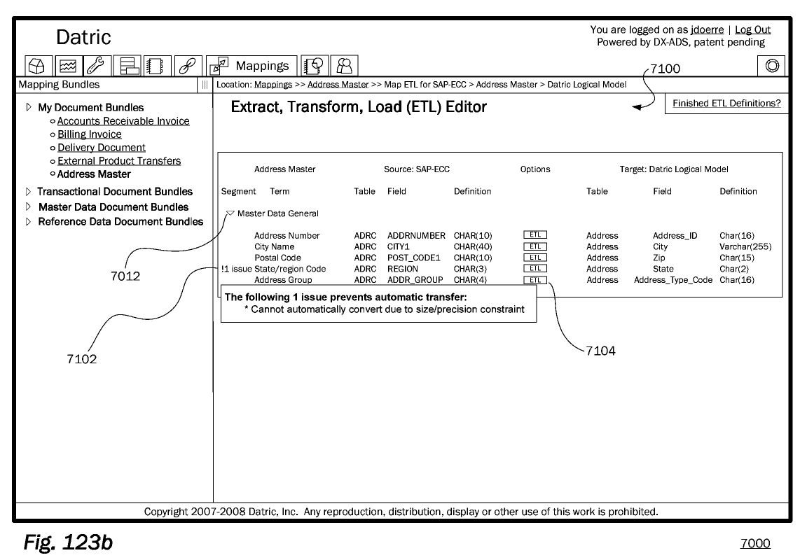

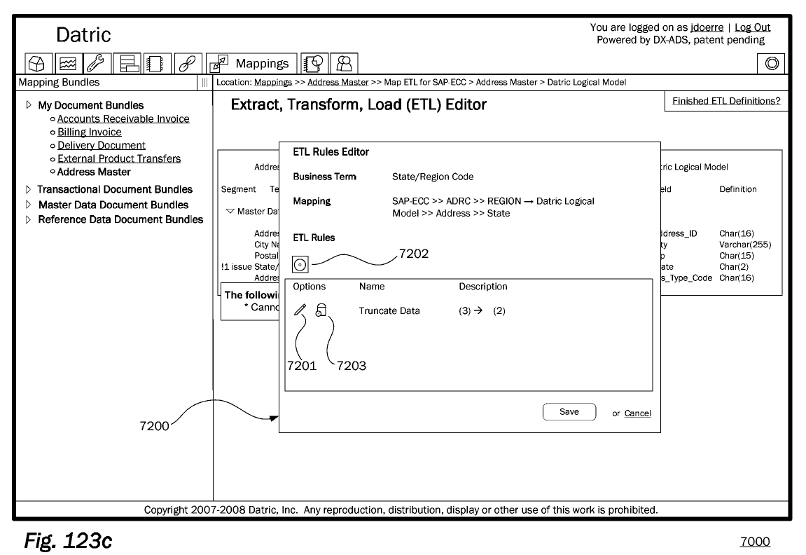

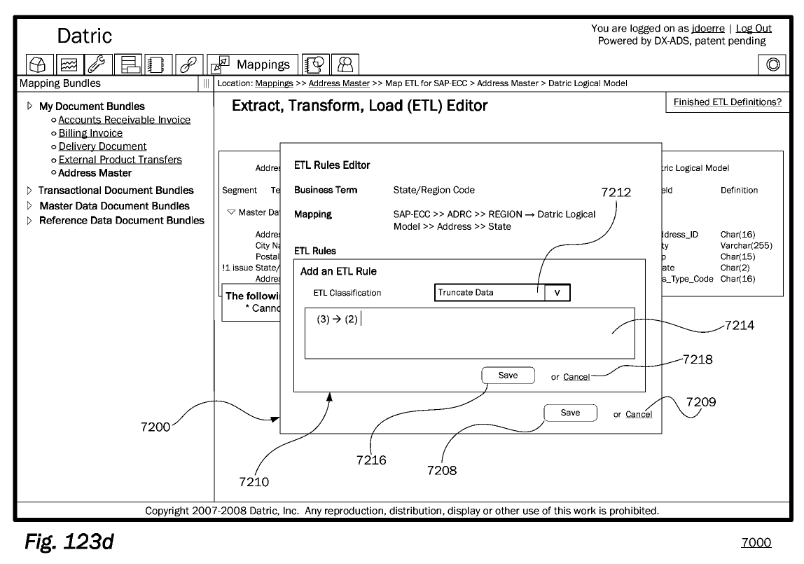

Returning to the mapping bundle subpage 7010, when a user mouses over a system to system mapping an ETL editor button 7018 is displayed, as can be seen in FIG. 123A. A user may click the ETL editor button to display an ETL editing page 7100. The ETL editing page 7100 displays an expandable menu 7012 for each document segment of the document that has been mapped to both systems, as can be seen in FIG. 123B. Expanding one of the expandable menus displays each business term of the document segment that has been mapped to both systems, as well as the data table, data field, and definition of both the source system and the target system that each business term has been mapped to. If there are any issues with the mapping, a warning 7102 is displayed together with an indication of the number of issues. A user may mouse over the warning to display a more detailed explanation, as can be seen in FIG. 123B. An ETL button 7104 is provided for each business term. A user may click the ETL button 7104 to display the ETL interface 7200, as can be seen in FIGS. 123C-D.

The ETL interface 7200 displays the business term as well as directory information for both the source and target data fields. The ETL interface 7200 further displays a name and description of any existing ETL rules, together with an adjacent editing button 7201 and removal button 7203. The removal button 7203 removes the associated ETL rule, while the editing button may be clicked to edit the associated ETL rule via an ETL rule interface 7210. An add ETL rule button 7202 may be clicked to display the ETL rule interface 7210. A user may select an ETL classification from a dropdown menu 7212 of the add ETL rule interface 7210 and a user may input a description via an input field 7214. A user may save his or her input via a save button 7216 or may cancel his or her input via a cancel link 7218.

When a user is finished on the ETL interface 7200, he or she may click a save button 7208 to save his or her changes, or a cancel link 7209 to cancel his or her changes.

Likewise, back on the ETL editing page 7100, a user may click a finish button 7109 to navigate away from the ETL editing page 7100.

### Account Tab

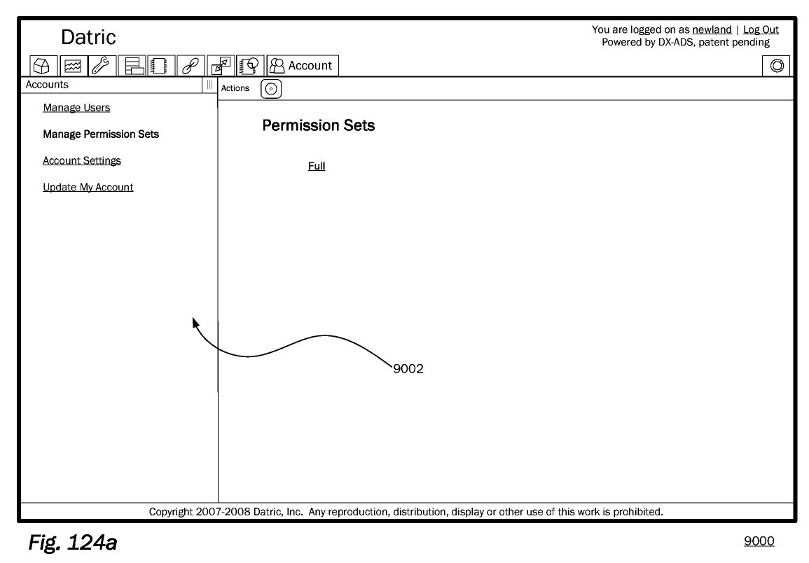

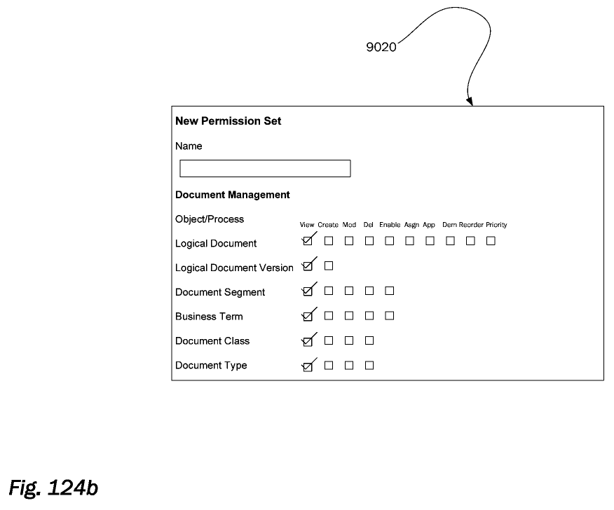

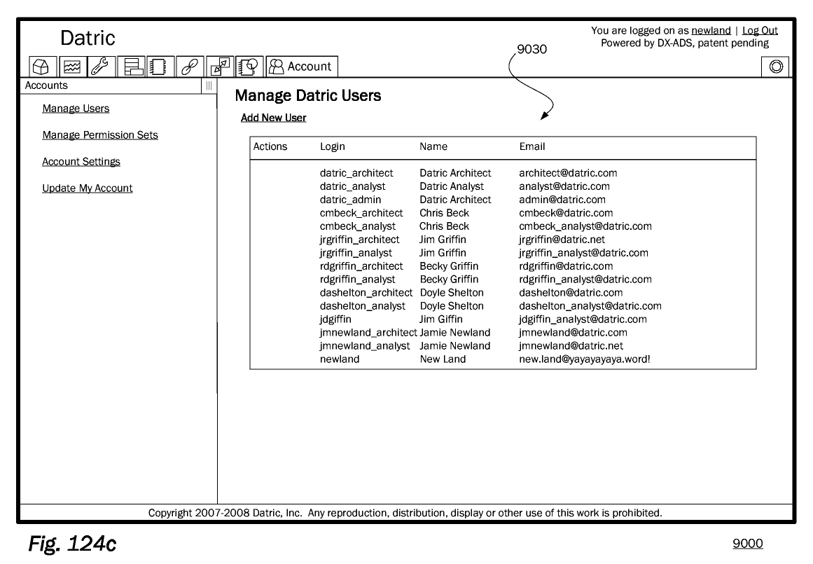

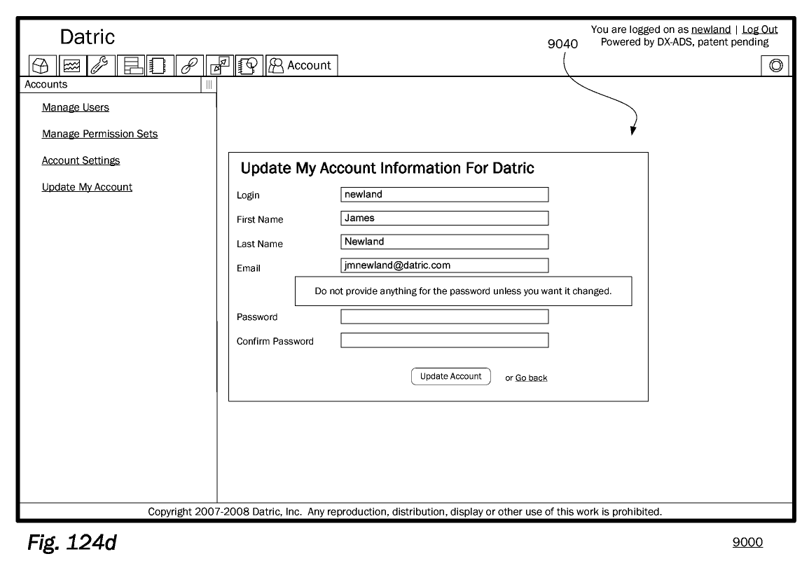

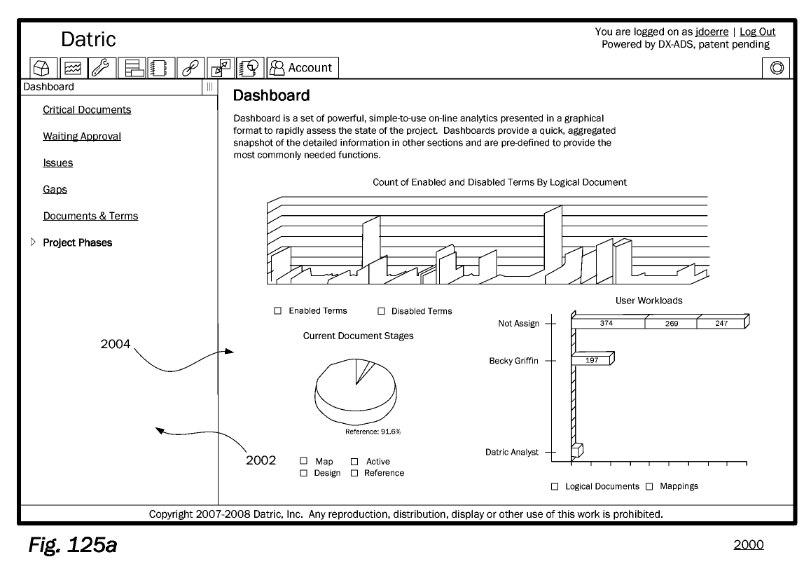

FIG. 124A is a partial screenshot of the account tab 9000 of the user page of the website. The account tab 9000 allows a user to manage users, manage permission sets, edit account settings, and update his or her account, as can be seen from the left pane 9002 of the account tab 9000 in FIG. 124A.

A user may create, edit, and delete permission sets via a permission set interface 9020, as can be seen in FIG. 124B. Permission sets specify what actions on the site members of that permission set may take. A user may assign permission sets to developers via a developer page 9030. A user may further add, edit, or delete developers through the developer page 9030, which can be seen in FIG. 124C. A user may further edit their own account information through an account update interface 9040, as can be seen in FIG. 124D.

### Dashboard Tab

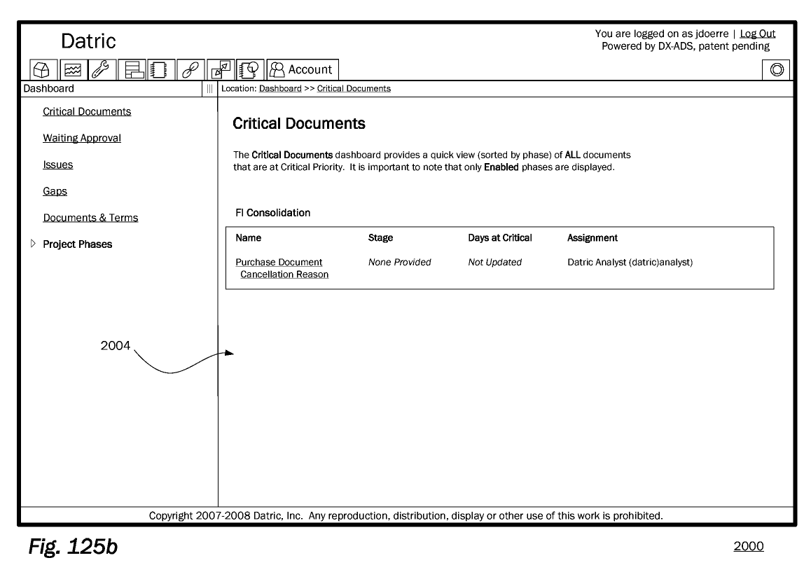

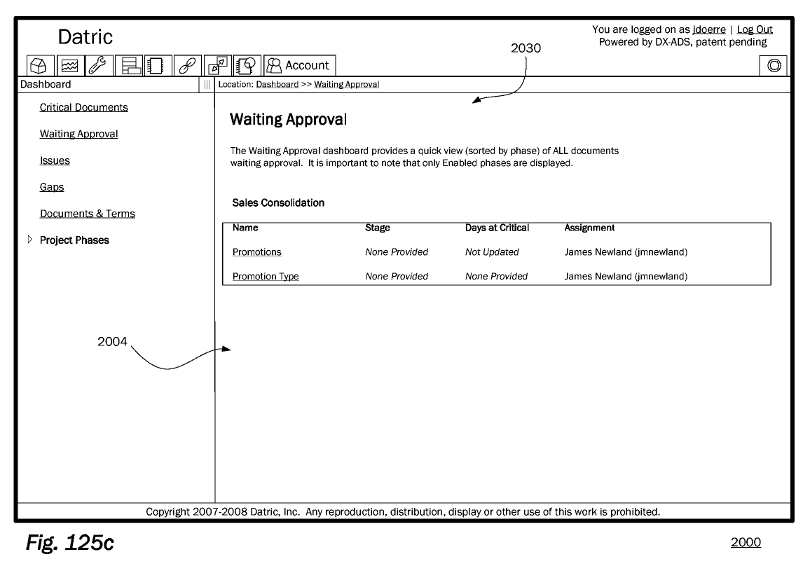

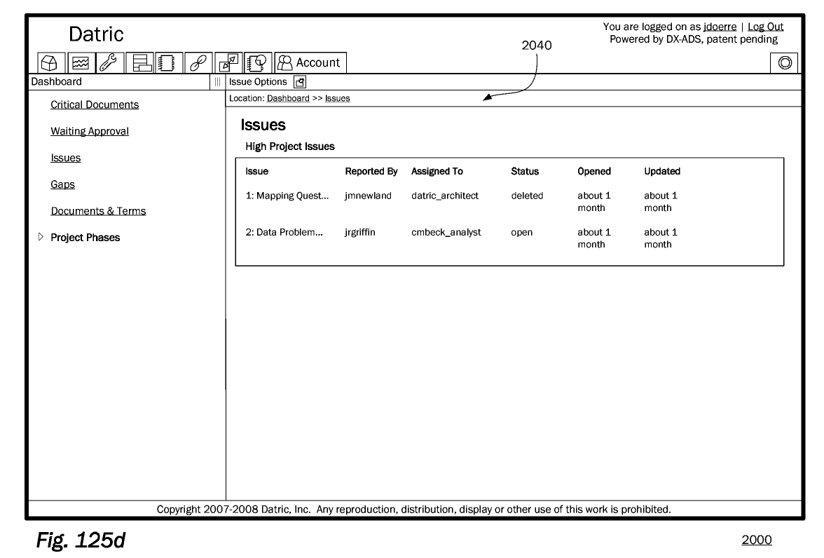

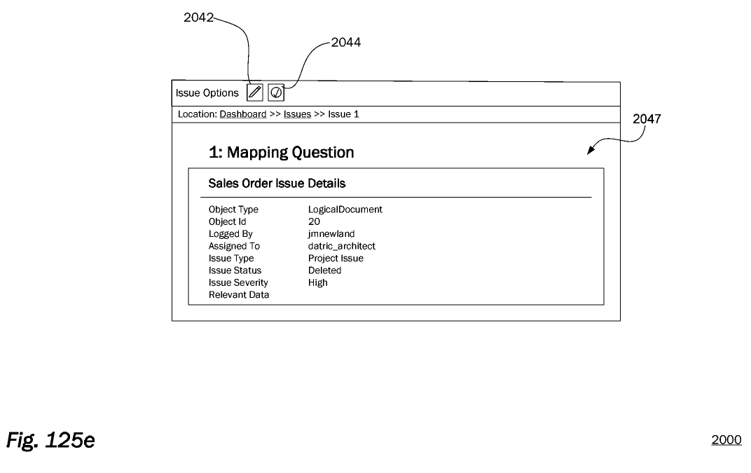

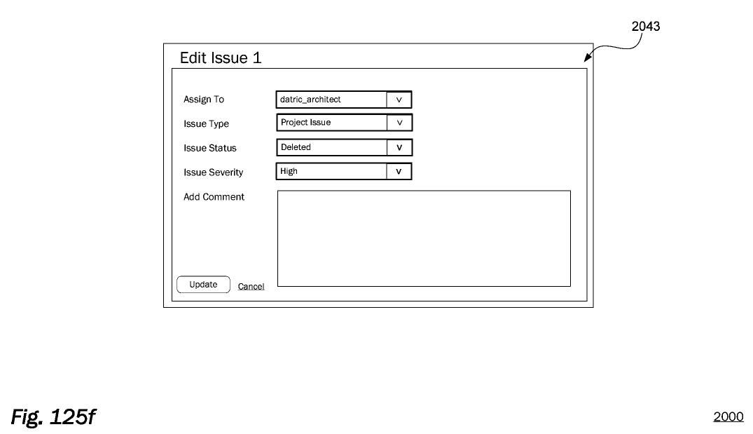

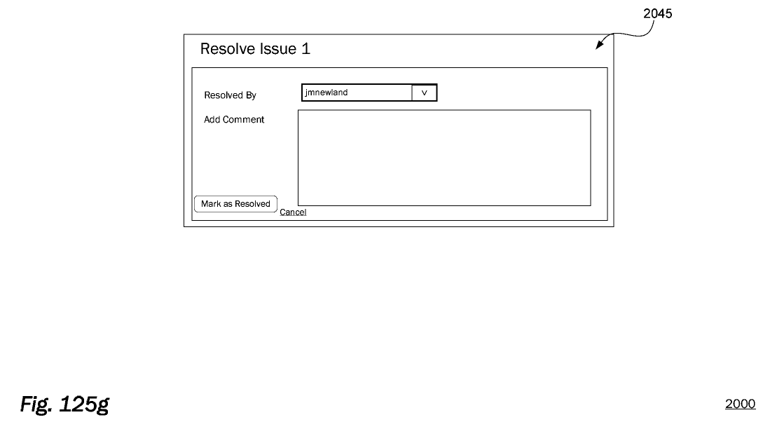

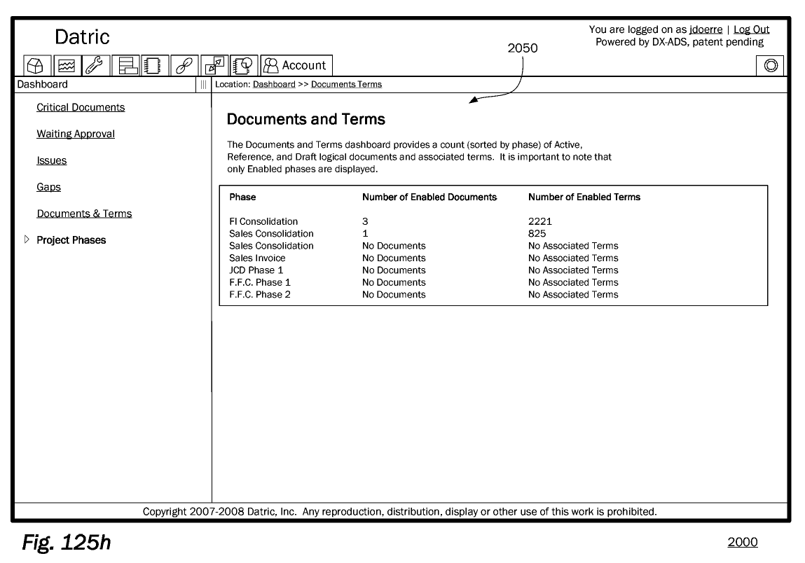

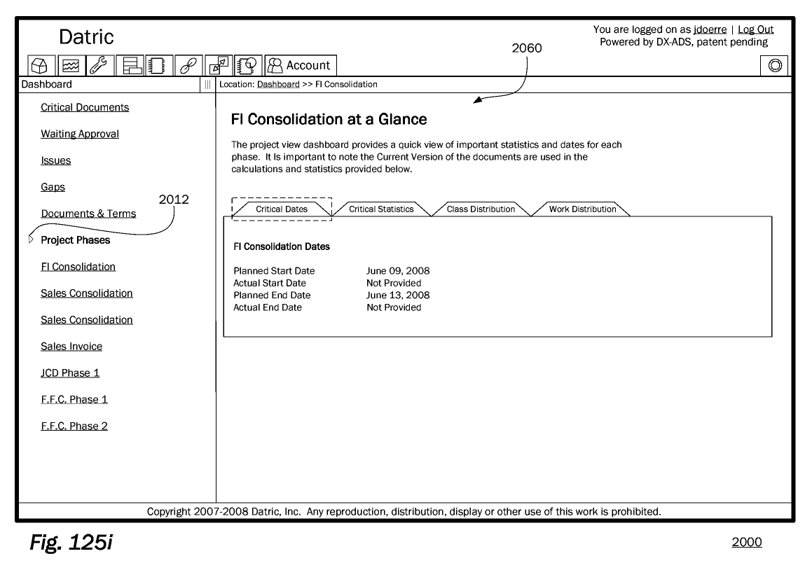

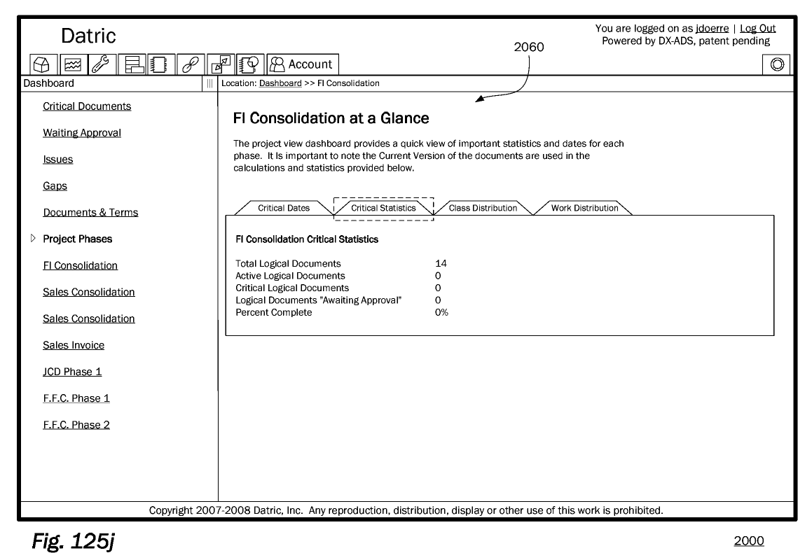

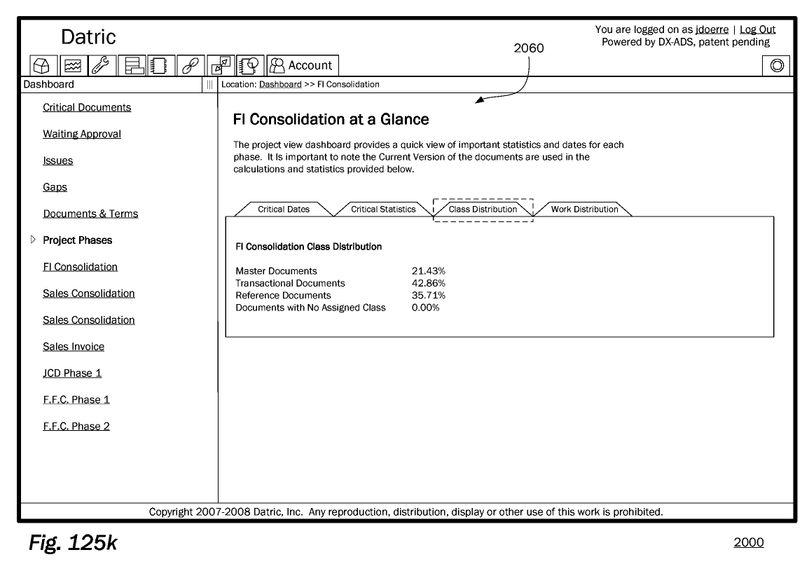

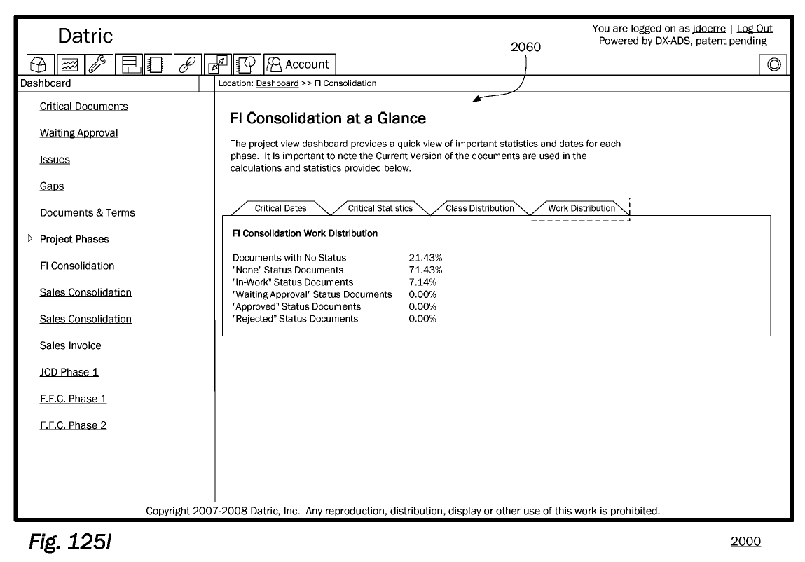

FIG. 125A is a screenshot of the dashboard tab 2000 of the user page of the website. The dashboard tab 2000 provides a set of powerful, simple-to-use online analytics presented in graphical format to rapidly assess a state of a project. The dashboard tab 2000 initially displays in a right pane 2004 a plurality of three-dimensional graphs representing information pertaining to one or more projects, as can be seen in FIG. 125A.

The dashboard tab 2000 additionally displays in a left pane 2002 a plurality of links, as well as an expandable menu 2012. The expandable menu 2012 is associated with project phases, and contains additional links, as can be seen in FIG. 125A.

A user may click on one of the links to display a critical documents page 2020 in the right pane 2004. The critical documents page 2020 displays all documents at critical priority as links, and further displays what stage they are at, together with the number of days they have been at critical and a name of the developer they are assigned to, as can be seen in FIG. 125B.

A user may click on one of the links to display a waiting approval page 2030 in the right pane 2004. The waiting approval page 2030 displays all documents waiting approval as links, and further displays what stage they are at, together with the number of days they have been awaiting approval and a name of the developer they are assigned to, as can be seen in FIG. 125C.

A user may click on one of the links to display an issues page 2040 in the right pane 2004. The issues page 2040 displays all issues that have been reported, as well as who they were reported by, a name of the developer the issue has been assigned to, a status of the issue, how long the issue has been open, and the last time the issue was updated, as can be seen in FIG. 125D. A user may click on an issue to view an issue information screen 2047, as can be seen in FIG. 125E. The issue information screen 2047 includes an edit issue button 2042 that may be clicked to edit information pertaining to the issue via an issue editing interface 2043, as can be seen in FIG. 125F. A user may still further click on a resolve issue button 2044 to display a resolution interface 2045, as can be seen in FIG. 125G. The resolution interface 2045 allows a user to select who the issue was resolved by and include a description.

It is contemplated that a user may click on one of the links to display a gap information page in the right pane 2004. The gap information page could display information pertaining to relationship, mapping, or ETL rule definition gaps among the elements and components, specifically among systems, system connections, and logical documents, and more specifically among data fields of systems and business terms of logical documents.

A user may click on one of the links to display a documents and terms page 2050. The documents and terms page 2050 provides a count, sorted by phase, of active, reference, and draft logical documents and associated business terms, as can be seen in FIG. 125H. Preferably, only enabled phases are displayed.

When the expandable menu 2012 in the left pane 2002 is expanded, it displays project phases as links. Clicking on one of the project phases displays a project phase dashboard page 2060 having four tabs. The tabs display phase information pertaining to critical dates, critical statistics, class distribution, and work distribution, as can be seen in FIGS. 125I-L.

### Reports Tab

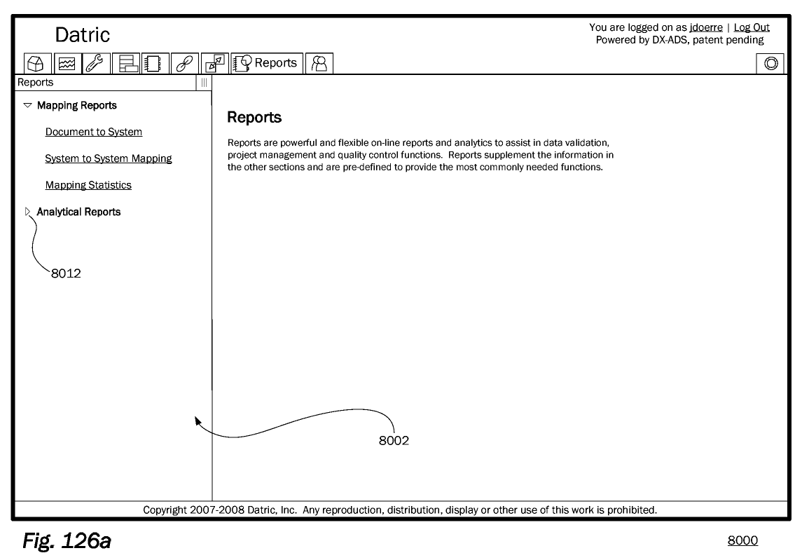

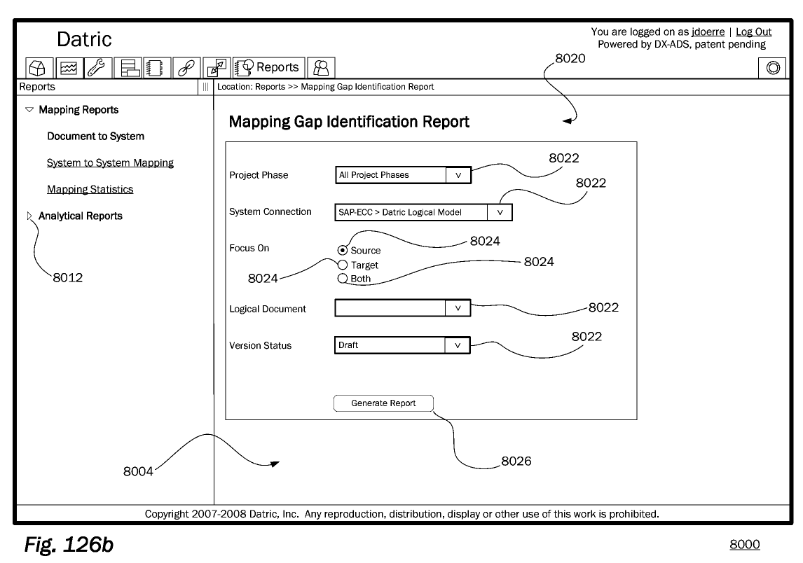

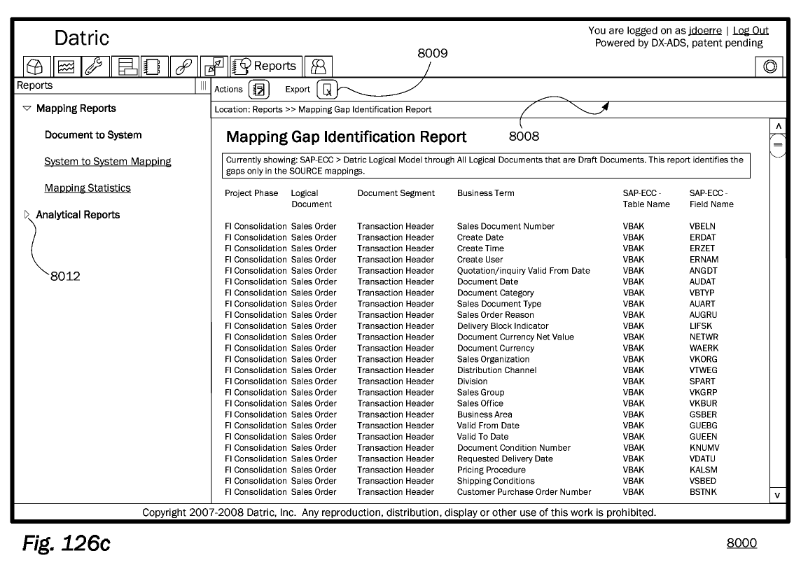

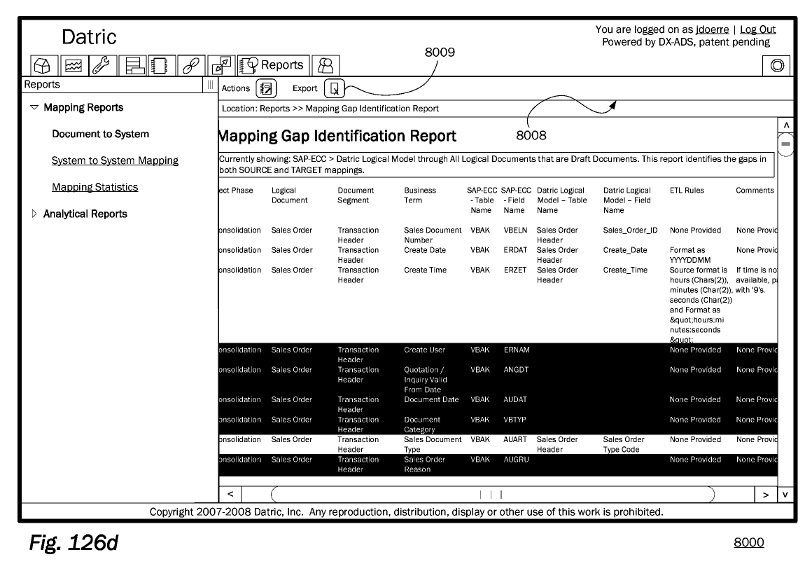

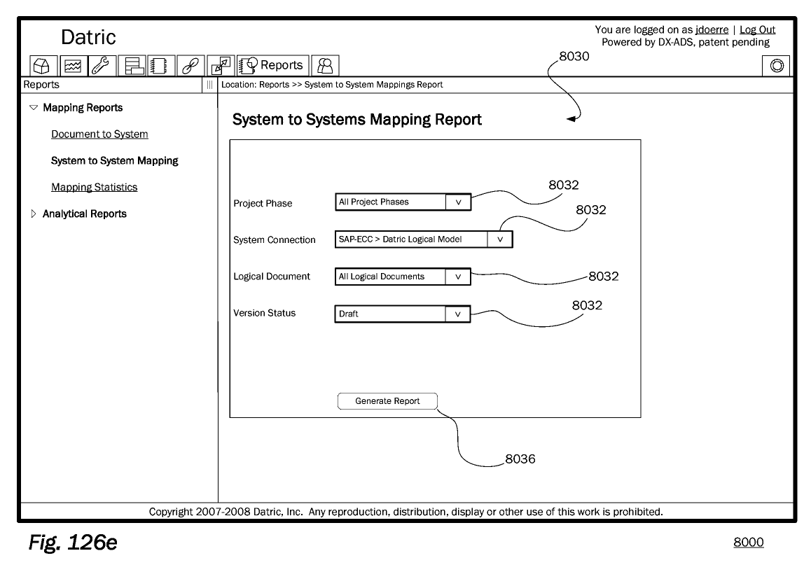

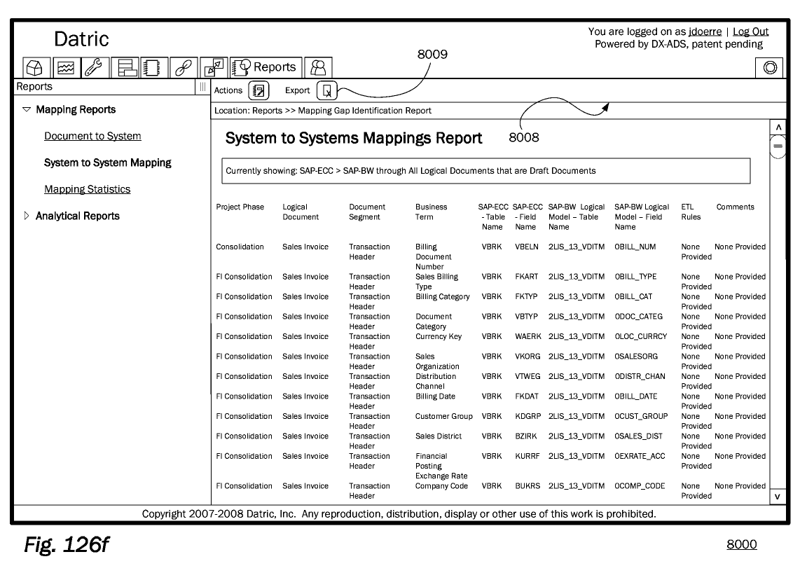

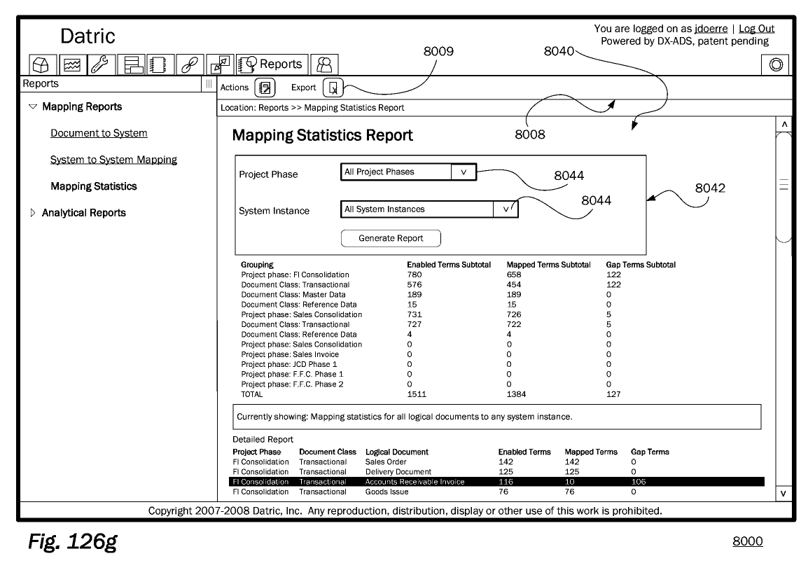

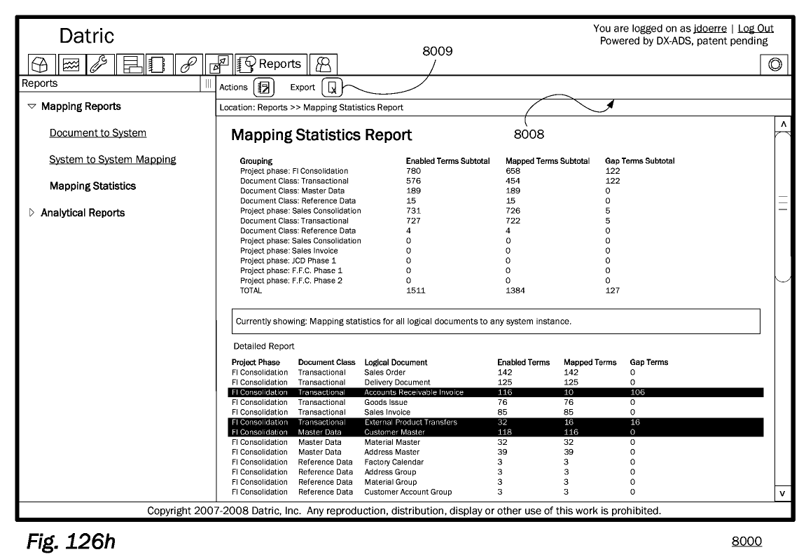

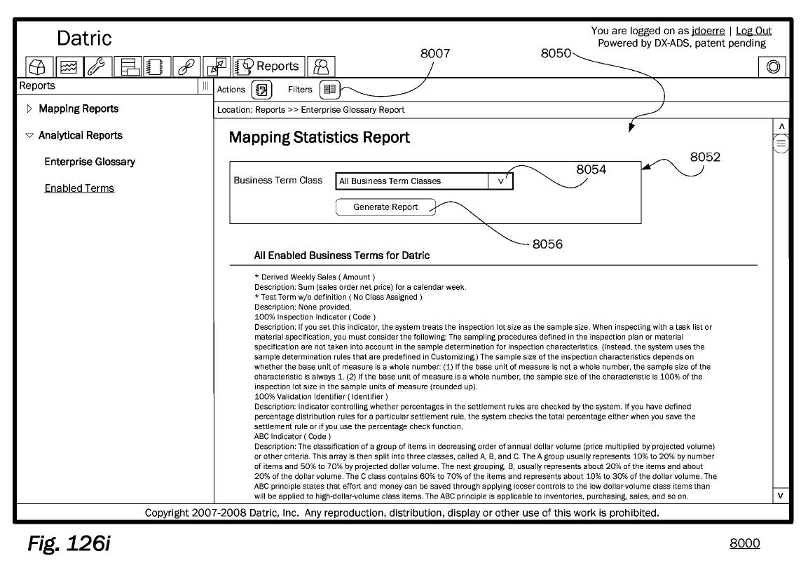

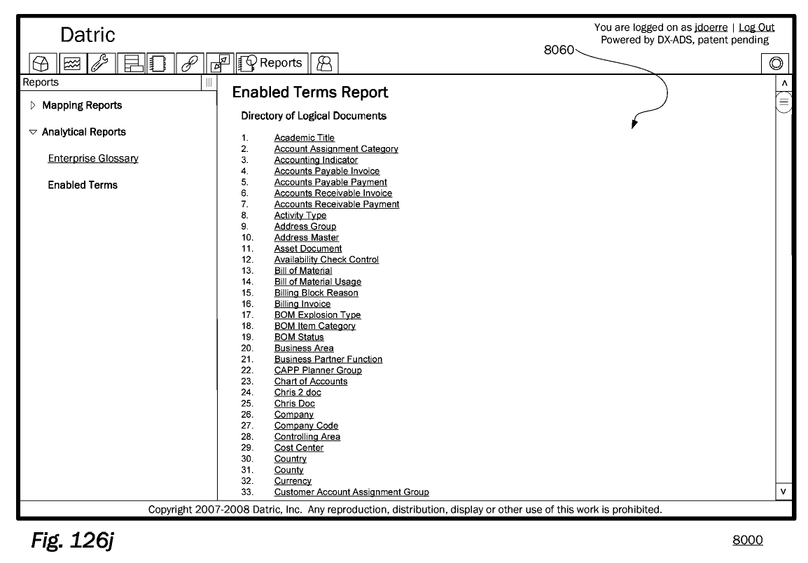

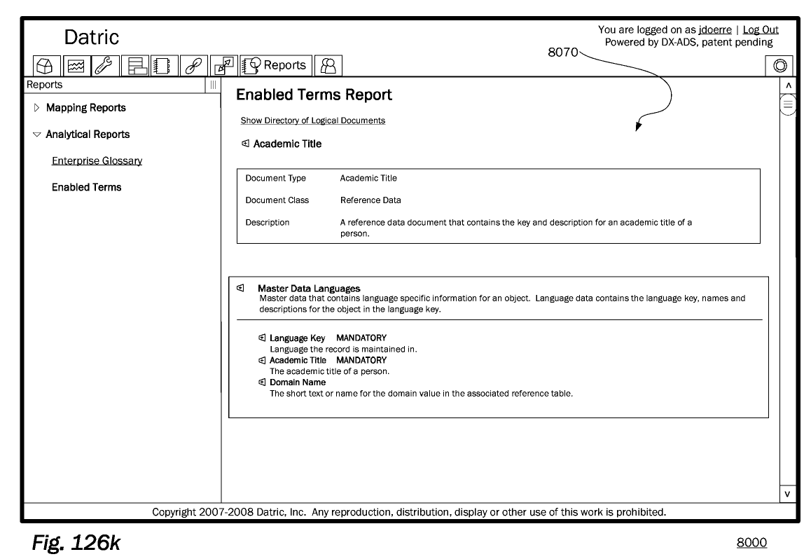

FIG. 126A is a screenshot of the reports tab 8000 of the user page of the website. The reports tab 8000 provides a powerful and flexible online reports and analytics to assist in data validation, project management, and quality control functions. Reports may be predefined to provide the most commonly needed functions.

The reports tab 8000 includes two expandable menus 8012 located in a left pane 8002 of the reports tab 8000. Each expandable menu 8012 includes a plurality of links that are displayed when the expandable menu is expanded. The first expandable menu 8012 is associated with mapping reports.

A user may click on a first of the links labeled “Document to System” to display a mapping gap identification report page 8020, as can be seen in FIG. 126B. A user may select a project phase and a system connection from dropdown menus 8022 and select whether to focus on a source system, a target system, or both via three radio buttons 8024. If a user focuses on the source system, only gaps in the source mapping will be reported. If a user focuses on the target system, only gaps in the target mapping will be reported. A user may choose to focus on both, in which case gaps in both will be reported. A user then may select a logical document, or all logical documents, associated with that system connection via another dropdown menu 8022 and select a version status for the report. For example, if a user selects “Draft” then only information pertaining to draft documents will be reported. After making selections, a user may generate a report by clicking a generate report button 8026. A report will be generated displaying all business terms of the selected documents, as well as the document segment and document each belongs to, and data fields of each system that they are mapped to, as well as the data table and system each belongs to, as can be seen in FIG. 126C. Any gaps will be highlighted in red, as can be seen in FIG. 126D.

A user may click on a second of the links labeled “System to System Mapping” to display a system to system mappings report page 8030, as can be seen in FIG. 126E. A user may select a project phase and a system connection from dropdown menus 8032. A user then may select a logical document, or all logical documents, associated with that system connection via another dropdown menu 8032 and select a version status for the report. For example, if a user selects “Draft” then only information pertaining to draft documents will be reported. After making selections, a user may generate a report by clicking a generate report button 8036. A report will be generated displaying all mappings from the source system to the target system through the selected logical documents. Business terms of the selected documents, as well as the document segment and document each belongs to, and data fields of each system that they are mapped to, as well as the data table and system each belongs to, will be displayed, as can be seen in FIG. 126F.

A user may click on a third of the links labeled “Mapping Statistics” to display a mapping statistics report page 8040, as can be seen in FIG. 126G. The mapping statistics report page 8040 displays a summary report displaying project phases, document classes of documents associated with the project phases, enabled business terms of both the project phases and document classes, mapped business terms of the same, and gap business terms of the same. The mapping statistics report page 8040 further displays a detailed report of each logical document, the project phase it is associated with, the document class it is associated with, a number of enabled business terms, a number of disabled business terms, and a number of gap business terms. Any document with one or more gap terms is highlighted in red, as can be seen in FIG. 126G.

The mapping statistics report page 8040 further includes a report interface 8042 having two dropdown menus 8044 a user may use to select a project phase and/or system instance to narrow the report to. After selecting the system “SAP-ECC” the mapping statistics reports page 8040 updates to display only those documents mapped to the “SAP-ECC” system, as can be seen in FIG. 126H.

The previously described report pages each further includes an export button 8009, located in an options bar 8008. A user may click the export button 8009 to export each respective report to an excel file. It is contemplated that in alternative embodiments, this export may be accomplished to additional file types.

The second expandable menu 8012 in the left pane 8002 is associated with analytical reports. A user may click a first of the links associated with the second expandable menu 8012 to display an enterprise glossary report page 8050, as can be seen in FIG. 1261. The enterprise glossary report page 8050 displays all enabled business terms and a description of each. A user may toggle the descriptions from displayed to not displayed via a description toggle button 8007. The enterprise glossary report page 8050 further displays a selection interface 8052. A user may utilize a dropdown menu 8054 of the selection interface 8052 to select a business term class, or select all business term classes. A user may click a generate report button 8056 to limit the displayed business terms to business terms of the selected class.

A user may click on a second of the links associated with the second expandable menu 8012 to display a directory page 8060, as can be seen in FIG. 126J. The directory page 8060 displays a directory of logical documents as clickable links. A user may click on a logical document to display a logical document display page 8070 which displays the logical document, a description of the logical document, data tables of the logical document, and any data fields of the logical document, as can be seen in FIG. 126K. Preferably, only enabled data tables are displayed. Enabling toggles are displayed as well. Additionally, if any data field is mandatory, a primary key, or a foreign key, an indication is displayed.

### Locations Bar and Log Issues Button

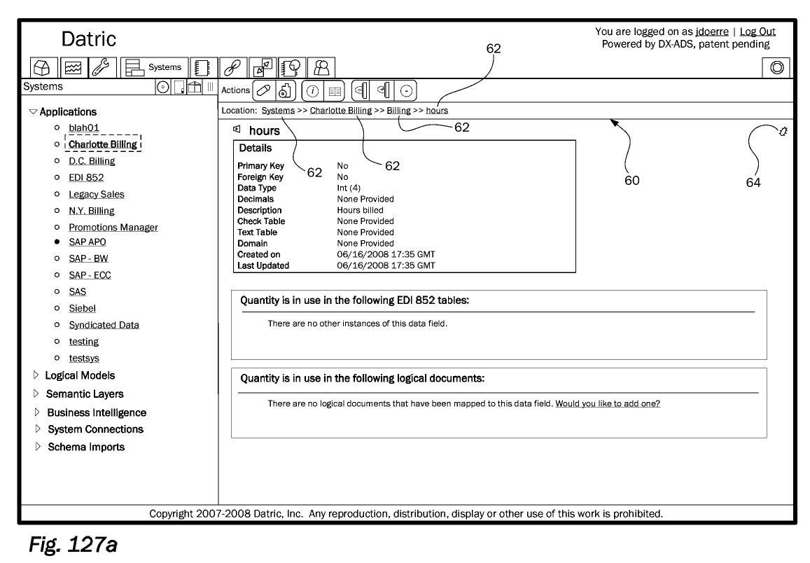

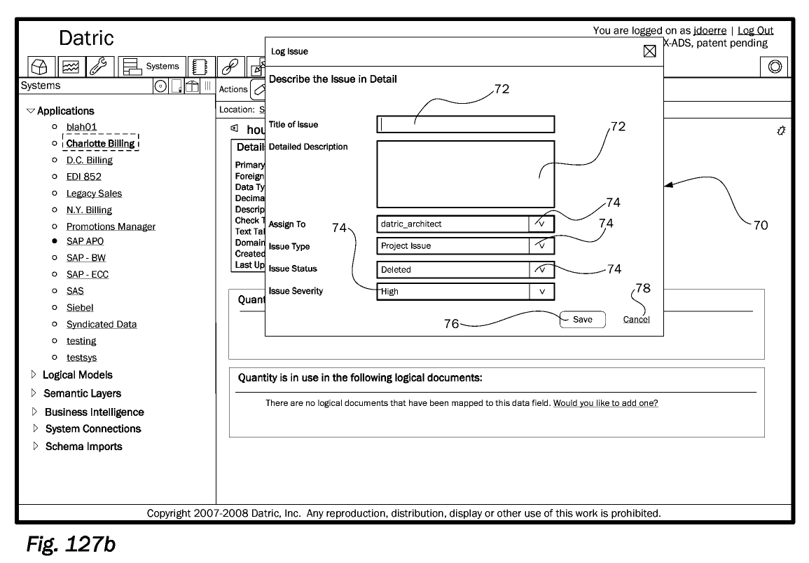

After clicking on any of the above described tabs 3000,4000,5000,6000,7000 a summary page will initially be displayed in the right pane 3004,4004,5004,6004,7004 of the respective tab. After this summary page is no longer displayed, a locations bar 60 will be displayed in the right pane 3004,4004,5004,6004,7004. This locations bar 60 will display a page hierarchy as a directory structure of clickable links 62 that will each navigate to a page associated with each link, as can be seen in FIG. 127A.

Further, a log issues button 64 will be included proximate a right side of the right pane 3004,4004,5004,6004,7004. A user may click the log issues button 64 to display a log issues interface 70 which allows a user to describe the issue by entering a name and description of the issue into text fields 72, as can be seen in FIG. 127B. A user may further assign the issue to a developer, select a type of the issue, select a status of the issue, and select a severity level of the issue via a plurality of dropdown menus 74. A user may save the issue via a save button 76 or may cancel his or her input via a cancel link 78.

### Method of Use

A method of using a preferred embodiment will now be described. Specifically, consider a hypothetical wherein a firm has two offices, a Charlotte office and a D.C. office. Each office keeps independent billing records on disparate software. However, because of inefficiencies in maintaining and utilizing these records, the firm has decided to consolidate billing records, specifically by making all billing records available to a financial department located in the D.C. office.

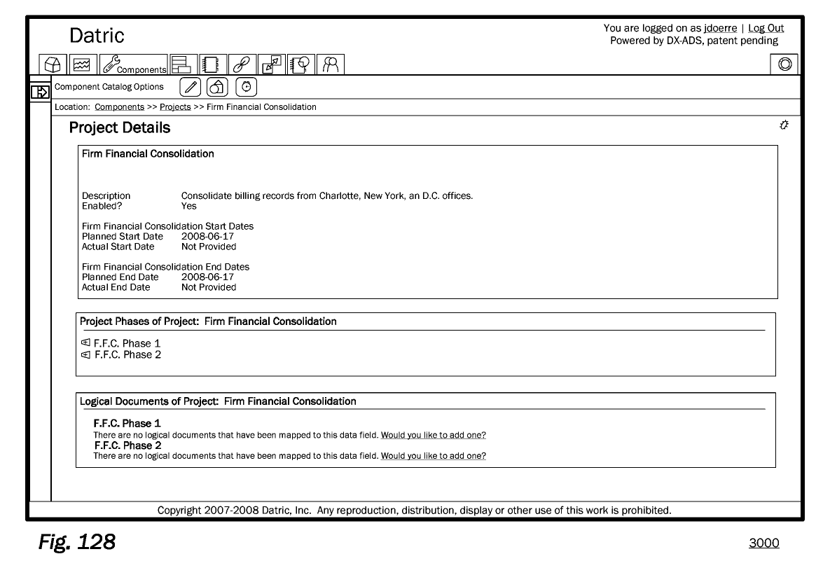

To accomplish this, a user first navigates to the project subpage 3320. On the project subpage 3320, a user may click on the add component button 3314 to display a project creation interface as described above. The user inputs a name and description of the new project to create via input fields, specifically the user may input “Firm Financial Consolidation” and “Consolidate billing records from Charlotte and D.C. offices.” The user may additionally enter the planned start date, planned end date, actual start date, and actual end date of the project via a plurality of drop down menus. The user then may select that the project is enabled and save the new project with a save button. The result is that the new project is displayed on the projects subpage 3320, as can be seen in FIG. 128.

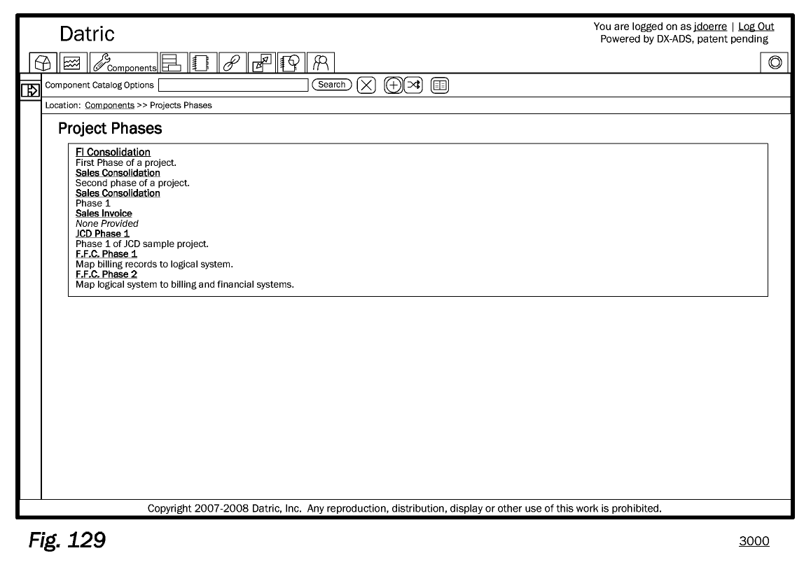

The “Firm Financial Consolidation” project may be easier to accomplish if broken into two phases, so the user may navigate to the project phase subpage 3360 and click on the add component button 3314 to display a project phase creation interface, as described. The user may select that the project phase is a part of the “Firm Financial Consolidation” project, input a name and description of a new project phase as “F.F.C. Phase 1” and “Map billing records to logical system” respectively. The user may then select a planned start date, planned end date, actual start date, and actual end date of the project phase and select that the project phase is enabled. The user additionally may select that the status of the phase is in progress. The result is that a new project phase has been created, as can be seen in FIG. 129.

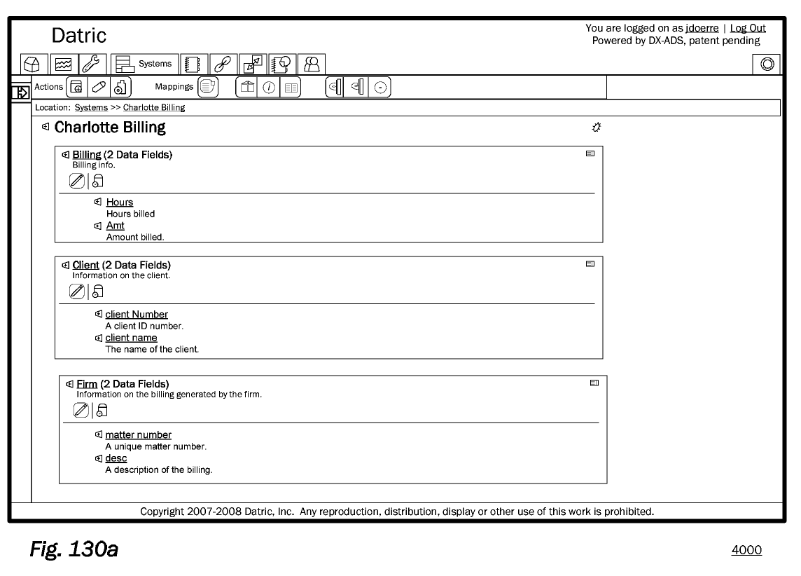

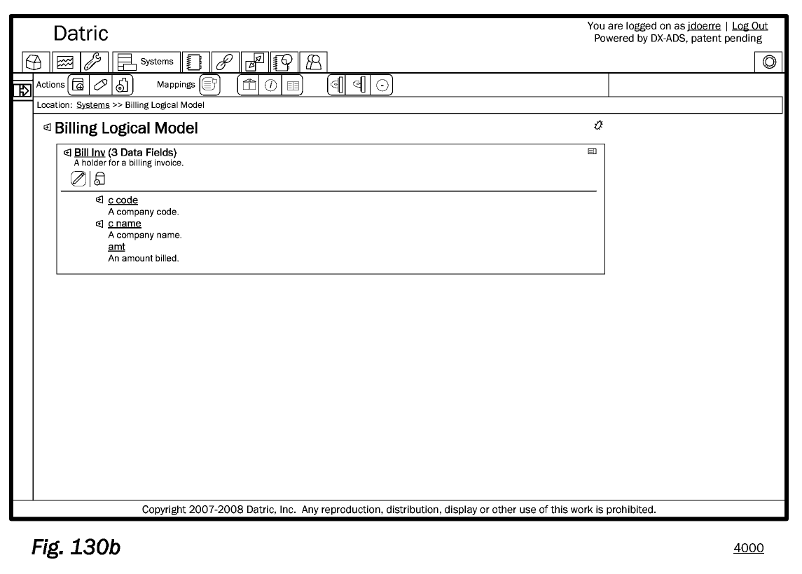

Next, the user may define systems within the website using the upload page 4320 of the systems tab 4000. The billing software used in Charlotte has three tables, each with two fields. A user may upload an excel spreadsheet that will load the application as a system within the website. A spreadsheet representing the Charlotte billing software may be seen in FIG. 84B. After uploading the spreadsheets, the system will be created in the website as can be seen in FIG. 130A.

The user may additionally create a Billing Logical System using the systems tab 4000. The user may click the add new system button 4022 to access the add new system page 4030 and create a Billing Logical System. The user further may add a Bill_Inv data table and c_code, c_name, and amt data fields, designed to hold a company code, a company name, and an amount billed respectively, as can be seen in FIG. 130B.

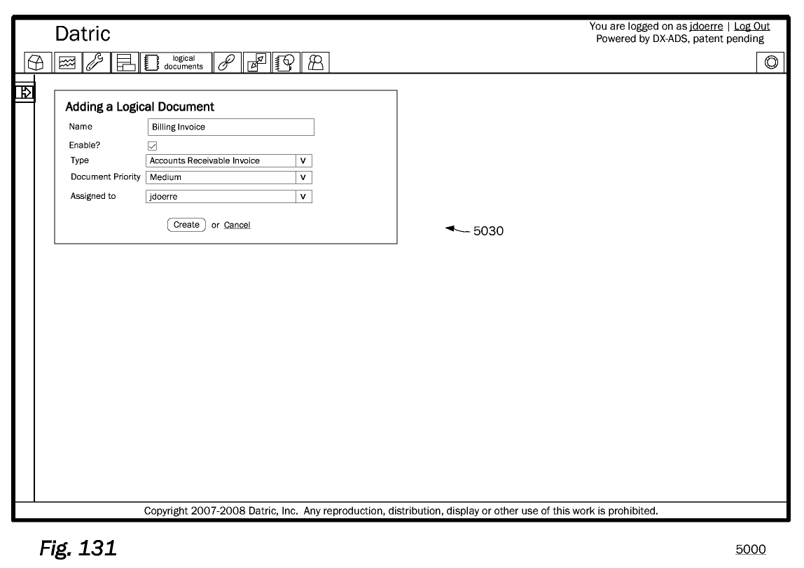

The user may then create a new logical document to map the Charlotte system to. To create a new logical document, the user may click the add new logical document button 5022 of the logical documents tab 5000 to access the add new logical document page 5030, which can be seen in FIG. 131. Specifically, a user may select the document type that matches the type of document he plans to create. It will be appreciated from the above description that if a user is not satisfied with any of the existing document types, a user may create a new document type via the components tab 3000. Here, a user may choose to select the document type “Accounts Receivable Invoice”.

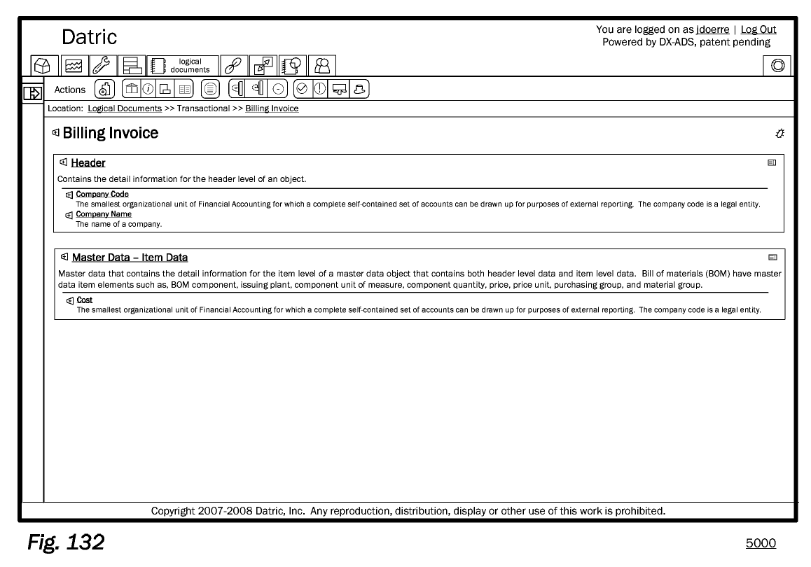

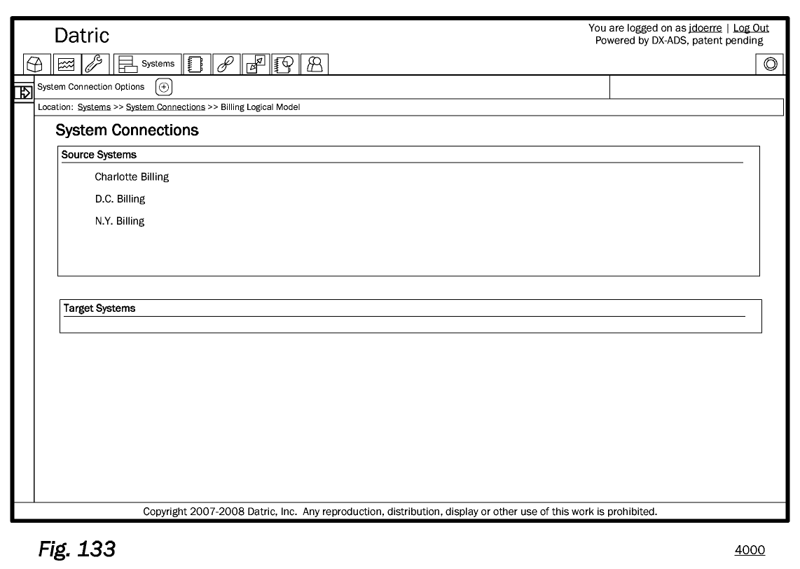

After creating the logical document “Billing Invoice”, a user may add document segments and business terms via the documents tab 5000. Specifically, a user may add a “Header” document segment having “Company Code” and “Company Name” business terms, and a “Master Data—Item Data” document segment having a “Cost” business term, as can be seen in FIG. 132. Next a user may change the work-status to “Waiting Approval” and assign an approver for the document. After the document has been approved, the user is ready to create system connections between the systems via the systems tab 4000. Specifically, the user may add the Charlotte Billing system as a source system of the Billing Logical Model, as can be seen in FIG. 133. The user may then associate the Billing Invoice logical document with this system connection via the relationships tab 6000.

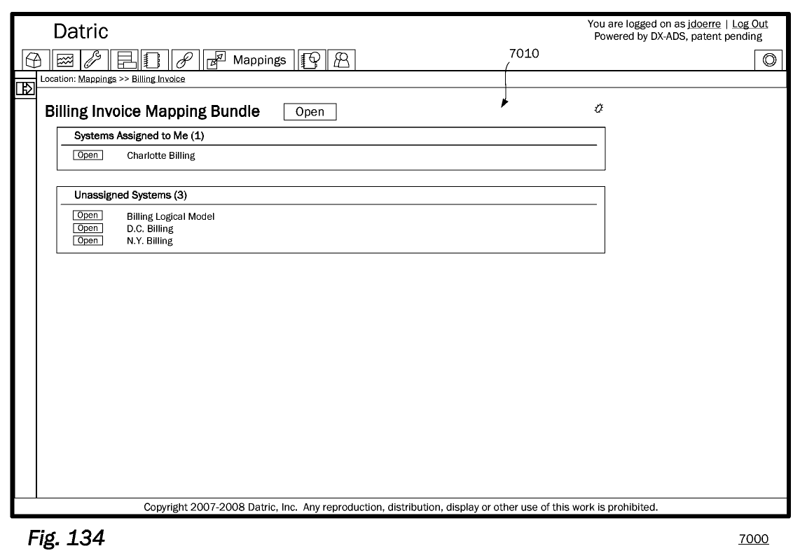

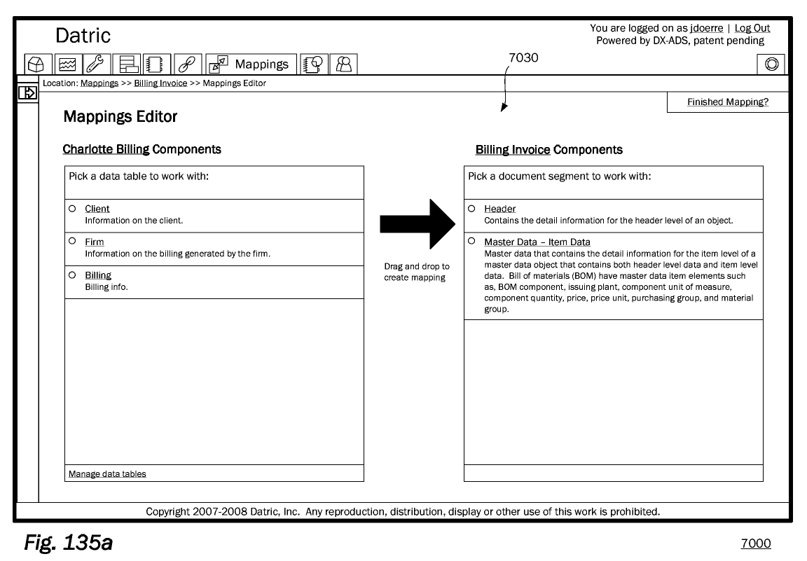

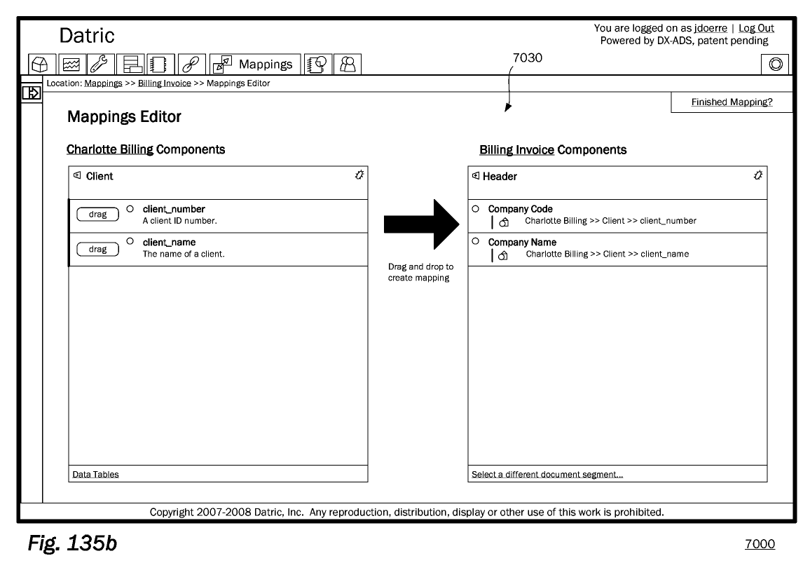

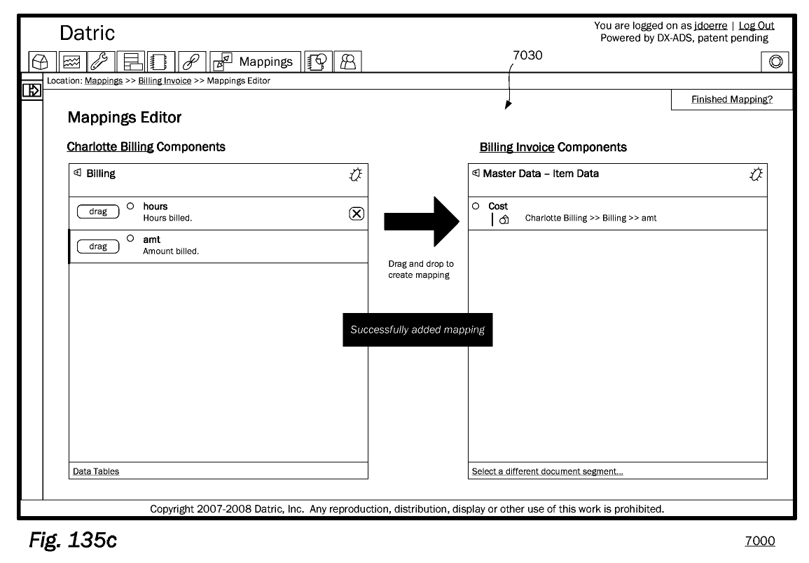

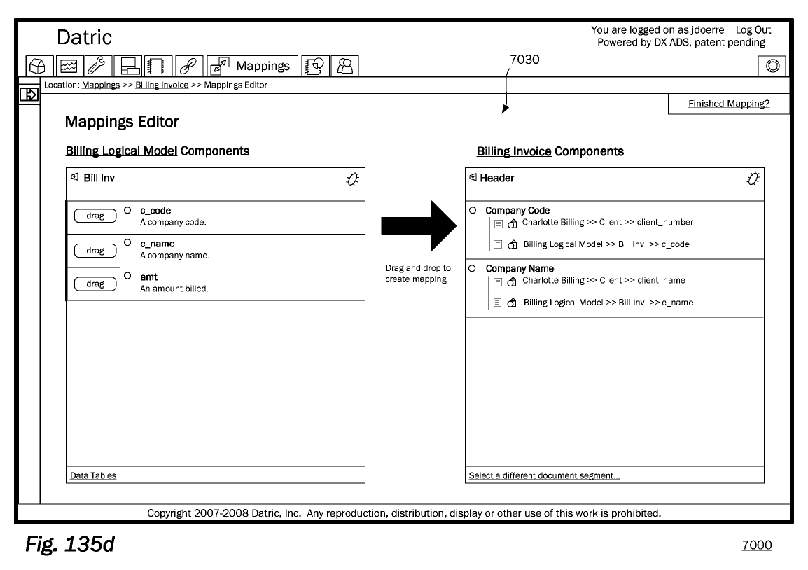

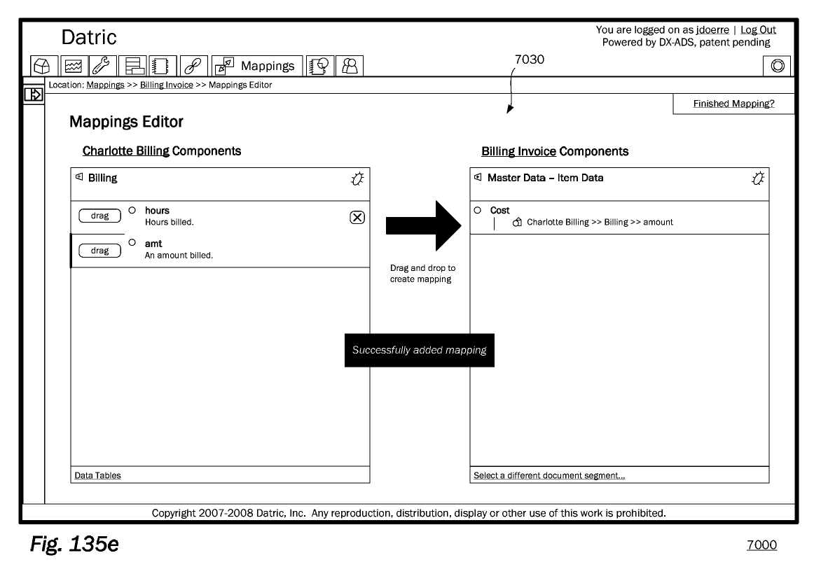

On the mappings tab 7000, the user may navigate to the mapping bundle subpage 7010 associated with the Billing Invoice logical document and assign the task of mapping the Charlotte Billing system to the document to himself or herself, which will cause the mapping bundle subpage 7010 to appear as displayed in FIG. 134. Utilizing the mappings editor page 7030, a user may map the client_number data field to the Company Code business term, may map the client_name data field to the Company Name business term, and may map the amt data field to the Cost business term, as can be seen in FIGS. 135A-C.

The user may then similarly map the Billing Logical Model to the Billing Invoice document, such that the data field c_code is mapped to the business term Company Code, the data field c_name is mapped to the business term company name, and the data field amt is mapped to the business term Cost, as can be seen in FIGS. 135D-E.

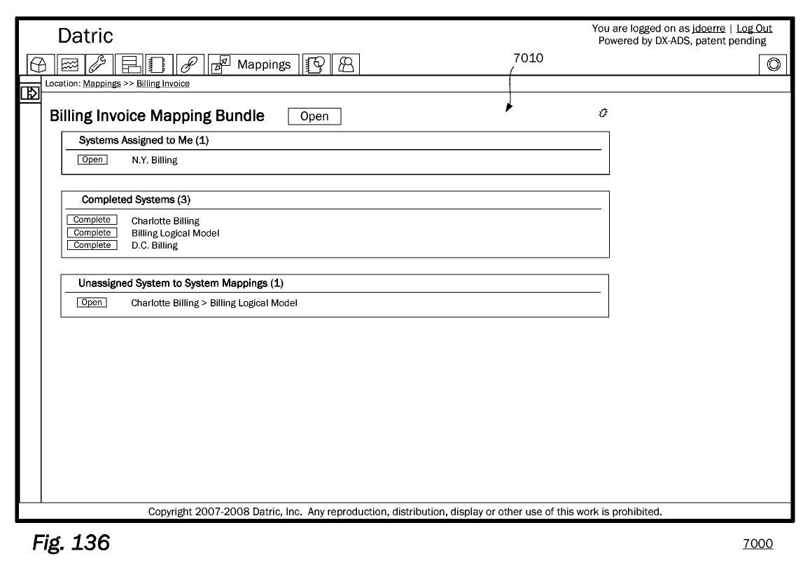

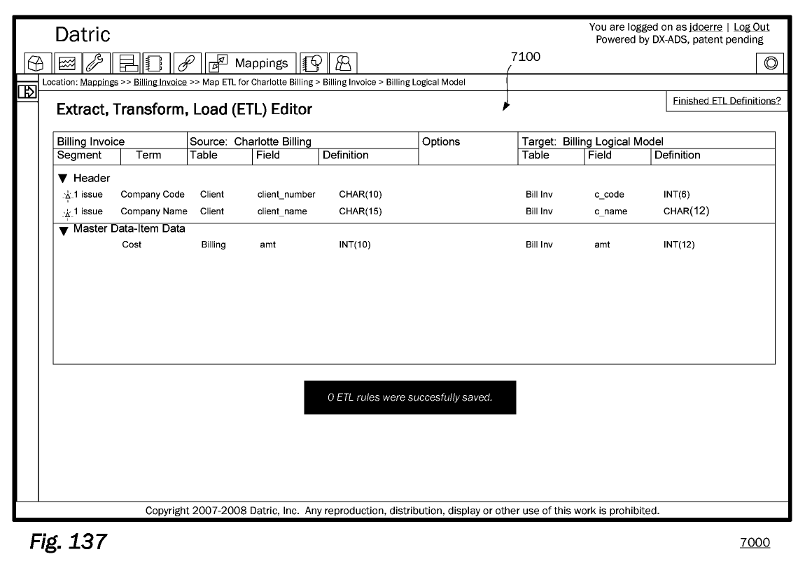

Following this, a new system to system mapping will be available, as can be seen in FIG. 136. The user may assign the system to system mapping and then proceed to the ETL editing page 7100, as can be seen in FIG. 137. On the ETL editing page 7100, there are two issues that the user must clear up via ETL rules. First, the data field client_number of the Charlotte Billing system is stored as characters with a maximum length of ten characters, but the c_code data field of the Billing Logical Model is stored as an integer with a maximum length of six digits. To resolve this issue, ETL rules must be added to convert the characters stored in client_number into an integer, and then the converted integer must be truncated to six digits, as can be seen in FIG. 138.

Second, the client_name data field of the Charlotte Billing system is stored as characters with a maximum length of fifteen, but the c_name data field of the Billing is stored as characters with a maximum length of twelve. To resolve this issue, an ETL rule must be added to truncate the c_name data field to a maximum length of twelve.

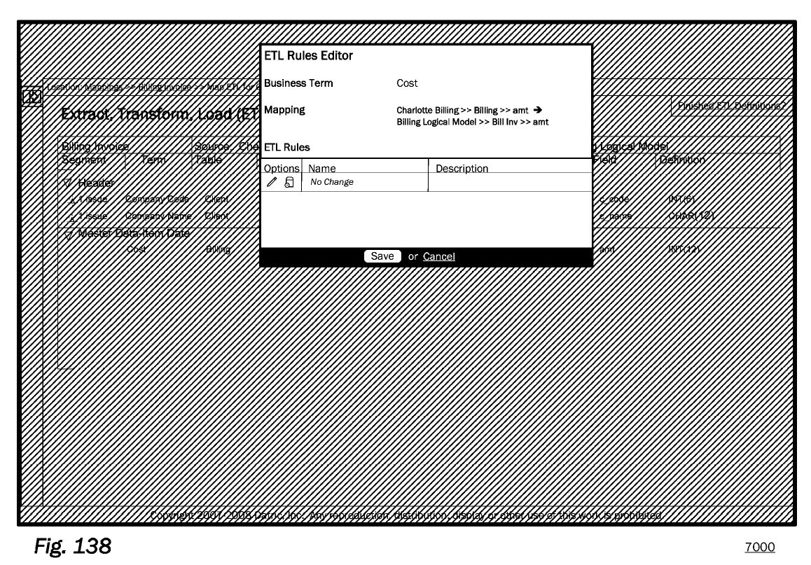

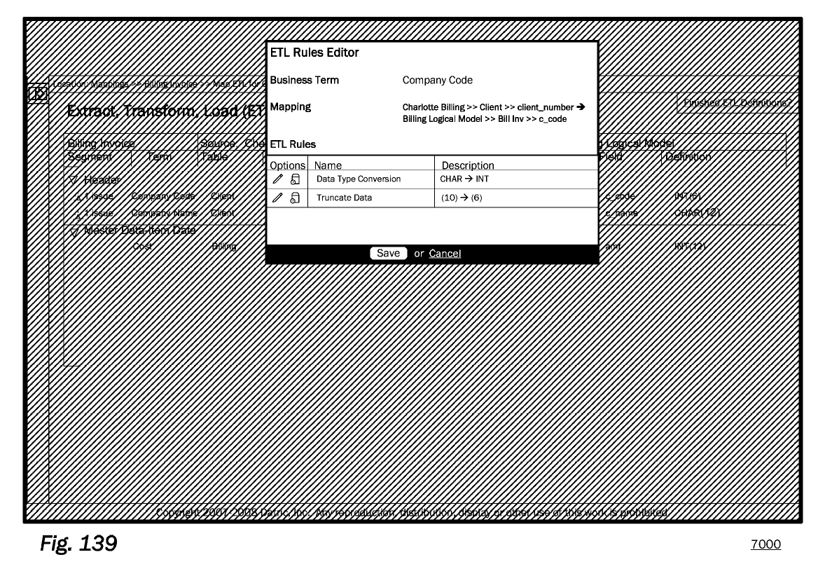

No ETL rules are required for mapping the amt field of the Charlotte Billing System to the amt field of the Billing Logical Model, so No Change is selected, as can be seen in FIG. 139.

These mappings and ETL rules may be used to generate a specification. Alternatively, it is contemplated that preferred software and platforms may generate ETL rules automatically. Further, it is contemplated that a physical model may be generated from a business or logical model of the preferred software and platforms, as described herein below.

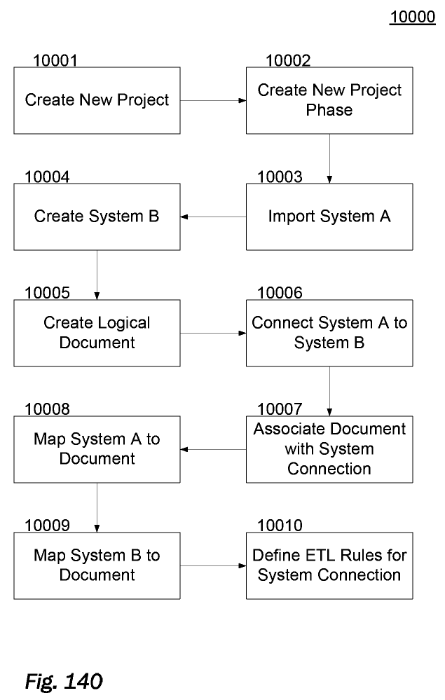

FIG. 140 is a flowchart of the method outlined above. More specifically, FIG. 140 is a flowchart of a process 10000 for mapping two systems to a logical document, and then creating extract, transform, and load rules for transforming data originating from a data field of the first system into a format acceptable for a data field of the second system. At step 10001, a user creates a new project. At step 10002, a user creates a new project phase. At step 10003, a user imports a first system, System A, having a plurality of data tables and a plurality of data fields, using a schema import. At step 10004, a user creates a second system, System B, and creates a plurality of data tables and a plurality of data fields of System B. At step 10005, a user creates a logical document having a plurality of document segments and a plurality of business terms. At step 10006, a user creates a system connection between System A and System B. At step 10007, a user associates the logical document with the system connection. At step 10008, a user maps data fields of system A to business terms of the logical document. At step 10009, a user maps data fields of system B to business terms of the logical document. At step 10010, a user defines ETL rules for the system connection via the logical document.

### ETL Code Generation

Traditionally, a specification is referenced by one or more programmers to write ETL code segments based on relationships detailed in the specification. The ETL code segments are written to extract data having data attributes from a first data system, transform the data such that the data attributes are those desired for a second data system, and load the transformed data into the second data system.

More specifically, data is stored in a first system in a data field. A second system has need of that data. The specification provides information on where the data is stored in the first data system, i.e. a reference to a certain data field of the first data system. The specification further provides information on where the data is to be loaded into the second system, i.e. a reference to a certain data field of the second data system. The specification still further provides format information relating to the data attributes of the data stored in the certain data field of the first data system, and information relating to desired data attributes for data storage in the certain data field of the second data system. Traditionally, a programmer would review the specification, and then write ETL code segments that would extract the data from the certain data field of the first data system, transform the data from the first format to the desired format, and load the transformed data, into the certain data field of the second data system. ETL code segments may also be written defining a value, including a default value, of a data field.

It is contemplated that one or more embodiments of the present invention would automatically generate ETL code segments from mappings and/or a specification (which may itself be embodied in preferred software and platforms) generated in accordance with an embodiment of the present invention. More specifically, a user may import or define a first system and a second system, and data tables and data fields of each system. Each of the first and second systems has a system type. A user may further define a logical document, and document segments and business terms of the logical document. A user may then define a system connection between the first and the second systems, associate the logical document with the system connection, and map a certain data field of each of the first and second systems to a business term of the logical document. Each of the certain data fields may have defined data attributes. It is contemplated that a code segment generation function may be written. The generation function may receive as inputs the data attributes of each of the first and second systems and/or an ETL rule input into preferred software and platforms by a developer. The generation function would then generate a T-code segment for conversion of data from the data attributes of the first system to the desired data attributes of the second system. It will be appreciated that some types of conversions from first particular data attributes to second particular data attributes may be repeatedly required. A plurality of common conversion algorithms may be incorporated, such that when the generation function receives as inputs the first particular data attributes and the second particular data attributes, one of the plurality of common conversion algorithms, or a derivation thereof, may be output as a T-code segment. Additionally, it is further contemplated that a user may define additional conversion algorithms that may be utilized similarly to the common conversion algorithms. It is similarly contemplated that multiple algorithms may be chained together to create a desired T-code segment. For example, a first conversion algorithm may convert data with data attribute A to data with data attribute B, and a second conversion algorithm may convert data with data attribute B to data with data attribute C. It is contemplated that if the generation function receives as inputs data attributes A and data attributes C, a T-code segment comprising the first and second conversion algorithms, or derivations thereof, may be output. A lookup table, or equivalent, may be utilized to trace conversion paths through multiple algorithms, both to determine whether a specific conversion is possible using a given plurality of algorithms, as well as to determine a most efficient conversion path utilizing multiple algorithms. Efficiency may be measured either by a number of algorithms that must be utilized, or alternatively by a plurality of efficiency metrics corresponding to each algorithm. These efficiency metrics may be pre-stored or pre-generated, or may be generated at run-time.

It will be appreciated that the T-code segment output by the above described generation function may itself be a desired deliverable, or alternatively may be utilized in a larger ETL code segment. The ETL code segment may additionally include an E-code segment generated for extraction of data from a data field of the first system. It will be appreciated that some types of extractions from a particular system type may be repeatedly required. A plurality of common extraction algorithms may be incorporated, such that when the generation function receives, as input, the particular system type, one of the plurality of common extraction algorithms, or a derivation thereof, may be output as an E-code segment. Additionally, it is further contemplated that a user may define additional extraction algorithms that may be utilized similarly to the common extraction algorithms.

The ETL code segment may include an L-code segment generated for loading of data into a data field of the second system. It will be appreciated that some types of loadings into a particular system type may be repeatedly required. A plurality of common loading algorithms may be incorporated, such that when the generation function receives, as input, the particular system type, one of the plurality of common loading algorithms, or a derivation thereof, may be output as an L-code segment. Additionally, it is further contemplated that a user may define additional loading algorithms that may be utilized similarly to the common extraction algorithms. It is still further contemplated that this L-code segment may include a default value to load into the data field when specified conditions are met. These conditions may be generated by the system or defined in a specification embodied by preferred software and platforms.

It is additionally contemplated that the output of this generation function may be in any number of formats, including, but not limited to, object language, machine language, and/or formats associated with XML, SQL, Java, C, C++, JavaScript, Perl, and/or C#.

### Model Generator

In at least some embodiments of the present invention, preferred software and platforms may include a model generator. The model generator may be used to generate data models from a set of enabled documents, enabled terms, relationships between the documents and defined rules for model creation. The model will be generated in the form of entities (or tables) and attributes (or fields).

Entities (or tables) and attributes (or fields) will be named according to naming standard rules. The default naming convention is “Document Name—Segment Name” for a table and “Business Term” for the field.

The generation process is a multiple-pass process similar in concept to a software compiler. The number of passes may be increased or decreased as needed to comply with desired abilities and outcomes.

During the generation of the model, the entities or tables created must be unique. While there may be multiple opportunities to create, it is expected that the process will always first check for existence. If the entity or table does not exist, then it will be created.

Models will be stored with at least the following attributes: Model name; Version identifier; Date and time stamp; Created by user name; and Model Status. It is contemplated that models may be compared and the differences indicated, either in a textual, graphical, or other visual format.

It is contemplated that models may be exported as SQL code instructions and/or XML.

A process is next described whereby a data model may be generated.

First, enabled documents are selected. Filter criteria based on Project, Version Status, Business Area, etc. may be provided at this point. Next, a temporary table with an entry for each enabled document is created, and the document type of each enabled document stored.

Next, all documents with a transaction document class are selected. For each document: a table definition is created for each enabled segment within the document using the naming convention; a table definition is created for each enabled business term within the segment using the naming convention; and primary and foreign keys and nullable attributes as defined by the business term are applied.

Then, all documents with a master document class are selected. For each document: a table definition is created for each enabled segment within the document using the naming convention; a table definition is created for each enabled business term within the segment using the naming convention; and primary and foreign keys and nullable attributes as defined by the business term are applied.

Further, all documents with a reference document class are selected. For each document: a table definition is created for each enabled segment within the document using the naming convention; a table definition is created for each enabled business term within the segment using the naming convention; and primary and foreign keys and nullable attributes as defined by the business term are applied.

Still further, all documents with a transaction document class are selected. For each document: business terms with foreign key indicators are selected; and associative tables are created to relate transaction documents as required.

Further yet, all documents with a master data document class are selected. For each document: business terms with foreign key indicators are selected; and associative tables are created to relate master data documents as required.

Following this, normalization rules are applied to the code set as required, and database brand-specific rules are applied as required.

The model generator may be used to generate logical models and physical models from the systems and documents of the preferred software and platforms.

It will be appreciated that in traditional data management, logical models of a data-system are created to insure integrity, consistency, and accuracy of data within the data-system, and to eliminate repetitious data.

It is contemplated that a logical model may be generated from system, document, and relationship data stored in the preferred software and platforms. More specifically, the preferred software and platforms may comprise a number of systems having data tables and fields and documents having segments and business terms. Systems may be connected together by system connections. Documents may be associated with system connections, and then systems may be mapped to documents by mapping data fields to data tables. The universe of documents associated with system connections and having documents mapped to them may be considered a business model.

It will be appreciated that in many respects, this business model already accomplishes one or more purposes of a traditional logical model. However, it is contemplated that this business model may be normalized to a logical model by applying a plurality of process rules. It will be appreciated that although logical modeling is well known, levels of normalization, and definitions of such, are not always agreed upon by experienced modelers. A business model may be normalized to varying levels based upon the desires of a user to create a logical model.

Further a logical model, or a normalized business model, may then be denormalized to generate a physical model based on a specification, or alternatively on data representing a specification embodied in or displayed by the preferred software and platforms.

It will be appreciated that a key issue in both normalization and denormalization is the extent of desired repetition. Although a logical model aims to completely eliminate repetition, and instead create relationships and links to data, in a business or physical model it may be more practical to include some repetition. For example, if a client name data field is contained in a large invoice data table, although a logical model would link to the client name data field rather than duplicating a client name entry, it may be more efficient to create duplicate client name entries in a contact list data table, rather than having to load the large invoice data table just to retrieve the client name value. In at least some embodiments, the model generation process asks for user input, specifically validation of whether to create repetitious fields.

In at least some embodiments of the present invention, the preferred software and platforms may include methods of project management and/or a project configurator for implementing these methods Traditional project management views a project as a finite endeavor with fixed goals. This traditional approach, however, is inadequate to manage data-driven businesses where both business processes and technical systems are constantly evolving. Unlike traditional project management tools, the project configurator allows this evolution to be viewed from a business perspective, a technical perspective, or both.

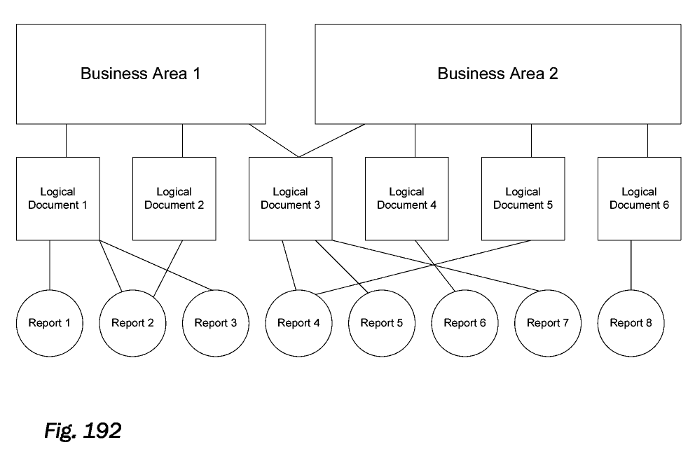

FIG. 192 is a simple example of extensible, pre-defined content that is included in the preferred software and platforms. The rectangular shapes represent business model constructs within the system while the circular shapes represent physical data constructs, in this case, reports. For the sake of clarity, only a few objects have been illustrated, and other types of constructs have been omitted. This is true throughout this section.

Lines between objects represent connections—as one moves UP the page from one level to the next it is accurate to say that an object is contained and/or constructed by the object(s) linked above it. For example, Report 2 is constructed by information contained in Logical Document 1 and 2. Logical documents 1 and 2 are both contained in Business Area 1. For the sake of clarity, document segments, business terms, data tables, and data fields are not depicted. This is true throughout this section.

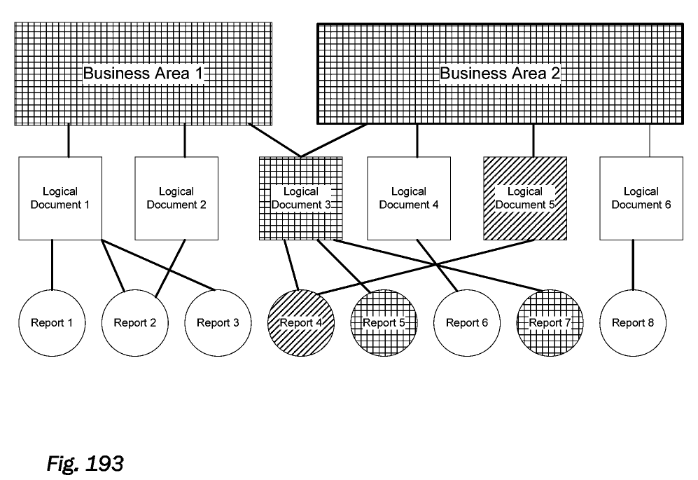

Starting from any object in FIG. 192, all other objects linked to it can be derived. Further, it can easily be determined at a glance what additional objects could be easily extended to. For example, it can be clearly seen that Logical Document 3 is used in Business Area 1 and Business Area 2 and contains all of the information needed for Report 5 and Report 7. This information is presented with shading in FIG. 193, but it is contemplated that this information may be presented with colors.

Further, it can easily be seen that part of the information needed to construct Report 4 is available. By using Logical Document 5 in conjunction with Logical Document 3, it would be possible to construct Report 4. This information is diagonally shaded.

In a similar manner, starting with either physical constructs and/or other business constructs, it can easily be determined how to construct an object and/or what else is possible from constructing the object.

Extending this example more generally to what is possible with the preferred software and platforms, starting with any level of granularity on any object it is possible to know immediately how to construct the object and/or what else can be constructed by it.

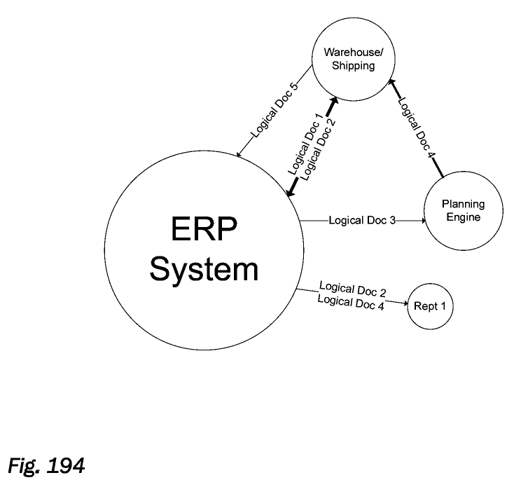

Because business constructs and physical system constructs are linked within the preferred software and platforms, a user may view a project from a business perspective, technical perspective, or both, as can be seen in FIG. 194. In embodiments in which a change log and audit trail are included, a user may view the business or technical state of an entire landscape at any point in time, including what was, what is, and what will be.

Further, it is possible to graphically depict a size of a system, a number of documents in a system connection, or a number of business terms in a logical document. Any changes may be immediately updated in the graphical representation.

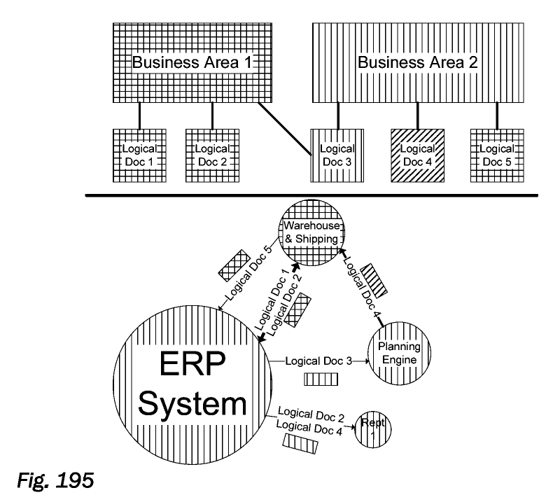

Utilizing the fact that the preferred software and platforms track statuses at every level of granularity in the system, i.e. statuses of both complex objects and of simple objects making up the complex objects, the preferred software and platforms can display the completion status of any object in the system from any perspective—business or technical. As can be seen in FIG. 195, project management stats may be depicted by a graphical representation. Dark shaded indicates that an object or connection is complete, light shaded indicates that it is in work, and diagonal shaded indicates that it has not been started.

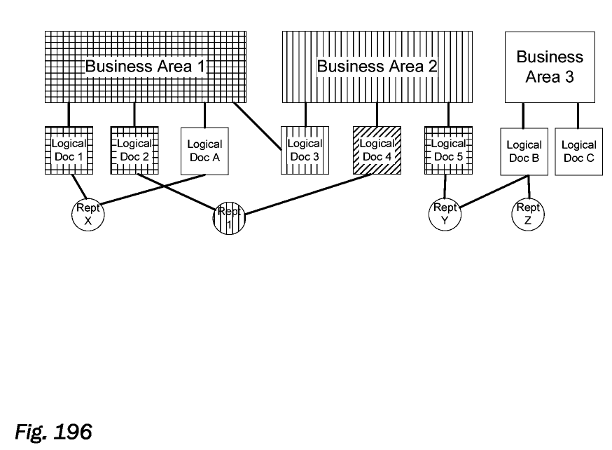

Utilizing pre-defined business model content, depicted as the white objects, possibilities for changes and their impact can be easily viewed, as can be seen in FIG. 196.

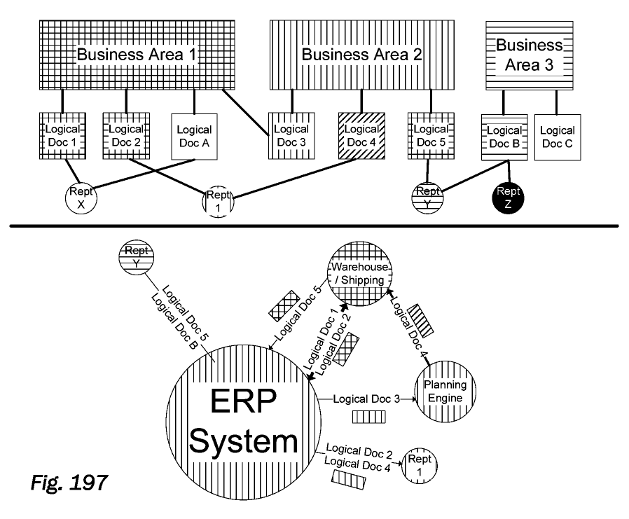

It can be easily seen that some of the data needed for Report Y is already available. By enabling Report Y the planner sees that she needs Logical Document B in Business Area 3, as can be seen in FIG. 197. Using the graphical interface, the planner drags report Y to the system diagram (below) and makes a connection between the ERP system and Report Y. Planned objects are depicted as lined. Report Z (black) is a possible area for expansion when Document B is enabled, which can be clearly seen from the graphical interface.

This graphical interface allows the pre-defined content of the preferred software and platforms to be utilized to perform ‘what if’ scenarios and then integrate them into the planned work so they may be managed.

### Expression Builder

In at least some embodiments of the present invention, the preferred software and platforms may include an expression builder. One important goal of the expression builder is to have an easy way to create new terms of business meaning (i.e., new business terms, often referred to as “derived terms”) from the existing business terms and documents. Expressions, utilizing mathematical operations, logical operations, and the like, are used to build definitions for derived terms. Derived terms are composed of one or more business terms (sometimes referred to as “base” terms) with some type of modifier. Examples of derived terms may include weekly sales (based at least on some measure of sales and some measure of time), percentage sales by large customer (based at least on some measure of sales and some measure of customer size), average selling price (based at least on some measure of selling price and some measure of number of units or the like), gross price, net price, and perfect order. Derived terms are typically used for reporting, dashboards and KPI's. They are not the base data collected in the transaction, but are composed of basic business terms. Derived terms would not be in a document, but for a derived term to be available in a report, all of the business terms comprising the derived term must be active and available.

The complexities of deriving new business terms from existing business terms may be illustrated using the example of weekly sales. First, to define weekly sales, information such as when the week begins, when the week ends, what constitutes a sale, and what is being counted may all be necessary. Further, although the date range to define start and end time seems to be straightforward, it is still tied to the issue of what constitutes a sale. This, in turn, raises still further questions, issues or the like. For example, a determination must be made as to when the sales are considered an actual sale—i.e., it must be determined whether each sale takes place when the original sales order is received or when the sales order is invoiced. If the criteria for a sale is to ship and invoice, the week's sales should be based on shipment or invoice dates, not the order received date. Further, a determination must be made as to whether the sales number is a quantity as in “we invoiced for 1000 units,” a currency amount, or something else. If the currency amount is being totaled, a determination must be made as to what “price” is used—unit price, price with tax and shipping, or the like. Clearly, there may be considerable complexity in the selection of base business terms.

In one proposed implementation, the business term creation page 5520 is modified by adding a “derived term” link, which if clicked causes a derived term creation page to be displayed. Such a page preferably includes appropriate fields, inputs and the like for a user to enter a derived term name, derived term description, an expression text box, controls for selecting operators, documents and document terms, and buttons or the like for saving the derived term or canceling and returning to the business term creation page 5520. When established, each derived term preferably has a business term type of “derived” and is defined in terms of existing business terms, which in at least some embodiments may be either pre-existing business terms or other derived business terms.

Alternatively, an interface may be provided that permits a user to create a new derived term merely by typing the entire expression, including all operators and underlying business terms, into a text box. Such an interface is easier to implement, but may be less preferred because of human error entering the entire expression manually.

In an additional feature, expressions may make temporary use of “placeholders,” which may be arbitrarily-set character strings, plain text, or the like, to indicate term requirements that are currently missing. Such placeholders become work items to be evaluated and scheduled.

In another additional feature, expressions entered by a user are validated before being added to the list of defined derived terms. For example, if an expression is entered that includes mathematical modification of another term, that term may be required to be of a term class that allows math (quantities and amounts).

In still another additional feature, a visual representation of the expression is provided that incorporates document version status, work status and term enablement.

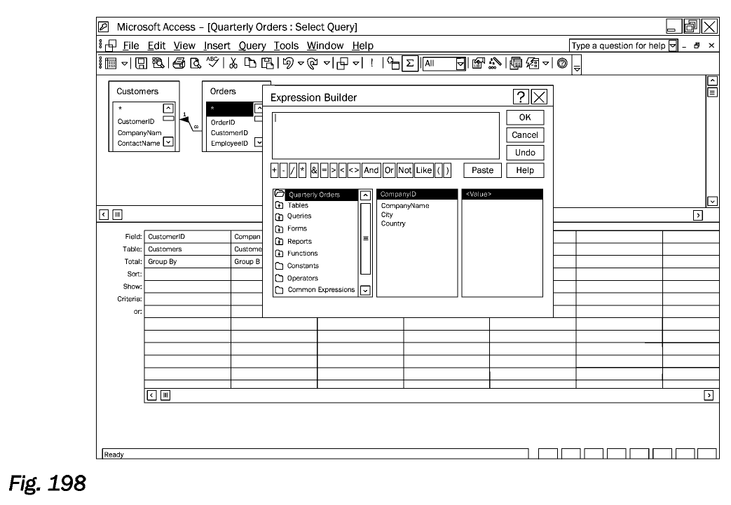

In one embodiment, the expression builder tool of the present invention provides functionality similar to that provided in the Access database software application available from Microsoft Corporation, Redmond, Wash. FIG. 198 is a screenshot from the Access database software application, illustrating an expression builder tool.

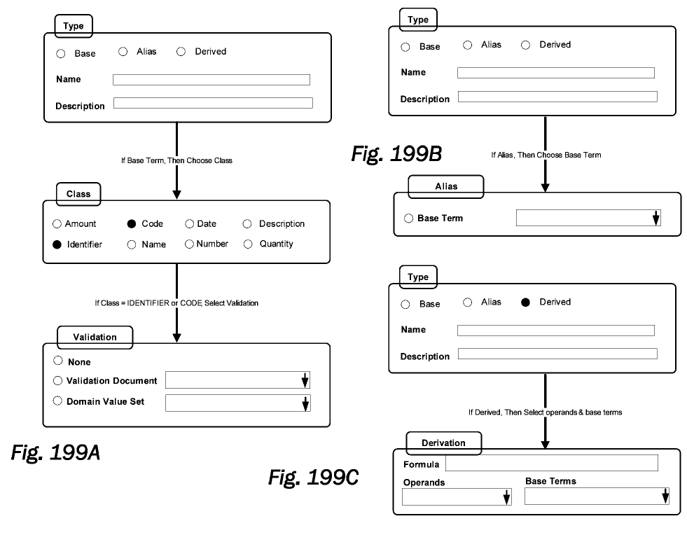

Particularly if use is made of aliases (i.e., alternative names) for business terms, then the business term creation page 5520 may further include radio buttons or the like for controlling whether the term to be added is a business term itself (alternatively referred to as a “basic term” in at least some embodiments), a business term alias (alternatively referred to as a “term alias” in at least some embodiments) or a derived term. In this regard, FIG. 199A is a series of exemplary screenshots illustrating the entry of a base business term, FIG. 199B is a series of exemplary screenshots illustrating the entry of a business term alias and FIG. 199C is a series of exemplary screenshots illustrating the entry of a derived business term. It will be appreciated that each series begins with the same input screen, wherein “base,” “alias” or “derived” is selected respectively, and the other screens in each series illustrate the progression of screens used to input the selected business term type.

The following Table 5 sets forth various exemplary derived term expressions available in at least some embodiments of the present invention.

TABLE 5

| Expression | | | |
|---|---|---|---|
| Group | Symbol | Name | Meaning |
| Sequence | ( | Left | Indicated the beginning |
| Operators | | Parentheses | of an evaluation sequence. All |
| | | | terms within the parentheses |
| | | | are evaluated as a unit. |
| Sequence | ) | Right | Indicated the end of an |
| Operators | | Parentheses | evaluation sequence. All |
| | | | terms within the parentheses |
| | | | are evaluated as a unit. |
| Math | + | Add | Add the term on right |
| Operators | | | side of the operator to the |
| | | | term on the left side of the |
| | | | operator. |
| Math | − | Subtract | Subtract the term on |
| Operators | | | right side of the operator from |
| | | | the term on the left side of the |
| | | | operator. |
| Math | / | Divide | Divide the term on left |
| Operators | | | side of the operator by the |
| | | | term on the right side of the |
| | | | operator. |
| Math | * | Multiply | Multiply the term on |
| Operators | | | right side of the operator by |
| | | | the term on the left side of the |
| | | | operator. |
| Math | SUM ( ) | Sum | Sum the term or |
| Functions | | | expression within the |
| | | | parentheses. |
| Math | COUNT ( ) | Count | Count the term or |
| Functions | | | expression within the |
| | | | parentheses. |
| Math | AVERAGE | Average | Average the term or |
| Functions | ( ) | | expression within the |
| | | | parentheses. |
| Math | MIN ( ) | Min | The minimum value |
| Functions | | | found for the term or |
| | | | expression within the |
| | | | parentheses. |
| Math | MAX ( ) | Max | The maximum value |
| Functions | | | found for the term or |
| | | | expression within the |
| | | | parentheses. |

In another additional feature, expressions entered by a user are validated before being added to the list of defined derived terms. For example, if an expression is entered that includes mathematical modification of another term, that term may be required to be of a term class that allows math (quantities and amounts).

In still another additional feature, a visual representation of the expression is provided that incorporates document version status, work status and term enablement.

The following Table 6 sets forth various exemplary additional operators and functions available in at least some embodiments of the present invention.

TABLE 6

| Function | | | |
|---|---|---|---|
| Group | Symbol | Name | Meaning |
| Conditions | = | Equal | |
| Conditions | > | Greater | |
| | | than | |
| Conditions | < | Less than | |
| Conditions | < > | Not equal to | |
| Logical | AND | | |
| Logical | OR | | |
| Logical | NOT | | |
| Logical | LIKE | | |
| String | CONC( ) | Concatenate | |
| Functions | | | |
| String | TRUN( ) | Truncate | |
| Functions | | | |
| String | PAD(term, | Pad With | |
| Functions | value) | | |
| String | TRIM(term, | Trim | |
| Functions | value) | | |
| String | REPLACE(term, | Replace | |
| Functions | value) | With | |
| String | L- | Left Justify | |
| Functions | JUSTIFY(term) | | |
| String | R-JUSTIFY | Right | |
| Functions | (term) | Justify | |

Using the foregoing teachings and principles, it will be appreciated, continuing the example from above, the sales invoice document terms required to established a new derived term “weekly sales” include Sales Invoice, Transaction Header, Billing Date and Sales Invoice, Transaction Line, Document Currency Net Value. An expression for weekly sales may be set forth as follows:

Weekly Sales=SUM(Sales Invoice>>Transaction Line Item>>Document Currency Net Value)

Building upon the basic features and capabilities of the preferred software and platforms as a foundation, the expression builder becomes a very powerful tool not only for documentation, but for defining work effort and requirements. It will be appreciated that an expression builder as described herein may be used to establish derived terms, as a report and analytic specifications builder, and for possible extensions to existing ELT rules.

### Control Log

The preferred software and platforms includes a plurality of user-editable components. Further, the preferred software and platforms allow a user to define logical documents, document segments, business terms, systems, data tables, data fields, and system connections. A user further can associate documents with system connections, and map data fields to business terms. Regardless of the action taken or the element affected, when a user makes a change within the preferred software and platforms, it is recorded to a control log. More specifically, an identification of the user is recorded, together with data relating to the change, when the change occurred, the state or value prior to the change, and the state or value following the change.

### Business Terms

In at least some embodiments, business terms can be defined as either a standard business term, having a primary name and definition, or else as an alias, which is a new business term that is linked to an existing standard term. A business term includes an alias flag attribute, a derived flag attribute, a time/date creation attribute, and a created by attribute.

When a user is selecting business terms to add to a logical document, alias business terms will be presented to the user for selection, however, after selecting the alias term, the alias term is replaced by the standard business term it is associated with.

Business terms can be classified into classification groups to help ensure consistency of names and definitions. Business terms in a document can be: enabled or disabled, mandatory or not, a primary key, a foreign key, and nullable or not, i.e. able to be set to a value of null.

Business term names and definitions can be changed at any time without having an impact on mapping. Likewise, business terms in documents can be replaced through editing, but that will not impact existing mappings.

A number of validations exist for business terms. First, duplicate terms cannot be added, because a name check is utilized to ensure two business terms do not have the same name. Likewise, duplicate aliases cannot be added. Further, a business term cannot be deleted or changed if the business term is associated with an active document. As to aliases, aliases can only be created for standard business terms, aliases may not be created for other aliases.

It is contemplated that an approval process be added to business terms, such as exists for design or mapping.

### Utilities

It is contemplated that a spell checker may be incorporated into the preferred software and platforms for all forms and fields. It is further contemplated that derived business terms may be included in an enterprise glossary. A definition rating system is further contemplated, whereby each definition may be given a rating.

### Graphics

In at least some embodiments of the present invention, system to system relationships are maintained as a source target pair under a systems tab. A graphical diagram is contemplated that will display all pairs and the inter-relationships one level from a system perspective. In at least some embodiments, this display will be a simple line and box diagram, but in alternative embodiments this display may include a representation of logical documents associated with the relationship. It is further contemplated that: system to system relationships will be able to be added using drag and drop functionality; a system type will be displayed graphically; a user will be able to click on a system to system connection line to view the documents associated with the relationship; and an indicator of whether a system is enabled or disabled is displayed.

In at least some embodiments of the present invention, a business process diagram is displayed for business processes. This business process diagram can be displayed as a linear sequence of documents involved in the business process, but it is contemplated that the business process diagram will include branching functionality. Further, it is contemplated that documents may be added, moved, or removed using drag and drop functionality, document enablement status may be displayed, the display may be limited to transactional documents, details associated with a document may be displayed upon clicking on the document, and a phase of the document can be displayed.

### Business Term Validations and Domains

During the design stage (configuration and document design), documents and all supporting objects and object relationships must be created and/or maintained. Establishing and preserving the relationships between documents, particularly the relationship between transaction, master data and reference documents, is very important. To increase the effectiveness of maintenance and increase quality and accuracy, critical relationships are maintained at the business term level. By establishing these relationships on the basis of the business terms, the relationships are automatically in-place when terms are enabled and used in documents. Changes to term names and term definitions have no impact on the relationships themselves and thus require no maintenance further downstream. Changes to term relationships are immediately available in the document as well.

In order to ensure that that new and edited business terms and their relationships are valid, at least some embodiments of the present invention preferably utilize at least a two-part approach. In one part of the approach, validation takes place of the relationship of business terms values to another document definition representing a table of values (sometimes called a “check table”). Validation against another document is used when values may change over time and/or require many entries. Examples include customer numbers that may be validated and/or require additional information from the customer master. In this regard, it will be appreciated that the number of customers often varies over time and cannot be pre-defined. On the other hand, in another part of the approach, business term values are validated against a fixed-value domain set of values. It will be appreciated that fixed-value domains are common for many terms. One example of a fixed-value domain is the simple set of (Yes, No), which often represents a large percentage of these terms.

Described very generally, the process for associating validation parameters with a business term can be described as follows. First, a business term is created or edited as desired. The user sets the term class for that business term to identifier or code and adds a validation document or fixed value domain set, as appropriate. Finally, the business term is saved. Preferably, validations as to change impacts can be assessed prior to saving the change.

Defined as the relationship between business terms and supporting documents in the ADS business model (object abstraction layer), whose ultimate use is to document how data values are checked and verified during data movement. The abstraction is composed of objects in the form of document type, segments, and business terms. To gather requirements, terms in the document are enabled or disabled as needed. Terms can be added or deleted from the document.

Business terms can be used in multiple documents. To determine what documents are necessary for a project, it is necessary to understand the relationship of terms and documents. Specifically, terms of the class “identifier” and “code” reference other documents.

It is common for master data and reference documents to be widely used. Once defined as required by a single document, the supporting document is available to all documents. In this manner, work scope can be accurately defined and monitored through additional ADS project management components.

In addition to describing potential work or reuse, these related documents describe how the data will be validated. The validation of data values is necessary in productive operations to assure accuracy and data integrity.

Rather than re-define all of the necessary relationships to supporting documents for each document term, the appropriate validation tables and domains are added at the term level.

The business-term-to-validation-documents process may be illustrated using a sales order document as an example. The logical steps of the process used in the program to display the appropriate related documents may be as follows. First, a business term local table is created with all business terms within a sales order. A Related Logical Document is assigned for each enabled business term that has a related document. The Business Term table and the logical document for Sales Order and joined, the Related Logical Document is joined to the Logical Document table to get the Document Class (Transaction, Ref. Master Data), the Sales Order Related Logical Documents is joined to the Reference Logical Documents to get the primary key fields needed from the Reference Logical Documents, and the Sales Order Related Logical Document is joined to the Master Data Logical document to get the primary key fields needed from the Master Data Logical Documents.

The sample SQL code below adds the ability to query fixed value domains as well as validation tables.
1. Create a table with the detail (enabled segments, enabled business terms) for a logical document version and name it Logical Document Detail:
   SELECT logical_document_instances.id, logical_documents.name AS [Logical Document], logical_document_instances.version, document_segment_instances.document_segment_id, document_segments.name AS [Document Segment], business_terms.id, business_terms.name AS [Business Term], document_segment_instances.enabled, document_segment_instance_terms.enabled, document_segment_instance_terms.position INTO [Logical Document Detail] FROM (document_segment_instances INNER JOIN ((logical_documents INNER JOIN logical_document_instances ON logical_documents.id=logical_document_instances.logical_document_id) INNER JOIN (business_terms INNER JOIN document_segment_instance_terms ON business_terms.id=document_segment_instance_terms.business_term_id) ON logical_document_instances.id=document_segment_instance_terms.logical_document_instance_id) ON document_segment_instances.id=document_segment_instance_terms.document_segment_instance_id) INNER JOIN document_segments ON document_segment_instances.document_segment_id=document_segments.id GROUP BY logical_document_instances.id, logical_documents.name, logical_document_instances.version, document_segment_instances.document_segment_id, document_segments.name, business_terms.id, business_terms.name, document_segment_instances.enabled, document_segment_instance_terms.enabled, document_segment_instance_terms.position HAVING (((logical_documents.name)=[Choose Logical Document]) AND ((logical_document_instances.version)=[Choose Version]) AND ((document_segment_instances.enabled)=1) AND ((document_segment_instance_terms.enabled)=1)) ORDER BY logical_documents.name;
2. Create a query using the Logical Document Detail table created in Step 1 to show the validation document for the enabled business term within a segment:
   SELECT [Logical Document Detail].[Logical Document], [Logical Document Detail].[Document Segment], [Business Terms with Validation Documents].name AS [Business Term], document_classes.name AS [Document Class] FROM (([Business Terms with Validation Documents] INNER JOIN logical_documents ON [Business Terms with Validation Documents].[Validation Document]=logical_documents.id) INNER JOIN document_classes ON logical_documents.document_class_id=document_classes.id) INNER JOIN [Logical Document Detail] ON [Business Terms with Validation Documents].id=[Logical Document Detail].business_terms_id GROUP BY [Logical Document Detail].[Logical Document], [Logical Document Detail].[Document Segment], [Business Terms with Validation Documents].name, document_classes.name, [Logical Document Detail].document_segment_id, logical_documents.name, document_classes.id, [Logical Document Detail].position ORDER BY [Logical Document Detail].document_segment_id, document_classes.id, [Logical Document Detail].position;
3. Create a query using the Logical Document Detail table created in Step 1 to show the fixed values for the enabled business term within a segment:
   SELECT [Logical Document Detail].[Logical Document], [Logical Document Detail].[Document Segment], [Business Terms with Validation Documents].name AS [Business Term], document_classes.name AS [Document Class], [Business Terms with Validation Documents].[Fixed Value Indicator], [Business Term Fixed Values].[Fixed Value Name], [Business Term Fixed Values].[System Value Code] FROM ((([Business Terms with Validation Documents] INNER JOIN logical_documents ON [Business Terms with Validation Documents].[Validation Document]=logical_documents.id) INNER JOIN document_classes ON logical_documents.document_class_id=document_classes.id) INNER JOIN [Logical Document Detail] ON [Business Terms with Validation Documents].id=[Logical Document Detail].business_terms_id) INNER JOIN [Business Term Fixed Values] ON [Business Terms with Validation Documents].id=[Business Term Fixed Values].business_term_id GROUP BY [Logical Document Detail].[Logical Document], [Logical Document Detail].[Document Segment], [Business Terms with Validation Documents].name, document_classes.name, [Logical Document Detail].document_segment_id, logical_documents.name, document_classes.id, [Logical Document Detail].position, [Business Terms with Validation Documents].[Fixed Value Indicator], [Business Term Fixed Values]. [Fixed Value Name], [Business Term Fixed Values]. [System Value Code] ORDER BY [Logical Document Detail].document_segment_id, document_classes.id, [Logical Document Detail].position;

The foregoing functions and principles may be interlinked to multiple methods in the agile data suite software. For example, this concept may be applied in areas including, but not limited to, project planning, system management, system connections, relationship management, data mapping, and stage gate validations.

### Agile Data Suite Architecture

The preferred software and platforms are preferably based on a web-application known as Rails. Rails is a web-application and persistence framework that includes everything needed to create database-backed web-applications according to the Model-View-Control pattern of separation. This pattern splits the view (also called the presentation) into “dumb” templates that are primarily responsible for inserting pre-built data in between HTML tags. The model contains the “smart” domain objects (such as Account, Product, Person, Post) that holds all the business logic and knows how to persist themselves to a database. The controller handles the incoming requests (such as Save New Account, Update Product, Show Post) by manipulating the model and directing data to the view.

In Rails, the model is handled by what's called an object-relational mapping layer entitled Active Record. This layer allows you to present the data from database rows as objects and embellish these data objects with business logic methods. The controller and view are handled by the Action Pack, which handles both layers by its two parts: Action View and Action Controller. These two layers are bundled in a single package due to their heavy interdependence. This is unlike the relationship between the Active Record and Action Pack that is much more separate. Each of these packages can be used independently outside of Rails. An agile data suite implementation preferably runs on a server within a datacenter currently available from Datric, Inc of Charlotte, N.C.

Architecture for an agile data suite implementation preferably includes: a web server; an application load balancer; the agile data suite software; and, a database.

All of the components can exist on one or multiple servers for performance and load balancing.

Preferably, the architecture comprises an Apache web server, a Mongrel load balancer for Ruby on Rails, Ruby on Rails Application framework, the agile data suite code, and a relational database.

Preferably, hardware comprises HP ProLiant servers and Red Hat Linux operating systems. The Ruby on Rails application framework supports ODBC and JDBC connectors to most databases. With some additional components, IBM WebSphere and Microsoft IIS can be used for the web server.

Suitable databases include, but are not limited to, the following: mySQL and PostGreSQL; HP Neoview; MS SQL Server; IBM db2; and, Oracle. A generic API is available for development framework to non-supported databases such as Netezza and Teradata.

### Monetization

The preferred software and platforms may be commercialized in any number of ways. The preferred software and platforms may be loaded into computer readable medium on a server and access may be purchased by third parties for a set period. Alternatively, the preferred software and platforms may be loaded into computer readable medium as pre-configured software on a hardware platform that is sold.

### ADSv1

A particular agile data suite software version (hereinafter “ADSv1”) in accordance with one or more embodiments of the present invention is a data integration suite based on understandable business needs, real-life experience and a holistic approach. In contrast to currently available tools, ADSv1 does not enforce a specific viewpoint and enables multiple view-points from a single underlying data set. With these views, the data can be created, managed and maintained consistently and accurately throughout the lifecycle. With ADSv1, business goals are aligned to data, processes, applications, systems and people. More importantly, information about data usage, lineage, modifications and change over time are immediately available with the click of a button.

ADSv1 can be described as a multi-dimensional data integration model reconciling and aligning the normally divergent architectures of business goals, processes, systems, applications, data and organization over time. Built upon a central data repository, ADSv1 uses an object-oriented abstraction layer in the form of business documents and document relationships. Most abstractions remove detail to convey ideas and provide easier understanding. In contrast, ADSv1 embraces details and provides a very robust abstraction layer that is designed to handle all technical, business and data management activities.

Ease of use is provided through filtered views addressing multiple perspectives of the underlying data. By selecting the level of granularity and subject matter, the abstraction layer provides not only ease of communication and understanding, but act as a pivot point between specific requirements. Rather than maintain multiple data sets for each different purpose (i.e. technical, business and data management), ADSv1 is built upon a single data set that accommodates multiple uses.

New requirements and changes resulting from expansion, corrections or replacement are handled through the abstraction resulting in time and expense reductions by orders of magnitude. Technical additions to a system can be achieved simply by modifying the linkage to abstraction—no other updates are required. Additions and changes concerning data governance allow of the modification of business term names and definitions without impacting technical information. Security, data lineage and object usage across system and processes are provided through the central data repository and the abstraction layer.

ADSv1 is a new paradigm in data management—one that solves traditional problems and provides new capabilities that were previously impossible in a concise, maintainable matter with significant savings in time and manpower.

### ADSv1—Design Foundation

The design of ADSv1 is based on these key concepts: start with a business perspective that aligns to business goals and needs; provide a common language for cross-team communications, but allow for specific needs; provide a platform that is easy to maintain across projects, time and people; link technical requirements to business requirements with automatic updates; view all data and relationships from multiple perspectives to eliminate redundancy; build in validations, quality and consistency while eliminating overhead; build in project management, metrics and analysis; change the implementation process to eliminate major causes of work and time; create a system that can radically improves the way projects are done; and, build a system that maximized forward progress, not billable hours.

### ADSv1—Design Results

The foundation concepts are realized in the physical design of ADSv1. Combining the right design with the right goals means we can accomplish the requirements while solving the underlying problems. The results are: a simple, understandable business model integrated with technical specifications; predefined content for consistency and implementation speed; a centralized repository (not “spreadmarts”)—always up-to-date and consistent; GUI mapping for speed and accuracy; integrated, real-time pro-active project measurement for risk reduction and cost containment; complete change tracking and traceability; cross-system where-used and data lineage; object security.

### ADSv1—Today's Data Management—Requirements Gathering

No matter what data integration and management projects are undertaken, most requirements gathering activities are similar. So the question becomes “if I'm facing the same requirements with only changes to scope and labels, why do we start over and re-invent the wheel?” Even when we try and establish patterns for reusability, they continue to be challenging and very hard to maintain: Identify and manage project work & scope; Identify problems and gaps; Understand data relationships; Understand terms, fields and attribute meaning; Maintain cross-team communications; Map sources to targets; Create specific data extraction, transform and load (ETL) logic; Create and maintain metadata & master data repositories.

### ADSv1—A Vision Realized

ADSv1 is built upon a central data repository using an object-orient abstraction layer that integrates multiple views and perspectives of data. Where most abstractions remove detail to convey ideas and provide easier understanding, ADSv1 embraces details and provides a robust abstraction layer designed to handle technical, business and data management activities.

The object-orient abstraction is based on logically-defined business documents (for example, sales order) consisting of business terms and definitions. Within the document, terms are grouped by segments. While ADSv1 provides most of the standard documents, terms and definitions, these objects can be added and modified as required.

Easy of use is provided through filtered views. By selecting the level of granularity and subject matter, the abstraction layer provides not only ease of communication and understanding, but act as a pivot point between specific requirements. Rather than maintain multiple data sets for each different purpose (i.e. technical, business and data management), ADSv1 is built upon a single data set that accommodates multiple uses.

Since data is not be replicated and altered for each function's perspective, consistency and accuracy are maintained with no additional work. Changes and modifications can be immediately validated and reflected—not through additional work, controlled replication and manual inspection, but through good design.

With ADSv1, significant reductions in cost and project time are realized.

### ADSv1—System-Neutral Business Orientation

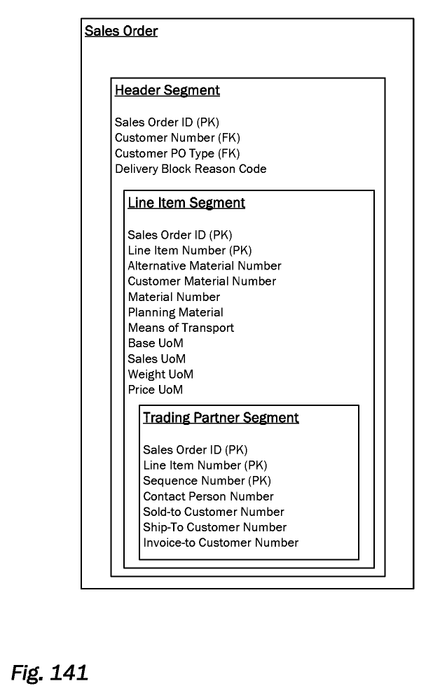

ADSv1 starts with a predefined and customizable layer of abstraction built upon common understandable business objects: documents, segments, business terms and term definitions, as can be seen in FIG. 141. The results are immediate communication improvements between business and technical teams. Glossaries and standards are a by-product of the design—not another work effort.

Misunderstandings of term meanings and usage are eliminated. A common, documented and defined language is immediately available. Flexibility is added through the use of term aliases. Validations are added through term classes and attributes. Changes to a term or definition are immediately reflected throughout the system—not through replication, but because all relationships share the same data.

All objects can be enabled, disabled, traced, tracked and measured. Base objects, such as business terms, segment names and document types can be combined to create complex objects like the business document.

Since the foundation is based on business terms, it is inherently system-neutral. Terms, usage, definitions and relationships are established at the beginning and are independent from technical systems. Problems, errors and large amounts of work are eliminated. The addition of new systems or changes to existing systems created only a limited amount of work as a result of the abstraction layer—the majority of existing relationships do not change.

### ADSv1—Enterprise Business Model

When documents and their relationships are viewed together, an enterprise business model is formed. The enterprise business model is similar in concept to a semantic representation of a normalized logical or physical model. Differing from a semantic model, the business model is more robust and complete as it is used for both the semantic view of what is available as well as to define current and future requirements.

All of the documents required for a full and robust ERP (enterprise resource planning) system are included and can be extended and modified as required. Documents and the business terms they contain are associated to business views (processes, business areas, reports and KPIs) as well as technical views (systems, source-target mapping and ETL rules).

Starting with a business model enables the strategic integration of tactical point solutions. Instead of redundant work for point solutions, the tactical solution can be view as part of the whole. As new solutions are required, existing data and data relationships can be leveraged.

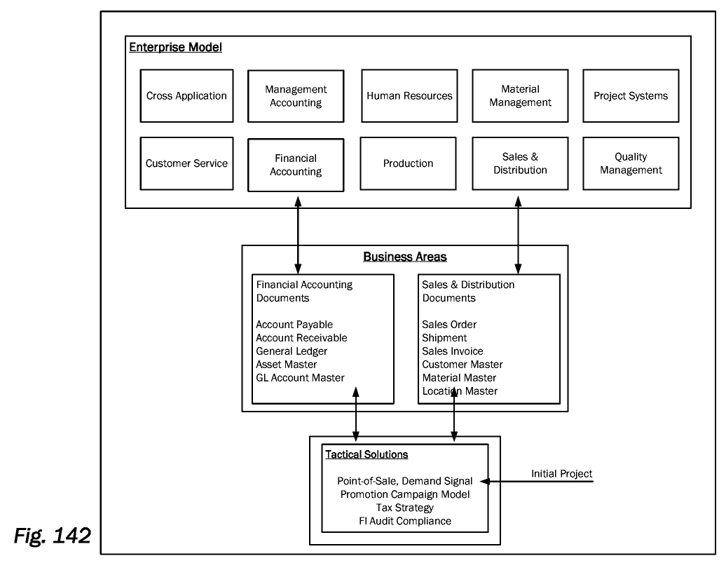

As can be seen from FIG. 142, an initial tactical project relates back to the enterprise model through business areas.

In the example of a demand signal repository, several transactions and supporting master data are required. When the next project is encountered, these documents are all or mostly complete. Leveraging existing work efforts reduces time and cost. Over time, less development is required to add business value.

### ADSv1—Cross-System Integrated Metadata

System inventories and the associated data structures for logical (entities and attributes) and physical (tables and fields) systems are loaded into our metadata repositories.

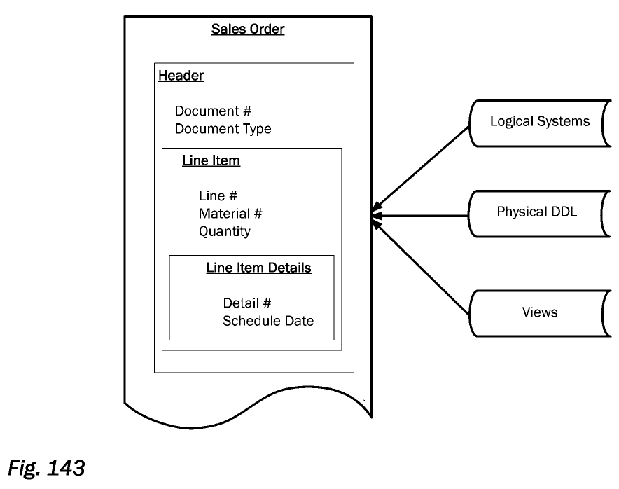

By mapping the metadata to the business document, precise definition, meaning and usage is established for the technical table and field names. As illustrated by FIG. 143, the document and business terms become the common linkage for multiple systems. Source to target mapping becomes a database query using the document and business term. Data transform rules can be added at this time at the field level.

### ADSv1—Simple Communication—One Data Source with Multiple Views

Even data implementations with the most advanced tool sets have a basic problem: different departments and teams use different tools and languages to discuss, define, test and approve the requirements. While many tools can ‘communicate’ with each other, this usually means that data is replicated into multiple formats. Additionally, most software is designed to approach the problem from a technical perspective.

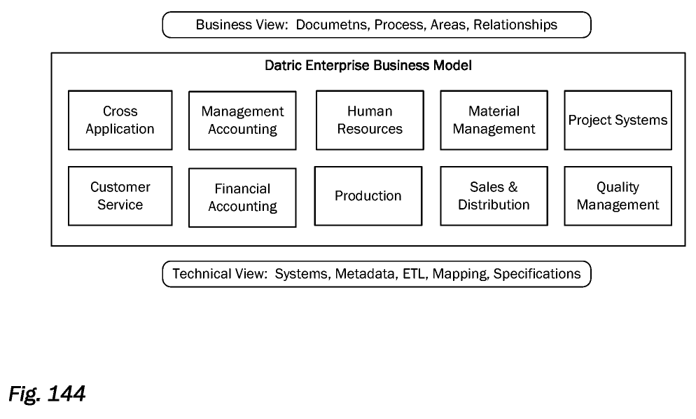

ADSv1 takes a different approach, as can be seen in FIG. 144. The business view is defined first, but is robust enough to carry all of the technical information required. By designing a single repository for data that expects to support multiple views, business and technical specifications are synchronized and consistent. An update to a data element is immediately reflects in all views.

### ADSv1—Robust Design

ADSv1 is an object-oriented design of both real and abstract data. This approach has several advantages: Simple (atomic) objects are the building blocks. The units are easy to maintainable and understand; Complex objects can be created from multiple combinations of simple objects. Flexibility is enhanced while maintenance is reduced; When simple objects are changed, the complex objects immediately reflect the change without additional update or maintenance; Complex objects can be instantiated, an instance has attributes of version number and status, version can be managed for project visibility and work flow; and, Relationships between objects can be defined, managed and validated for both project management and quality assurance purposes.

The traditional approach is to manage different functionalities with different applications. This separation of data requires extensive reviews and manual efforts to insure consistency and quality. Changes over time require extensive management to insure accuracy and consistency. With data in separate applications, new relationships must be manually researched, defined and maintained.

ADSv1 is a new paradigm. A single data repository contains objects, object relationships and application metadata. The potential combinations (and thus flexibility) of objects and object relationship can be extensive, but management is simple and verifiable.

### ADSv1—Efficient Relationship Management

All components of ADSv1 are managed as objects and object relationships. This consistent approach is not only highly flexible, but amazingly simple to manage and maintain. It has a profound impact on taming the management of complex environments. Examples of this approach are illustrated both in the positioning of ADSv1 between other technical systems and in our approach to data mapping and transformation.

The number of possible relationships between objects is based on a well-known mathematical formula: Possible connections=Σ(nᵢ−1) where i=1 to ∞ and n is the number of nodes.

With ADSv1, we place a level of abstraction in the center of relationships that acts as an integration point. When new nodes are added, they are directly attached to the central point.

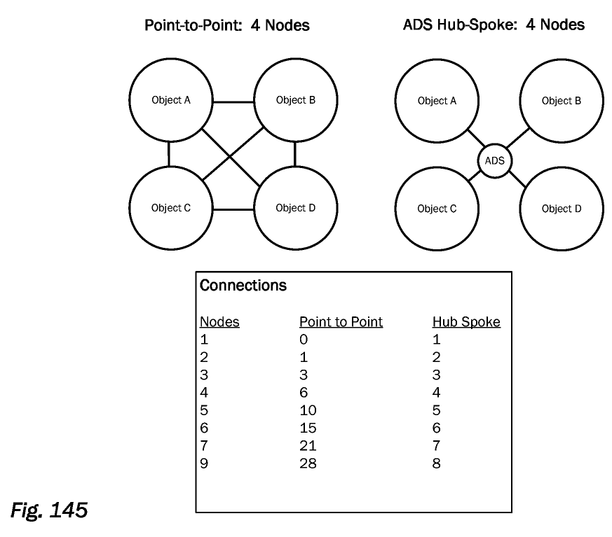

As you can see from the tables and diagrams of FIG. 145, once you pass three nodes, the reductions in potential complexity are significant. There are two more important points that are less obvious.

One, if data moves from one system through another, the maximum number of potential ‘hops’ between point-to-point architectures is n−1. In ADSv1, the maximum is two, but only the first time through. Generally, connections require none or one.

Two, since ADSv1 is based on object relationships, new relationships between objects can be derived without additional work. In the example of FIG. 145, adding Object D's relationships to ADSv1 immediately and with no additional work establishes relationships to A, B and C.

### ADSv1—Data Management—Multi-dimensional Data Visualization and Control

Data specifications are typically created, reviewed and maintained with a complex combination of PC applications, document management and database tools.

There are tools designed for process, metadata, mapping and ETL management. Most are individual applications. Integration abilities are limited and depend on dedicated manual maintenance.

Specifications from different perspectives are impossible to align. Consistency and comparisons over time are time consuming manual efforts.

The approach of ADSv1 is to view data through the business abstraction layer. As a result, multiple perspectives can be obtained from a single underlying data set. Business and technical relationships can be derived as opposed to manual addition. Relationship management is automated. Due to the project management and object track and trace features, systems and data relationships can be observed at multiple points in time.

The advantage is in answering the question “Do I have the data necessary for this report?” Not only can you answer the question, through proper use you can look across time to say when it was or will be available.

### ADSv1—Data Mapping—Map once, Derive Many, Leverage All

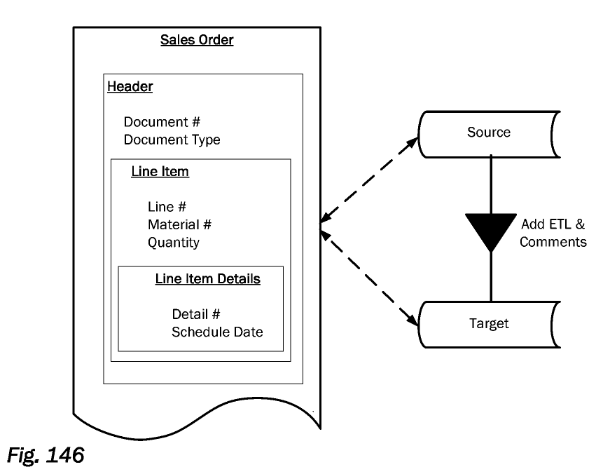

ADSv1 is specifically built to handle complex data definition and mapping. This unique two-step approach to mapping through defined business objects results in substantial advantages: System-document mapping can be defined in advance; Mappings can be done in parallel without the need for the same person to understand both source and target; Mappings can be done at different times—ideal for phased projects; Once a system-document map is complete, mappings to all other system using that document can be derived, as illustrated in FIG. 146.

Typical projects that require ADSv1 are systems replacement, upgrades and implementation, legacy decommissioning, data mart consolidation, enterprise data warehousing, reporting and analytics definitions.

By providing a predefined, extensible data framework dramatic reductions in implementation time, costs and management overhead are achieved while insuring a rapid, accurate and successful implementation.

### ADSv1—Data Governance—Consistent, Single-Point Control of Multiple Systems

Data governance in most systems requires compiling the data from multiple systems, profiling and analyzing, setting and enforcing standards and trying to backfill or cross-reference data.

ADSv1 changes the methodology. Data standards can be imposed without changing the underlying systems. The meaning of data takes a central role, not the label. Data element usages, validations, consistency, lineage and where-used are all built into the base design. As a result, SOX and audit compliance are natural and behind the scenes. Not an additional work effort, but instead part of the design.

### ADSv1—Process Flow

ADSv1 is designed to operate in large-scale complex environments. As such, it provides a platform to: manage multiple concurrent projects with multiple phases; provide a predefined framework with configurable options; and, provide an integration point between multiple teams and work efforts.

ADSv1 follows an accepted implementation flow process of discover, design, develop, and test prior to productive operations. ADSv1 supports multiple project approaches such as waterfall, iterative and hybrid. By concentrating on the discovery and design phases, the areas most prone to consistency, complexity and rework are made effective. Good consistent design specifications reduce work in the development and testing areas. Data management and governance are in the design, not after the fact.

Development and testing are normally accomplished in different application tools. To provide easy consistent management, ADSv1 requires only high-level time and status updates from the development and testing teams. Changes to design specifications are accomplished by returning to the appropriate process stage and a built-in issue log. If returned for change, work priorities reset to “Critical’ for enhanced project visibility. In essence, the further downstream a change is identified, the more attention the resolution receives.

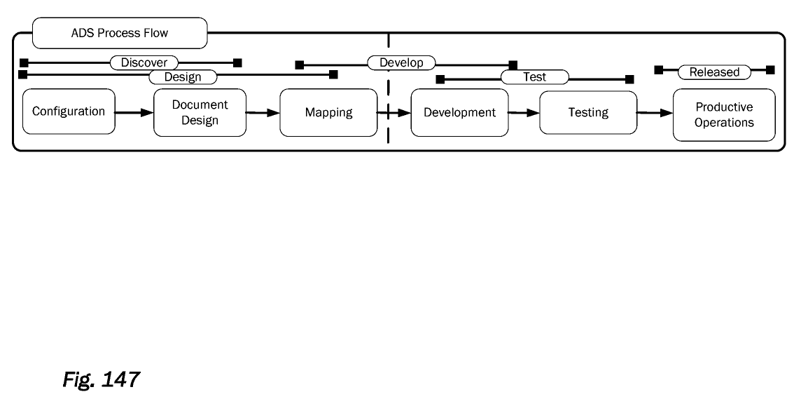

As can be seen from FIG. 147, ADSv1 supports the normal methodologies, but is more effective due to parallel instead of sequential flow. Due to the business model and object oriented design, discovery, design and release to development is much quicker. For one, configuration and design start with predefined content. The approach is to validate and refine, not create from scratch. Second, documents can be released individually to mapping as some as complete. Third, mapping specifications are done in two steps: system-to-document (½ mappings) allowing for non-sequential, non-dependent work and the addition of non-directional ETL specifications; and, system-to-system (source-target) query. Using the document as a pivot point, source and target are related. Directional ETL specifications can be added at this time. Fourth, individual source-target mapping pairs can be released to development independently. And fifth, development and testing can be executed on other systems, but ADSv1 tracks the high-level dates, assignment, work status, and priorities. As a result, the project management dashboards, issue log and plan-vs.-actual hours are integrated.

### ADSv1—Positioning ADSv1 in the Enterprise Architecture

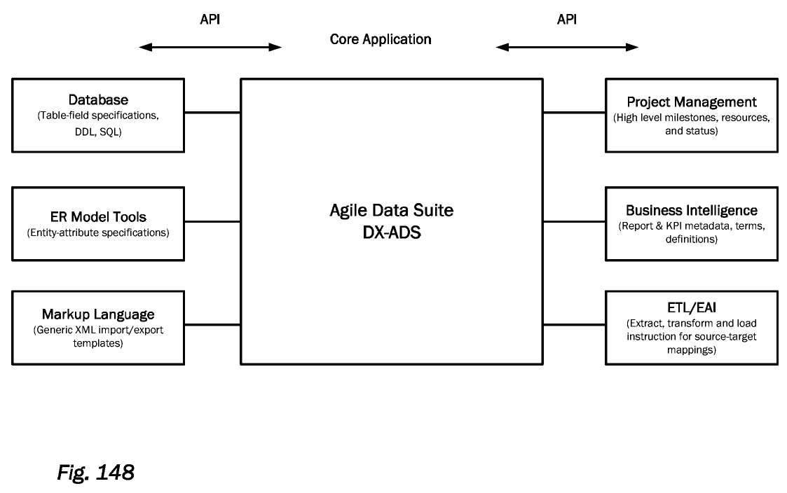

ADSv1 is positioned as an integration hub between application systems, as can be seen in FIG. 148. While many software applications claim to take this approach, ADSv1 is the only one that accomplishes the goal from multiple perspectives with a layer of abstraction that insulates components from non-essential change.

ADSv1 requires no additional software components for use, but provides integration connections appropriate for the class of application through defined interfaces in a common-sense approach. ADSv1 is application and database neutral but provides accelerators for certain applications such as SAP. While not required for use with ADSv1, integration with standard tools are provided. Specifications can be moved bi-directionally to most ER and UML modeling tools. Specifications can be moved bi-directionally to most BI tools. Milestones can be moved bi-directionally to most PM tools. Generic templates can be used to load metadata. Import and export via MS Excel is support in most areas.

### ADSv1—Project Management—Seamless Business and Technical Integration

By changing the way projects are done, ADSv1 dramatically reduces the time and cost to implement, increases the ability to manage and quantify change and provides a single, consistent and accurate view of any data migration and management project.

Projects can be easily scoped and monitored through reports and dashboards. Assignments, progress and status are all tracked at the object level. Unlike other software, ADSv1 allows you to pro-actively analyze so as to determine the cost of change prior to commitment. Technical changes are natively linked to business value.

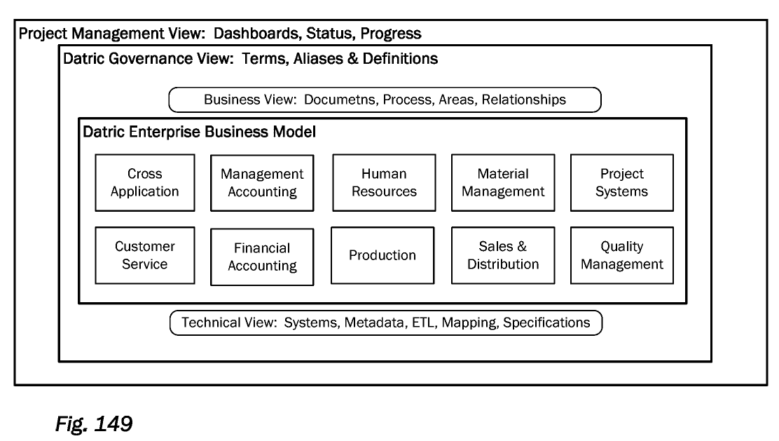

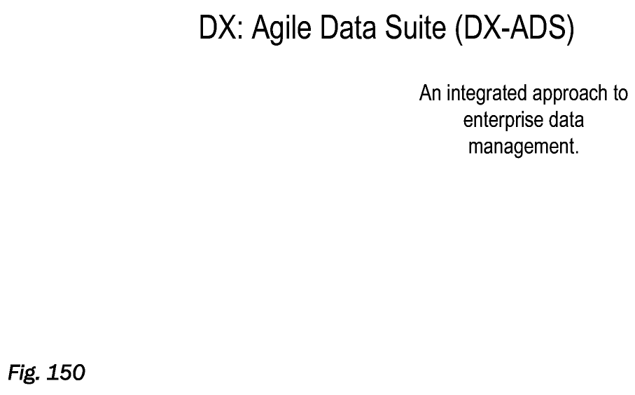

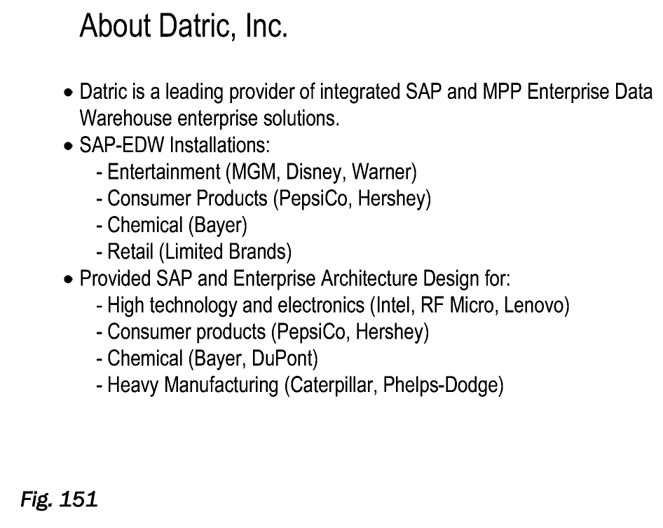

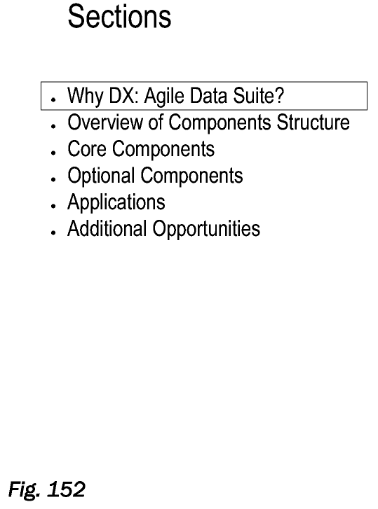

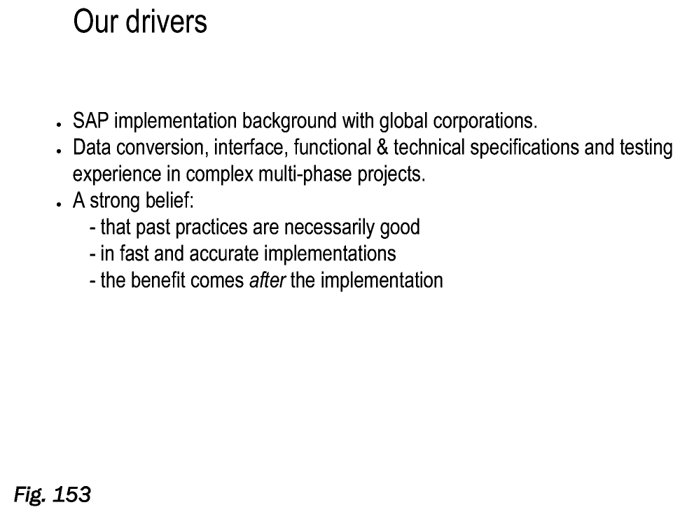

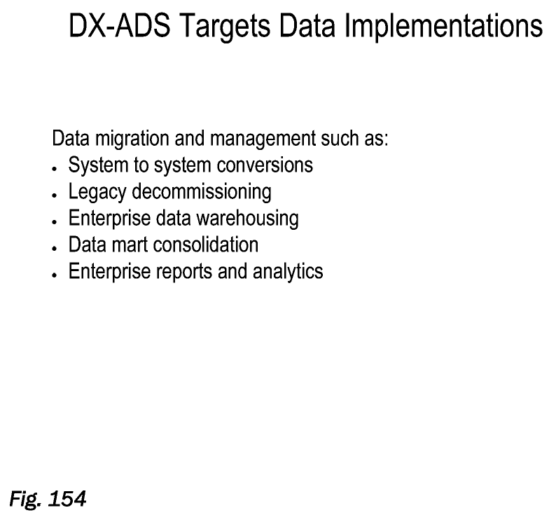

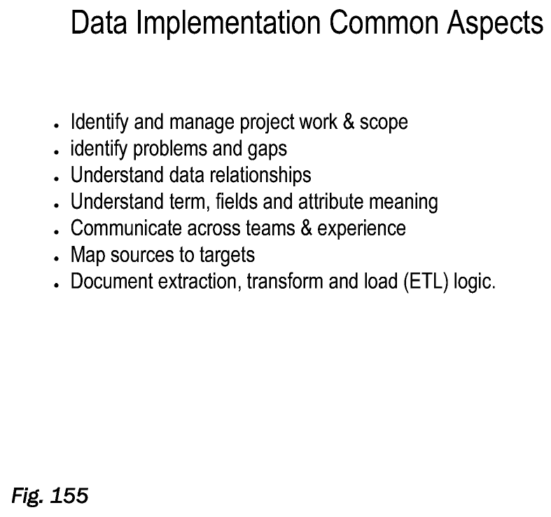

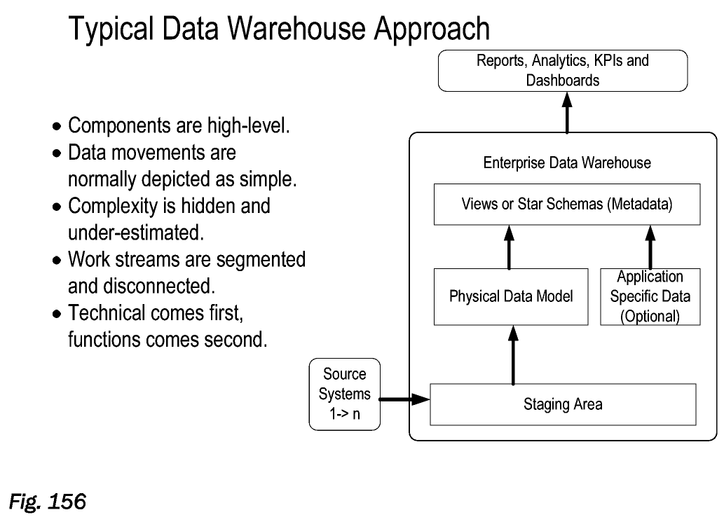

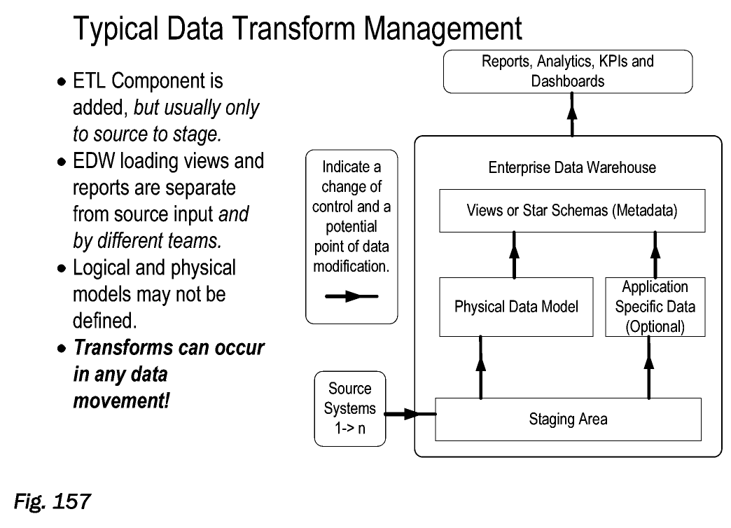

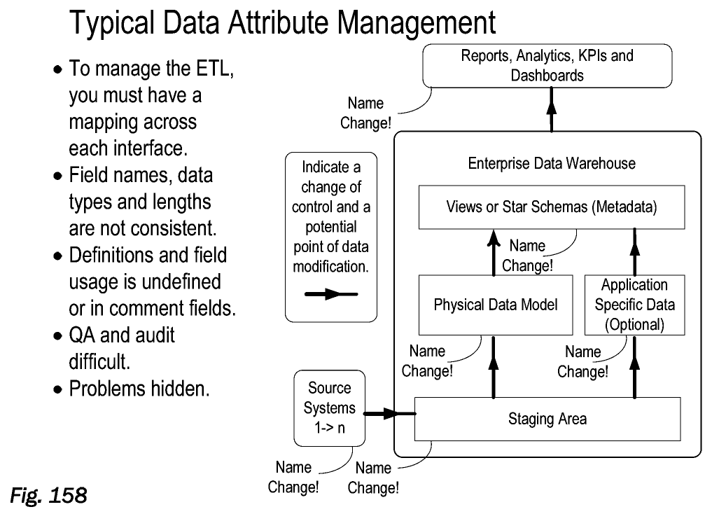

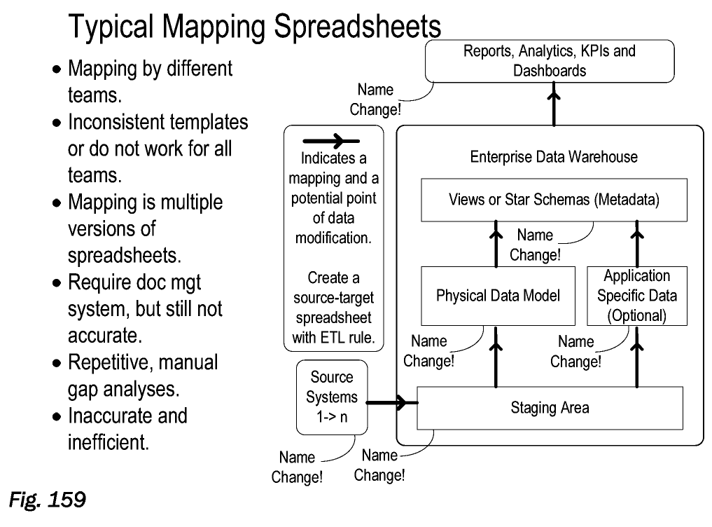

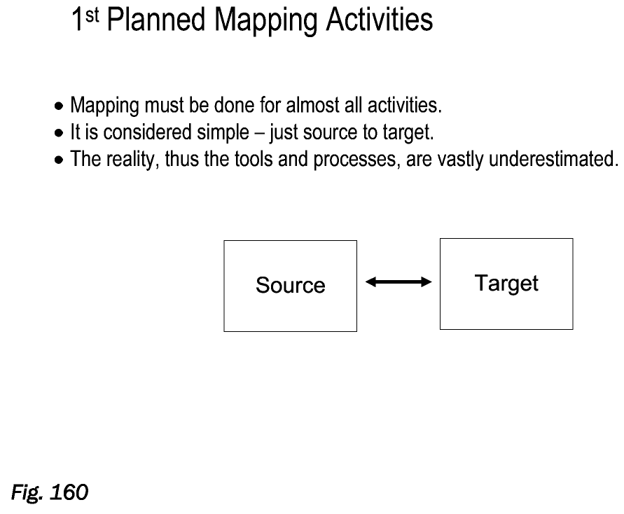

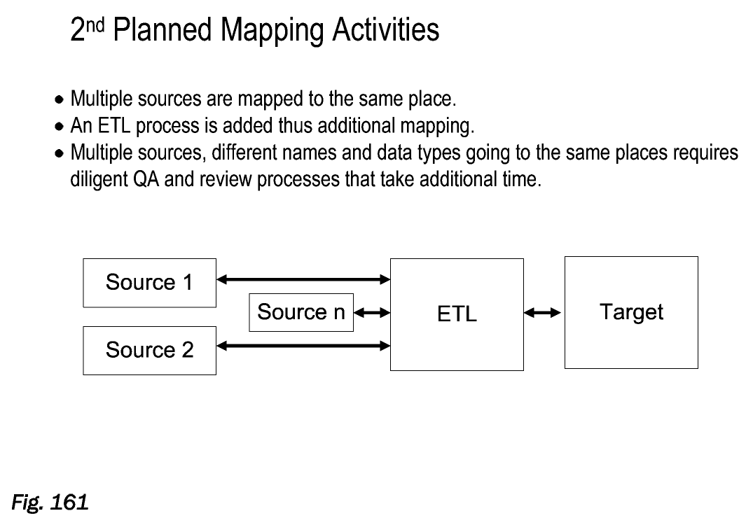

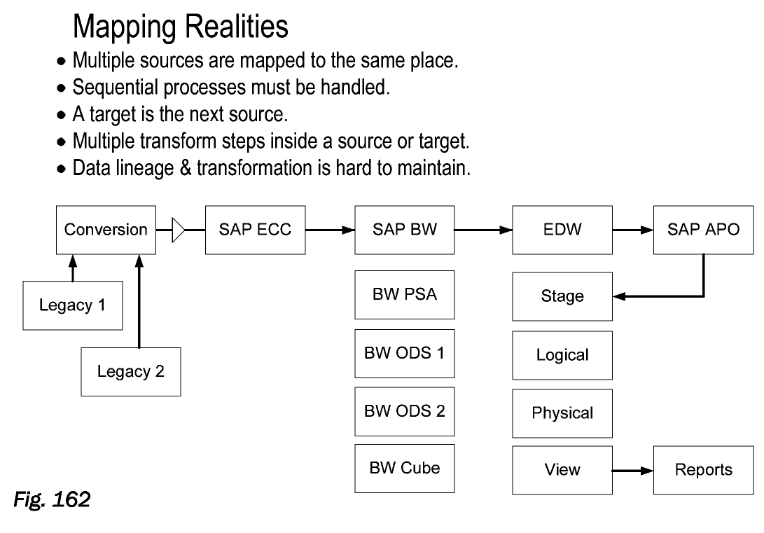

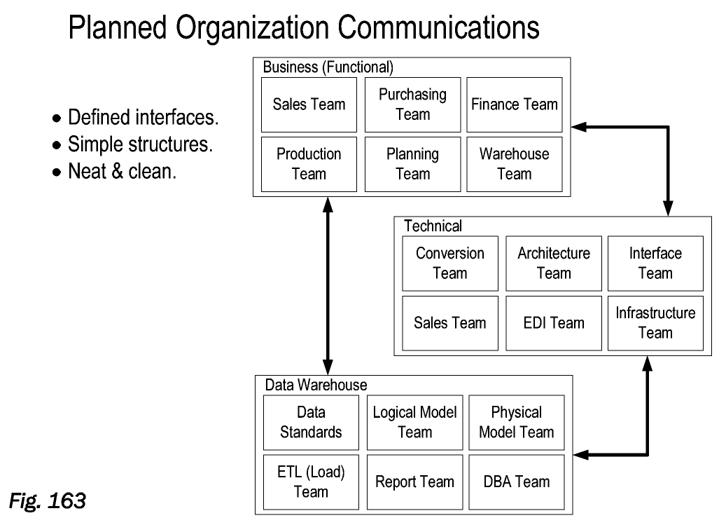

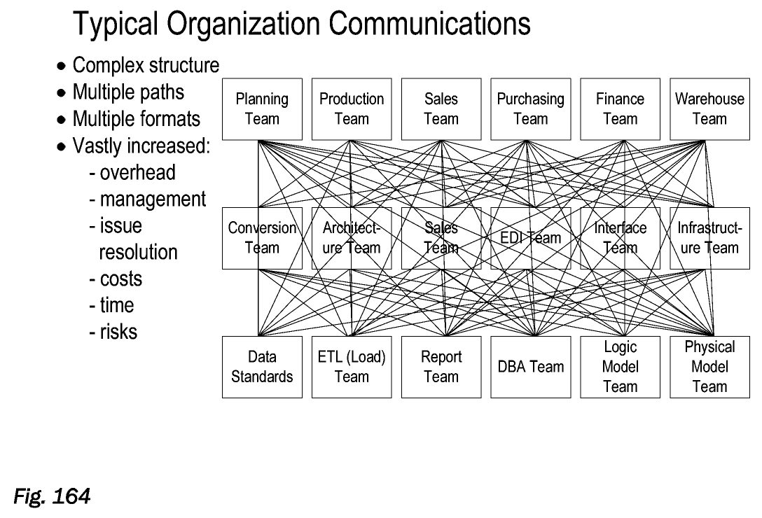

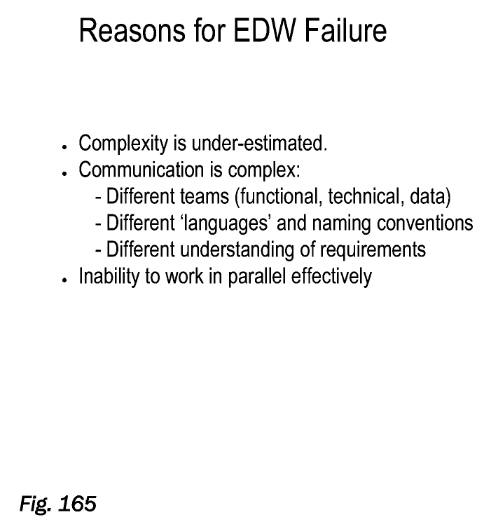

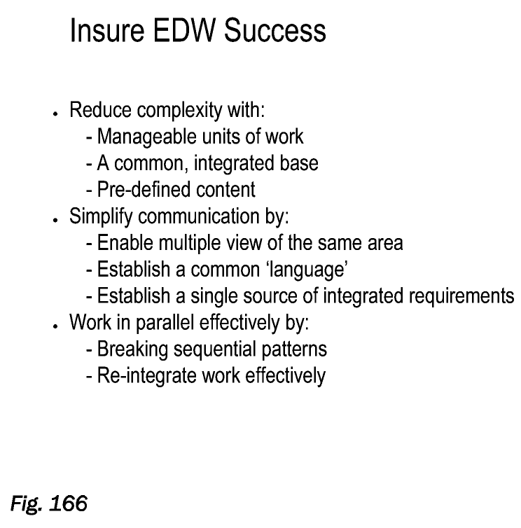

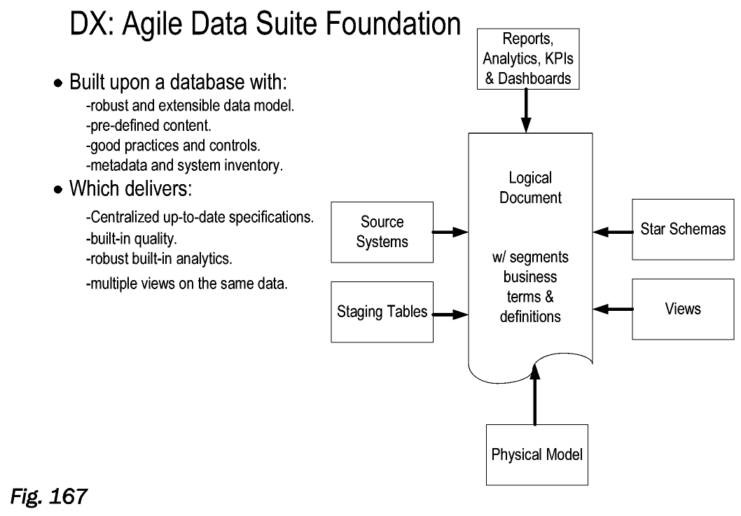

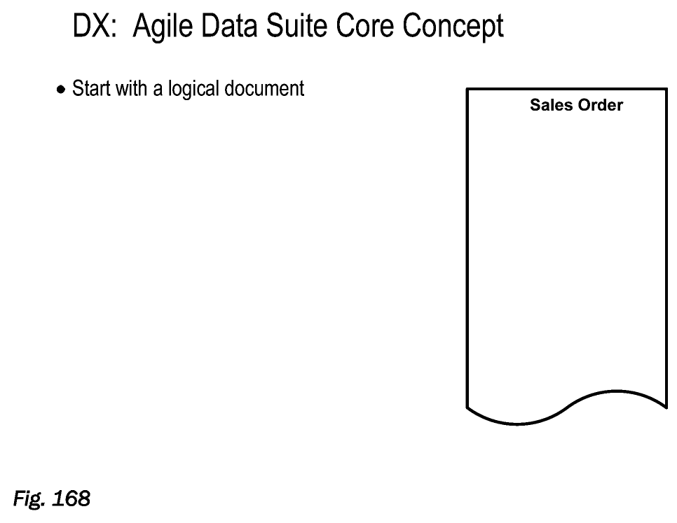

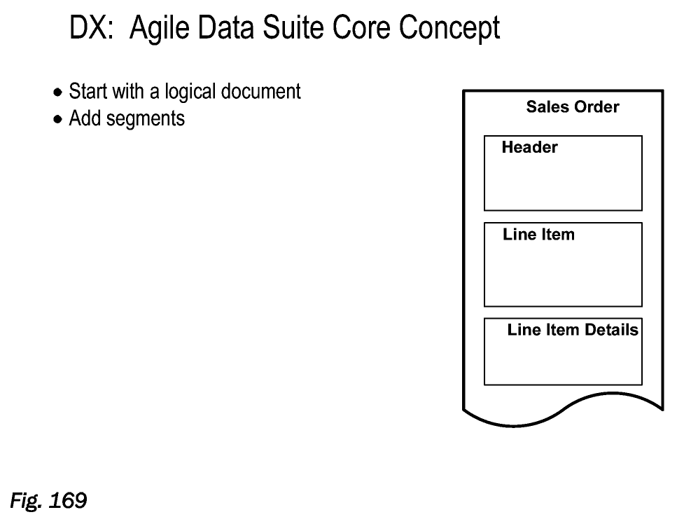

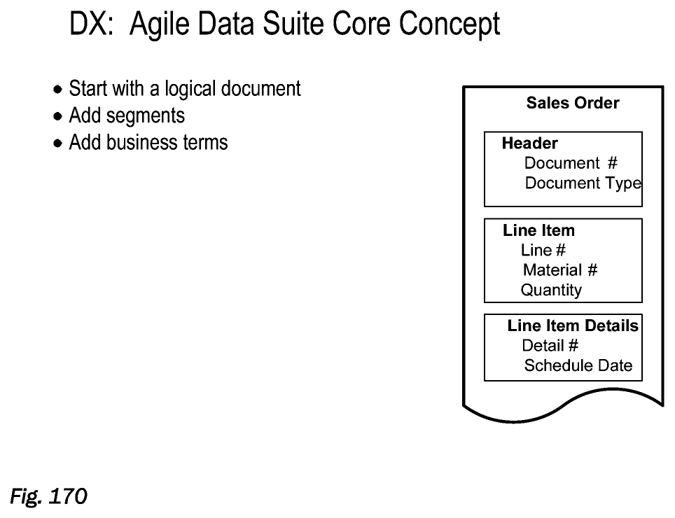

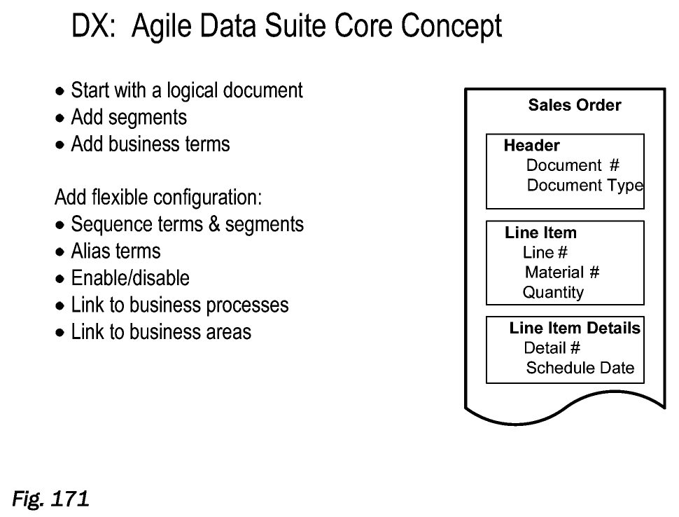

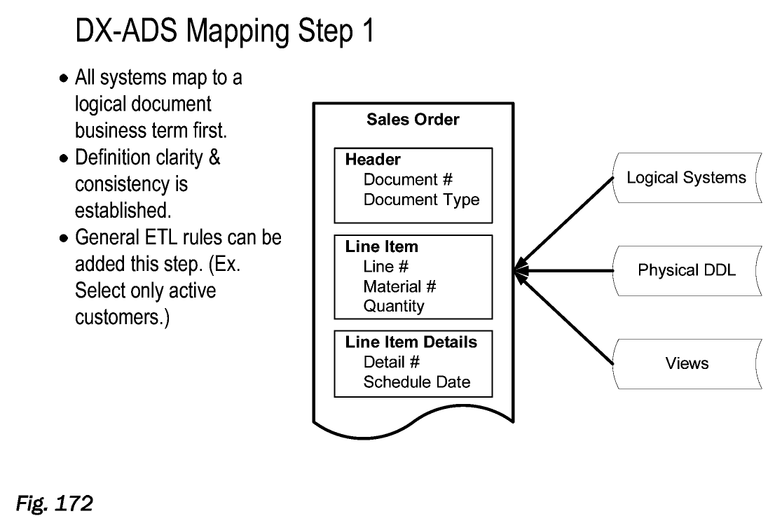

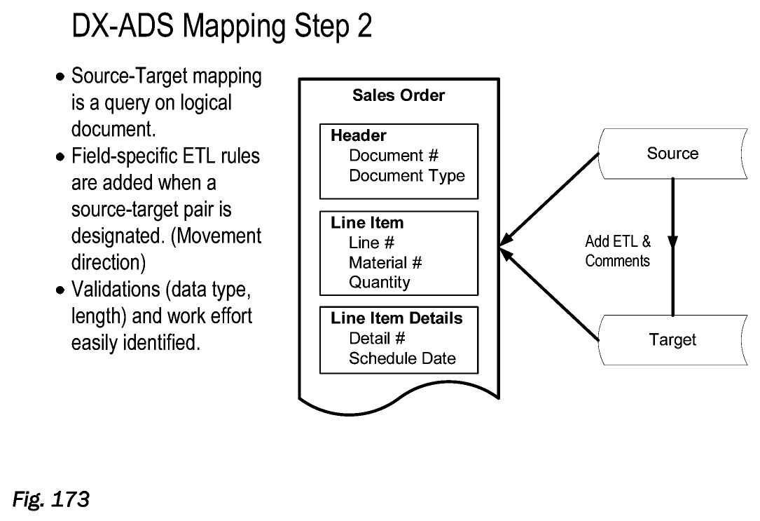

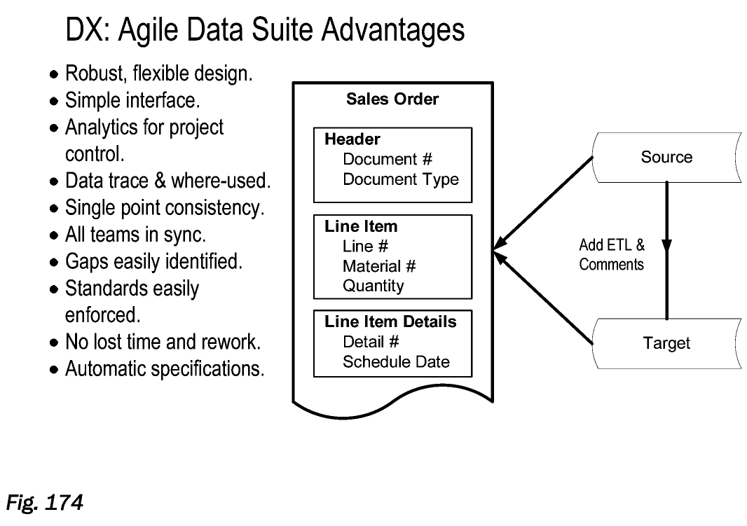

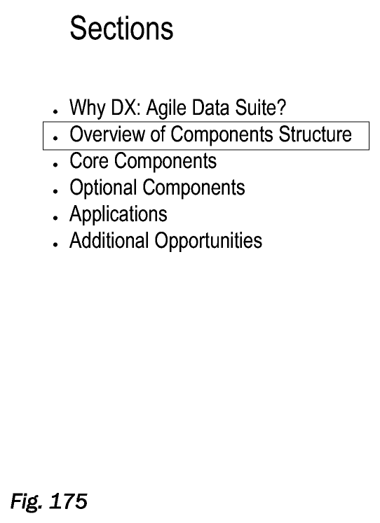

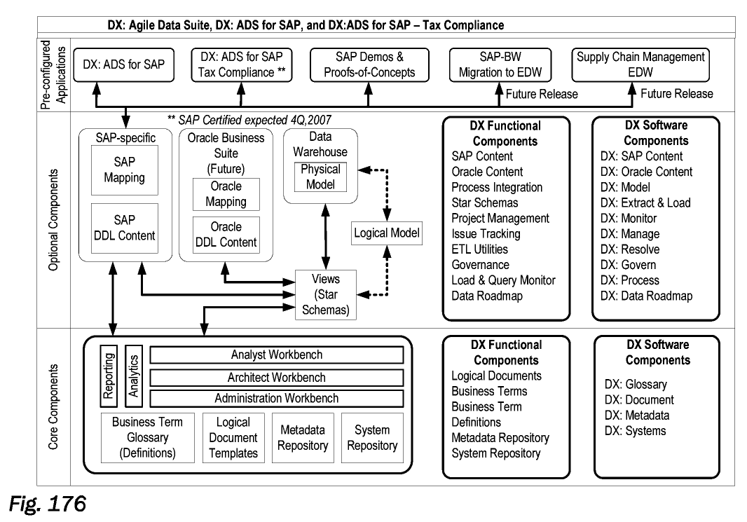

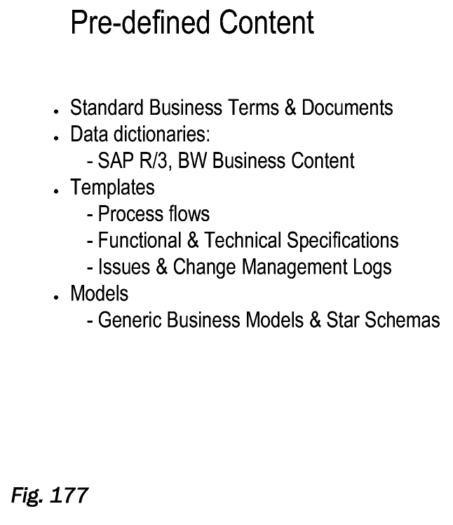

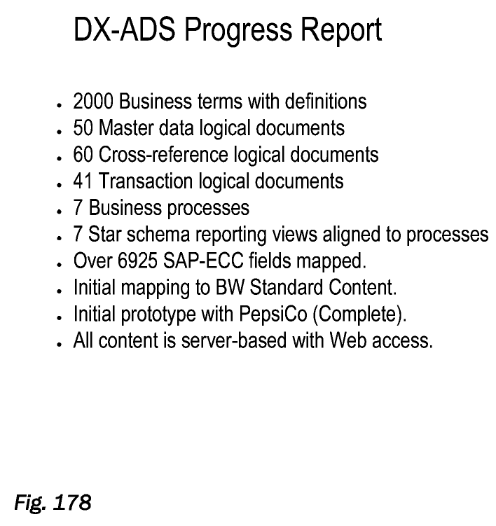

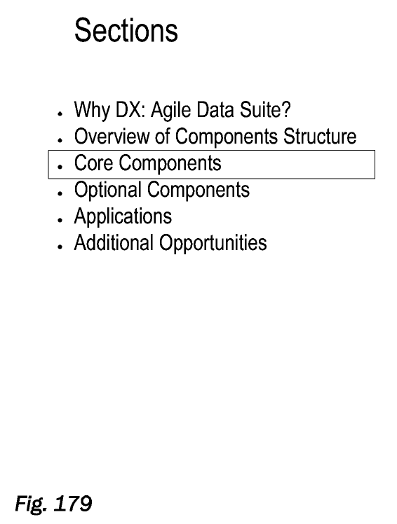

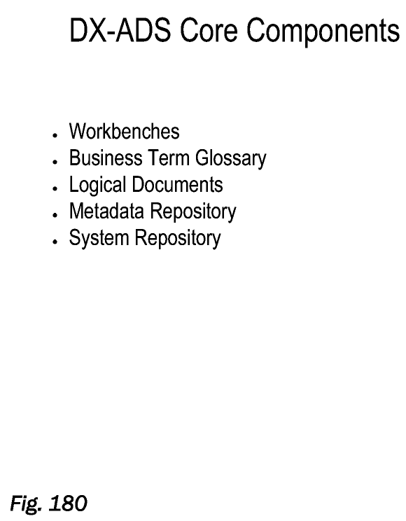

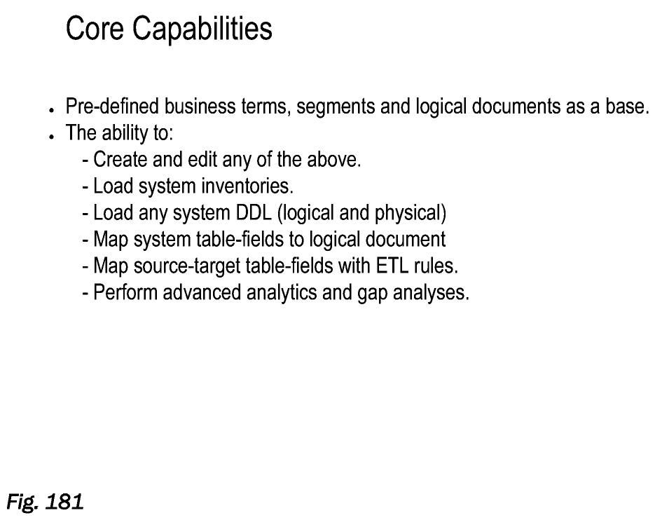

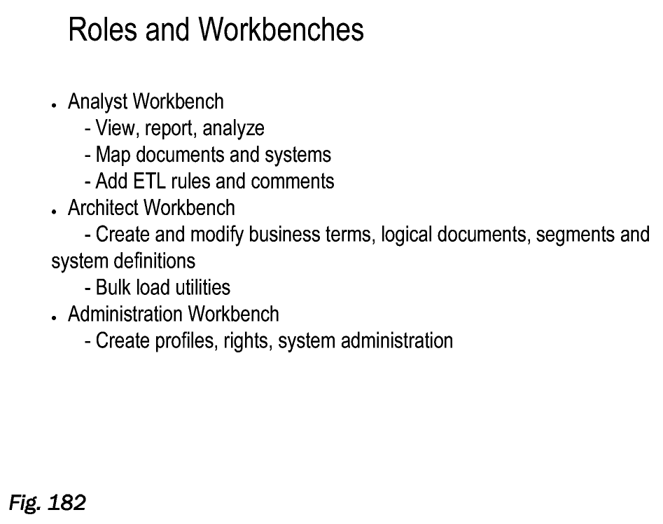

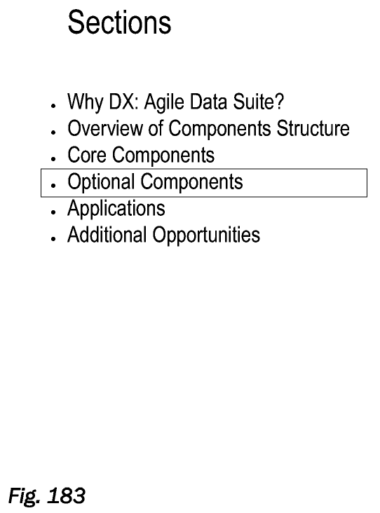

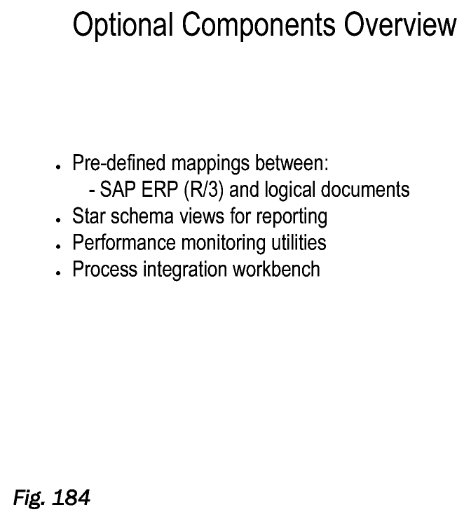

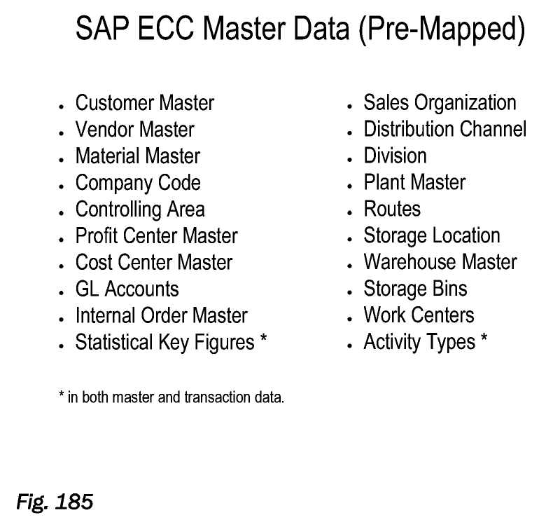

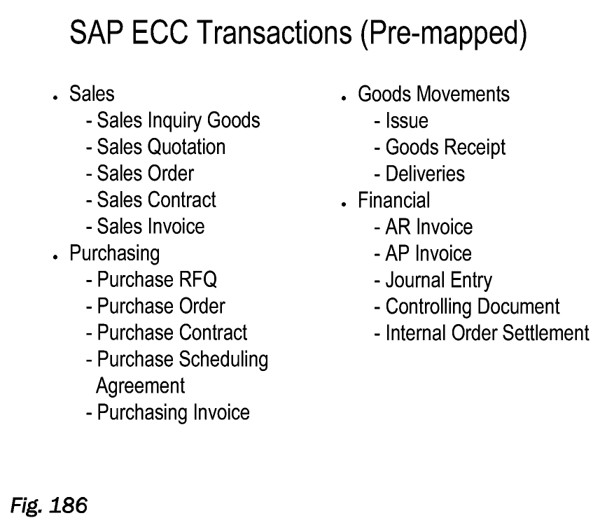

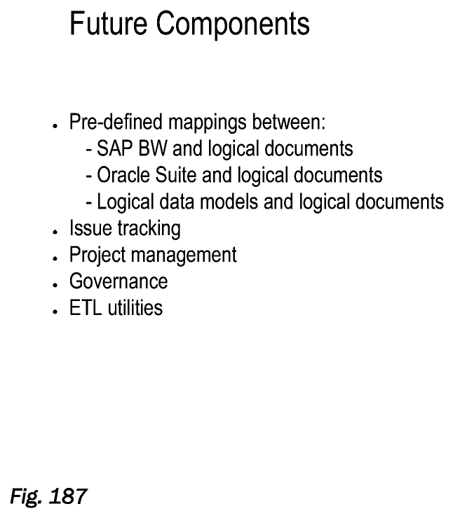

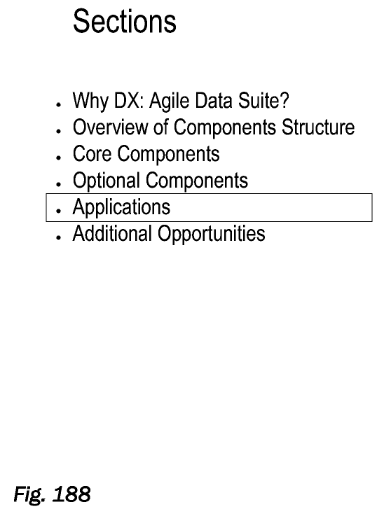

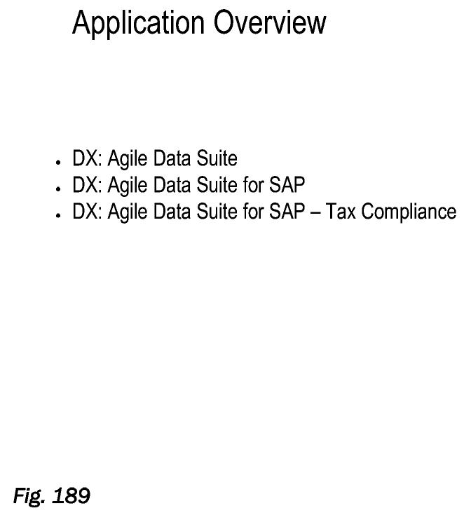

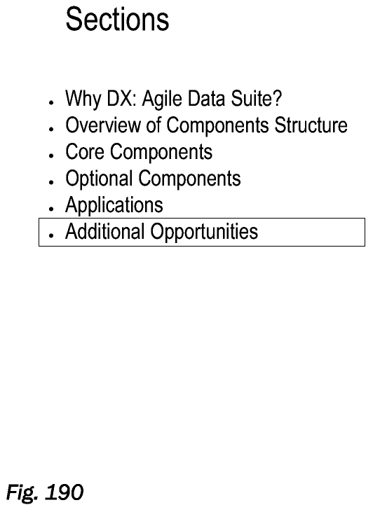

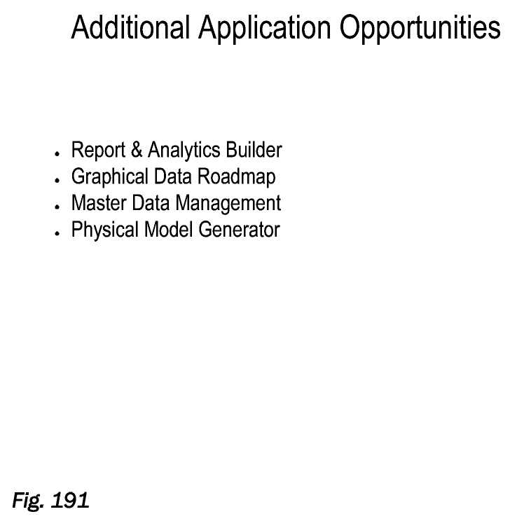

As ADSv1 is an integrated system, objects have multiple purposes and their attributes can be shared across functions. While projects, phases and stages all have obvious project management use, object assignments (work assignments), work status and the version status of a document instance are all shared to be viewed individually or in the context of the whole, as can be seen in FIG. 149. With this approach, multiple view levels from details to overviews are available and always consistent.

### ADSv1—ADSv1 for SAP

ADSv1 for SAP is an optional component consisting of predefined mappings for over 13,000 SAP ECC tables and fields to the ADSv1 enterprise business model. By providing the source mapping and necessary extract logic, the time to production is greatly reduced for any data integration project in a SAP environment. New installations, archiving projects, data warehousing projects can all benefit from this tested solution.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

### Process Flow

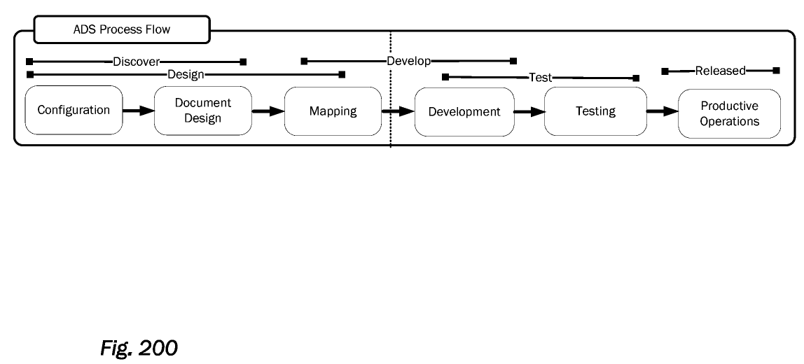

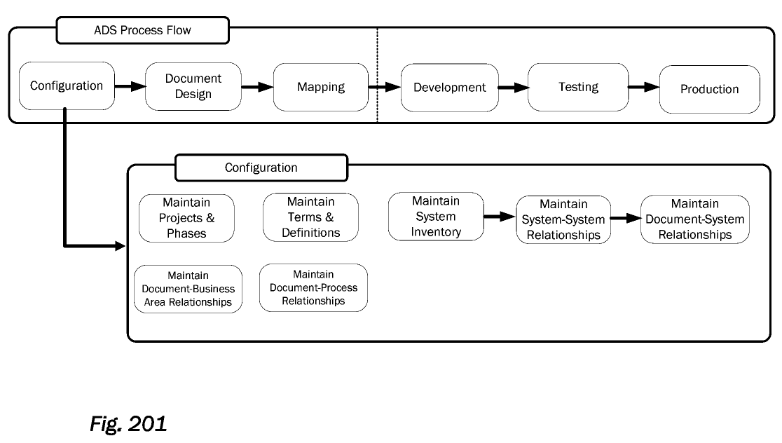

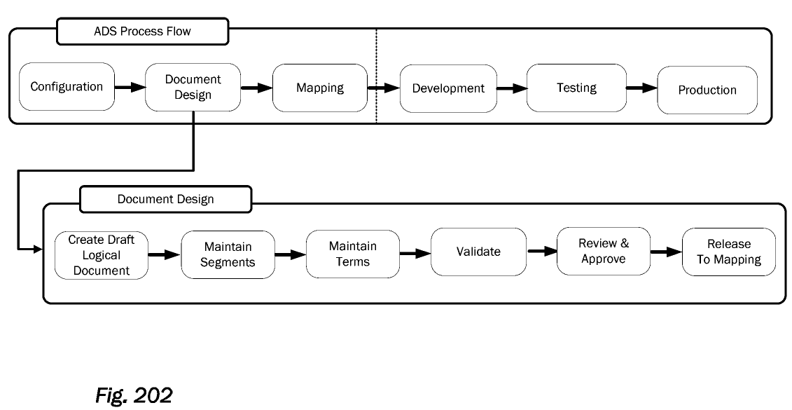

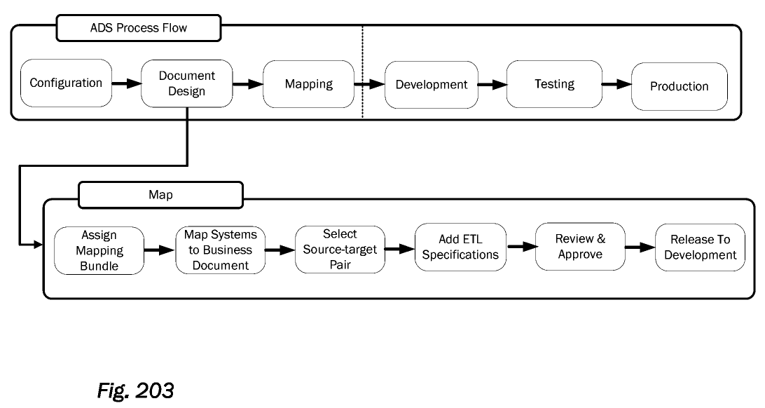

FIG. 200 is a flowchart of a process flow in accordance with an embodiment of the present invention. More specifically, there are six tasks represented: a configuration task, a document design task, a mapping task, a development task, a testing task, and a productive operations task. FIG. 201 illustrates the configuration task in more detail. A user can configure various elements within the preferred software and platforms. FIG. 202 illustrates the document design task in more detail. A user can create a draft logical document, add, edit, and delete document segments, add, edit, and delete business terms, validate the document, request approval of the document, and if approved, the document will be released to mapping. FIG. 203 illustrates the mapping task in more detail. A user can assign a mapping bundle to a system connection, map systems to a logical document, sometimes referred to herein as a business document, select a source and target system pair, add extract, transform, and load specifications, request approval of the mapping, and if approved, release the mapping to development.

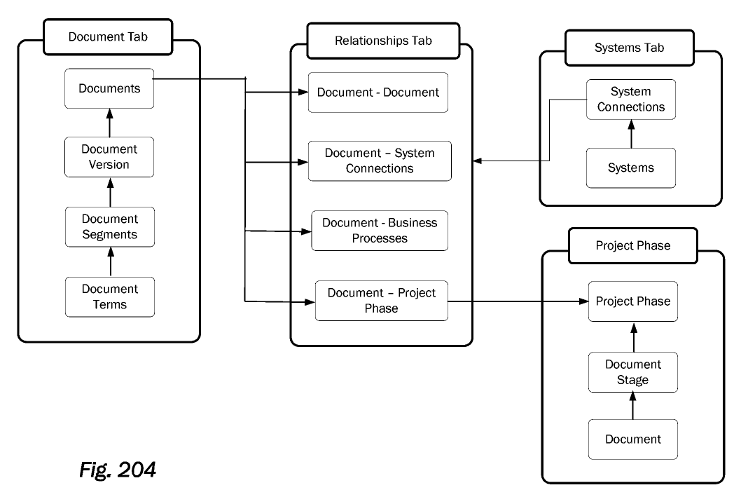

FIG. 204 is an illustration of actions that may be taken on a plurality of tabs of an agile data system, and the associated effects such actions may have on actions that may be taken on other tabs. Specifically, a user may create or edit a document having a document version, one or more document segments, and one or more document terms on the document tab. A user may create or modify a system on a systems tab. A user may further create a system connection between two or more systems on the systems tab.

On the relationships tab, a user can create a relationship between two documents, create a relationship between a document and a system connection, associate a document and a business process, and associate a document and a project phase.

It will be appreciated that, although certain functionality described is not described with reference to each described embodiment, each embodiment may suitably be practiced as including or excluding any described functionality, features, and aspects explicitly or implicitly disclosed herein.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1-20. (canceled)

21. A method for use in integrating multiple computer data systems of third parties, comprising the steps of:
(a) for a particular one of the third parties,
(i) providing a platform having predefined content,
(ii) enabling or disabling, by a user, elements of the predefined content for the system integration of the particular third party,
(iii) adding, by a user, additional content to the platform for the system integration of the particular third party, and
(iv) providing a relational specification between the computer data systems using the platform for integration of the computer data systems of the particular third party; and
(b) for another one of the third parties,
(i) providing the same platform having the same predefined content,
(ii) enabling or disabling, by a user, elements of the predefined content for the system integration of the other third party,
(iii) adding, by a user, additional content to the platform for the system integration of the other third party, and
(iv) providing a relational specification between the computer data systems for integration of the computer data systems of the other third party.

22. The method of claim 21, wherein step (a)(iv) of providing comprises displaying the relational specification on a display.

23. The method of claim 21, wherein step (a)(iv) of providing the relational specification comprises printing the relational specification.

24. The method of claim 21, wherein step (a)(iv) of providing the relational specification comprises saving the relational specification to a computer-readable medium.

25. A method for facilitating integration of multiple computer data systems, comprising the steps of:
(a) providing a platform having predefined content, the predefined content including predefined business terms and logical documents comprised of one or more of the predefined business terms,
(b) adding, by a user, additional content to the platform, such additional content including new business terms and new logical documents comprised of one or more of the predefined business terms and the new business terms, and
(c) mapping, by a user, data fields from each of the computer data systems to the business terms of the platform.

26. The method of claim 25, further comprising the step of saving, by the user, the mappings performed in said step (c) to a computer-readable medium.

27. The method of claim 25, further comprising the step of providing a relational specification between the computer data systems using the platform for integration of the computer data systems.

28. The method of claim 27, wherein the step of providing the relational specification comprises displaying the relational specification on a display.

29. The method of claim 27, wherein the step of providing the relational specification comprises printing the relational specification.

30. The method of claim 27, wherein the step of providing the relational specification comprises saving the relational specification to a computer-readable medium.

31. The method of claim 25, wherein the additional content includes an alias that is associated with predefined content.

32. The method of claim 25, further comprising the step of modifying the predefined content.

33. The method of claim 25, further comprising the step of modifying, by a user, the additional content.

34. A method for facilitating integration of multiple computer data systems, comprising the steps of:
(a) providing, to a user, a platform having predefined content, the predefined content including predefined business terms and logical documents comprised of one or more of the predefined business terms,
(b) allowing the user to add additional content to the platform, such additional content including new business terms and new logical documents comprised of one or more of the predefined business terms and the new business terms, and
(c) allowing the user to map data fields from each of the computer data systems to the business terms of the platform.

35. The method of claim 34, further comprising the step of saving the mappings performed in said step (c) to a computer-readable medium.

36. The method of claim 34, further comprising the step of providing a relational specification between the computer data systems using the platform for integration of the computer data systems.

37. The method of claim 36, wherein the step of providing the relational specification comprises displaying the relational specification on a display.

38. The method of claim 36, wherein the step of providing the relational specification comprises saving the relational specification to a computer-readable medium.

39. The method of claim 34, wherein the additional content includes an alias that is associated with predefined content.

40. The method of claim 34, further comprising the step of allowing the user to modify the predefined content.
